(19) United States
(12) Patent Application Publication
(10) Pub. No.: US 2005/0240428 A1
(43) Pub. Date: Oct. 27, 2005

(54) System for automating and managing an IP environment

(76) Inventors: John J. Gabrick, Pittsburgh, PA (US); Cassius Elston, Sammamish, WA (US); Charles Monfradi, Wheeling, WV (US); Mark Infantino, Washington, PA (US); Michael R. Sarnowski, Bridgeville, PA (US); Andrew Formica, Bridgeport, WV (US)

Correspondence Address: PATRICK M. DWYER;MINDMATTERS TECHNOLOGIES, INC., SUITE 114, 1818 WESTLAKE AVENUE N, SEATTLE, WA, 98109, US

(21) Appl. No.: 10/985,731

(22) Filed: Nov. 10, 2004

Related U.S. Application Data
(63) Continuation-in-part of application No. 10/459,116, filed on Jun. 10, 2003.
Application No. 10/459,116 is a continuation-in-part of application No. 09/709,900, filed on Nov. 10, 2000.
(60) Provisional application No. 60/520,061, filed on Nov. 13, 2003.

(51) Int. Cl. G06F 17/60

(52) U.S. Cl. 705/1

(57) ABSTRACT

A system for automating and managing an intellectual property environment in an organization over a network of computers. The system has user interface displays on each of the computers, and includes computer readable code devices in computer readable media for displaying, and methods for displaying, a number of management tools in the form of frames or screens or pages that provide for users submitting and sharing innovations, innovation analysis, finding experts for collaboration and evaluation of innovations, highlighting, spotlighting and showcasing innovations and innovation development, creating and responding to innovation challenges, and timelining, tasking and workflow peculiar to innovation management in an organization.

This application is a continuation-in-part of Ser. No. 10/459,116 filed Jun. 10, 2003; which is a continuation-in-part of Ser. No. 09/709,900 filed Nov. 10, 2000; this application also claims priority to Provisional Ser. No. 60/520,061 filed Nov. 13, 2003.

### TECHNICAL FIELD

The invention relates to knowledge management systems; more particularly it relates to systems for automating and managing an enterprise IP environment, with global communications network capabilities.

### BACKGROUND OF THE INVENTION

The significance of intellectual property (IP) is growing daily. More and more, corporations realize the importance of preserving and protecting these vital assets, and a select few even appreciate how to capitalize on them. However, the real underlying issue that has not been addressed, up until now, is that in today's digital enterprise there is a tremendous need for a reliable, real-time system for creating, preserving and building value from corporate IP assets. This model must be in synch with today's digital world and enterprise environment and operate on a continuous, real time basis. It must work transparently with the way in which employees work and innovate. It must be a useful productivity tool for IP attorneys and corporate counselors. And it must safeguard and protect the most valuable assets a company owns, its intellectual capital.

Many companies are only now recognizing the rise in significance of IP as a core asset. However, even with heightened awareness, most continue to operate in antiquated ways, relying on “defensive mechanisms,” such as legalistic paperwork and cumbersome procedures. These techniques are expensive, time-intensive, and inadequately suited for today's digital environment, since they fail to operate in real time.

Today, very few companies use the potential of information technology to streamline processes, promote new innovation, and document and protect their assets. Often, their employees at just about every level are undereducated and unaware of the risks of inadvertent disclosure or competitive loss—setting the stage for future disputes and often leading to litigation, or even worse, the permanent loss of valuable trade secrets.

Most significantly, virtually all corporations underestimate the strategic value of their IP, and therefore, fail to capitalize on the full potential of it. And even while recognizing the growing significance of IP assets, there are essentially no companies that do an effective job at providing the knowledge-connectivity™ and incentive for new innovations.

In today's job market, employees are more mobile than ever before. Mergers, acquisitions, and downsizing are just a few of the reasons. The result is a constantly changing workforce, and the constant creation, disclosure, and turnover of corporate intellectual property. And whereas it is perfectly legal for a highly skilled employee to leave and go to work with a competitor, taking with him or her his own skills and experience, it is not lawful to leave with proprietary company information.

These trends of higher worker mobility and the increasing value of digital assets have converged to create a tremendous opportunity for a new solution. Companies certainly want to avoid additional litigation nightmares, when even a single trade secret dispute or patent infringement suit can cost well over $1 million in legal fees. Douglas Brotz, principle scientist at Adobe Systems, commenting on a patent infringement suit described how it had cost the company more than $4.5 million in legal fees and expenses alone, not to mention over 3,500 hours of his time—the equivalent of two, full years of working time. Most remarkably, this was a case that Adobe had won, initially and on appeal. Clearly, an effective means for mitigating the risk of a costly lawsuit would be of great benefit to many leading technology companies.

For the most part, individual employees don't want or intend to break trade secret laws, steal proprietary assets or misappropriate secret files. They just want to pursue the opportunities afforded to them in the free marketplace. In many cases, the core issue, the one that becomes highly volatile, is that it is nearly impossible to discern between company IP assets and individual skills and knowledge. This is coupled with the fact that companies in general appear to do a very poor job of identifying their IP assets in the first place—as many as 62% of companies have no procedures for even reporting information loss. This tension often becomes the catalyst for another wasteful lawsuit, pitting the company against ex-employee. The company, quite self-righteously, stakes a claim to a broad range of trade secrets; and the employee, defends by pleading that the information is in the public domain, or part of his general skills and knowledge. In another high profile suit that illustrates this growing problem, Motorola, Inc. sued Intel for hiring away a number of its key employees. An Intel spokesperson said the action was taken solely to protect Motorola's intellectual property, which it characterized as its “lifeblood.”

As a further example of the seriousness of this issue, in 1998 the American Society for Industrial Security (ASIS) reported that IP losses for U.S. companies might exceed $250 billion annually. Furthermore, five times more companies feel the issue of intellectual property loss is increasing. With the nation's competitiveness riding on our ability to maintain technological superiority, losing trade secrets can be devastating. What makes matters worse is that most companies don't know, nor have they taken action to find out what their specific trade secrets are, and whether or not they are legally protected. This only adds to the potential of a future lawsuit, since only a lengthy hearing of the facts can ultimately determine the “right and wrong.”

Slow, expensive and outmoded legal precautions, and time-consuming audits are not the answer in this day and age of rapid product development. To keep their competitive edge, and to promote innovation and capitalize on knowledge assets, there is a need for a new solution-an innovative way of managing IP property.

In the past, intellectual property was not as pressing an issue as it has now become. The connection between an idea and the creation of wealth was less direct, and the road from the one to the other was traveled at a more leisurely pace. By contrast, in today's information-intensive economy, that connection is immediate and intense. Knowledge is now the driving force behind innovation and the creation of new wealth.

Within many of today's companies, innovation fuels high market caps, not tangible assets as in the past. The trends of higher worker mobility and widespread litigation, coupled with the increasing value of digital assets have converged to create a tremendous opportunity for a new solution.

Need for an Innovation Management System

The preponderance of adjectives such as “monitoring,” “protection,” “litigation,” and “security” immediately conjures up images of “Big Brother.” And while proper oversight cannot and should not be ignored, this functionality in and of itself fails to address an even more important issue: How effectively do companies promote innovation? After all, if you accept the fact that IP is becoming more and more critical, then shouldn't companies treat it like their corporate lives depend upon it?

Most companies do very little to tap into the vast resources of knowledge that exist inside their own organizations. One Fortune 100 Company offers a $100 dinner-for-two award for new ideas submitted by email to the corporate counselor. That's not much of an incentive, when you consider the other options available to today's employees, especially those with an entrepreneurial drive, and the ready supply of venture capital that exists.

Many of these companies rely on a perceived underlying expectation that their employees will automatically produce new innovations, as if obligated merely by the fact that they receive a paycheck and benefits. And most companies employ legal covenants that dictate the assignment of new ideas to the company, if developed on company time, with company resources, or which relate to the company's business. That mind set may have worked a generation ago, but it doesn't meet today's needs, or work for today's dynamic job market. After all, who gets to decide where one idea starts and ends? Who owns an idea that may not have been reduced to practice by the employee while he worked for the company? Ownership issues can destroy the potential of a new concept before it gets off the blocks.

It just does not appear that legal pressure is the best way to promote the creation of new ideas. Nor does it appear that employees, particularly the most savvy ones, will naively turn over their best and brightest ideas without some reasonable incentive or recognition, especially as they become more aware of the potential value. Considering that the ideas that gave birth to over 70% of the country's 100 fastest growing companies came from previous employment, it is easy to appreciate the significance of this issue. Today, most companies fail to recognize this, and consequently, they wonder why some of their best talent leaves to pursue other opportunities—including business ideas that they originated while working for their previous employer.

A survey published in the Harvard Business Review reported that “71% of entrepreneurs responsible for starting the country's 100 fastest growing companies developed their ideas through their former employment—either by recognizing an opportunity that the former employer didn't appreciate or even know about, or by improving upon some aspect of the company's products or services.”

Overall, the existing corporate infrastructure and antiquated operating methods are poorly designed to deal with today's climate. In this fiercely competitive world just providing a job doesn't do nearly enough to promote innovation—the ultimate goal for progressive companies. What is needed is an Innovation Management System.

Existing Technology in the Knowledge Management Field

The Knowledge Management industry is quickly consuming the myriad fragmented and disparate niche industries that have evolved over the past two decades, including document management, search and retrieval, repositories, object technology, workflow, and most recently the intranet. According to Delphi Consulting Group, buying trends for IT will revolve around this central theme for the next decade.

The most significant aspect of this industry is the growing awareness of the increasing amount of useless data—in other words, no information—in a typical company. Strategically, companies are realizing that knowledge is the key driving force in the next decade, and systems which help manage documents, search, and aid collaboration are desperately needed. In one survey, nearly half (43%) of the survey population regarded knowledge management as an opportunity to add value to information inside and outside the organization. But nearly as many respondents (37%) viewed knowledge management in a very different light—as a “major new strategic initiative for staying competitive.” Overall, 80% view knowledge management as providing an important contribution to business practice, and 46% of that group views knowledge management as strategic.

The data however clearly show that while employees are the primary sources of information in the company, all of the current solutions have focused on the remaining items: paper documents, electronic documents, and databases.

The data also reveals that the biggest obstacle is culture. The current business climate simply does not address the needs and wants of the typical knowledge “gold-collar” worker. These employees typically don't trust the “system.” Highly skilled workers know they can leave the corporate environment and get better returns, higher salaries, stock options, and greater opportunities than by simply handing over important innovations. Employees are even heard to say “why should I give ABC company my ideas, I'm going to start my own company.”

Accounting and valuation begin with documentation. A company with an expensive piece of capital equipment is sure to be aware of it. But most companies have valuable intellectual capital that they do not fully recognize. Many technology companies, for example, with dozens, hundreds or thousands of patents do not have a coherent catalogue of their patents, let alone an analysis of how their patents might be useful and how they might be exploited for economic and competitive gain.

These trends don't just apply to a limited number of high technology companies. Even companies not directly involved in high tech must realize that a substantial portion of their overall assets relate to intellectual property or capital. For instance, a small manufacturer may possess unique mechanical know-how, process knowledge, or techniques that create competitive space. Service companies use proprietary calculations and customer lists to their advantage. The implications of managing IP reach just about every industry classification and category.

The following needs can be identified among companies that produce IP. They need to organize intellectual property so that it can be quickly retrieved, filtered, and sorted by multiple criteria; they need to create an environment conducive to innovation by inspiring IP creation, sharing IP across the corporation, and promoting the intellectual output of individuals within the firm; they need to increase the value of corporate IP assets; they need to slow employee turnover and keep key employees from moving outside the company to start new enterprises; they need to communicate to employees, joint venture partners, and others that it is serious about protecting it's IP, and want to be sure that these same people have acknowledged this; and they need efficient and centralized access to disparate IP-related information, such as legal contracts, signed documents, IP, and usage patterns for making decisions about departing personnel, potential patent infringement, or partnership negotiations.

A brief look at the trade secret laws in the context of a buyer of IP assets provides further illustration of the need for an Innovation Management System. Today, there is no effective way for companies to accomplish this level of analysis, cost-effectively and efficiently.

### DISCLOSURE OF THE INVENTION

A three-tiered, scalable, web-based architecture (“the system”) is disclosed to dynamically and cost-effectively promote innovation, foster learning, encourage preservation, and allow the management and maximization of corporate IP assets; a solution for automating and managing the modern-day enterprise IP environment. This system works efficiently within the legal parameters of any company environment, regardless of industry, and works in cooperation with In-house Counsel. With real-time access to key information, IP Counsel can focus on higher level, strategic issues, and not mundane documentation tasks.

A reliable, real-time system for creating, preserving and building value from corporate IP assets is disclosed. The system is in synch with today's digital world and enterprise environment and operates on a continuous, real time basis. It works transparently with the way in which employees work and innovate, it is a useful productivity tool for IP attorneys and corporate counselors, and it safeguards and protects the most valuable assets a company owns, its intellectual capital. It uses the potential of information technology to streamline processes, promote new innovation, and document and protect a company's assets. It does a very effective job of providing the Knowledge-connectivity™ and incentive for new innovations.

The system meets all of the needs identified above. Using the system, companies can organize intellectual property so that it can be quickly retrieved, filtered, and sorted by multiple criteria; create an environment conducive to innovation by inspiring IP creation, sharing IP across the corporation, and promoting the intellectual output of individuals within the firm; increase the value of corporate IP assets; slow employee, turnover and motivate key employees from moving outside the company to start new enterprises; communicate to employees, joint venture partners, and others that they are serious about protecting their IP, with assurance that these same people have acknowledged this serious view; and achieve efficient and centralized access to disparate IP-related information, such as legal contracts, signed documents, IP, and usage patterns for making decisions about departing personnel, potential patent infringement, or partnership negotiations. With the system companies can accomplish a cost effective and efficient level of analysis as to their trade secrets or any other IP assets.

This application herewith incorporates by reference, as if fully set forth herein, U.S. patent applications Ser. No. 10/459,116 filed Jun. 10, 2003; Ser. No. 09/709,900 filed Nov. 10, 2000; and U.S. Provisional application Ser. No. 60/520,061 filed Nov. 13, 2003.

The disclosed system may be viewed in several respects through the particular ways in which it can benefit an organization. Methodology, computer systems and computer readable media containing computer readable code for various code devices are all disclosed. Coding of disclosed devices, unless otherwise specified herein, is all believed to be within the capability of persons of ordinary skill in the programming art.

Stimulate Development

Organizations do not generally have means to communicate to their employees how much new ideas are valued. While inventive employees, fearing criticism for wasting time on non-assigned tasks, will often stifle their own creative ideas. Also, inventors have a natural tendency to keep their innovative ideas, research and prototypes secret, on the one hand, or to conversely share them inappropriately, on the other hand. As a result, such ideas are almost never submitted or developed within the organization, sometimes due to lack of resources, or to employee attempts to profit from them outside the organization, and sometimes just through improvident public disclosure.

The disclosed system stimulates development by rewarding innovation and encouraging inventors to share their ideas through organization wide recognition for generating ideas and sharing them, as well as recognition for the best ideas.

The following methods of giving such recognition are incorporated into the disclosed system:
1. Appearing on every home page throughout the organization is a Spotlight frame which gives recognition to a single outstanding innovation idea (note: not even a finished product, just the idea).
2. The home page has a Highlights frame that gives submitted innovation statistics for the top department, top location and most prolific innovators.
3. Data for each department and location may be viewed by anyone in the organization through the Showcase page. For each department and location the “most outstanding innovations” are displayed. In addition, data for each department and location is displayed for the last 12 months for the number of participating employees, the number of innovations shared with the organization and the number of innovations submitted to the system but kept private. This can optionally promote a sense of healthy competition between departments and locations.
4. Inventors are given a particular kind of buffer to further encourage them in entering an idea into the system (and thereby time stamping the invention). The buffer is that an idea may at the inventor's discretion be kept private within the innovator's own list until such time that they themselves forward it or submit it for review. (Meanwhile, everyone in the organization can see on the Showcase page if a department or location has many innovations being kept private and it constructively begs the question, “Why?”)
5. Each individual within the organization has a Personal Statistics page displaying the number of profile hits, submissions, analysis performed on their innovation (indicating interest in it), etc. There is a natural inclination to increase the numbers with more submissions and better ideas which generate more interest.
6. Inventors who submit ideas to the system can ask for corporate development resources and collaboration.
   Encourage Collaboration

Inventors often feel isolated within the organization. There is often no system in place to share resources or bring together individuals to collaboratively develop innovations. Again, innovations are underdeveloped, or not developed at all, because of a lack of resources both material and human.

The disclosed system stimulates development by encouraging inventors to share their ideas through the promise of resources, support and expert collaboration from within the organization. Then, the Innovator system delivers on this promise by providing the forum (to individuals at multiple levels within the organization) for expressing such needs, and a communication system for searching out the best sources and making powerful requests.

Methods of Facilitating Collaboration:

1. Information about users that is essential to innovation development is visible throughout the organization. When users are entered in the Innovator system, the Administrator creates an extensive profile outlining their areas of expertise, degrees held, papers published, etc. Users or Managers then augment these profiles through the My Profile page. These profiles are accessible through a link wherever a user's name appears in the system, for example, as the inventor of an innovation submission or attached to a comment or analysis.
2. Anyone in the organization may search through the profiles for an individual with needed resources or expertise through the Find an Expert page at any time.
3. Also any individual may view All Shared Innovations to see if any developing ideas interest them.
4. Any individual may submit Comments on a shared innovation or enter an organization wide Discussion.
5. Once inventors or managers have located individuals that may be of collaborative help, they Forward the innovation to them. The expert receives a notice on their homepage through the Innovation Notices frame, an email is generated and sent, and links to the Innovation Overview included.
6. Users may search the Innovator system automatically for collaboration possibilities by creating Collaboration Agents. These user-directed searches of the entire Innovator system database are usually scheduled by an Administrator to run once per day. The agents return notification through the Innovation Notices frame and email.
7. Upon submission of an innovation, inventors may specify Required Resources of Person-Hours, Equipment and Budget. An Add Required Resources button on the Overview page allows anyone in the organization who is viewing the innovation to add resources to the innovation. Again, notification is through the Innovation Notices frame and email.
8. The Review Committee process, while filling an evaluative role, also stimulates collaboration by bringing innovations to the attention of multiple experts in the organization.
   Direct Resources and Development in the Most Profitable Way

While organizations often have mechanisms in place for tracking and directing projects, innovations, by their nature, are often invisible to Managers and Administrators. An innovative idea needs different methods of tracking and developing since the organization may not want to commit to development and completion until a certain amount of evaluation has been performed. Innovators themselves often cannot see the organization-wide picture. Managers and Administrators know what innovations would be most timely for the profit or advancement of the company, but have no methods for disseminating prompts for those innovations. And if corporate priorities shift there is no method of communication for redirecting innovation efforts.

The disclosed system provides multiple mechanisms for directing resources in the most profitable way. Managers communicate to the entire organization what areas are considered most important for innovation. Higher level managers can see submitted innovations, required resources and the multiple areas of expertise required from the inception of an innovation and continue to direct and monitor progress. Lines of communication are opened allowing input from the entire organization as to the value of the project and the direction of the development.

Methods of Directing Resources and Energies:

1. The Breakthrough Challenges frame on the homepage disseminates throughout the organization the innovation areas considered most important. Any user may submit innovations to the challenge and the manager is notified immediately of the submission.
2. When an innovation is submitted, whether shared or kept private, a Search Agent is created to search the Innovator database for similar innovations daily. If similar innovations are found, the results are reported to the innovator through the Notices frame and by email, thus preventing costly duplication and promoting collaboration.
3. In addition, the Quick Search available from all pages, allows inventors to run searches throughout the organization at any time and Internet connected searches, such as through the USPTO database, and using Internet search engines, such as Google and Vivisimo. Articles posted to the Education Center can also keep inventors apprised of the latest developments in their fields. All these methods prevent costly development of ideas already on the market and redirect development to the leading edge.
4. Even before an innovation is shared the inventor can Perform An Analysis on the innovation using a Question Set designed by an Administrator. The Question Sets are a way of weighting various factors and scoring innovations accordingly. They are a valuable tool for communicating what is most important to the organization and which innovations deserve attention.
5. When an innovation is shared, it is visible to all in the organization. Anyone can submit Comments to the inventor or Perform An Analysis, providing the innovator with needed perspective, feedback and direction. A shared innovation is also visible to Collaboration Agents, so other inventors are automatically notified of the efforts, again, avoiding costly duplication and opening possible collaboration.
6. The Activity Log shows an inventor and Manager how much activity an innovation has generated and gives them a measure of how much interest the innovation is to the organization. An innovator may choose to put energy into the innovations of most interest.
7. When an innovation is shared by an inventor, a Manager sees the idea immediately. If the innovation is not the best use of the innovator's energies, they may Comment back to them accordingly, backed up by an organization Analysis. If the innovation is timely and potentially profitable, they may direct energies in a number of ways. They may Comment back to the innovator, start an organization wide Discussion, Forward the innovation to whom is most interested and assign Tasks to the inventor and others in the organization.
8. If the Manager deems an innovation worthwhile, he submits it to a Review Committee. In some organizations, innovators can submit directly to Review Committees. Review Committees also provide needed perspective, feedback and direction to the innovator.
9. The Innovator System provides a number of methods for tracking the progress of an innovation. Besides the Activity Log, there are the Timeline, Workflow and Tasks pages. Manager's and innovators use these displays to see at a glance the progress and direction of development, what steps are next and what is being done and not done, making timely direction possible.
   Track Intellectual Property for Protection

When employees work on an innovation in secret, there is often insufficient time/date stamped documentation for intellectual property protection purposes. Material objects associated with the innovation may not be attached to the records. Also, as the invention develops, additional documents and materials are not time/date stamped. These practices make efforts to patent and otherwise protect the invention less effective.

As innovators initiate and develop their innovations, the disclosed system automatically creates a record, time/date stamping the initial idea and every version. The system provides a method for relating all materials pertaining to the innovation.

Methods for Tracking Intellectual Property:

1. Employees are encouraged to Submit new innovation ideas from conception as described above. Even if the ideas are not shared, there is now a record made in the system of the date the idea first began development.
2. As part of the submission process, Electronic Documents are attached to the innovation. The system is able to take the creation dates from the documents.
3. The inventor is able to Update an Electronic Document and the previous versions are kept with their time/date stamp in the Innovator system database, so no information once entered is ever lost.
4. Likewise, the inventor Attaches Paper Documents and Material Objects, such as spreadsheets, drawings or sketches, source code, material samples, white paper, lab notebooks, prototypes or other objects to an innovation. At submission a unique barcode is automatically created. The user prints the barcode and attaches it to the paper document, prototype or other object, thereby providing proof of the development date.
5. Any collaborator can attach electronic and material items to the innovation. The system thereby provides a central cache for all development to be associated with the innovation and time/date stamped.
6. At any time an innovator, collaborator or manager can take a Snapshot of the innovation and the current state, attachments, description, analysis results, comments, etc. are recorded and time/date stamped.
   Facilitate Security

Employees are often unaware of intellectual property security issues. New ideas are shared haphazardly and sometimes inappropriately with friends or “around the water cooler.”

The disclosed system provides education to users regarding security in general and the security needed for each innovation. The system encourages sharing of innovations through the appropriate channels first, allowing for recognition and proper handling of sensitive innovations from their inception.

Methods of Facilitating Security:

1. Education regarding the organization's security policies and intellectual property law is available through articles and links in the Education Center. Users are attracted to the page to stay apprised of new and interesting developments in their fields, but an underlying purpose for the page is to expose and educate innovators to the necessities of intellectual property protection.
2. Through the Innovator system, the organization's administration is able to design a complex security system, setting Innovation Protection Group definitions, creating appropriate User Groups and setting User Group Access such that only the appropriate individuals will be given access to the different levels of security needed.
3. As soon as an innovation is shared, the managers and administrators can evaluate the needed security level (Innovation Protection Group) it should be assigned and Set the Status appropriately.
4. Confidentiality Messages are assigned to higher level Innovation Protection Groups and are displayed whenever the innovation data is accessed. This continually reminds workers of the need for security while working with the innovation during a sensitive time.
5. The IP Status Track page allows managers to view a history of the changes to the intellectual property Status of an innovation and facilitate the proper amount of protection.
   Evaluation Tool for Employees in Terms of Innovation

Most organizations do not have quantitative methods of evaluating employees according to their creativity, innovation and contribution to the intellectual property of the organization. Consequently, as time proceeds an organization will not reward employees for these traits and the workforce will become less and less creative and innovative.

The disclosed system provides for the collection and reporting of data relating to innovation productivity and quality. This data can be analyzed for individuals, departments, sub-departments, locations and sub-locations.

Methods for Evaluating Innovation Contribution and Quality:

1. Managers can generate dozens of Reports, both predefined in the system and designed according to their specifications, using all the data available for each employee and the hierarchies of departments and locations. A reading of the Reports step in the Manager Process will give an idea of the usefulness of such reports.
2. Review Committee Comments and recommendations expose an innovator to greater recognition than is usually possible within an organization's hierarchy and provide a record for evaluation as well.
3. For the Personal Statistics page, what statistics are generated is designed by the administration and can reflect the numbers most valued by the organization. These pages are automatically generated for each employee and available for evaluation at any time.
4. The Showcase page is a similar evaluation tool, providing statistics for each department and location.
   Alternate Uses for the System
1. Identify and encourage promising future innovators through a youth program in individual schools, districts, local areas or on a national scale.
2. Encouragement of underdeveloped societal sectors for innovation through recognition and connection to existing experts, such as minorities, girls and women and handicapped individuals.
3. Communication, tracking and resource sharing through the Internet, for worldwide issues such as environmental improvement, hunger management, disease control, health improvement and endangered species.
4. Breaking isolation, recognition and resource sharing through an Internet program for home schooled students.

### BRIEF DESCRIPTION OF THE DRAWINGS

FIG. 1 is a UML Activity Diagram (flowchart) of a presentation of steps and navigational means (the Homepage) to an innovator upon entry into the system.

FIG. 2 is a UML Activity Diagram (flowchart) of a method of allowing certain steps and navigational means to be continuously available to the user (the page Frame).

FIG. 3 is a UML Activity Diagram (flowchart) of a navigational means continuously available to the user (the Homepage Menu).

FIG. 4 is a flowchart illustrating the submission of a new innovation.

FIG. 5 is a flowchart of a means of editing and adding data to an existing innovation.

FIGS. 6 and 7 are UML Activity Diagrams (flowcharts) of a means of managing and performing steps with personally submitted innovations.

FIG. 8 is a UML Activity Diagram (flowchart) of the steps performed and optionally available once an innovation has been shared.

FIG. 9 is a UML Activity Diagram (flowchart) of a means of managing and performing steps upon all shared innovations.

FIG. 10 is a UML Activity Diagram (flowchart) of a process for introducing and retrieving responses to breakthrough challenges facing the organization using the disclosed system.

FIG. 11 is a UML Activity Diagram (flowchart) of a means of navigating to steps performed upon an innovation from an innovation's detail page.

FIG. 12 is a UML Activity Diagram (flowchart) of a means of navigating to steps from a user's biographical information page.

FIGS. 13, 14 and 15 are UML Activity Diagrams (flowcharts) of various paths of task management.

FIG. 16 is a UML Activity Diagram (flowchart) of the steps available from a graphical depiction of an innovation's timeline.

FIG. 17 is a flowchart of the various paths for and possible steps performed on forwarded innovations.

FIG. 18 is a UML Activity Diagram (flowchart) of a collaborator process.

FIG. 19 is a graphical representation of the navigation available through the Homepage Menu.

FIG. 20 is a UML Activity Diagram (flowchart) of a presentation of steps and navigational means (the Homepage) to a manager upon entry into the system.

FIG. 21 is a UML Activity Diagram (flowchart) of a means for managers of managing and performing steps upon all innovations within a manager's domain.

FIG. 22 is a UML Activity Diagram (flowchart) of a means for managers for introducing, managing and retrieving responses to breakthrough challenges facing the organization using the disclosed system.

FIGS. 23 and 24 is a flowchart of the process managers perform when an innovation is shared.

FIG. 25 is a UML Activity Diagram (flowchart) of the management reports available to managers.

FIG. 26 is a UML Activity Diagram (flowchart) of the presentation of entry steps and navigational means (the Homepage) for an administrator.

FIG. 27 is a UML Activity Diagram (flowchart) of the steps performed by administrators for security configuration.

FIG. 28 is a UML Activity Diagram (flowchart) of the steps performed by administrators for organization configuration.

FIG. 29 is a UML Activity Diagram (flowchart) of the steps performed by administrators for the innovation system itselfs configuration.

FIG. 30 is a UML Activity Diagram (flowchart) of a presentation of steps and navigational means (the Homepage) to a review committee member upon entry into the system.

FIG. 31 is a UML Activity Diagram (flowchart) of a review committee process.

FIG. 32 is a screenshot for submitting an innovation.

FIG. 33 is a screenshot for managing all personal innovations and proceeding to further steps with each innovation within the disclosed system.

FIG. 34 is a screenshot for locating users within the disclosed system.

FIG. 35 is a screenshot for attaching electronic documents to innovations.

FIG. 36 is a screenshot for attaching paper documents or objects to innovations.

FIG. 37 is a screenshot for requesting required resources for an innovation.

FIG. 38 is a screenshot for viewing analysis results.

FIG. 39 is a screenshot for finding and selecting experts within the disclosed system.

FIG. 40 is a screenshot for forwarding an innovation to other users.

FIG. 41 is a screenshot for checking the statuses of innovations under review.

FIG. 42 is a screenshot for configuring an automated search.

FIG. 43 is a screenshot for viewing all activity connected with an innovation.

FIG. 44 is a screenshot for tracking events associated with an innovation.

FIG. 45 is an element from a screenshot of a navigation device for initializing a search from any page.

FIG. 46 is a screenshot of a search method.

FIG. 47 is a screenshot for viewing and managing comments.

FIG. 48 is a screenshot for viewing and managing comments for an innovation.

FIG. 49 is a screenshot for adding a comment.

FIG. 50 is a screenshot of the initial steps prominently featured upon login to the disclosed system.

FIG. 51 is a screenshot of a showcase for departments, locations and individual innovations within the disclosed system.

FIG. 52 is a screenshot for disseminating breakthrough challenges.

FIG. 53 is a screenshot for disseminating breakthrough challenges.

FIG. 54 is a screenshot of notification.

FIG. 55 is a screenshot for requesting and managing peer review.

FIG. 56 is a screenshot for viewing and managing all shared innovations.

FIG. 57 is a screenshot for displaying biographical information.

FIGS. 58 and 59 are screenshots for entering biographical information.

FIGS. 60 and 61 are screenshots for entering and managing automated searches.

FIGS. 62 and 63 are screenshots for assigning and managing tasks.

FIG. 64 is a screenshot for viewing user and group login information and correcting the login.

FIG. 65 is a screenshot for analyzing an innovation.

FIG. 66 is a screenshot for viewing and managing all shared innovations.

FIG. 67 is a screenshot for managing a spotlighted innovations display.

FIG. 68 is a screenshot for managing a showcase display of departments, locations and individual innovations.

FIGS. 69, 70 and 71 are screenshots for disseminating breakthrough challenges.

FIG. 72 is a screenshot for assigning a status to an innovation.

FIG. 73 is a screenshot for changing the department assigned to an innovation.

FIG. 74 is a diagram depicting the configuration of security.

FIG. 75 is a screenshot for configuring security.

FIG. 76 is a screenshot for creating a report.

FIG. 77 is a screenshot for forwarding multiple innovations.

FIG. 78 is a screenshot for managing user groups.

FIG. 79 is a screenshot for configuring user groups.

FIGS. 80 and 81 are screenshots for managing and configuring innovation protection assignments.

FIGS. 82 and 83 are screenshots for managing and entering users.

FIG. 84 is a screenshot for managing and entering departments.

FIG. 85 is a screenshot for managing and entering locations.

FIG. 86 is a screenshot for e-mail configuration.

FIG. 87 is a screenshot for configuring personal statistics tracking and display.

FIG. 88 displays screenshots for creating and managing question sets used in analysis of innovations.

FIG. 89 is a screenshot for entering and configuring review committees.

FIG. 90 is a screenshot for viewing and managing the innovations that have been forwarded for peer review.

FIG. 91 is a screenshot for performing peer reviews of innovations.

FIG. 92 is a screenshot for disseminating intellectual property education.

FIG. 93 is a screenshot for viewing and managing tasks assigned to an innovation.

FIG. 94 is a screenshot for viewing and managing tasks assigned to other users.

FIG. 95 is a screenshot for viewing and printing personal statistics.

FIG. 96 is a screenshot for selecting an innovation's type.

FIG. 97 is a screenshot for configuring user groups.

FIG. 98 is a screenshot for creating and configuring review committees.

FIG. 99 is a screenshot for creating and editing innovation types.

FIG. 100 is a screenshot for creating and editing an education center.

FIGS. 101a and 101b are screenshots for creating and editing intellectual property statuses.

FIG. 102 is a screenshot for creating and editing event codes.

FIG. 103 is a screenshot for creating and editing task statuses.

FIGS. 104a and 104b are screenshots for creating and configuring user groups.

FIG. 105 is a symbol key for use with UML Activity diagrams, FIGS. 1-3, 6-16, 18, 20-22 and 25-31.

FIGS. 106-109 intentionally left out.

FIGS. 110, 111 and 112 are screenshots of navigational menus.

FIGS. 113-114 intentionally left out.

FIG. 115 is a diagram of one embodiment of innovator process options.

### BEST MODE OF CARRYING OUT THE INVENTION

Turning now to the drawings, the invention is described in preferred embodiments, sometimes by reference to numerals in the drawing figures wherein like numbers indicate like parts.

Where flowcharts have been used for illustration, the process is shown in specific sequential steps with branching alternates, but it is to be understood that the process may be performed with fewer than all of the steps, and that steps that will occur to those skilled in the art may be interposed at various places in the illustrated sequence without departing from the scope of the disclosed system.

Where UML activity diagrams have been used for illustration, a convention has been observed that takes into consideration that the disclosed process may be pursued through many alternate paths. The process is shown with steps simultaneously available where a branching bar spans several alternate paths. Based on user decisions, the process continues through one of the paths, but not necessarily all, until the user ends the process by choosing to proceed through the final branching bar to the Logout step and exit the system. It is a feature of the system that a user may proceed to any step in the system from any point within the system. For this reason, small circles have been used to indicate the close of a step or branch within the process which does not proceed to a specific next step nor result in a decision to proceed to the Logout step. Users may proceed to any other steps from this point and are not required to proceed to the Logout step and exit the system.

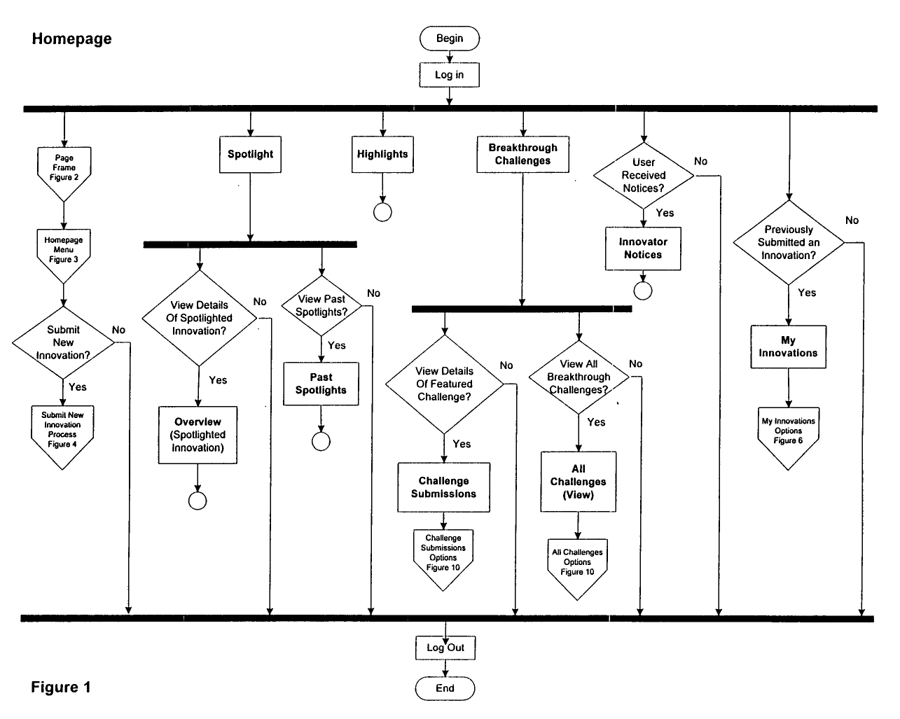

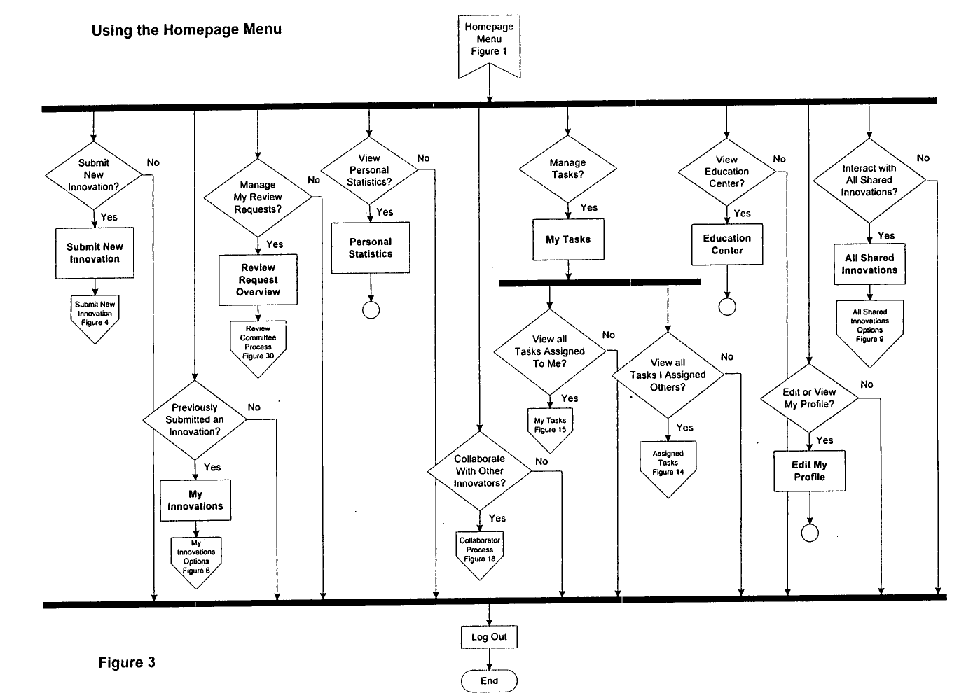

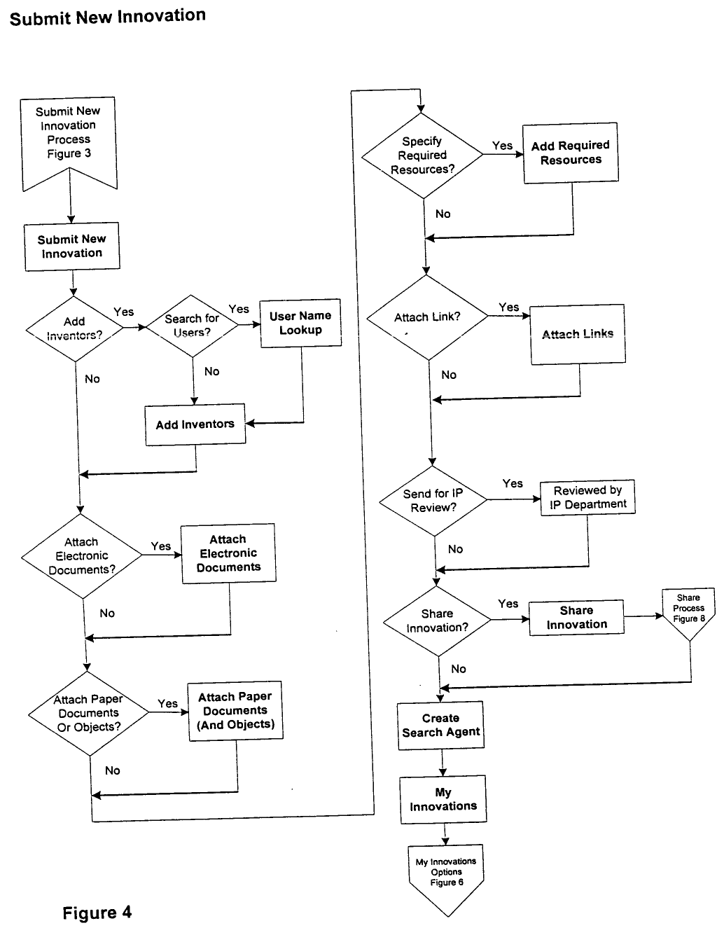

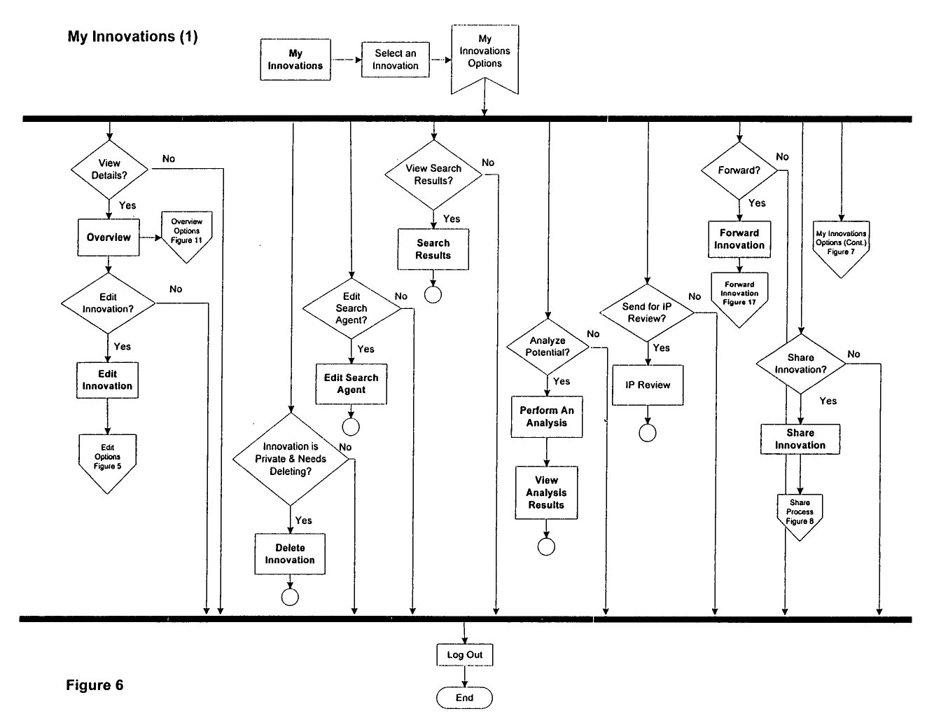

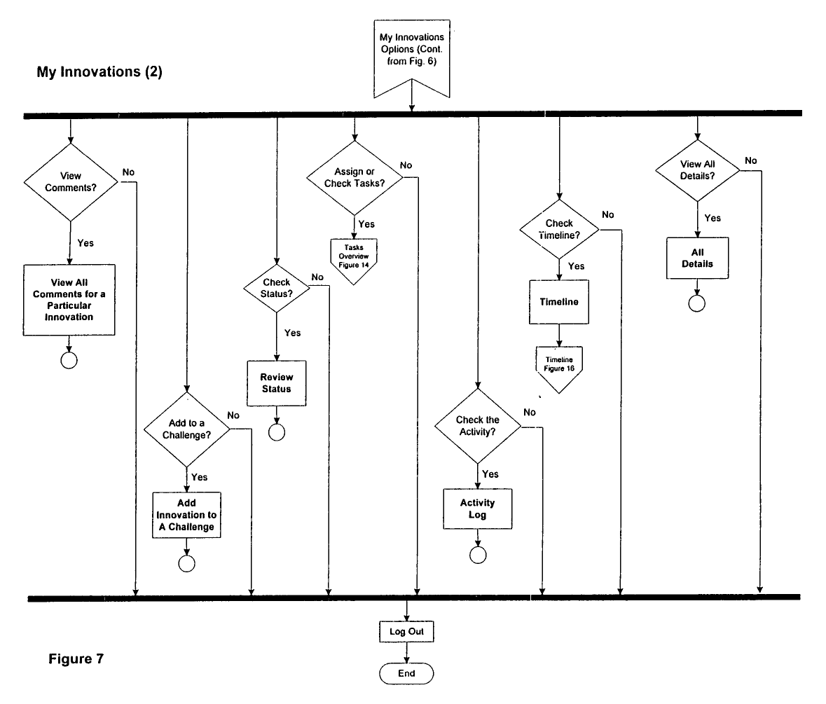

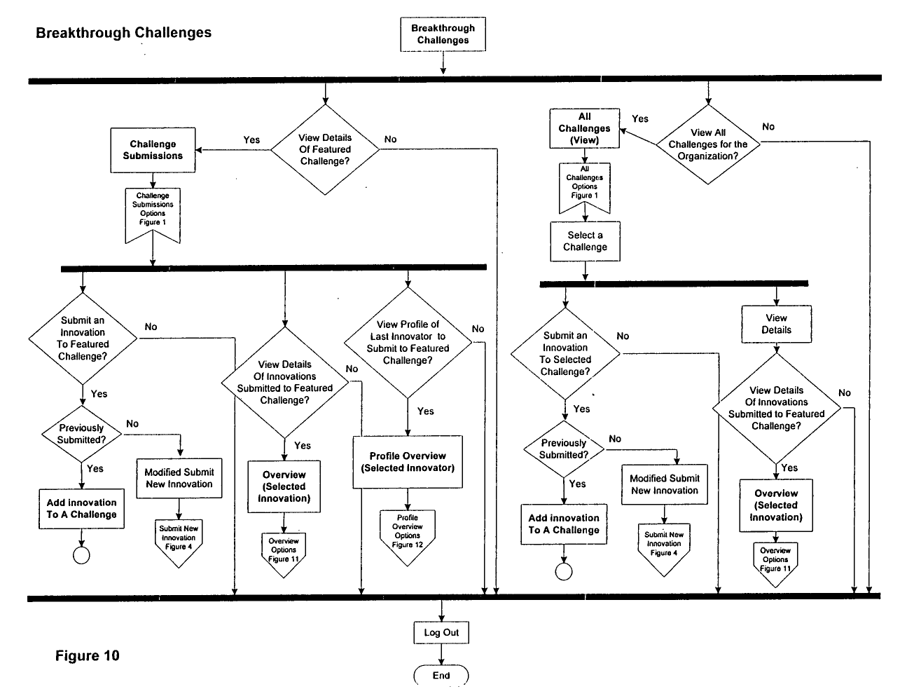

FIG. 1 illustrates a process for innovators entering the disclosed innovation management system hereafter referred to as a Homepage. Several steps are performed upon entering the system; innovators view the spotlighted innovation and organization highlights, and innovators are presented with a breakthrough challenge. An innovator may decide to view the details of the spotlighted innovation or decide to view all the innovations spotlighted in the recent past. While viewing the featured breakthrough challenge, they may choose to view the challenge details and pursue optional paths illustrated in FIG. 10, or they may choose to view all the breakthrough challenges currently facing the organization and pursue optional paths also illustrated in FIG. 10. A preferred navigation tool, hereafter referred to as the Homepage menu, is immediately available to innovators upon entering the system. The alternate paths possible through the Homepage menu are illustrated in FIG. 3. An important menu navigation option is depicted in this drawing: the option to submit a new innovation into the system. This process is illustrated in FIG. 4. In addition, there are certain events of which Innovators are immediately notified upon entering the system through an innovation notices display. If an innovator has submitted any innovations to the system, whether private or shared, these innovations are viewed upon entering the system. The innovator may, from this point, pursue optional paths illustrated in FIGS. 6 and 7.

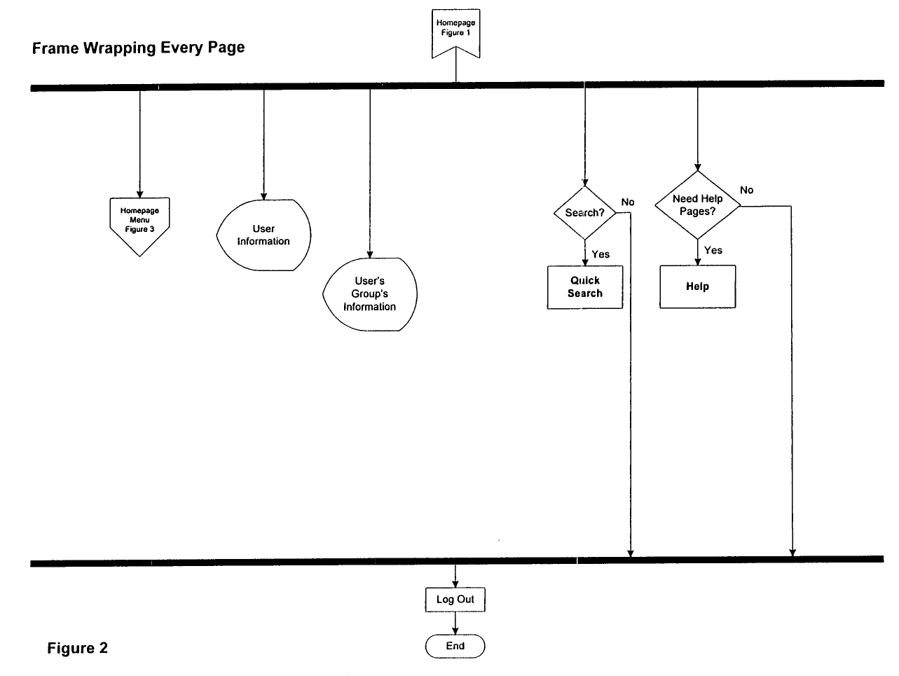

FIG. 2 is an illustration of a method for keeping certain steps and information available to the innovator throughout the processes of the system. A frame presenting these steps and information is displayed to users during every step within the process. Users view their personal information and their user group's information. They may also perform a search or access the system's help files. The Homepage menu illustrated in FIG. 3 is always available as part of this frame and optimally allows for navigation to any step in the system available to the user.

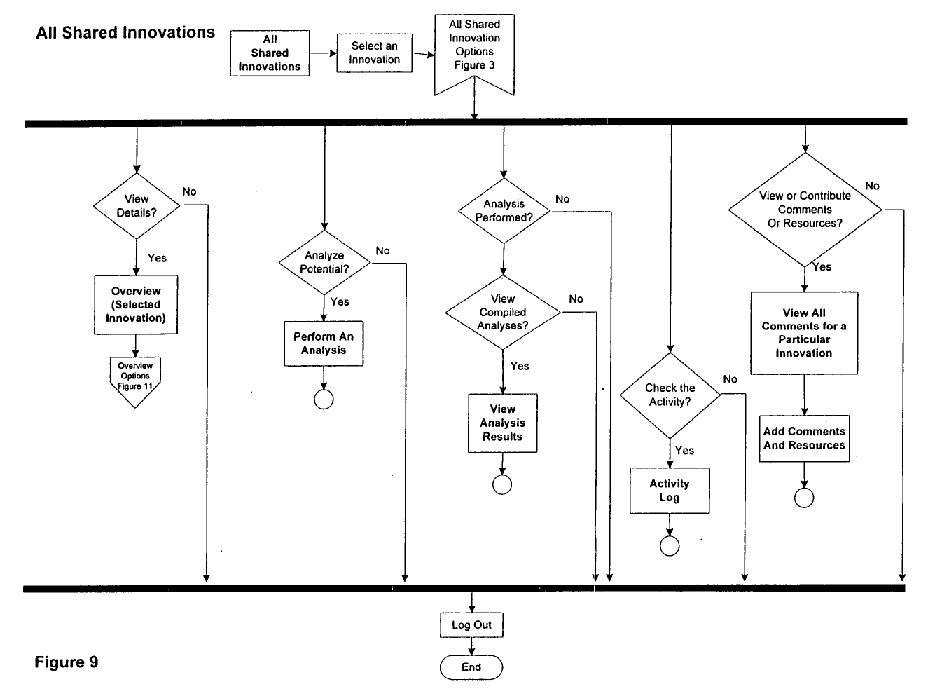

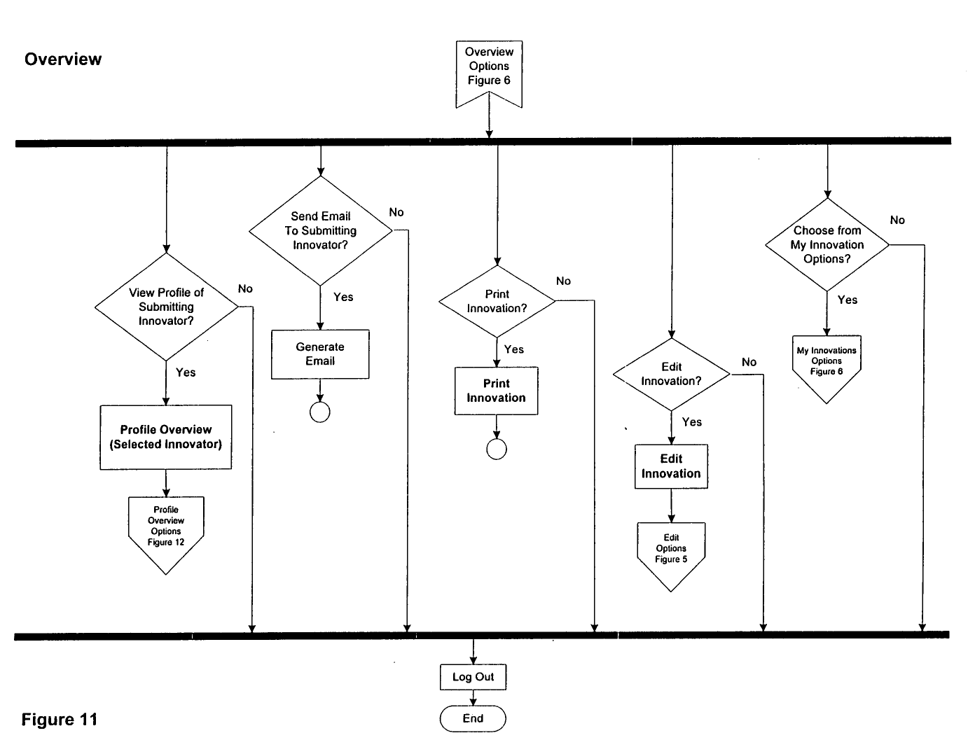

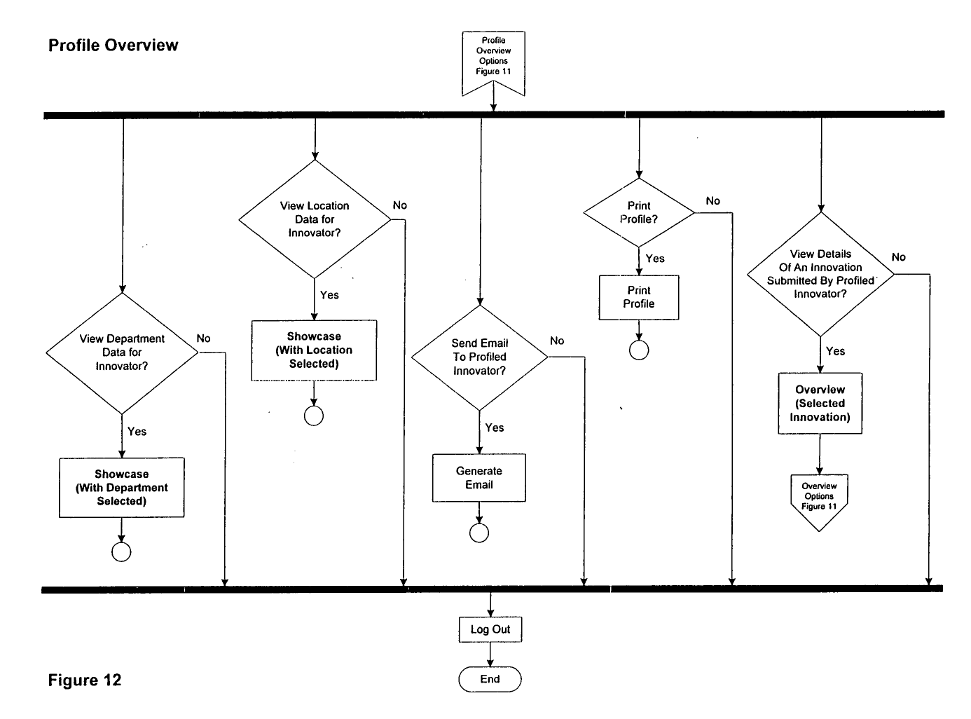

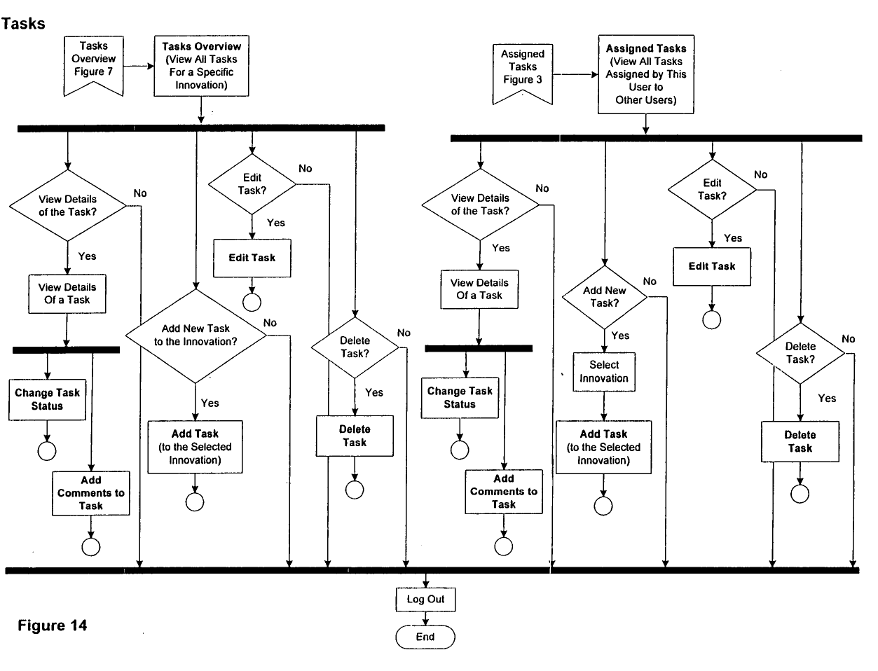

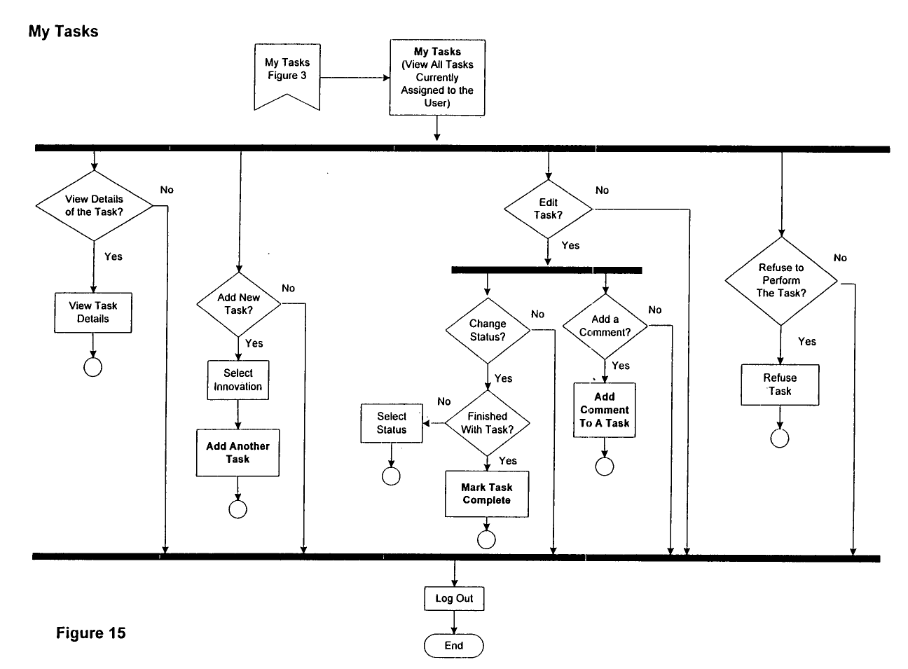

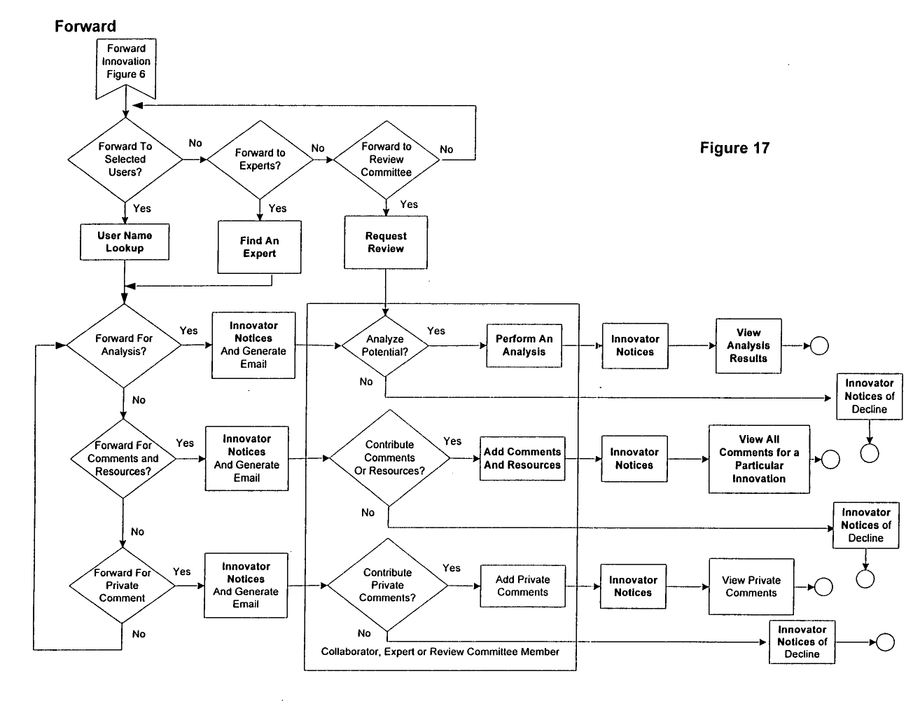

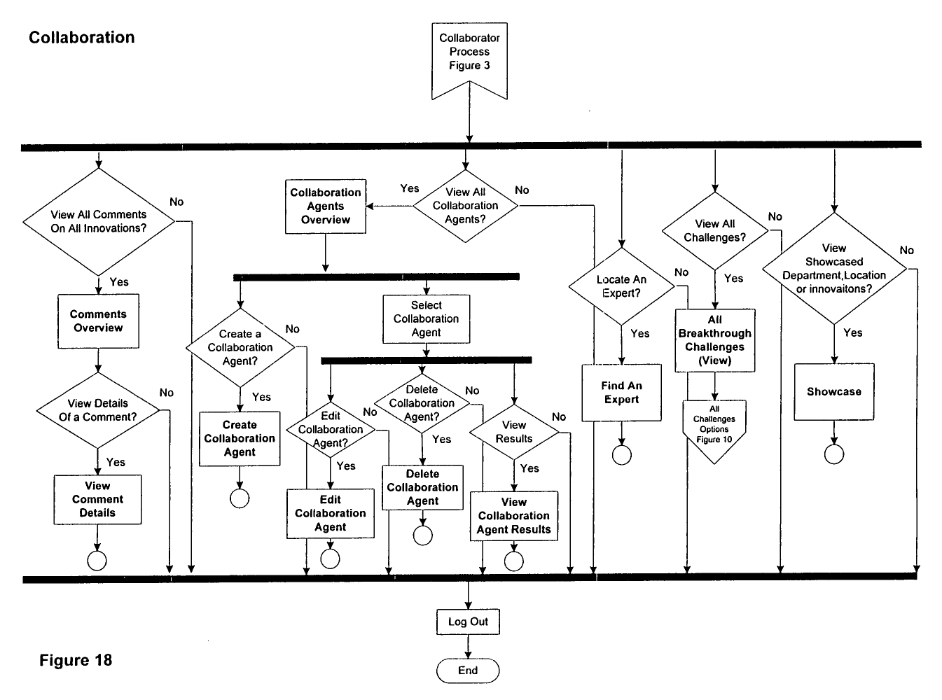

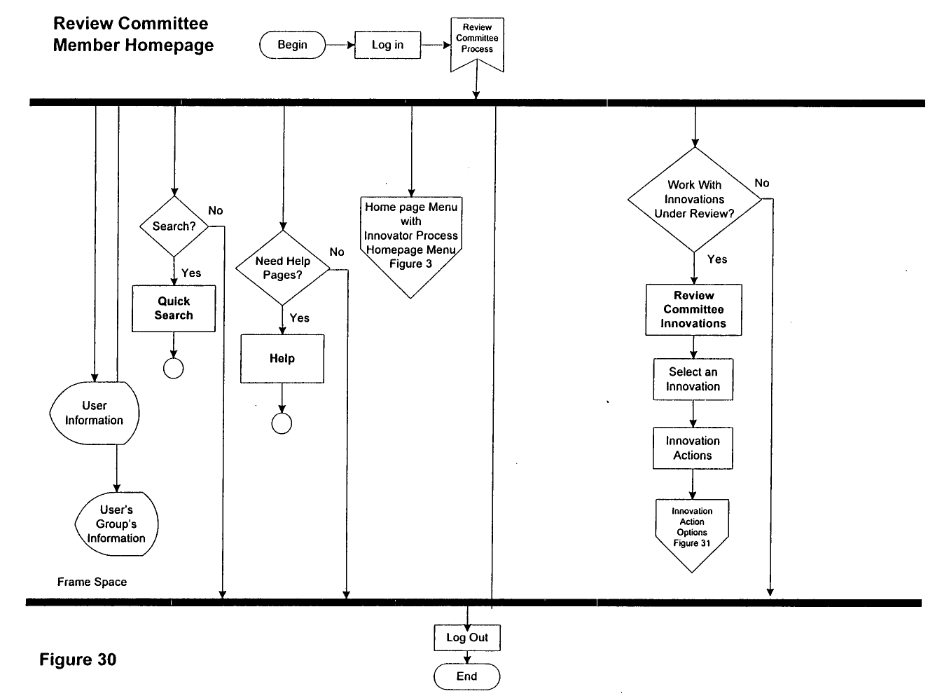

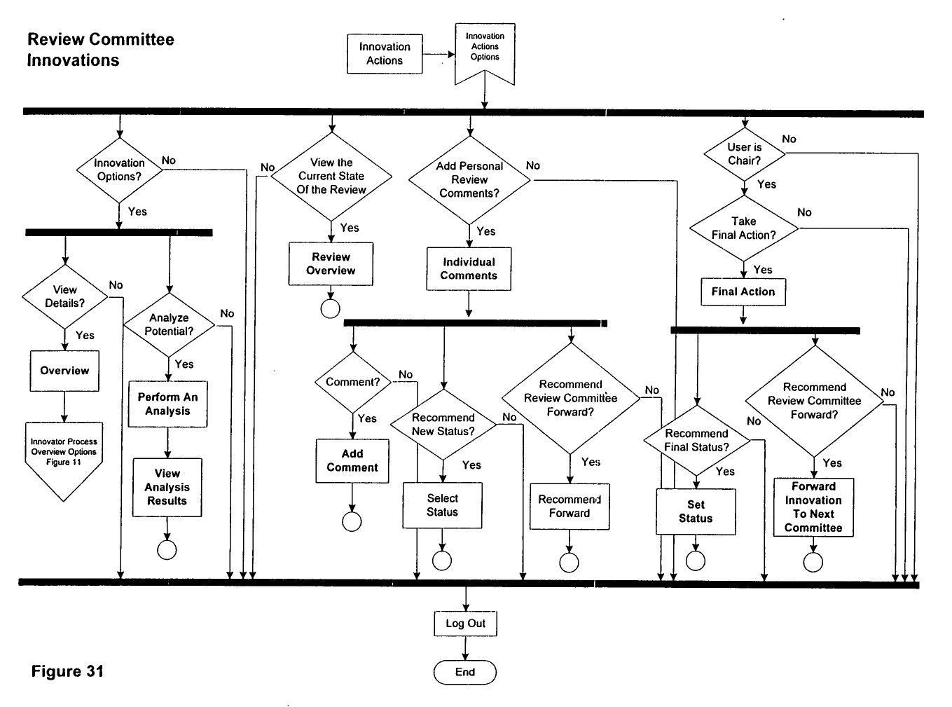

FIG. 3 illustrates the steps readily available through the Homepage menu. An innovator intending to submit a new innovation to the system selects the option and the continuation of the process is illustrated in FIG. 4. If an innovator has previously submitted any innovations, whether shared or private, they are listed as items in the Homepage menu and the optional steps that may be accessed for the individual innovation menu items are illustrated in FIGS. 6 and 7. Innovators may have requested reviews of their innovations or they may have been requested to review innovations by other users. To interact with the review request processes, innovators navigate from this point to the steps for review requests illustrated in FIGS. 30 and 31. Innovators may access a compilation of their personal statistics. Innovators may collaborate together through the collaboration process begun here, the continuation of which is illustrated in FIG. 18. If an innovator wants to manage tasks, they select either a listing of tasks assigned to them and a continuation of the process illustrated in FIG. 15, or a listing of those tasks they have assigned others and a continuation of the process illustrated in FIG. 14. From the Homepage menu, an innovator may navigate to the Education Center and obtain information about their field, the organization and intellectual property protection. The innovator may access their biographical information and continue with that process as illustrated in FIG. 12, or the innovator may choose to perform an editing of their biographical information. Alternately, through the Homepage menu an innovator may interact with all the innovations that have been shared by all the users in the system. The process of working with shared innovations is begun here and continues as illustrated in FIG. 9.

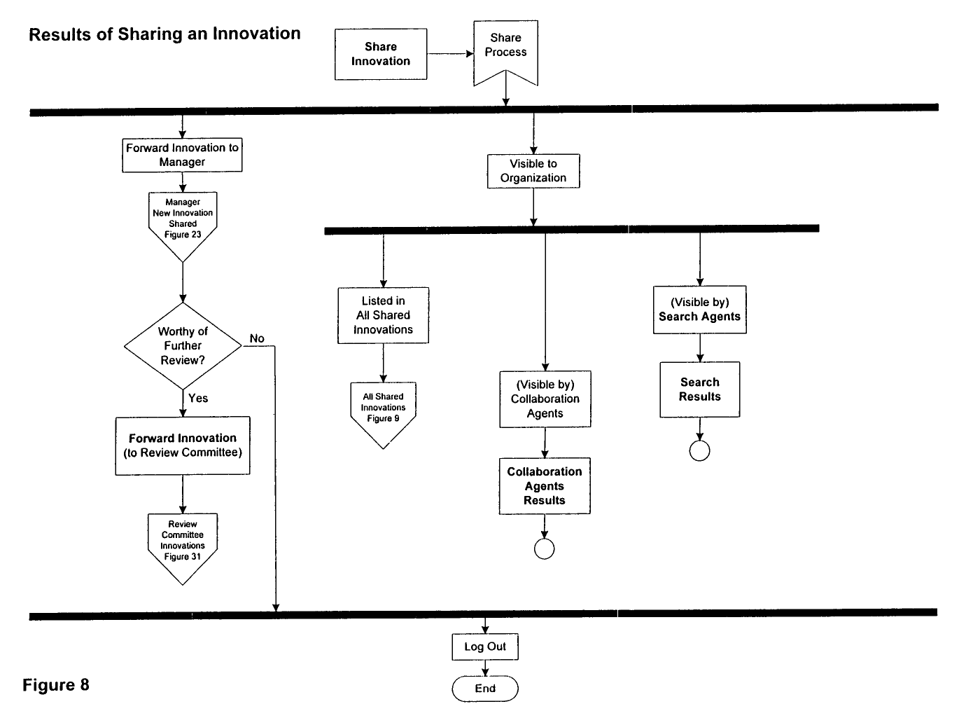

FIG. 4 illustrates a process for submitting a new innovation. Deciding in no preferred order if they will include any other inventors, and whether they are going to attach any electronic documents such as disclosure documents of illustrations. Innovators decide whether they are going to attach any other paper documents or objects, such as prototypes or materials. Objects are scanned with bar code and data attached to the innovation such that the barcode discloses information pertinent to the object and where the object is stored. Innovators also decide whether the innovation requires any resources in order to exploit or further explore the invention that is being submitted. Such resources include monetary or research resources, space resources and, in particular, experts or human resources. The innovator has an opportunity to attach a link, linking the innovation to such digital items as files, intranet and internet sites related to the innovation. This is all from the perspective of the inventor, the submitter, without benefit of feedback at this point. The innovator decides whether they are ready to send the submission to a committee for intellectual property (IP) review, and if so, notice of the innovation is forwarded to the IP department and it is accessible to the IP department through the system. If an innovator decides to share the invention, then they specifically so indicate to the system and the submission proceeds to the share process disclosed in FIG. 8. In preferred processes, even if the innovator is going to maintain the innovation as a private submission, an automated search event (search agent) is created and the innovation is listed amongst the innovations the innovator may access and the innovator proceeds to the process disclosure in FIG. 6.

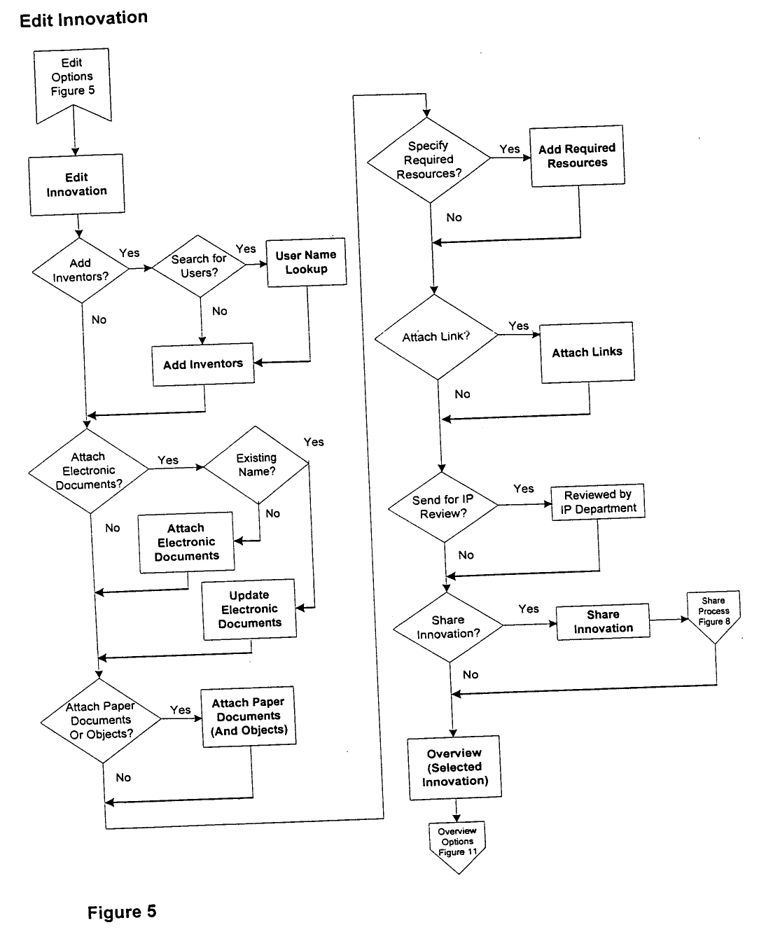

FIG. 5 illustrates a process for editing an innovation that has been previously submitted by the innovator inside of the disclosed invention management system. The innovator may add new co-inventors or collaborators. New or additional electronic documents may be added. If the electronic document is a new version of a previously attached document, the updated version will be attached, while the previous version with its time and date stamp will remain attached to the innovation for intellectual property protection purposes. If the document is completely new, it is attached in the same way as during the innovation's initial submission. The innovator has the opportunity to attach paper document references and other physical objects. A barcode is used as above. The innovator may specify further or edit existing required resources requested for the innovation and attach new or additional links to such digital items as files, intranet and internet sites. If an innovation has not been shared with the organization previously, it can now be shared, and the innovation proceeds to the share process disclosed in FIG. 8. Upon closing the editing process, the innovator is returned to an overview of the innovation data, illustrated in FIG. 11.

FIGS. 6 and 7 illustrate a means of managing and performing steps or actions upon personally submitted innovations in the disclosed system. Innovators view a display of a listing of their personally submitted innovations with relevant data for each. An innovator selects the innovation they wish to work on and an action to be performed on the innovation. The actions available include but are not limited to those described in this paragraph hereafter. The innovator may decide to view additional data for the innovation by proceeding to an overview of the innovation. Additional processing of the innovation is available from the overview as disclosed in FIG. 11. Editing of the innovation, as described above and illustrated in FIG. 5, may be performed from the overview. An innovator may delete the innovation provided that it has not yet been shared with the organization. As described above and illustrated in FIG. 4, a search agent is created for each innovation upon submission. From this display, innovators may edit this search agent or they may view all the results returned by the search agent. An analysis process is built into the disclosed system and innovators may perform this analysis or view the analysis results of not only their personally performed analysis, but of a compilation of all the analyses performed throughout the system on the particular innovation. The innovator may decide to send the innovation for review by the IP department of their organization. They may also send (forward) the innovation to another user, manager, multiple users or a formally appointed review committee and proceed to the process disclosure in FIG. 17. The options illustrated in FIG. 7 are also available as discussed below.

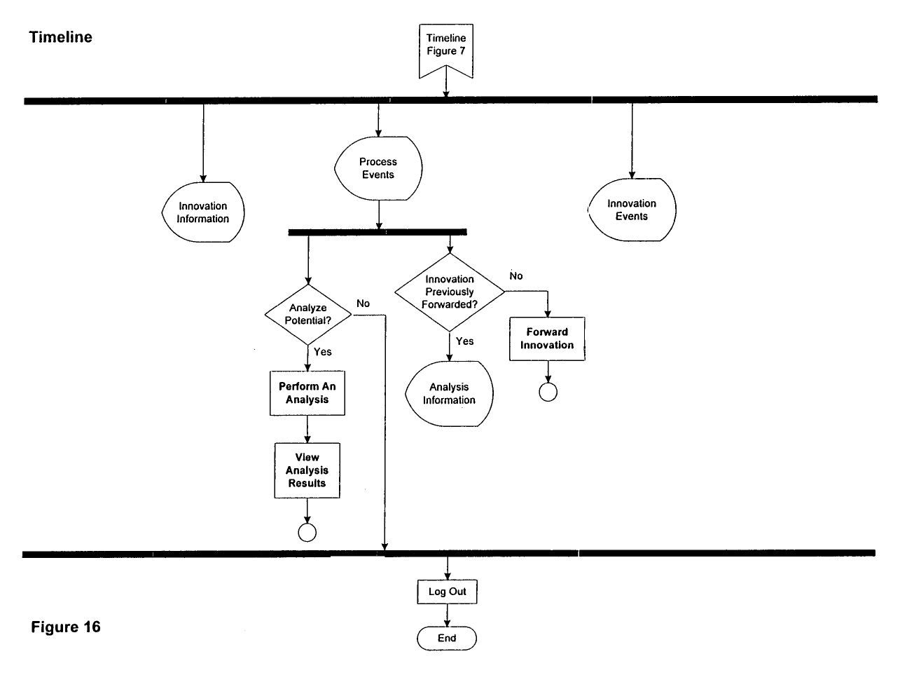

FIG. 7 continues the illustration of a means of managing and performing steps or actions upon personally submitted innovations in the disclosed system. The innovator may view all the comments submitted concerning their innovation. They may also add the innovation to a challenge posed by the organization. Innovations move through a set of statuses predetermined by the organization and the innovator may track the status history and current status. The innovator may choose to assign tasks, proceeding to the task assignment process illustrated in FIG. 14. An innovator may view summaries of all the activity performed by themselves and other users on the innovation heretofore through an activity log and they may view a graphical representation of the progress of the innovation (previous and projected events) through the timeline process as illustrated in FIG. 16. The innovator may access all the innovation data by choosing to view all the innovation details.

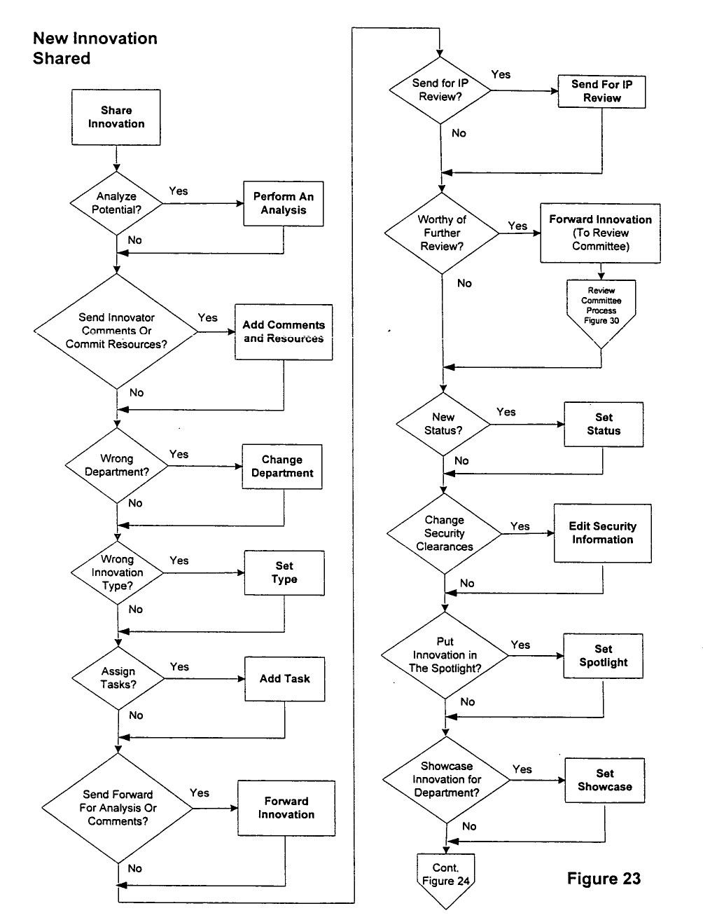

FIG. 8 illustrates the process performed when an innovation is shared in the disclosed system. Two events immediately result from the innovator choosing to share an innovation. The innovation is forwarded to the innovator's manager or head of department and the innovation becomes visible to other users of the disclosed system. When the innovation forward is received, the manager continues through the process disclosure in FIG. 23. As part of that process, they will determine if the innovation is worthy of further review and optionally forward it to a review committee to perform the process disclosed in FIG. 31. As a result of becoming visible to the entire organization (subject to security clearances), the innovation is included in a listing of all shared innovations viewable by the appropriate set of users. The actions which may then be performed by other users are illustrated in FIG. 9. In addition, the innovation becomes included in the search regions, such as databases, which are searched by automated search events, such as the collaboration agents created by the system users and search agents created whenever an innovation is submitted. The search results appear to various users throughout the system.

FIG. 9 illustrates a means of managing and performing steps or actions upon shared innovations in the disclosed system. Users view a listing of all shared innovations for which they have security clearance with relevant data for each. A user selects the innovation they wish to work on and an action to be performed on the innovation. The actions available include but are not limited to those described hereafter in this paragraph. The user may decide to view additional data for the innovation by proceeding to an overview of the innovation. Additional processing of the innovation is available from the overview as disclosed in FIG. 11. An analysis process is built into the disclosed system and innovators may perform this analysis or view the analysis results of not only their personally performed analysis, but of a compilation of all the analyses performed throughout the system on the chosen innovation. If a user is interested in the activity an innovation has generated, the user may view the activity log for the innovation. Users may view all comments attached to the innovation to date and then a user may also contribute comments or resources, such as time, budget money, lab or office space, materials or use of special equipment, to the innovation.

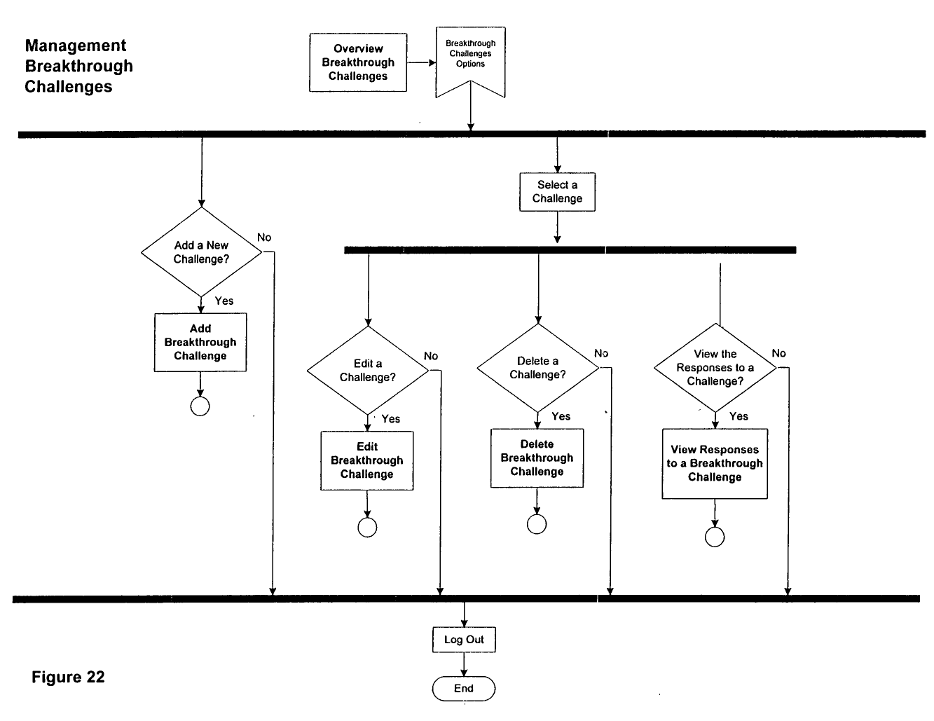

FIG. 10 illustrates a system for presenting breakthrough challenges and for receiving the responses to those challenges. As described above, the Homepage entry into the system presents a single breakthrough challenge. Alternatively, users may choose to view a listing of all the challenges currently in the system. Users may choose to view the details of the featured challenge or select a specific challenge from the listing of all challenges. While viewing the challenge details, users are given several additional step options. They may choose to submit an innovation for consideration as addressing the challenge. If the innovation they wish to submit has been submitted to the system already, they simply submit it now to the challenge and it becomes viewable to the manager who created the challenge (see FIG. 22) and other innovators in the system. If the innovation is an innovation completely new to the system, they are navigated to the process disclosed in FIG. 4 to submit the new innovation to the system. Having approached the submission from this process path, the innovation will be submitted to the selected challenge as well. Another option available to users while viewing details of the featured challenge is to view the details of any of the innovations currently submitted to the challenge. This will navigate the user to the innovation overview disclosed in FIG. 11. Alternately, the user may choose to view the biographical information of the inventor who submitted a particular innovation to the challenge. The user then navigates to the inventor's profile and has the options available disclosed in FIG. 12.

FIG. 11 illustrates the steps that are available from the detailed overview of an innovation. The user may choose to view the biographical information of the inventor who submitted the innovation and proceeds to the step disclosed in FIG. 12. Users may choose to send an e-mail message to the submitting innovator or to print the details of the innovation they are viewing. The innovator may proceed to the editing process illustrated in FIG. 5. In addition, the steps disclosed through the innovation management process in FIGS. 6 and 7 are available to users through this path.

FIG. 12 illustrates the steps available from an overview of the biographical information or profile of a selected user of the system. Users may choose to view detailed information (a showcase) of the selected user's department or location. Users may choose to send an e-mail message to the selected innovator or to print the biographical information they are viewing. Preferably, a list of the selected user's shared innovations is displayed and the user may navigate to the detailed overview of any of these innovations. From the overview, the options illustrated in FIG. 11 are available.

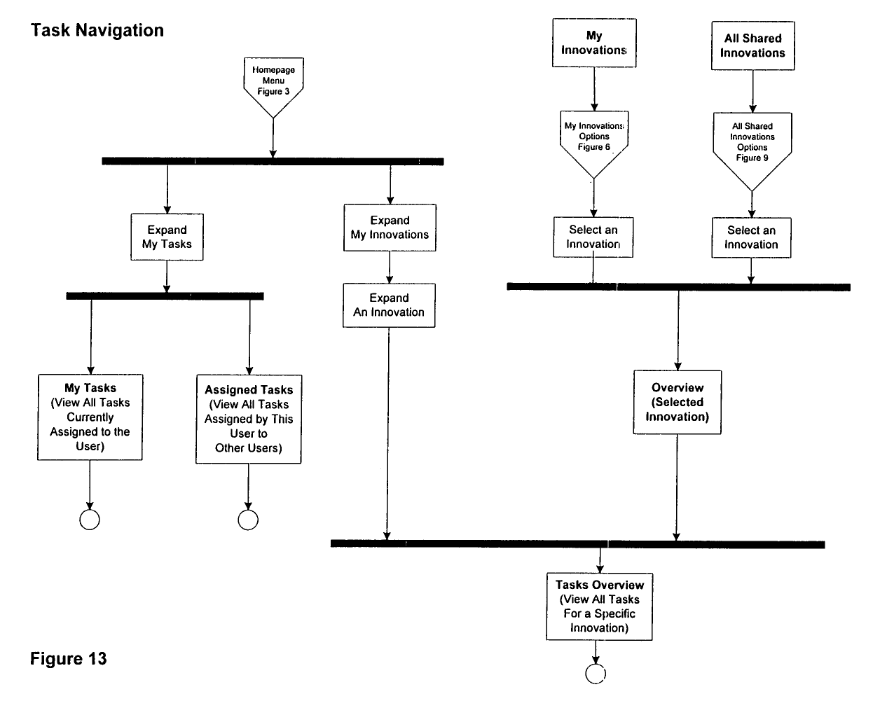

FIG. 13 illustrates navigation of the task management system. In preferred processes, access to listings of assigned tasks is flexible and managed according to the desired purpose for accessing a listing. Optimally, it is possible to access all tasks from the Homepage menu. Advantageously, several paths to individual tasks may be taken. Users select the My Tasks menu item and choose to view a listing of all the tasks assigned to them or choose to view a listing of all the tasks they have assigned to other users by selecting the Assigned Tasks menu item. Alternately, a user wishing to access a listing of all tasks associated with a particular innovation has several paths to choose from. The user may select the innovation from among their personal innovations listed in the Homepage menu and select the Tasks menu item under the innovation menu item. Alternately, the user may start on the listing of all their innovations on the Homepage, select a particular innovation and select Tasks from the options offered (see FIG. 7). If an innovation is not a personal innovation, a user may start on the listing of all shared innovations available to them, select a particular innovation and select Tasks from the options offered (see FIG. 9).

FIGS. 14 and 15 illustrate the processing available in the task management system. From the listing of all tasks for a specific innovation or the listing of tasks the user has assigned to other users, users choose a specific task. Users may view the details of the task and change the task status or add comments to the task. Alternatively, a user may add another task to the innovation associated with the selected task. Users may also edit or delete a selected task. In FIG. 15, users begin processing from the listing of all tasks that have been assigned to them. Again, they may view the task details or add another task to the innovation associated with a task they select. In addition, users can edit a task, adding a comment to the task or choosing a new status. If the task has been completed, the user chooses a status so indicating. Users are also, advantageously, given the option of refusing to perform a task.

FIG. 16 illustrates the displays and steps available through the timeline process. By selecting the timeline step, users are given a graphical display of innovation information, processing and previous and projected events. From the display a user may choose to perform an analysis or repeat an analysis. They may forward the innovation to other users for comments, analysis or as a request for resources. If the innovation has undergone analysis, data from all the analyses performed on the innovation throughout the system is graphically displayed.

FIG. 17 is a flowchart illustrating the processing an innovation may undergo through forwarding within the system. An innovator or manager chooses to forward an innovation, choosing whether to forward to selected users of the system, experts within the system or a review committee set up by an administrator. If the innovator or manager wishes to forward to selected users they are navigated to user lookup assistance. Should the forward be to experts, the system will also locate experts using the innovation's department, location, keywords and description. If a review committee is sought, a listing of all relevant review committees is displayed and the innovator or manager chooses the committee desired. In the case of a review committee forward, selection of the committee generates the request for a formal review committee analysis and all members of the committee are notified. If selected users or experts are the recipients, the innovator or manager decides whether the forward is a request for an analysis, comments and resources, or a private comment. Once this has been decided, the recipients of the forward are notified through the system and, advantageously, through e-mail. Action is now taken by the forward recipients and once the analysis, commenting or adding resources has been performed the forwarding innovator or manager is notified and may view the various results. Alternately, the forward recipients may decline to take action and the forwarding innovator or manager is notified that they have declined.

FIG. 18 illustrates the various steps available to users who wish to collaborate with other innovators in the system. A user chooses to view a listing of all comments contributed so far in the system. They then pursue a specific line of commenting by viewing a specific comment. From this point they may add comments of their own. Users may collaborate together by creating collaboration agents (regularly scheduled searches of the system for innovations with criteria of specific interest to the user) and receiving the search results. Search results allow users to pursue further follow up, such as adding comments, resources and analysis to an innovation. Users may also contact the innovator of an innovation returned by search results by sending an email or forwarding another innovation. The user chooses to view all collaboration agents and from this overview, creates, edits and deletes their personal agents. A user may choose to locate an expert or experts and start a collaboration. They may view all the breakthrough challenges posed by the organization and follow the breakthrough challenges paths illustrated in FIG. 10. A user may also view a showcase of a particular department or location to acquaint themselves with the work being done and follow up on the innovations or users displayed there.

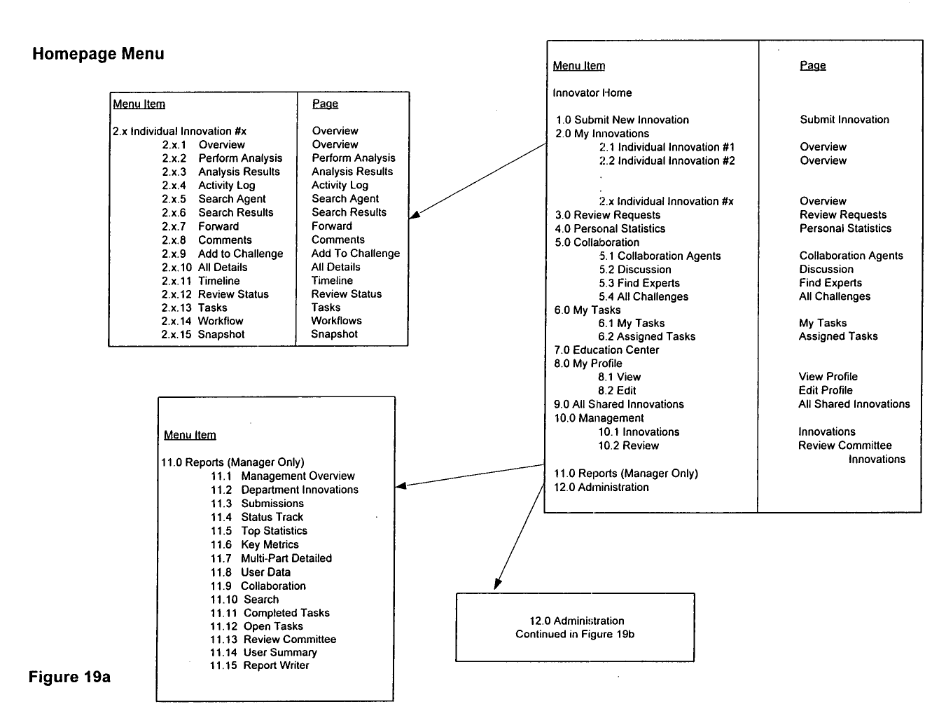

FIG. 19 illustrates the navigation of the system through the Homepage menu. In preferred processes, every process step in the system is available to innovators through the Homepage menu. Menu items are listed in one column, the page a user is navigated to, upon selection of that menu item, in the next column. The menu items are numbered. Child menu items that are available upon expansion of the parent menu item, are given a subsequent number sequence, following a period. Arrows indicate a menu item is further illustrated in the indicated box. In the case of menu item 2.0, the variable number of an innovator's personal innovations are listed. The box indicated by the arrow lists the process steps available for each individual innovation upon expansion of it as a menu item. In the case of menu item 11.0, the arrow indicates a box listing fourteen separate reports that are activated upon selection of the menu item.

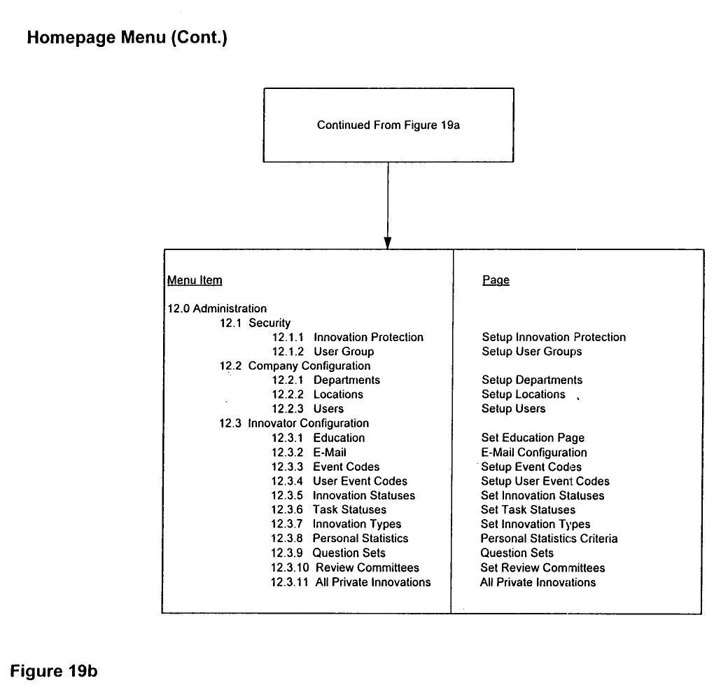

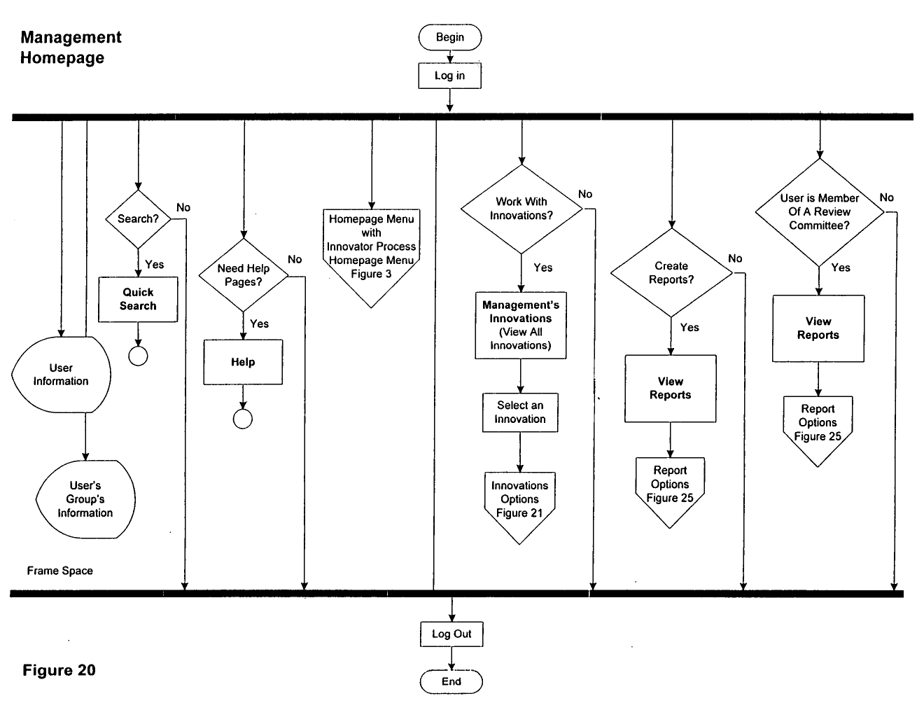

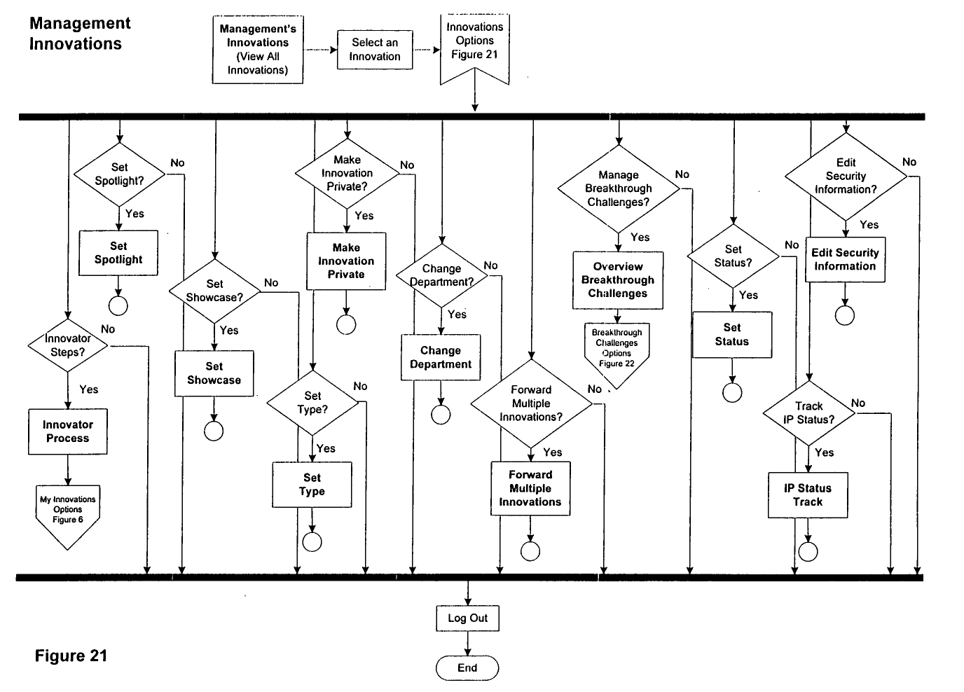

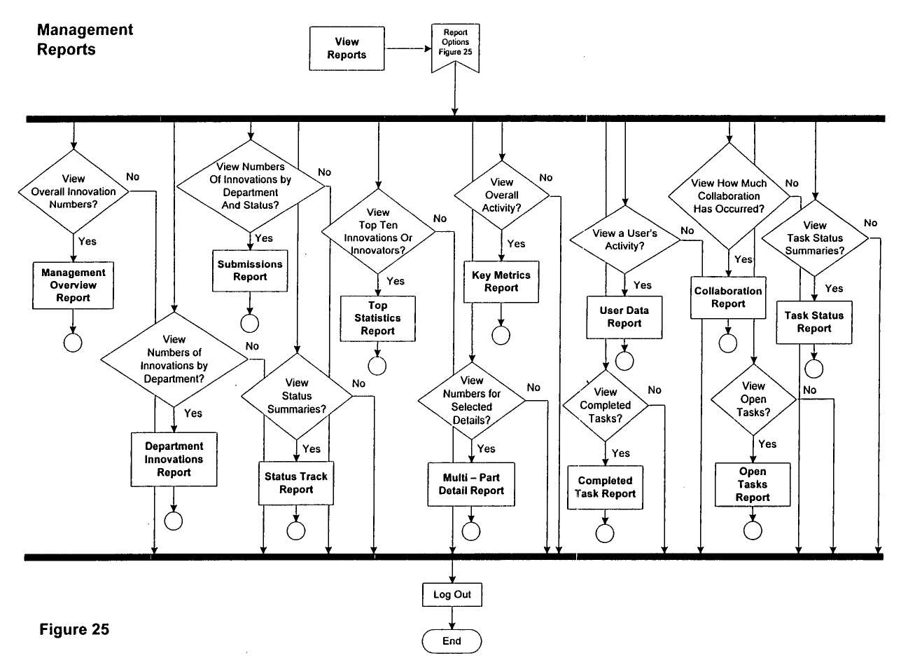

FIG. 20 illustrates a process for managers entering the disclosed innovation management system. As described above for an innovator's process, a frame presenting process steps and important information is displayed to users during every step within the system. Advantageously, included in the frame is the manager's personal information and their user group's information along with links allowing managers to perform a search or access the system's help files. A manager's Homepage menu is always available as part of this frame and optimally allows for navigation to any step in the system. The manager's Homepage menu is a composite of the Homepage menu for innovators illustrated in FIG. 3 with additional steps for managers only. Managers work with innovations that are not exclusively those submitted by themselves. A listing of all the innovations for which a manager has clearance is presented and a manager chooses the innovation they wish to work with and proceeds with any of the options illustrated in FIG. 21. An important manager-only option is depicted in this drawing: the option to generate reports. Managers have available many reports for generation as illustrated in FIG. 25.

FIG. 21 illustrates a means of managing and performing steps or actions upon innovations accessible to the manager in the disclosed system. Optimally, managers view a listing of the innovations under their supervision with relevant data for each. A manager selects the innovation they wish to work on and an action to be performed on the innovation. The actions available include but are not limited to those described in this paragraph hereafter. Advantageously, once the innovation has been shared, managers may perform any of the steps upon innovations available to the submitting innovators which are illustrated in FIG. 7. In addition, they may choose to set the spotlight frame with an innovation and, once the manager has started this process, they may choose to set and order the spotlight display. Managers control the showcase display for their department or location also through this path. Managers may change an innovation's type, make the innovation private again and change the department through which it is being managed. They may also forward multiple innovations. The management paths to entering, editing and reviewing submissions to the breakthrough challenges of the organization are available through this process and continue as illustrated in FIG. 22. In addition, managers may set the status of an innovation or view a display of the history of the IP status in order to track the IP status of an innovation. Managers also edit the security levels assigned to an innovation through this process.

FIG. 22 illustrates the management of breakthrough challenges presented to the innovators of the organization. Managers are presented with a listing of all the breakthrough challenges currently in the system and the order they will be showcased to the innovators on the innovators' Homepage. From this list a manager has the opportunity to add a new breakthrough challenge or they may choose one from the list for editing or deleting. In addition, a manager may view a listing of all the responses that have been submitted by the innovators in the system. From that point, they may proceed to overviews of the individual innovations, contact the innovators or other relevant actions.

FIG. 23 illustrates the process a manager performs when a new innovation is shared by an innovator under his supervision or forwarded by another manager or user in the system. The manager decides whether or not to analyze the innovations potential and, thereby, proceed to the analysis step. They may add comments or resources to the innovation. If the innovation is not configured correctly, the manager may change the relevant department or the innovation type. A manager may assign tasks to be associated with the innovation to the original innovator(s), other users of the system or themselves. The manager decides whether to forward the innovation for analysis or comments to other users in the system, such as experts in related fields or innovators working on similar matters. The manager also decides whether to forward the innovation to the IP department of their organization for further processing of IP protection or on to one of the organization's review committees for the process disclosed in FIG. 30. The manager then has the options of changing the innovation status and security assignments. They may choose to put the innovation in the innovator's Homepage spotlight or in the departmental showcase.

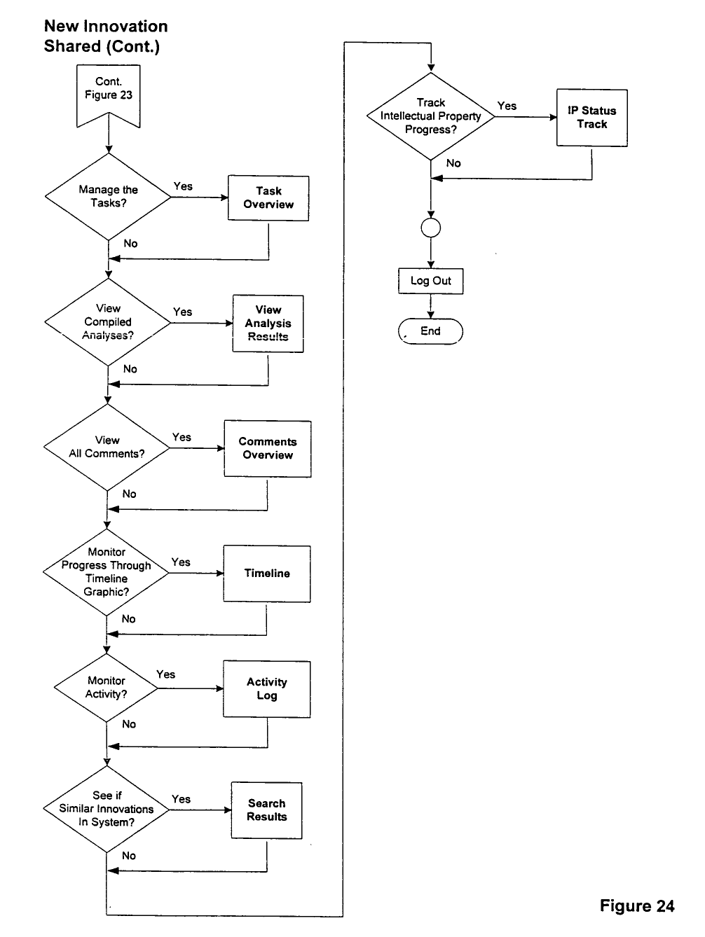

Continuing the illustration in FIG. 24 of the process a manager performs when a new innovation is shared, a manager decides whether to view or manage tasks that have been assigned by the originating innovator and, if so, proceeds to the task overview for the innovation (illustrated in FIG. 14). The manager may view a compilation of all the analyses previously performed on the innovation and all of the comments and assigned resources previously submitted. The manager may decide to view a graphical display of a timeline for the innovation of previous and projected events. Additionally, the manager may view a listing of all previous events through the activity log created for the innovation. Upon initial submission of an innovation to the system, an automated search is conducted at regularly scheduled intervals. The manager may now view the results of these searches (how many have been conducted depends on how long the innovation was kept private by the innovator). In addition, the innovator may track the IP status changes of the innovation by viewing a listing of the IP events the innovation has undergone. The manager may perform other steps on other innovations within the system or logout and exit the system.

FIG. 25 illustrates the manager's process of generating and viewing reports of specifically tailored information from the system. Such reports include but are not limited to the following reports, which are discussed in more detail elsewhere in this disclosure: management overview, department innovations, submissions, status track, top statistics, multi-part detail, key metrics, user data, collaboration, completed tasks, open tasks and task status.

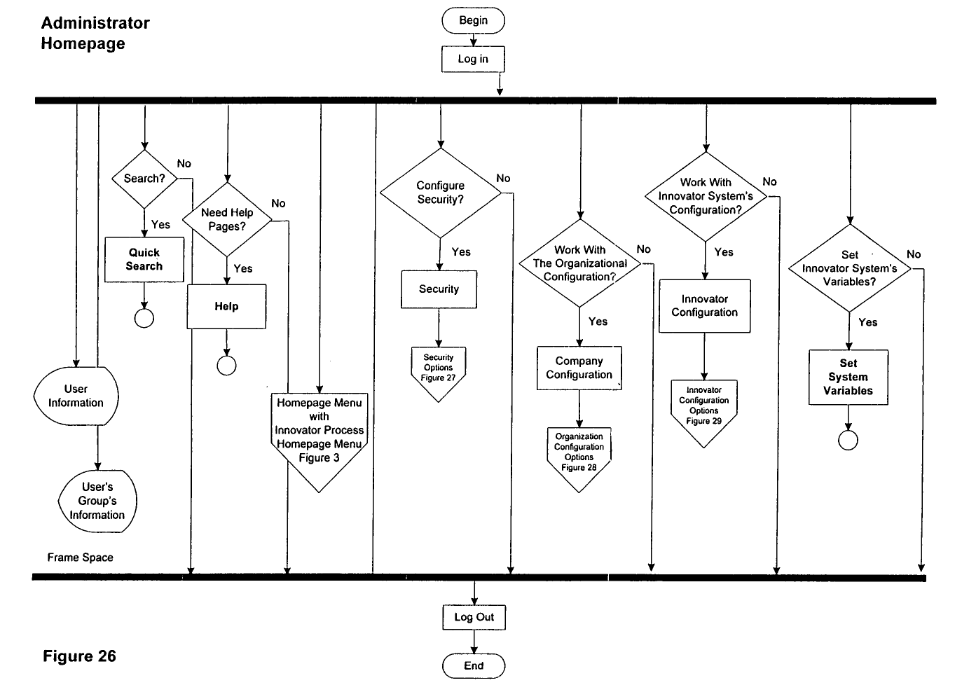

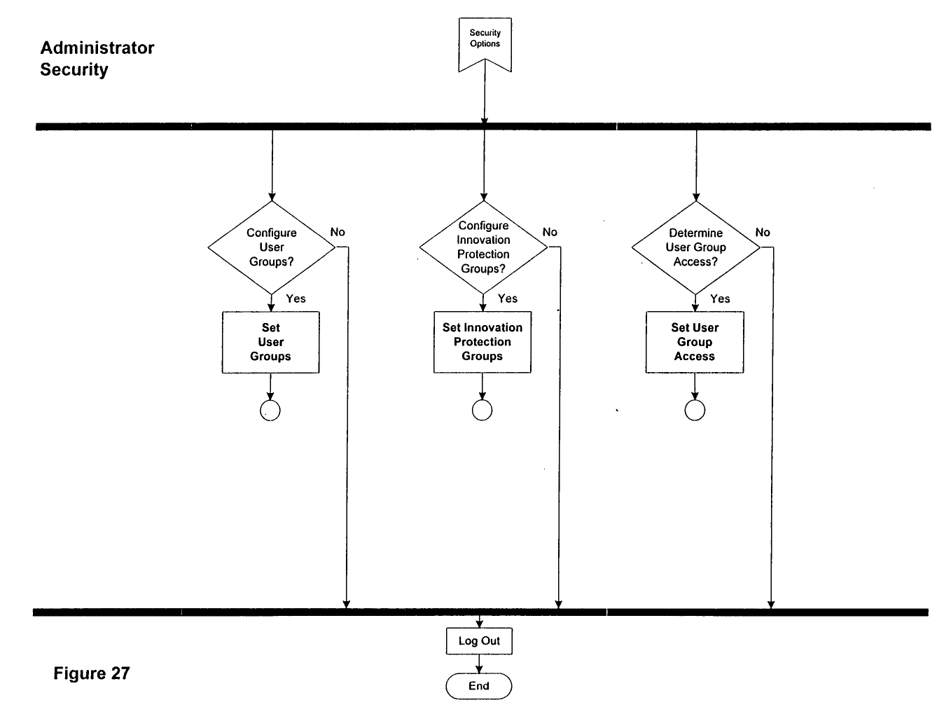

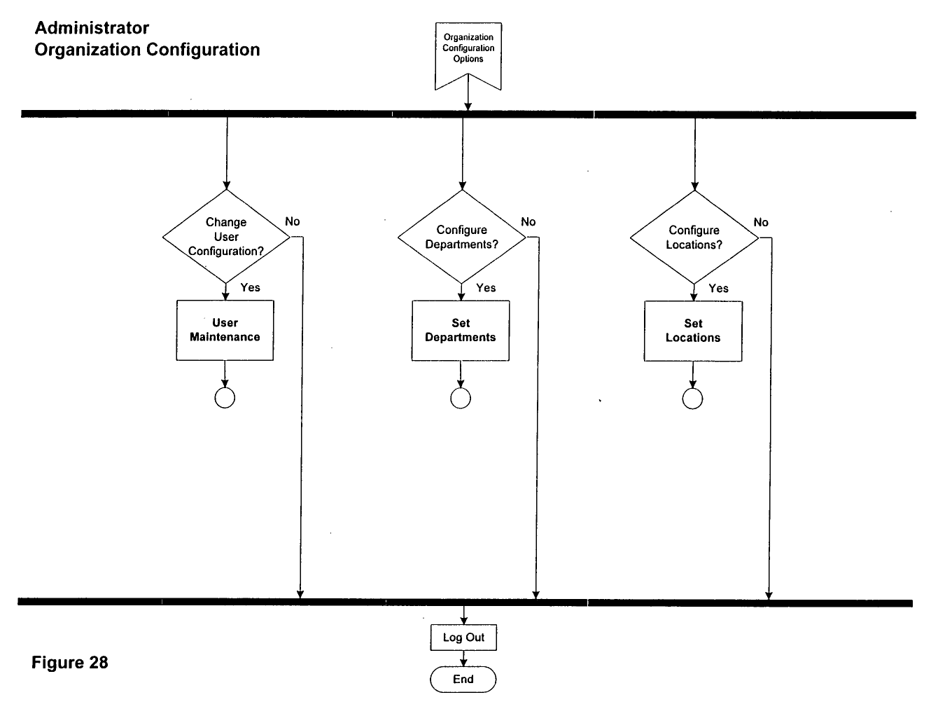

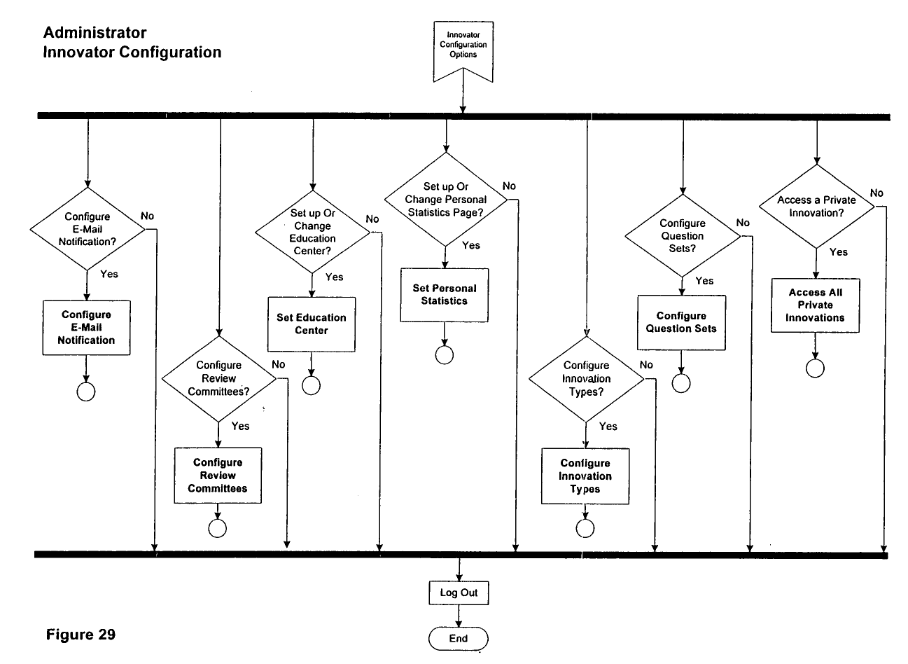

FIG. 26 illustrates a process for administrators to enter the disclosed innovation management system. As described above for an innovator's process, a frame presenting process steps and important information is displayed to users during every step within the system. Advantageously included in the frame is the administrator's personal information and their user group's information along with links allowing administrators to perform a search or access the system's help files. An administrator's Homepage menu is always available as part of this frame and optimally allows for navigation to any step in the system. The administrator's Homepage menu is a composite of the Homepage menu for innovators illustrated in FIG. 3 and additional steps for administrators only. Several important menu navigation options are depicted in this drawing. Administrators configure the security system for the organization. Administrators may decide to work with the configuration and proceed to the process illustrated in FIG. 27. Administrators also configure the structure of the organization in the system, such as the departments and locations listed and their sub-departments and sub-locations. An administrator proceeds to the process illustrated in FIG. 28 for such work. If an administrator wishes to configure the innovation management system itself, they proceed to the process illustrated in FIG. 29. Advantageously, an administrator may also choose to set or reset the system variables from the Homepage menu.

FIG. 27 illustrates the process steps by which an administrator configures the security system for the disclosed innovation management system. An administrator chooses to create and configure the user groups for the system, create and configure the innovation protection groups, or determine the user groups' access to various functions, events and innovation protection groups.

FIG. 28 illustrates the process steps by which an administrator configures the structure of the organization within the disclosed innovation management system. An administrator chooses if they wish to enter or change the data pertaining to an individual user, add edit or delete departments, sub-departments, locations and sub-locations.

FIG. 29 illustrates the process steps by which an administrator configures and manages the disclosed innovation management system. The administrator may configure the e-mail notification system. They may create, add members to, configure or retire review committees. The administrator determines the content of and creates the education center for the organization. The administrator configures the personal statistics page and configures the innovation types for the system from this process. The administrator also configures the question sets used for analysis of innovations and assigned to innovation types. Advantageously, it is possible to access all private innovations from this path.

FIG. 30 illustrates a process for review committee members to enter the disclosed innovation management system. As described above for an innovator's process, a frame presenting process steps and important information is displayed to users during every step within the process. Advantageously, included in the frame is the review committee member's personal information and their user group's information along with links allowing review committee members to perform a search or access the system's help files. A review committee member's Homepage menu is always available as part of this frame and optimally allows for navigation to any step in the system. The review committee member's Homepage menu is a composite of the Homepage menu for innovators illustrated in FIG. 3 with additional steps for review committee members only. An important menu navigation option is depicted in this drawing: the option to work with innovations under review. If so, a review committee member views a listing of the innovations under review by their committee with relevant data for each. The review committee member then selects the innovation they wish to work on and proceeds to select an action to be performed on the innovation. The actions available include but are not limited to those illustrated in FIG. 31.

FIG. 31 illustrates the steps and actions a review committee member may perform on an individual innovation under review. The review committee member may decide to view additional data for the innovation by proceeding to an overview of the innovation. Additional processing of the innovation is available from the overview as disclosed in FIG. 11. Review committee members may perform an analysis on the innovation or view the analyses results of not only their personally performed analysis, but of a compilation of all the analyses performed throughout the system on the particular innovation. The review committee member may familiarize themselves with the current state of the review by proceeding to an overview of the review for this innovation. Review committee members may continue the review process, add a comment, recommend a status for the innovation or recommend that the innovation be forwarded to another review committee. If the review committee member is also the committee's chair, final action may be taken on the innovation. The committee chair may set the final status assigned the innovation and perform the forwarding to another review committee if that is warranted.

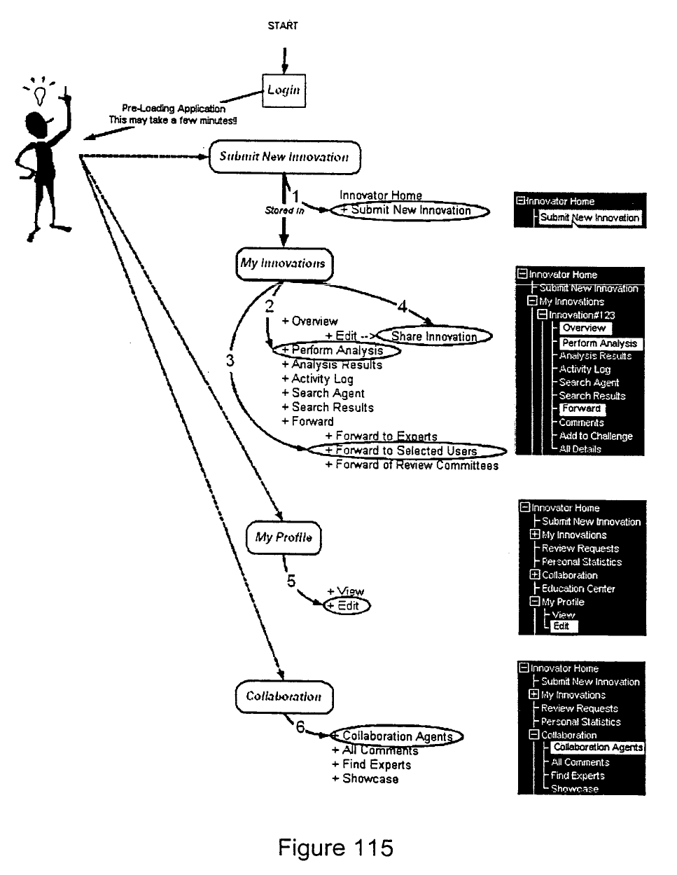

FIG. 115 illustrates an optional and selectably variable progression through one embodiment of innovation process options. Illustrated in the boxes on the right is a homepage menu that may be used to navigate an innovator to the process steps. The user starts by logging into the system, proceeds to the first step of submitting a new innovation. This innovation is automatically and preferably immediately listed in the My Innovations data grid and the user may select it and proceed to the second step of Performing an Analysis. The user may choose to Forward [the innovation] to Selected Users as a third step and, if the response is favorable, Share the Innovation with the entire organization. As a fifth step, the user elects to augment their biographical information visible to the organization through the My Profile step and as a sixth step to create Collaboration Agents which automatically search for innovations and experts related to their submitted innovation.

The following descriptions correspond to several major process categories employed in the disclosed system. It is to be noted that although the processes use a familiar web browser interface, the underlying operation advantageously differs from a typical web based system. One of the differences is that a preferred embodiment does not operate like a typical intranet solution; a typical web-based application will use point-and-click methods whereby the user clicks on a link and then the system retrieves the information associated with the link. Normally, this information is retrieved by making a request to the server and then repainting the page, which takes time. In preferred embodiments of the system, many of the pages that will be needed for a user are automatically downloaded, even while the user is logging on to the Innovator. Then a user clicks on a link or a menu item, the system has already retrieved the information needed and thus the time of going over the network is saved. The result is a faster web application. It should be noted that the typical internet browser Back and Forward buttons are not used to navigate, because users use two buttons displaying forward and back arrows in the upper left-hand corner of the system frame to effect this kind of navigation.

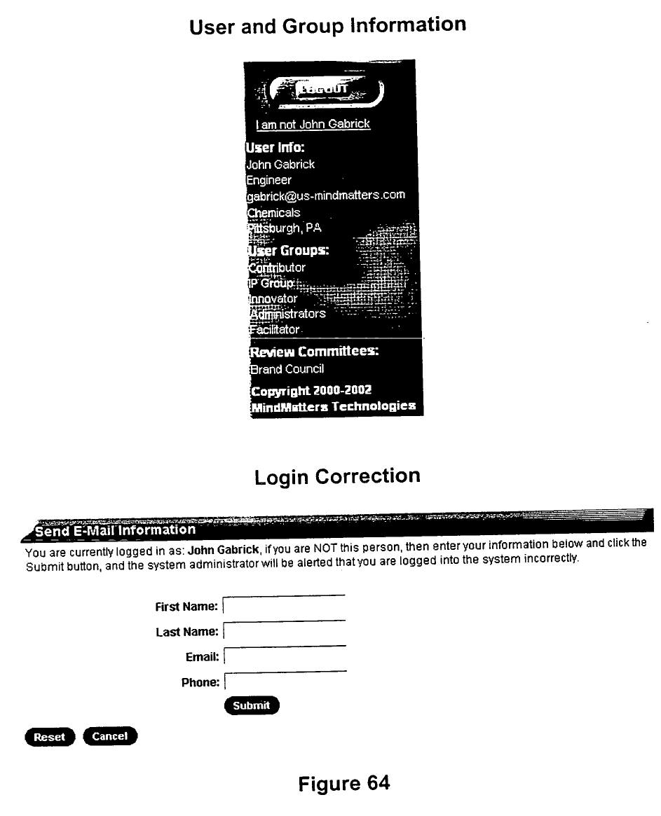

Advantageously, the Innovator, Manager and Administrator Processes provide users with ready access to all steps as they navigate through the process. Towards this end, a Process Frame is provided. This frame is diagramed in FIG. 2. As can be seen, the frame contains the Homepage menu (see FIGS. 3, 19a, 20, 26, 30 and 110-112) that may be used to navigate users to every step in the process, display of the User Information and User Groups Information (see FIG. 64), a Search button that navigates users to the Quick Search step (see FIG. 45) and a Help button that navigates users to the Help process (see FIG. 45), as well as the Logout button that allows users to exit the process at any time (see FIG. 64). In preferred processes, an Administrator may configure the system to anticipate a user accidentally logged in to the wrong account. An I Am Not This User button is advantageously provided in the frame to navigate users to the Send E-Mail Information page (see FIG. 64). This page allows the user to communicate to the system administrator that they are not the user logged in to the current account. The user is then returned to the Login page for a correct login identity.

In preferred processes, the Homepage menu system is dynamically created based on user rights, user preferences, and user data. For example, each time an innovation is submitted, the innovator's Homepage menu is updated with the new innovation. Advantageously, users simply click on the text of each menu item, and are automatically navigated to the appropriate step. Text items that are preceded by a plus sign have additional text options, and advantageously, when the plus sign or text is clicked, expand to provide more menu options. With this Homepage menu system users easily navigate to any innovation and perform any function.

The Innovator's Process

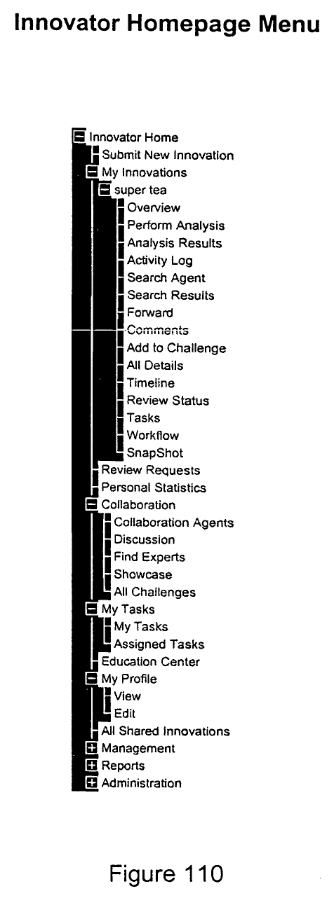

FIG. 110 illustrates the innovator's Homepage menu with menu items advantageously available to innovators expanded.

Submit New Innovation

The Submit New Innovation step in the Innovator's process allows the innovator to populate the data fields necessary to capture, track, analyze and share a new idea submission. This step advantageously replaces an invention disclosure document.

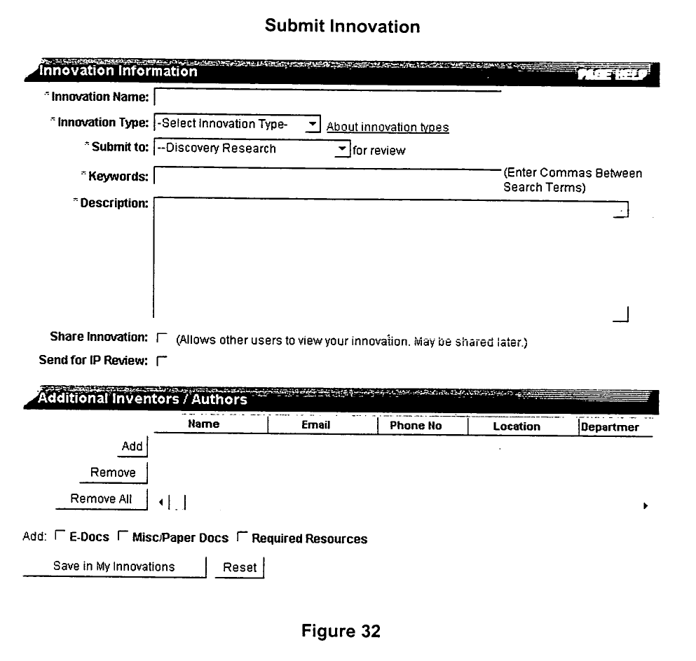

In one embodiment of the process, the user navigates to a Submit Innovation page (see FIGS. 4 and 32) using a menu selection, or by other means, and enters the necessary data using check boxes, drop-down list box selection, text boxes or other input methods. Optimally, certain data is required, other data is optional. Required data is indicated with an asterisk next to the label and includes a Name for the innovation, an innovation Type, a Department the innovation is to be submitted to, Keywords and a Description of the innovation.

Advantageously placed next to the Innovation Type text box is an About Innovations Types link that provides additional information regarding innovation types such as descriptions of the types and associated departments.

When selecting a department for submission, the innovation is optimally sent by default for review within the user's department or location. However, if the idea is more appropriate to another department or location, then the user is allowed to indicate a different department for submission by selecting from a list, by entering the name into a textbox or by other means.

Keywords are unique words that help to identify an innovation. They are used to set up searches, find experts and assist with collaboration throughout the system. Optimally, keywords are entered in a text box as a comma delineated list. Additional keywords may be added at a later time.

Optional data is also entered on the Submit Innovation page (see FIGS. 4 and 32) by check box, data grid, text box or other means, or by navigation to other input screens. One example of optional input is whether or not the innovation is to be shared (made accessible to all users within the organization). Sharing the innovation allows the organization to begin the review process. Reviewing the innovation is performed by other innovators, collaborators, managers, administrators, the organization's IP department or others. Selecting the reviewing bodies may be optional at this time and later.

Navigation to other steps is optimally available at the time of the initial submission of the innovation. Optional steps include the Add Inventors/Contributors/Collaborators/Co-authors, Attach Electronic Documents, Attach Paper Documents (and Objects) and Add Required Resources steps.

My Innovations (View All Innovations of Specific User)

The My Innovations step allows users to view key data for all of the innovations they have entered in the system and advantageously navigate to further steps for each innovation from one page or frame.

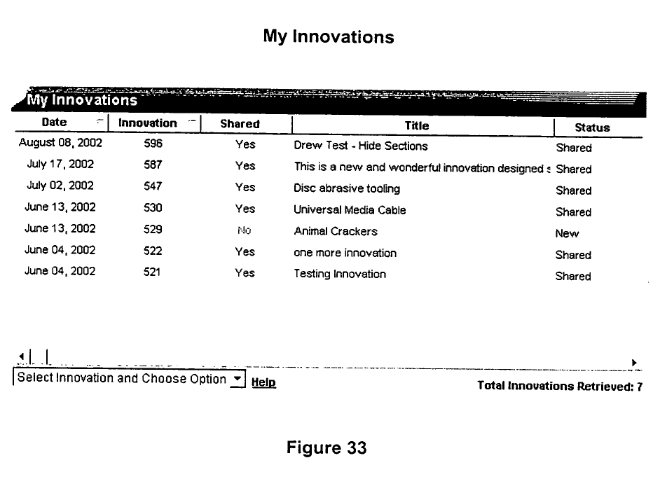

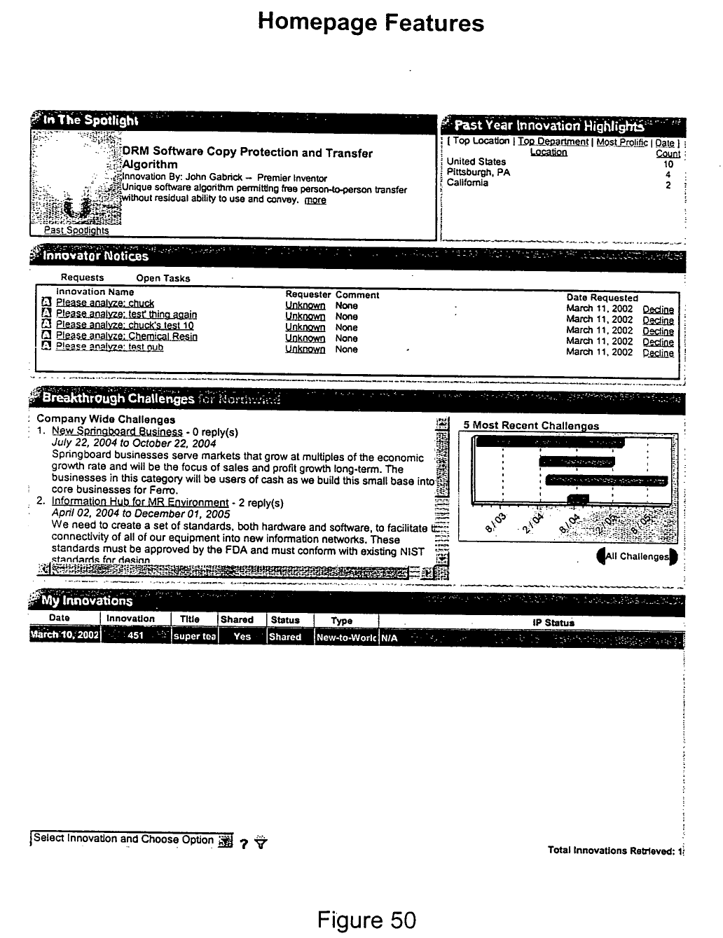

In preferred processes, the My Innovations frame is presented on the Homepage (see FIGS. 1 and 50). Alternately, the user may navigate to the My Innovations page (see FIG. 33) by a number of means such as double clicking on the My Innovations menu item on the Homepage (See FIGS. 3 and 19a). On this page, all of the innovations submitted by the individual innovator are optimally displayed in an interactive My Innovations data grid. Data pertaining to the innovations is advantageously displayed in columns and includes such items as the Date the innovation was submitted, an innovation Number, a column labeled Shared indicating whether the innovator has marked the innovation as available to be displayed to others in the organization, the innovation Name and the assigned Status of the innovation. In addition, the page displays the number of innovations retrieved to populate the grid.

Optimally, the innovations are automatically sorted by clicking on any of the columns. Clicking on the column again sorts the column in reverse order. Additionally, the width of individual columns may be changed by dragging the column edge to the desired width using the mouse, and column titles may be rearranged in any order by clicking and holding the mouse on a column and then moving it to the desired location.

Beneath the My Innovations data grid, is a drop-down list box labeled Select an Innovation and Pick an Option. These options are illustrated in FIGS. 6 and 7. This list contains options such as Overview, Perform Analysis, View Analysis Results, Activity Log, Search Agents, Search Results, Forward, Share Innovation, Delete Private Innovation, View Comments, Comments, Add to Challenge, All Details, Tasks, Timeline and Review Status. When a user selects a particular innovation in the data grid, by clicking on it or using the arrow keys, and then selects an option from the drop-down list box, they are navigated to the appropriate steps with the selected innovation's data advantageously transferred automatically.

Overview (View Details of a Specific Innovation)

The Overview (View Details of a Specific Innovation) step allows users to View Details, Edit, Update and Print data for a specific innovation (See FIG. 11).

The user navigates to the Overview page using a variety of methods including menu selection, drop-down list box selection or by other means, from the Homepage or elsewhere in the program. Advantageously, the user may navigate by selecting and double clicking a particular innovation in the My Innovation page's grid (see FIG. 33). Alternatively, the user may use a drop-down list box advantageously located on the My Innovation page labeled Select Innovation and Choose Option. The user selects an innovation in the grid then chooses Overview from the drop-down list box (see FIG. 33).

Through one of these navigation methods, a modified version of the Submit Innovation page opens. The page contains all of the data entry and display options and links to other process steps included on the Submit Innovation page, including the Share Innovation, Request Review, Add Inventors/Contributors/Collaborators/Co-authors, Attach Electronic Documents, Attach Paper Documents (and Objects) and Add Required Resources steps. However, this modified page is display only and contains, for appropriate users, navigational links to the Edit Innovation and Print Innovation steps.

All Details

The All Details step allows users to view a comprehensive set of the details associated with an innovation. The step is similar to the Overview step, but includes additional information pertaining to the activity that has been performed on the innovation and the progress of the innovation through various statuses.

Users navigate to the All Details step and page through a variety of methods. One such method is from the Homepage menu (See FIGS. 3 and 19a). The user expands the chosen innovation menu item and clicks the All Details menu item. Another method is from the My Innovations step on the My Innovations page (see FIGS. 7 and 33). Located beneath the data grid that lists the user's Innovations, is a drop-down list box labeled Select Innovation and Choose Option. The user selects a particular innovation in the data grid, by clicking on it or using the arrow keys, and then selects All Details from the drop-down list box. If the user is not the inventor or a collaborator of the innovation, they may still access the all details page through the All Shared Innovations page (provided they have the security clearance to view the innovation).

Through one of these navigation methods the All Details page opens. The page includes an Innovation Information frame displaying such items as the Innovation Name, Innovation Number, Inventor Innovation Type, Challenges, Security Level, Innovation Status, Date Created, whether it is Shared, Department, Location, IP Status, Keywords, Description, Status, Type, Who Requested, Developer, Priority, Client, Product, Version and Feature Set. Below this frame additional frames display as applicable including, but not limited to, status information, other inventors, comments, complete analysis results, attached electronic documents, attached paper and miscellaneous items, an activity log and tasks. In addition to viewing the information, users are provided a print button to allow them to print the information.

Edit Innovation

The Edit Innovation step allows users to edit data previously entered for the innovation. The step is illustrated in FIG. 5.

The user first navigates to the Overview page as described in the Overview step. Optimally, in order to edit the innovation, a user must click an Edit button, preventing accidental editing and allowing for an additional security check.

Provided a user has the required security clearance, a modified Submit Innovation page opens with the innovations data displayed. The modified Submit Innovation page contains all of the data entry and links to other process steps included on the Submit Innovation page such as the Share Innovation, Request Review, Add Inventors/Contributors/Collaborators/Co-authors, Attach Electronic Documents, Attach Paper Documents (and Objects) and Add Required Resources steps. Preferably, some fields are not changeable such as the date of submission. Optimally, changes are not saved to the database until a user clicks an Update button upon completion of editing.

Print Innovation

The Print Innovation step allows a user to print a paper copy of predetermined. details from a specific innovation.

The user navigates to the Overview page as described in the Overview step (see FIG. 11). The user selects the print action in some way, such as clicking a Print button, and a paper copy of predetermined details from the innovation's data prints.

Delete Innovation

Innovations denoted as Private may be deleted from an innovator's list of innovations through the Delete Innovation step.

On the My Innovations page, a drop-down list box, labeled Select Innovation and Choose Option, is located beneath the data grid that lists the users Innovations. Optimally, the user selects a particular innovation by using the keyboard arrows or clicking on the innovation in the My Innovations page's data grid. The user then selects Delete Private Innovation from the drop-down list box (see FIGS. 6 and 33). In preferred processes, a user is asked to confirm the deletion by means of another frame or page with Yes, No or Cancel buttons. Upon confirmation, the innovation is deleted from the Innovator system. In preferred processes, deletion of innovations denoted as shared is not allowed.

Add Inventors/Contributors/Collaborators/Co-authors (Search, Delete)

The Add Inventors, Collaborators, Contributors or Co-authors is an optional step available during the Submit New Innovation and Edit Innovation steps (see FIGS. 4 and 5). This step allows a user to store with the innovation's data the names of any users, in addition to the submitting innovator, who are participating (or have participated) in the development of the innovation. Advantageously, from the initial or modified Submit Innovation page (see FIG. 32), the user clicks an Add button and a list of registered users is displayed in a data grid. Display information includes Name, Email Address, Phone Number, Location, Department and other pertinent data. The submitting innovator selects other users from the list by highlighting them using standard techniques such as clicking with the mouse and using the Shift and/or Control keys for multiple selections. Remove and Remove All buttons are advantageously provided to enable deletion of one, all or multiple users from the list (see FIG. 32).

Alternatively, users navigate to a User Name Lookup step by clicking the Lookup button. This step enables users to reduce a list of all the users of the Innovator system to a more manageable number while making selections. The selections are then returned to the Additional Inventors/Authors frame at the completion of the User Name Lookup step.

Inventors, Collaborators, Contributors or Co-authors displayed in the Additional Inventors/Authors frame are recorded along with all other innovation data when the user clicks the Save in My Innovations button on the Submit Innovation page during the Submit a New Innovation step or clicks the Update button during the Edit Innovation step.

User Name Lookup

The User Name Lookup step allows users to search, filter and make selections from all the users in the Innovator system. Selected users are then returned to a data grid or other display within the step the user navigated from.

Innovator's navigate to the User Name Lookup page by a method provided in the Submit New Innovation, Edit Innovation or Forward Innovation steps (see FIGS. 4 and 5).

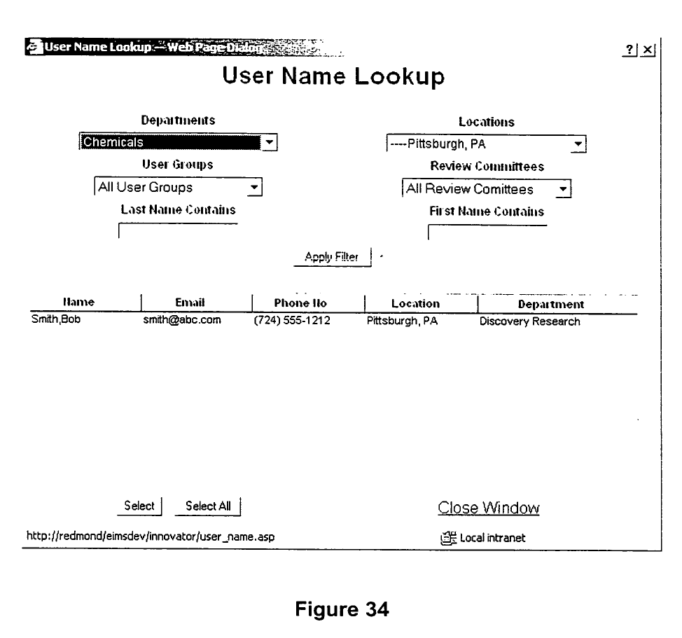

The User Name Lookup page (see FIG. 34) opens automatically displaying a list of all the users of the Innovator system. In order to reduce the list to a more manageable number, users select from the drop-down list boxes under Departments, Locations, User Groups, and Review Committees. When a selection is made from any of these drop-down list boxes, the list will only include users who meet the criteria selected. For example, if a user selects Pittsburgh from the Locations drop-down list box and clicks an Apply Filter button, then only the people who were located in Pittsburgh would be displayed in the list (see FIG. 34).

Selected names are automatically added to the list from which the user navigated. For example, names may be added to the Additional Inventors/Authors or the Forward To Users/Experts for Analysis frames. Optimally, a double-click on the name or highlighting the name and clicking on the Select button will select the name and close the User Name Lookup page. The step is repeated for multiple inventors. The Select All button returns all of the users of the Innovator system appearing in the User Name Lookup page's list box.

In preferred systems, if an inventor's location, e-mail, department or other descriptive information has been mis-entered or changes, the information will automatically be changed (when corrected or updated) to reflect the new changes. For example, if an inventor moves to a new department, this information will automatically be displayed correctly throughout the Innovator system once changed by a system administrator or the inventor.

Attach Electronic Documents (Add, Remove)

Any electronic documents, such as descriptions of the innovation in a text file, spreadsheets, drawings, or source code, may be attached to the innovation. By attaching all documentation, a permanent record of the innovation with a time and date stamp is created and the documents are securely recorded on the server, and are available should the originals somehow be lost or destroyed.

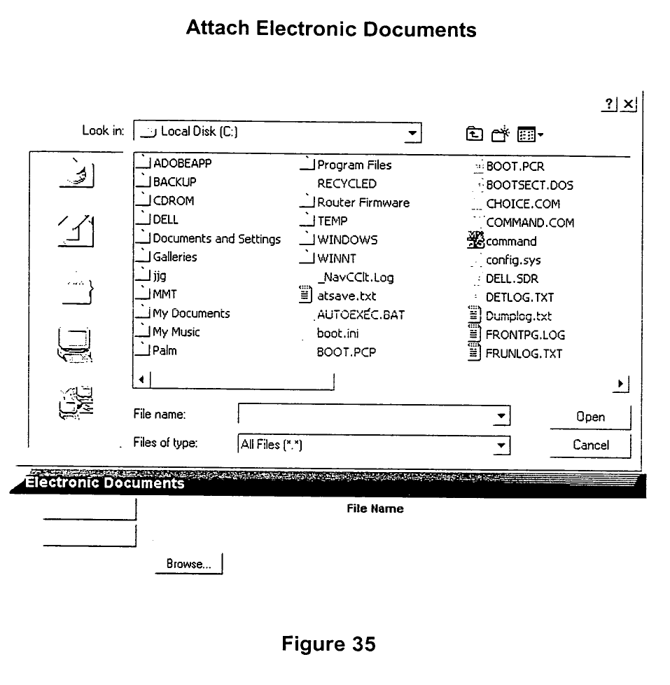

Users may navigate to this step through the Submit New Innovation step or the Edit Innovation step (see FIGS. 4 and 5) or by other means such as a selection from the Homepage Menu (See FIGS. 3 and 19a). Advantageously, a check box is placed upon the Submit Innovation page such that, when clicked, navigates to the Electronic Documents page (see FIG. 35). Electronic documents may be added to or removed from association with the innovation from this page.

To associate an electronic document with the innovation, optimally, an Add or Browse button is clicked and a Choose File page is displayed (see FIG. 35) with a familiar selection method such as a Windows™ Select box, directory list box or file list box, allowing the user to browse and select all the electronic documents to be attached. Optimally, standard features such as use of the <Shift> and/or <Ctrl> buttons are available for multiple selections. Users locate the document and select it using a familiar method such as double-clicking the file or clicking the file then clicking an Open button. Optimally, when the file is selected, the Choose File page closes automatically. Selected document names are displayed in the File Name list box (see FIG. 35) A Remove button may be clicked to remove a selected (one or multiple) electronic document from the list. Advantageously, a Remove All button is available to clear the entire list of electronic documents.

Even if the attached documents contain a more complete description, placement of a brief description of the electronic document into a field on the Electronic Documents page is required to attach the documents. In preferred processes, because of the sensitive nature of attached documents, searches are only performed on the description entered on the Electronic Documents page, not the attached documents.

Update Electronic Documents

As described in the Overview step and the Edit Innovation step, electronic documents are attached to innovations during and after the initial submission. The Update Electronic Documents step allows users to attach additional versions of previously attached documents.

The user navigates to the Update Electronic Documents step through the Edit Innovation step (see FIGS. 5 and 32) as described in the Overview step. The innovator clicks an advantageously placed check box labeled Add E-Docs and the Electronic Documents page opens (see FIG. 35). Users then proceed with attachment as described in the Attach Electronic Documents step.

Optimally, in order to preserve the integrity of the original electronic documents, previous attachments are not changed when subsequent documents are added even if the document name is the same. The system automatically determines if the file names are the same, and if so, automatically creates a new version without deleting the original.

Attach Paper Documents (and Objects)

Paper or tangible documents and/or prototypes such as spreadsheets, drawings, source code or material samples may be attached to the innovation through the Attach Paper Documents (and Objects) step.

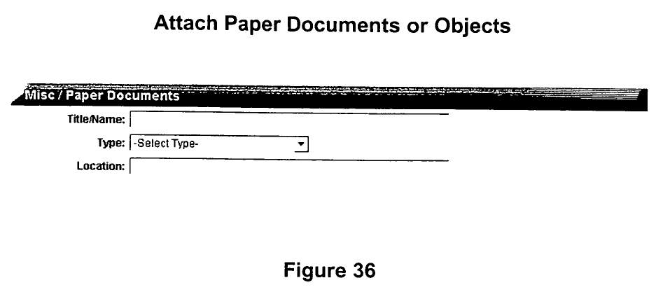

Users may navigate to this step through the Submit New Innovation step or the Edit Innovation step (see FIGS. 4 and 5) or by other means such as a selection from the Homepage Menu. Optimally, a check box is place upon the Submit Innovation page (see FIG. 32) that navigates the user to the Misc/Paper Documents page when clicked (see FIG. 36).

Users enter the necessary data using check boxes, drop-down list box selection, text boxes or other input methods. Optimally, certain data is required. Required data is indicated with an asterisk next to the label and includes a Title or Name for the document, the document Type (for example, White Paper, Lab Notebook or Sketch) and the document's Location (for example, File Cabinet, Safe Deposit Box, Office or Laboratory locations or numbers). Optimally, document Type is input using selection from an established list displayed in a list box.

When the innovation is submitted in the Submit New Innovation step or the Edit Innovation step, a unique barcode is automatically created. In preferred processes, the user prints the barcode and attaches it to the paper document, prototype or other object.

Attach Links

Links to web sites that the innovator believes are helpful or links to the user's own computer files and directories may be attached to the innovation.

Users may navigate to this step through the Submit New Innovation step or the Edit Innovation step (see FIGS. 4 and 5) or by other means such as a selection from the Homepage Menu. Advantageously, a check box is placed upon the Submit Innovation page that, when clicked, causes the Links frame to be displayed. Optimally, within the frame is a data grid displaying the Type of link, a Description and the Value.

To delete a previously attached link the user selects it in the Links frame and clicks an advantageously provided delete button.

To add a new link or file, the user clicks on an advantageously provided Add button and a new input area is displayed. A drop-down list is provided for the user to select URL for a Web site, File for a specific file, or File Location for an entire directory of files. If the user selects URL, they then add a description of the web site, and enter the address for the web site. If the user selects File or File Location, they enter the file path or in preferred processes click on a Browse button to open a Windows dialog box, and then select either the file or directory they wish shared. The user clicks an Add button to complete attaching the link.

Add Required Resources

An optional step available during the Submit New Innovation and Edit Innovation steps is Add Required Resources. In this step, provision is made for an innovator to identify and submit with the innovation a description of the resources they believe are required to bring their idea to the next decision point, the next development stage or completion.

Users navigate to this step through the Submit New Innovation step or the Edit Innovation step (see FIGS. 4 and 5) or by other means such as a selection from the Homepage Menu. Advantageously, a check box is placed upon the Submit Innovation page (see FIG. 32) that, when clicked, navigates to the Required Resources page (see FIG. 37).

Users enter the necessary data, such as Person-Hours, Equipment and Budget, using check boxes, drop-down list box selection, text fields or other input methods. A label on the page instructs users for what level of completion they will be estimating resources. For example, the resources may be to reach an end goal described in the innovation description, such as a working prototype or a marketed product, or they may be to reach the next development stage or the next decision point.

Optimally, innovators enter Person-Hours as a total estimate. For example, an innovation that requires 10 hours of marketing research and 40 hours of laboratory work is entered as 50 hours. Users are informed by a label accompanying the input box that 1 month equals 167 Person-Hours and 1 year equals 2000 Person-Hours.

Users are instructed that Equipment requirements are accepted as a comma delineated list. The definition of Equipment requirements is broad and may include such things as computers, test gear, floor space, a new software program or a specific piece of laboratory equipment.

Labeling accompanying the input box for Budget instructs users what currency is used for the evaluation. Optimally, an innovator is asked to estimate the total monetary investment required. For example, if $300 is needed to purchase an information database, $10,000 for a PC, and $5,000 for outside contract work, the user enters $15,300 ($300+$10,000+$5,000) for Budget.

This information is viewed by others to determine the level of effort required to test the innovation or bring the innovation to fruition. Also, in preferred processes, other Innovator system users are allowed to contribute resources to the innovation.

Share Innovation

The Share Innovation step makes an innovation viewable by all Innovator system users with the appropriate security privileges. Preferred processes allow the innovator's facilitator or manager to view the innovation and it may be sent to the appropriate review committees or individuals as determined by the organization's distribution policy. The results of sharing an innovation are illustrated in FIGS. 8 and 9.

Within the Submit New Innovation step, the default Share status is set to Private. Private innovations are not viewed by anyone but the submitting innovator, not even managers or review committee members, but are made available to the submitting innovator and those users listed as Inventors, Contributors, Collaborators and Co-authors for review, editing, updating and other process steps through the Overview step and the My Innovations page. Private innovations can be Forwarded (see the Forward step) to other Innovator system users for review. However, it is preferable that they are not returned as Search step results to other Innovator system users.

Different methods are provided to determine whether an innovation's Share status is Private or Shared. One such method is to view the innovation in the data grid provided on the My Innovations page (see FIG. 33). Under the column labeled Status, the user checks to see whether it indicates Yes or No. A Yes indicates that the innovation is shared. Alternatively, a column labeled Status may include the status assignments of Shared and Private.

Advantageously, there are several methods available to an innovator to Share an innovation. One such method is upon initial submission of an innovation (see FIG. 4). A user has the option of checking a check box labeled Share Innovation as described in the Submit New Innovation step on the Submit Innovation page (see FIG. 32). Optimally, users are informed by a label next to the check box that checking this box will allow other users to view the innovation and that the innovation may be Shared later through other methods. After clicking a Save in My Innovation button the status of the Innovation is set to Shared.

A similar method is used after the innovation has been initially submitted through the Edit Innovation step where the innovator is able to edit data previously entered for the innovation including the Share Innovation check box described above (see FIG. 5). As with all Edit Innovation changes the status is changed when the user clicks an Update button.

Another method allows the user to change the Shared status from the My Innovations page (see FIG. 6) as described in the My Innovations (View All Innovations of Specific User) step. Optimally, the user selects a particular innovation in the My Innovations page's data grid by highlighting. A drop-down list box labeled Select Innovation and Choose Option is advantageously located below the data grid (See FIG. 33). The user selects Share Innovation from the drop-down list box and the status is changed with no further steps required.

Yet another method allows the user to change the Shared status from the Homepage. The user expands the My Innovations folder, highlights the innovation they wish to share on the expanded menu and selects Share Innovation from the menu items directly below the selected folder and the status is changed with no further steps required. In preferred processes, when a user shares an innovation, the innovation becomes available to appropriate system users for additional steps as described in the All Shared Innovations step and illustrated in FIG. 9.

Perform an Analysis

Through the Perform an Analysis step, an innovation receives a rating based on responses to a set of questions. Question Sets are designed prior to innovation analysis and, in preferred processes, assigned to innovations by type. This provides a standard against which other submissions are compared. The innovation undergoing analysis is selected by the user or, alternatively, received (through the Innovator Notices step or via email) with a request to perform an analysis (see FIG. 17).

Users navigate to the Perform an Analysis step in several ways. One method is from the Homepage menu (see FIGS. 3 and 19a). The user expands the My Innovations folder, expands the innovation they wish to analyze and selects Perform Analysis from the menu items directly below the selected folder. An alternate method begins from the My Innovations step on the My Innovations page (see FIGS. 6 and 33). Located beneath the data grid that lists the user's Innovations, is a drop-down list box labeled Select Innovation and Choose Option. The user selects a particular innovation in the data grid, by clicking on it or using the arrow keys, and then selects Perform Analysis from the drop-down list box. In preferred processes, another method is through the Innovator Notices step. When an innovation has been forwarded to the user with a request for analysis, the innovation appears in the user's Innovator Notices frame on the user's Homepage under the Requests tab (see FIG. 50). Clicking on the innovation name in he data grid will navigate the user to the Perform Analysis page with the selected innovation's data displayed.

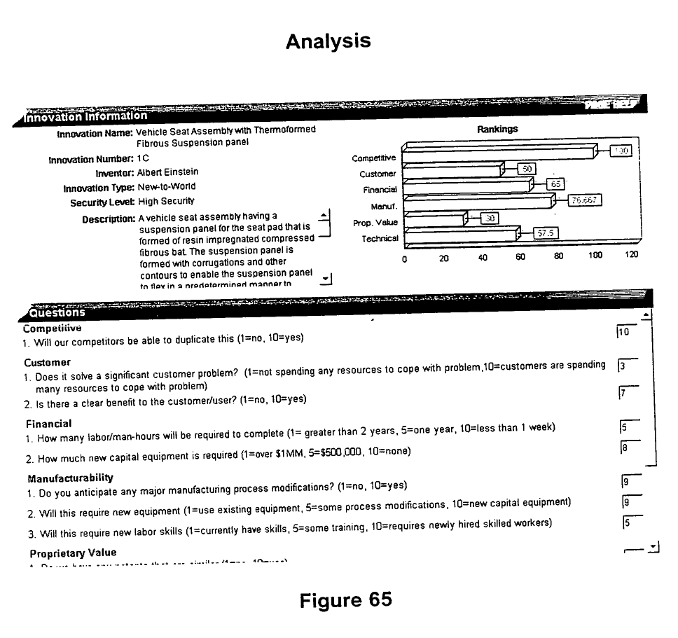

The Perform Analysis page opens (see FIG. 65) advantageously displaying an Innovation Information frame with the Innovation Name (presented as a button to navigate the user to the Overview step), the Innovation Number, the Inventor Name and the Innovation Type. Optimally, if the user has been forwarded the innovation for analysis, a Forward Info frame displays relevant information such as the Requestor Name, Request Date and User Comment. In preferred processes, the analysis is accomplished through a Questions frame (see FIG. 65). This frame is divided into titled sections, each section presenting the user with a numbered series of questions for that innovation. Navigation to the next question is accomplished by pressing the Tab key, using the mouse or similar method.

In preferred processes, Administrators have a great flexibility in designing the system of rating according to user input. Answers to the questions may be submitted by entering a number, selecting a radio button, clicking a check box or other method. Labeling and the wording of questions is used to communicate the meaning of the rating system. The numeric scale used may have a wide range of meaning. For example, a scale may be used from 1 to 10 without decimals allowed and with one (1) being lowest or of least significance and with ten (10) being highest or of most significance. Alternatively, a scale may be selected using 1 to 5, including decimals, with 1 being the highest rating. Even questions with a yes/no answer may or may not use the entire scale. For example, the number five (5) may be chosen to represent the highest possible level of agreement. If a user wishes to answer yes without strong agreement, they are allowed to enter a 4. Alternatively, question designers may choose to assign individual numbers to specific answers.

Optimally, users answer every question, as they are helping to apply a standard against all submissions. However, since questions may exist that are not within a user's knowledge, or truly “do not apply”, the user is allowed to move on to the next question without submitting an answer.

In preferred processes, comments may be entered for the analysis in general and for each question.

Advantageously, as answers are entered, a graph at the top of page displays the results. The results of answers may or may not be displayed as weighted. In other words, in the Perform Analysis process, if the particular analysis has been designated to be displayed as unweighted and a user enters the highest rating, it shows up as a 100% on the graph. Alternatively, answers may be displayed as weighted with an average of all submissions for the innovation or according to previously defined sections. For example, if a user enters the highest mark for a question, a previously submitted analysis may make the answer display lower on the related graph. Alternatively, if a user enters the highest mark for a question, a previously assigned section weighting may make the answer display lower on the related graph. In preferred processes, an Administrator determines how each submission will be displayed with regards to weighting.

The analysis is submitted by clicking the Submit Completed Analysis button or a similar method. After submitting an Analysis users are routed to review the graphed results of the analysis or users may select View Analysis Results from a drop-down list box or other method.

Optimally, the user who has just performed the analysis may forward the innovation to other users for a more diverse sampling of analyses, provided the innovation is assigned Share status.

View Analysis Results

The View Analysis Results step displays a summary overview of all of the analyses that have been performed on a particular innovation.

Users navigate to the View Analysis Results step in several ways. One method is from the Homepage menu (see FIGS. 3 and 19a). The user expands the My Innovations folder, expands the innovation they wish to analyze and selects Analysis Results from the menu items directly below the selected folder. An alternate method begins from the My Innovations step on the My Innovations page (see FIGS. 6 and 33). Located beneath the data grid that lists the user's Innovations, is a drop-down list box labeled Select Innovation and Choose Option. The user selects a particular innovation in the data grid, by clicking on it or using the arrow keys, and then selects View Analysis Results from the drop-down list box.

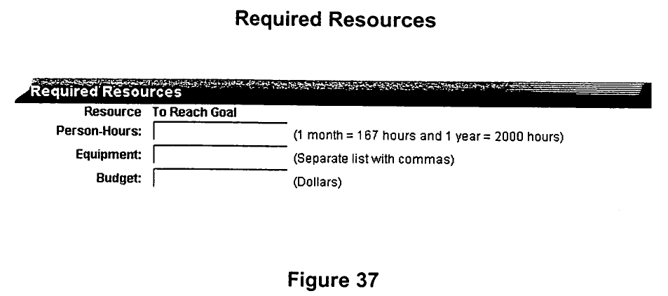

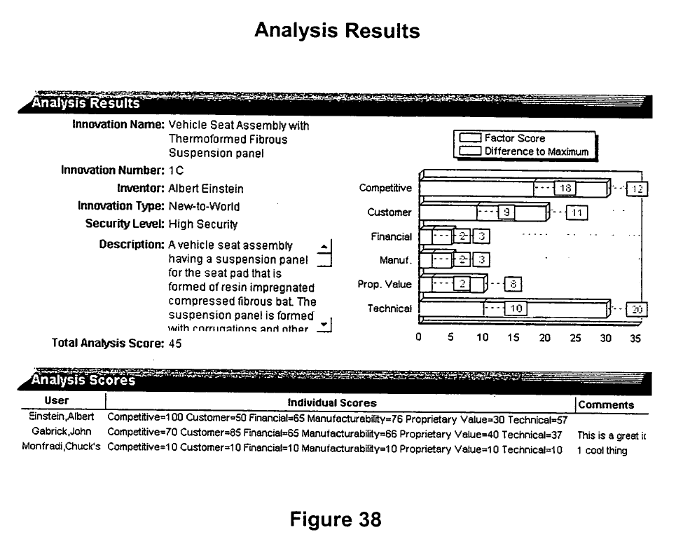

The user is navigated to the Analysis Results page (see FIG. 38). In preferred processes, this page contains an Analysis Scores frame with a data grid listing all the analysis that have been performed on the selected innovation. Advantageously, an Analysis Results frame displays a graphical representation of the total scores, along with information about the innovation and the people who performed the analyses and their individual scores. Selecting an analysis in the Analysis Scores frame's data grid will display specific information about the analysis in the analysis Results frame such as Innovation Name, Innovation Number, the inventor who performed the analysis, the Innovation Type, The Security Level, the Innovation Description and the Total Analysis Score.

When numbers are submitted in the Perform Analysis step the representation shown may be weighted or unweighted. In the View Analysis Results step, the scores are weighted. Answers may be displayed as weighted with an average of submissions. In other words, weighted according to an average with other analyses that have already been performed. For example, if a user gives a particular question a 5, and someone else gives the same question a 2, then in the View Analysis Results step the question's score is displayed as an average between 2 and 5. It is possible to weight certain submitter's scores more heavily. In this case the overall total score represents the summation of all of the weighted scores. Questions with blank answers are not averaged, so they do not influence the display of the final score.

Alternatively or additionally, answers may be displayed weighted according to previously strategic priorities for defined sections. For example, all of the questions in the Technical Section of the analysis may have been answered with the highest score, but if the Technical Section has only been given a weight of 30%, the highest possible score displayed would be 30% for the Technical Section when viewing the Analysis Results in the Analysis Results step.

Forward Innovation

The Forward Innovation step allows an innovation to be brought to the attention of a peer, supervisor, team member, review committee, or any other Innovator system users. Innovations are forwarded for informal reasons and for the purposes of Analysis or Review in order to satisfy the organization's approval process. The various paths of the Forward Innovation step in this embodiment is illustrated in FIG. 17.

Users navigate to the Forward Innovation step in several ways. One method is from the Homepage menu (see FIGS. 3 and 19a). The user expands the My Innovations folder, expands the innovation they wish to share on the expanded menu and selects Forward from the menu items directly below the selected innovation. An alternate method begins from the My Innovations step on the My Innovations page (see FIGS. 6 and 33). Located beneath the data grid that lists the user's Innovations, is a drop-down list box labeled Select Innovation and Choose Option. The user selects a particular innovation in the data grid, by clicking on it or using the arrow keys, and then selects Forward from the drop-down list box.

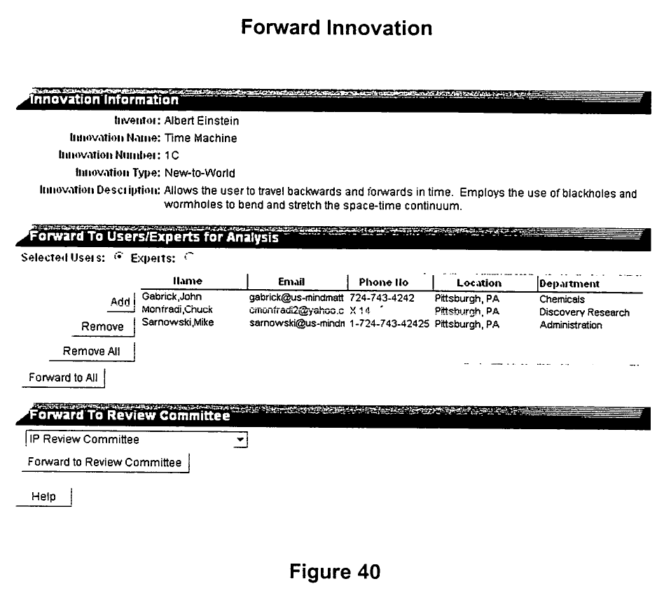

Once the user has navigated to the Forward page (see FIG. 40), the user chooses to notify either individual users, experts or a Review Committee's members. In preferred processes, several radio buttons facilitate the selection of who the innovation will be forwarded to. Clicking the Selected Users radio button in the Forward to Users/Experts/Review Committee frame displays the Find button that navigates the user to the User Name Lookup step and page. Clicking the Experts radio button also displays the Find button. Optimally, clicking the Find button then initiates a search and returns names of relevant experts. Alternately, clicking the Find button navigates users to the Find an Expert step, allowing users to conduct a-more user controlled search. At the close of either of these steps the selected names, and additional data about the users, such as Email address, Phone Number, Location and Department, are displayed in the data grid in the Forward to Users/Experts/Review Committee frame. Users may review the names and remove any names they do not want to forward the innovation to by clicking on the Remove or Remove All buttons. Clicking on the Forward to Users button forwards the innovation to everyone displayed in the data grid.

When forwarding an innovation to other users or experts, the user may indicate what the innovation is being forwarded for by the use of advantageously provided radio buttons for Analysis, Comments or Private Comments (see the Perform an Analysis, Add Comments and Resources and Add Private Comments steps).

Optimally, forwarding to a Review Committee is a somewhat different process. Clicking the Review Committee radio button in the Forward To line displays a Review Committee list box allowing the user to select from a list of Review Committees within the system. The user does not need to specify what the innovation is being forwarded for. Once a committee has been selected, clicking the Forward to Review Committee button forwards the innovation to every member of the selected committee.

Advantageously, the Forward to Users/Experts/Review Committee frame also contains a Comments text box allowing the user to attach a comment to the forwarding information.

When an innovation is forwarded, all the selected users or Review Committee members are notified through the Innovator Notices step under the Requests tab. The attached comment is displayed in the Innovator Notices data grid along with the innovation information and, if applicable what the innovation has been forwarded for (analysis, comments or private comments). In addition, the organization Administrator may choose to notify all recipients through automatically generated emails, also containing the comments in the body of the email.

Find an Expert

The Find an Expert step enables users to find experts within the organization who can help improve and analyze their innovation, as well as to find experts to send the innovation to for review. This step automatically finds experts from among the other Innovator system users based on the innovation's description and key words, and the expertise entered in the other users' profiles. See the Edit My Profile step.

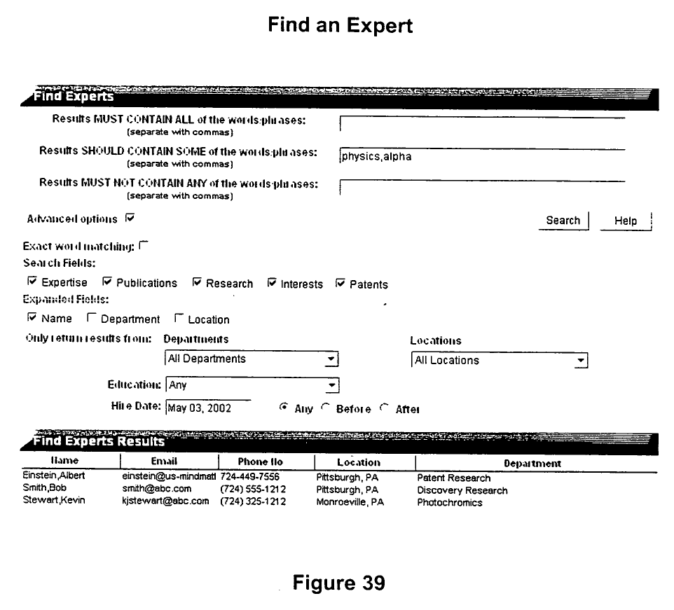

Users navigate to the Find an Expert step through the Forward Innovation step (see FIG. 17) or by other means such as a selection from the Homepage menu (see FIGS. 3 and 19a). The user expands the Collaboration folder and selects Find Expert from the menu items, and the Find an Expert page opens (see FIG. 39).

If the user has navigated through the Forward Innovation step, text is automatically entered from the innovation's data (Description and Keywords) and a search started. Alternatively, the user enters the keywords or expertise description that is to be used to find experts. Optimally, users are instructed by labels attached to a series of text boxes that text is entered in comma delineated lists and of the function of each text box for the search. For example, one text box is labeled that the search results must contain all of the words or phrases entered. Another text box is labeled that the search results should contain some of the words or phrases entered and a third text box is labeled that the results must not contain any of the words or phrases entered. The user then clicks the Search button and the innovator will search the Profiles for people who have expertise that matches the submitted text.

If a user is searching from the Forward Innovation step or another step that utilizes a specific innovation's data, and the user is not finding the type of experts desired, they may go back and change the keywords entered for the innovation (see the Edit Innovation step) or they may navigate to the Advanced Options step.

The names of the experts found through the search and additional data about the experts, such as Email address, Phone Number, Location and Department, will be displayed in the data grid on the Find Experts Results page or the data grid on the Forward Innovation page, depending on the route by which the user came to the Find an Expert step. Users remove names that they would not like to send their innovation by clicking on the Remove or Remove All buttons.

Initially, the Find an Expert step returns results for all departments, locations and fields of specialty. Advantageously, users may click the check box labeled Advanced Options on the Find Experts page and a new frame opens that allows users to further refine their search (see FIG. 39).

On this page, a user is allowed to check the Exact Word Matching check box to further limit the results. With this checked, the results will contain only the exact text entered in the Find Experts frame. For example, if a user did not have this box checked and entered the word “play”, the results would contain “play”, “plays”, “player”, and “playing”.

Users are given the option of checking or unchecking boxes to include or exclude Search Fields such as Expertise, Publications, Research, Interests and Patents. For example, if a user desired only experts with not just an interest in fiber optics, but a publication in fiber optics, they could enter “Fiber Optics” in the text boxes and uncheck all check boxes except Publications. The Search Fields check boxes default to checked.

Check boxes are also provided to allow users to include Expanded Fields, fields not normally searched such as Name, Department and Location. This would allow a user to enter the name “John Smith”, check only the Name check box and return all Innovation users by that name. The Expanded Fields check boxes default to unchecked.

Another search refinement available through this frame are drop-down list boxes for Departments, Locations and Education. For example, if a user only wanted results from one location, such as Pittsburgh, they would select Pittsburgh from the Locations drop-down list box. If no selection is made the list boxes default to Any Education, All Departments and All Locations.

Users may also enter a Hire Date constraint on the search. The user enters a date and selects a radio button to indicate whether the search should be limited to experts hired on dates which satisfy Any, Before or After constraints.

After constructing the search refinements through the Advanced Options frame, the user clicks the Search button on the Find Experts page. The names of the experts found through the search will be displayed in the data grid on the Find Experts Results age or the data grid on the Forward Innovation page, depending on the route by which he user came to the Find an Expert step.

Request Review

Innovators are allowed to request Peer Review of their Private innovations from any other Innovator system users, assuming those users have the appropriate security clearance. This step is the same as the Forward Innovation step illustrated in FIG. 17.

The organization chooses whether innovators will be allowed to forward innovations directly to Review Committees as part of the organization's process of evaluating innovations. If the organization chooses to allow this, innovators may forward an innovation to a predefined Review Committee through the Forward Innovation step. On the Forward Innovation page (see FIG. 40), the user selects a Review Committee from the drop-down list box in the Forward to Review Committee frame. Clicking on the Forward to Review Committee button sends messages to all individuals previously assigned to the selected Review Committee.

Review Status (View)

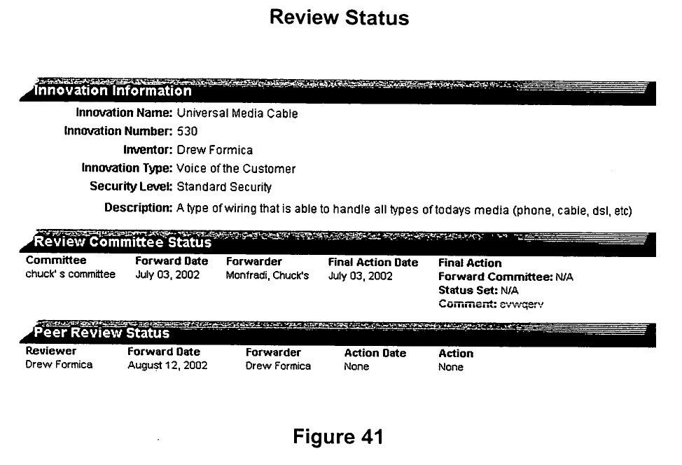

Innovators are able to check on what the status of their innovation is in the review process. Users navigate to the Review Status page (see FIG. 41) from the My Innovations step and page (see FIG. 7). On the My Innovations page, a drop-down list box, labeled Select Innovation and Choose Option, is located beneath the data grid that lists the user's Innovations. Optimally, the user selects a particular innovation by using the arrow keys or clicking on it in the My Innovations page's data grid, then Review Status from the drop-down list box (see FIG. 33).

The Review Status page contains a frame titled Innovation Information that displays the data for the Innovation selected such as Name, Number, Inventor, Type, Security Level and Description.

A Review Committee Status frame displays in a data grid the Review Committee status information such as Committee Name, Forward Date, Forwarder, Final Action Date and Final Actions. Optimally, Final Actions are displayed in a list within the data grid and include Forward Committee Name, Status Set and Comments.

Also displayed on this page is a Peer Review Status frame. This frame also contains a data grid with information such as Reviewer Name, Forward Date, Forwarder, Action Date and Action.

Create Search Agent

Search agents are search processes performed by the Innovator system to find duplicate or similar innovations within the Innovator system to the innovations submitted. Through the Search Agent steps users are directed to innovations that are duplicates or where there might be areas of overlap and potential collaboration. The primary difference between collaboration agents and search agents are that search agents are attached to specific innovations and return results based on a particular innovation (see the Collaboration Agents Overview step).

In preferred processes, the Create Search Agent step is automatically performed when a user enters an innovation (see the Submit New Innovation step). Each time a new innovation is submitted, a search agent is automatically configured to search for similar innovations based on the keywords and description that the user enters in the Submit New Innovation step (see FIG. 4). Users can edit or delete this Search Agent later. After the search agent performs an initial search, it periodically (optimally once a day) searches the Innovator system database for new innovations using the entered criteria.

Edit Search Agent

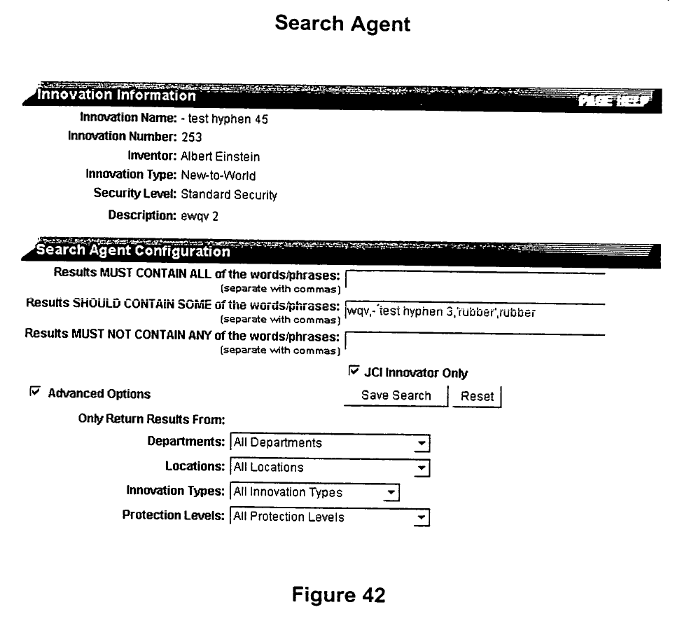

To edit a search agent users navigate to the Edit Search Agent step in several ways. One method is from the Homepage (see FIGS. 3 and 19a). The user expands the My Innovations folder, expands the innovation they wish to edit the search agent for and selects Search Agent from the menu items directly below the selected folder. An alternate method begins from the My Innovations step on the My Innovations page (see FIGS. 6 and 33). Located beneath the data grid that lists the user's Innovations, is a drop-down list box labeled Select Innovation and Choose Option. The user selects a particular innovation in the data grid, by clicking on it or using the arrow keys, and then selects Search Agent from the drop-down list box. The user is navigated to the Search Agent page (see FIG. 42). Another advantageous method is from the Search Results page through the Edit Search Agent button.

On the Search Agent page (see FIG. 42), an Innovation Information frame advantageously displays data such as the Innovation Name, Innovation Number, Inventor Name, Innovation Type, Security Level and Description. A Search Agent Configuration frame contains the search agent's current search criteria displayed in text boxes, drop-down list boxes, check boxes or other means.

Optimally, the current keywords and description that are used for searching are displayed in text boxes. Users are instructed by labels attached to the series of text boxes that text is entered in comma delineated lists and of the function of each text box for the search. For example, one text box is labeled that the search results must contain all of the words of phrases entered. Another text box is labeled that the search results should contain some of the words or phrases entered and a third text box labeled that the results must not contain any of the words or phrases entered. Users edit the search agent by removing and entering text for the search criteria.

In preferred processes, search agents may be configured to conduct searches through data outside the Innovator system's database, through databases within the organization and even over the Internet. The Search Agent Configuration frame optimally contains a check box to indicate whether the search is to be conducted in the organization's Innovator system database only.

Optimally, the search agent is initially configured to return results for all departments, locations, innovation types, and protection levels. A check box labeled Advanced Options is advantageously provided that allows users to further refine the search criteria. When the check box is selected a new frame opens containing drop-down list boxes for Departments, Locations, Innovation Types and Protection Levels. Selecting specific items from these lists limits the search results to those innovations that meet the selected criteria. For example, if a user wants results from one location, such as Pittsburgh, then they select Pittsburgh from the drop-down list box labeled Locations.

Once search criteria have been entered, the user clicks the Save Search button to save the changes made or clicks the Reset button to reset the search agent to its original state.

Search Results (View)

Through the Search Results step users view the results from the search agents. Note that search agents are attached to a particular innovation, thus the search results referred to in this step pertain to only one innovation.

Users are notified that new information has been located by a search agent through various methods throughout the system. For example, users are notified through the Innovator Notices step (see FIGS. 1 and 50). Alternatively, from the My Innovations step, in the data grid on the My Innovations page, cells under the column Search Agent are colored red when new information has been located. Advantageously, the red color returns to black after a user logs out, and is turned red again if new data is found.

Users navigate to the Search Results step in several ways. One method is from the Homepage (see FIGS. 3 and 19a). The user expands the My Innovations folder, expands the innovation they wish to view search results for and selects Search Results from the menu items directly below the selected folder. An alternate method begins from the My Innovations step on the My Innovations page (see FIGS. 6 and 33). Located beneath the data grid that lists the user's Innovations, is a drop-down list box labeled Select Innovation and Choose Option. The user selects a particular innovation in the data grid, by clicking on it or using the arrow keys, and then selects Search Results from the drop-down list box. Another advantageous method is through the Innovator Notices step.

Once the user has navigated to the Search Results page, an Search Results data grid displays the list of innovations returned by the search agent. The data grid includes information for each innovation such as Rank, Number, Title, Inventors, Location, Date Found and Type. Advantageously, users may double-click on any of the results to navigate to the Overview step and view the details of the innovation.

Activity Log

Preferred processes include tracking the activity relating to particular innovations. This advantageously provides a higher degree of feedback on innovations. The Activity Log tracks background activities, such as who performed an analysis and when (see the Perform an Analysis step) and who viewed the details of an innovation and when (see the Overview step), as well as manual activities such as a status change.

In one embodiment, users navigate to the Activity Log page from the My Innovations step on the My Innovations page (see FIGS. 7 and 33). Located beneath the data grid that lists the user's Innovations, is a drop-down list box labeled Select Innovation and Choose Option. The user selects a particular innovation in the data grid, by clicking on it or using the arrow keys, and then selects Activity Log from the drop-down list box.

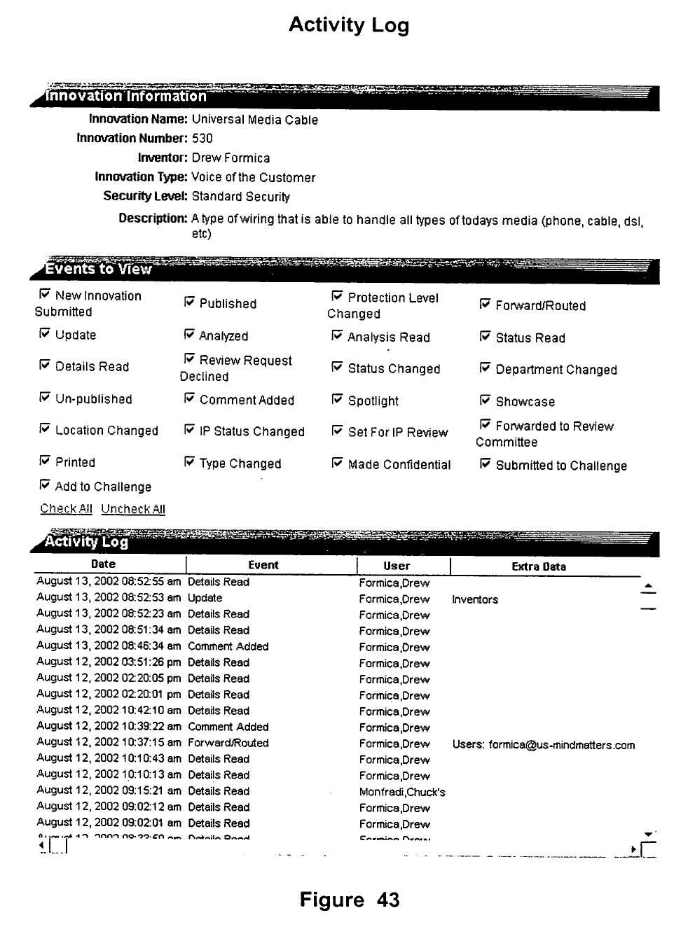

On the Activity Log page (see FIG. 43), an Innovation Information frame displays data for the innovation selected such as Innovation Name, Innovation Number, Inventor, Innovation Type, Security level and Description.

An Events To View frame contains advantageously provided check boxes, allowing users to select which information they want displayed. Users click on the check boxes to view data, or uncheck to hide the data. Similarly, Check All and Uncheck All links are provided to either check all of the boxes or uncheck all of the boxes. Displayable data includes such information as New Innovation Submitted, Updated, Details Read, Un-Published, Location Changed, Printed, Added to Challenge, Published, Analyzed, Review Request Declined, Comment Added, IP Status Changed, Type Changed, Protection Level Changed, Analysis Read, Status Changed, Spotlight, Set For IP Review, Made Confidential, Forward/Routed, Status Read, Department Changed, Showcase, Forwarded to Review Committee and Submitted to Challenge.

Beneath the Events to View frame is the Activity Log frame containing a data grid that displays the list of requested activities and important data for each such as the Date Performed, Event Name, User that performed the activity and Extra Data (a column for miscellaneous data pertinent to the specific activity). Optimally, as users check and uncheck the desired events in the Events to View frame, the list in the Activity Log frame is filtered and redisplayed accordingly.

Timeline

The Timeline step allows a user to view a graphical representation of the status, activities and processes that an innovation has already completed as well as an indication of what steps are required or expected next.

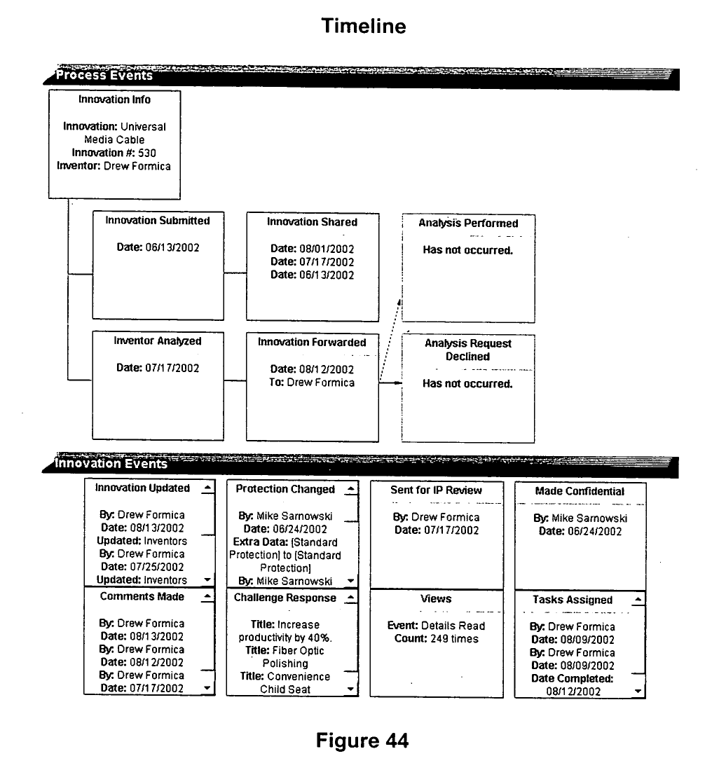

In one embodiment, users navigate to the Timeline page (see FIG. 44) from the My Innovations step on the My Innovations page (see FIGS. 7 and 33). Located beneath the data grid that lists the user's Innovations, is a drop-down list box labeled Select Innovation and Choose Option. The user selects a particular innovation in the data grid, by clicking on it or using the arrow keys, and then selects Timeline from the drop-down list box.

Displays and options available to users through the Timeline step are illustrated in FIG. 16. On the Timeline page (see FIG. 44) is displayed a Process Events frame. Within this frame is advantageously placed a series of titled boxes representing process events with arrows between appropriate events indicating the process flow, similar to a flow chart. Optimally, one of the boxes is titled Innovation Information and contains essential data for the innovation such as the Innovation Name, Innovation Number and Inventor Name. Other examples of process events displayed are Innovation Submitted, Innovation Shared, Analysis Performed, Inventor Analyzed, Innovation Forwarded and Analysis Request Declined. In preferred processes, some of these boxes or events contain dates and additional relevant information such as to whom an innovation was forwarded. Other boxes contain the information that the event has not yet occurred. Also, attached to this frame is an Innovation Pages tab list that allows users to select any of the Overview step's options for the selected innovation.

Also displayed on the Timeline page (see FIG. 44) is an Innovation Events frame. Within this frame is placed a similar series of titled boxes representing events not required in the processing of the innovation, but worth tracking, such as Innovation Updated, Comments Made, Protection Changed, Challenge Response, Sent for IP Review, Views, Made Confidential and Tasks Assigned. As in the Process Events frame, some of these boxes or events contain dates and additional relevant information such as who sent the innovation for IP Review and who assigned tasks on what date.

Quick Search

The Quick Search step provides users with a method to perform a search for innovations inside and outside the organization that are duplicates or where there might be areas of overlap and potential collaboration. While Search Agents (see the Create Search Agent step) are configured to run automatically, a user may perform the Quick Search step at any time.

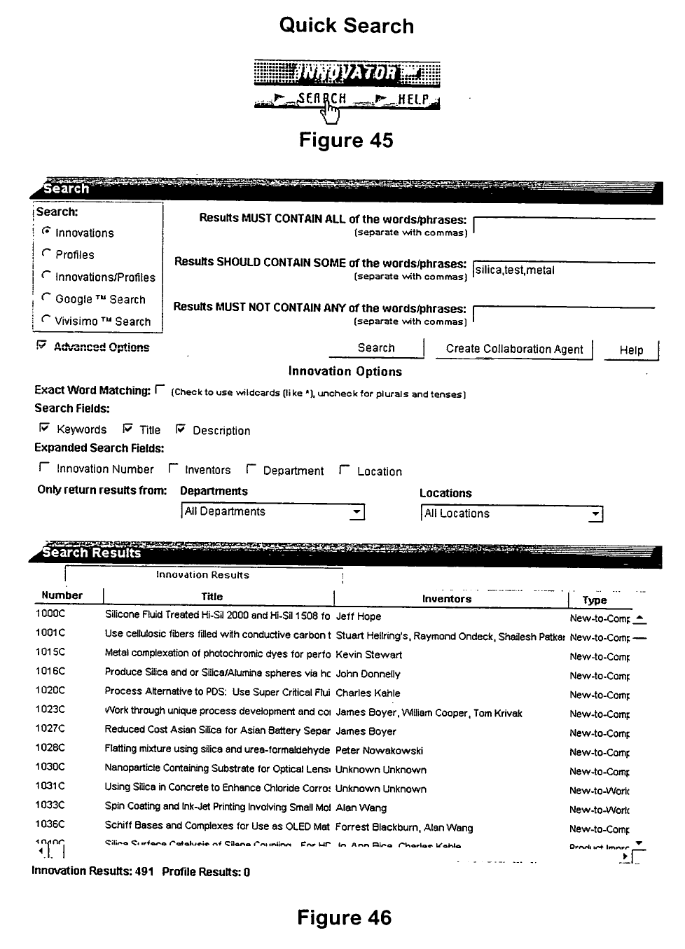

Advantageously, users may navigate to the Quick Search step, at any time during the process, by clicking on the Search graphic (see FIG. 45) provided in the frame surrounding every page (see FIG. 2). The user clicks the Search button and the Quick Search page opens (see FIG. 46).

The Search page (see FIG. 46) contains a Search frame allowing the user to select the data to be searched by selecting a radio button, check box or other such method. For example, a user may select from radio buttons for Innovations, Profiles, Innovations and Profiles and any one of a number of search engines provided on the World Wide Web outside the organization. Advantageously, if an outside search engine is selected, an automated process is started that opens the requested web page, routes the search criteria to the page and runs the search. Results are returned on the opened page of the outside engine.

Also on the Search page are a series of text boxes for the entry of the search criteria. Labels for each box instruct the user that text is entered in comma delineated lists and of the function of each text box for the search. For example, one text box is labeled that the search results must contain all of the words or phrases entered. Another text box is labeled that the search results should contain some of the words or phrases entered and a third text box labeled that the results must not contain any of the words or phrases entered. Optimally, users enter either words or phrases, both of which are separated by commas. Desirably, phrases do not need to include quotes and they can be intermixed with single words, for example: golf, PGA, Arnold Palmer. To additionally simplify word entry, searches are not case sensitive The user enters the desired search terms and clicks the Search button on the page to run the search.

Initially, the Quick Search step returns results for all departments, locations, keywords and other fields in the Innovator system database. Advantageously, users may click the check box labeled Advanced Options on the Search page and a new frame opens that allows users to further refine their search.

In the Innovation Options frame (see FIG. 45), a user is advantageously allowed to check the Exact Word Matching check box to further limit the results. With this checked, the results will contain only the exact text entered in the Search frame. For example, if a user did not have this box checked and entered the word “play”, the results would contain “play”, “plays”, “player”, and “playing”. A label for the check box explains that it must be unchecked for plurals and tenses to be returned and checked to use standard wildcard functions (such as the asterisk).

Users are given the option of checking or unchecking check boxes to include or exclude Search Fields such as Keywords, Title and Description. The Search Fields check boxes default to checked.

Check boxes are also provided to allow users to include Expanded Search Fields, fields not normally searched such as Innovation Number, Inventor Name, Department and Location. This would allow a user to enter the name “John Smith”, check only the Name check box and return all innovations submitted by that inventor name. The Expanded Fields check boxes default to unchecked.

Another search refinement available through this frame are drop-down list boxes for Departments and Locations. For example, if a user only wanted results from one location, such as Pittsburgh, they would select Pittsburgh from the Locations drop-down list box. If no selection is made, the list boxes default to All Departments and All Locations.

After the user enters the advanced options, they click the Search button on the page to run the search.

In preferred processes, new information is automatically indexed nightly. Therefore, innovations will be available to the search engines the day after their submission. Also, new innovations will not show up in search results unless they have been marked to be shared by the inventor(s). (See the Share Innovation step.)

Optimally, users click an advantageously provided Search button and search results are returned immediately. A Search Results frame opens (see FIG. 45) containing an Innovation Results data grid listing all returned innovations with information, such as Innovation Number, Title, Inventors, Type and Status. Advantageously, users may double-click on any of the results to navigate to the Overview step and view the details of the innovation. A similar Profile Results data grid displays biographical data for other Innovator system users returned by the search such as Name, E-mail, Phone Number, Department and Location. Advantageously, users may double-click on any of the results to navigate to the Profile Overview step and view the profile of the biographical data of the selected user. Also advantageously displayed on the page are the number of innovation and profile results returned. A Print Results button allows users to print out the results of the current search.

Optimally, a Create Collaboration Agent button is provided on the Search page which allows users to immediately create a Collaboration Agent from the search criteria they have just entered and have the system alert them to new results on a regular basis. The button navigates users to the Create Collaboration step with the currently entered search criteria automatically transferred.

Comments Overview (View, Search and Filter All Comments for All Innovations)

As part of the collaboration process, other users can add comments to innovations provided they have the appropriate security level. In addition to commentary, other innovators can add knowledge and resources to the innovations to contribute toward their eventual success. Contribution of resources may be in response to the Required Resources entered by the inventor(s) through the Add Required Resources step, or may be a new idea from the commentator. Steps involving comments include Overview (View, Search and Filter All Comments for All Innovations), View Comment Details for a specific innovation, View All Comments for a specific innovation and Add Comments and Resources to an innovation. Through the Comments Overview step, users View, Search or Filter all comments on all of the innovations in the Innovator system.

Users may navigate to the All User Comments page by several methods. One such method is through the Homepage menu (See FIGS. 3 and 19a). Users expand the Collaboration menu item and select the All Comments menu item under it to open the All User Comments page (see FIG. 18).

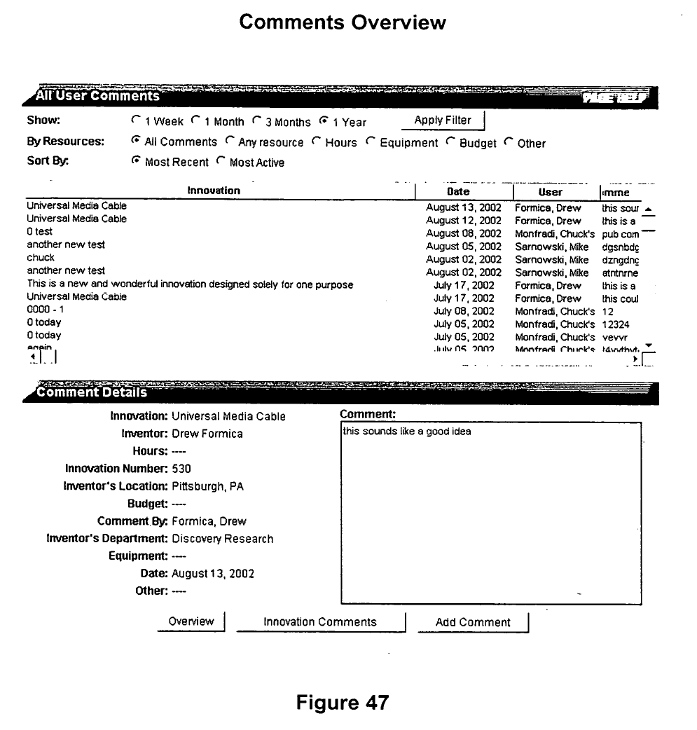

Optimally, when the All User Comments page (see FIG. 47) is opened, it initially displays the most recent comments made on any of the innovations during the past week in a data grid. The grid contains data such as Innovation Name, Comment Date, User (Commentator) and the Comment. To perform the Search and Filter step, and display more or fewer innovation comments, or sort the comments differently, users are advantageously offered a number of radio buttons to select from. Comments may be filtered or sorted according to various criteria. One such criteria is to Show comments submitted within a specified time period such as the last 1 Week, 1 Month, 3 Months or 1 Year. Another is to filter By Resources and specify All Comments, Any Resource, Hours, Equipment, Budget or Other (any resource not in the other radio button selections). Users may also request the data grid be Sorted By the Most Recent comments or the Most Active innovations. Advantageously, the user clicks on any of the choices, then clicks on the Apply Filter button to refresh the list displayed in the data grid.

View Comment Details

Users may view the details of a specific comment. Advantageously, from the Comments Overview step, the user double clicks on any comment in the list within the data grid on the All User Comments page, to view the details of the comment (see FIG. 18). This opens the Comments Details page (see FIG. 47). The page displays the Comment in a large text box as well as other information about the specific Innovation such as Innovation Name, Inventor Name, Hours (Required Resource), Innovation Number, Inventor's Location, Budget (Required Resource), Comment By (Commentator's Name), Inventor's Department, Equipment(Required Resource), Date (of Comment) and Other (Miscellaneous Information). Advantageously, buttons are available to navigate users back to the Overview, or on to the Add Comments and Resources step and the View All Comments for a Particular Innovation step. To add a new comment, users click on the Comment on This Innovation button. To view all of the comments for the current innovation, users click on the All Comments on This Innovation button.

View All Comments for a Particular Innovation

This step allows users to view all the comments made on a particular innovation in the Innovator system. Both the Inventor(s) and all other users with appropriate security clearance may view the comments.

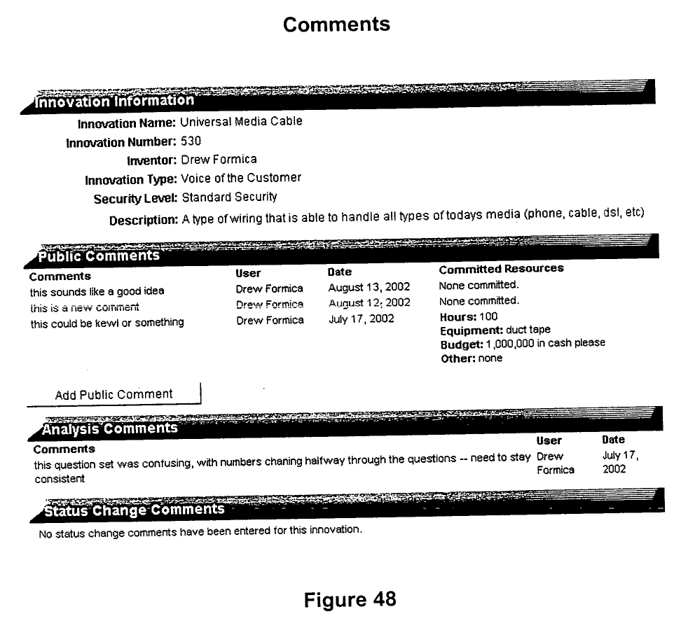

The Inventor(s) of the innovation may navigate to the Comments page (see FIG. 48) by several methods. One such method is to expand the My Innovations menu item on the Homepage menu (See FIGS. 3 and 19a), expand the innovation number desired and select the Comments menu item (see Figure. Another method is to navigate from the Overview step. On the My Innovations page (see FIG. 33), a drop-down list box, labeled Select Innovation and Choose Option, is located beneath the data grid that lists the users Innovations. Optimally, the user selects a particular innovation by using the arrow keys or clicking on it in the My Innovations page's data grid, then selects View Comments from the drop-down list box (see FIG. 7).

If a user is not one of the inventors of the innovation, they can navigate to the Comments page by using the Search button in the top right hand corner of the Homepage (see FIG. 45), or reviewing the list of all the shared innovations by clicking the All Shared Innovations menu item on the Homepage (See FIGS. 3 and 19a).

Once the user has located the innovation, they highlight and select or double click the menu item to view the overview. The user then clicks on the Innovation Pages tab at the top of the page and clicks on the Comments menu item.

Once the user has navigated to the Comments page (see FIG. 48), all of the comments that have been made regarding this innovation are displayed. Advantageously, a Innovation Information frame at the top of the page displays relevant data such as Innovation Name, Innovation Number, Inventor, Innovation Type, Security Level and Description of the Innovation.

Optimally, comments are divided into 3 types for display, Public Comments, Analysis Comments, and Status Change Comments. They are displayed in separate frames with data grids displaying relevant information. Public comments can be made by anyone in the system who has the corresponding security clearance. The Public Comments frame contains a data grid with columns for Comments, User, Date and Committed Resources. The Committed Resources Column advantageously displays data in a list format with additional labels such as Hours, Equipment, Budget and Other. Optimally, an Add Public Comment button is provided to navigate the user to the Add Comments and Resources step and the Add Comment page[{Graphic p. 53]}. Analysis Comments are comments submitted during the Perform an Analysis step, by a user other than the inventor(s) such as a review committee member. The Analysis Comments frame contains a data grid with columns for Comments, Comment By and Date. Status Change comments are comments submitted when a user, typically a manager or review committee member, changes the status of the innovation. The Status Change Comments frame contains a data grid with columns for Comments, Comment By and Date.

Add Comments and Resources

Users may add comments and resources to any of the innovations in the Innovator system. For a definition of Required Resources see the Add Required Resources step.

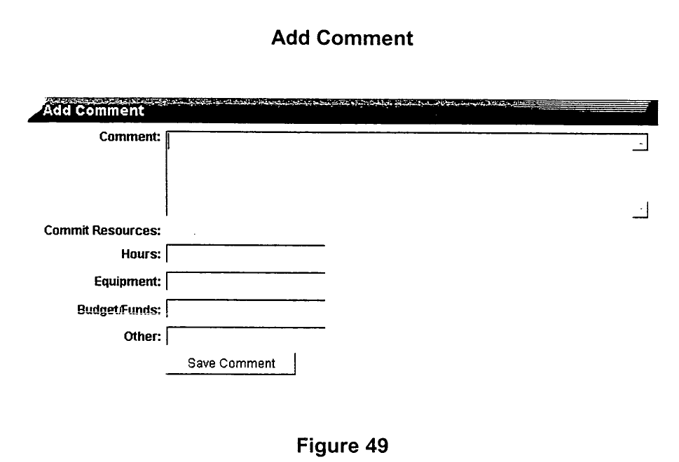

In this step, users navigate to the Add Comment page (see FIG. 49) by several methods. One such method is through the View Details page described in the View Comment Details step (see FIG. 18). Another navigational method is described in View All Comments for a Particular Innovation step (see FIG. 7). Alternatively, the user may navigate to the step through the Forward An Innovation step (see FIG. 17). Once on the Comments page (see FIG. 48), the user clicks the Add Public Comment in the Public Comments frame and the Add Comment page displays.

Optimally, the Add Comment page contains text boxes for the submission of a Comment and Committed Resources. Individual text boxes are provided for Hours, Equipment, Budget/Funds and Other. Users are advised to submit only resources that they personally are committing to the innovation. The user clicks a Save Comment button to submit the entries.

Education Center

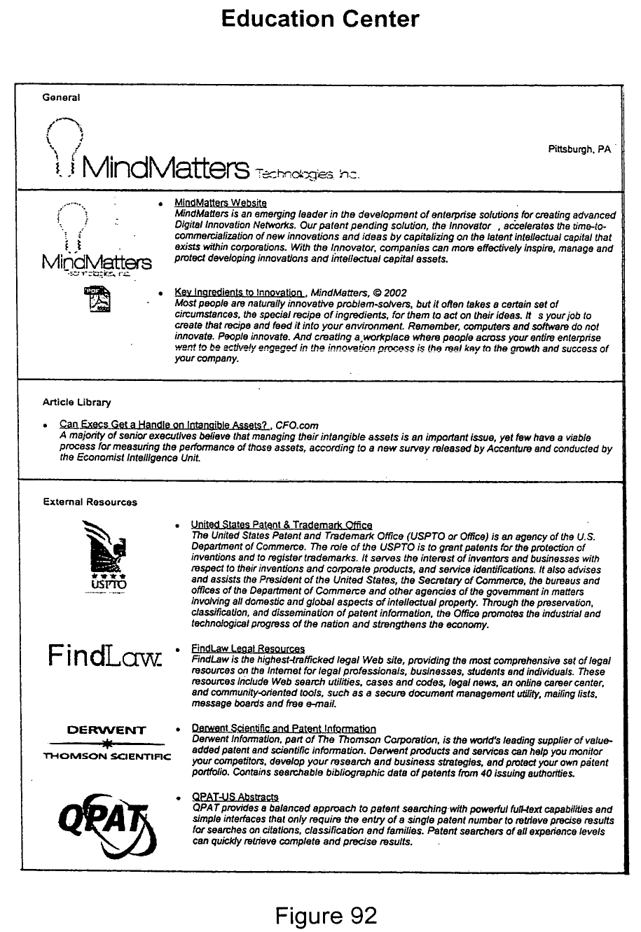

The Education Center step and page (see FIG. 92) provides a method of viewing information on topics of particular interest to the innovators and relative to the organization's business. Users are attracted to the page to stay apprised of new and interesting developments in their fields, but an underlying purpose for the page is to expose and educate innovators to the necessities of intellectual property protection. Advantageously, articles (or links to articles) are provided for patenting, searching for prior art and any other topics that the organization deems important.

In preferred processes, users navigate to the Education Center by clicking on the Education Center menu item on the Homepage menu (See FIGS. 3 and 19a) or through a link provided on a graphic on the Homepage (see FIG. 50). Optimally, the Education Center page (see FIG. 92) is divided into titled frames with links clearly delineated by graphics, underlining and text coloring presenting a collection of information, links to other web sites or documents within the organization and/or web sites outside the organization that the organization believes are important to a better understanding of the chosen topics. In preferred processes, the Education Center is customized by the Innovator System Administrator.

Highlights

The Highlights step allows users to view statistics derived from Innovator system activity. The Innovation Highlights frame within the Homepage (see FIGS. 1 and 50) advantageously displays (or provides links for displays) of the top results for the categories of Top Department, Top Location, Most Prolific and Date. Top Department and Lop Location are lists of the number of submissions by either department or location. Most Prolific represents the individual users who have submitted the most innovations into the Innovator system. Date represents the users who have most recently submitted innovations into the Innovator system. Clicking on the links Top Department, Top Location, Most Prolific or Date displays within the frame the corresponding information.

Spotlight

The Spotlight step allows users to view information about an innovation or multiple innovations that the organization decides deserve recognition or that are of particular interest to everyone using the Innovator system. Optimally, the displayed innovations have passed through pre-defined levels of qualification, such as a high analysis score. In preferred processes, a Manager determines the Spotlight innovations. The In The Spotlight frame within the Homepage (see FIGS. 1 and 50) displays a description of the innovation and a link labeled More that navigates the user to additional information about that particular innovation through the Overview step. Additionally, there is a Past Spotlights link that navigates the user to the Past Spotlights step and page where they may view information about past spotlighted innovations.

Past Spotlights

The Past Spotlights step allows users to view information about innovations or multiple innovations that have appeared on all users' Homepage as spotlighted innovations (see the Spotlight step above and FIGS. 1 and 50).

A Past Spotlights link is advantageously provided to navigate users to the Past Spotlights step from the Spotlight step. On the Spotlight page, a Listing of All Previous Spotlight Innovations frame lists the previously spotlighted innovations in a data grid containing information such as the Date displayed, the Title of the innovation, the Innovation number and the Inventors.

An advantageously provided Print button allows users to print the Listing of All Previous Spotlight Innovations list and associated information.

Showcase

The Showcase step allows users to view information regarding the innovation activity of different divisions within the organization such as departments and locations. Predefined divisions within the organization showcase their most promising, most interesting, or more important innovations. It provides a quick demographic overview of the innovation activity within the department, location or division and insight into what innovations they feel are the most important to show users outside the division.

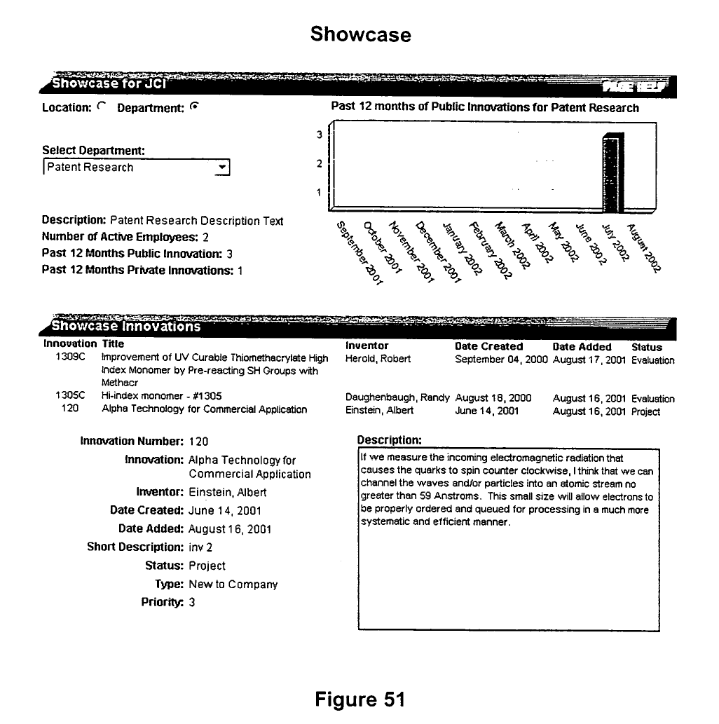

Advantageously, users navigate to the Showcase For [Division Name] page and Showcase Innovations page (See FIGS. 18 and 51) by expanding the Collaboration menu item on the Homepage (see FIGS. 3 and 19a) and selecting the Showcase menu item. Alternately, the users may navigate through links on the View Profile page (See FIGS. 12 and 51).

Once the user has navigated to the Showcase For [Division Name] page (See FIG. 51), the user displays data for the division they are particularly interested in by interacting through radio buttons, list boxes and other methods. One such method is selecting a department or a location by clicking either a Department or Location radio button, then selecting a department or location from the Select Department or Location drop-down list box. The information, such as Description of the division, Number of Active Employees, the number of Public Innovations in the Past 12 Months and number of Private Innovations in the Past 12 Months, is then displayed. In preferred processes, this page also contains graphical representation (See FIG. 51) of the number of Public Innovations in the Past 12 Months.

Advantageously, a Showcase Innovations page (See FIG. 51) accompanies the Showcase For [Division Name] page. This page displays data in a grid such as Innovation number, Innovation Title (or name), Inventor name, Date Created, Date Added and Status. This data is also displayed in a labeled list along with a Short Description, the innovation Type and Priority. The innovation description is also displayed in a large text box. Optimally, an Add Comments button navigates users from this page to the Add Comments and Resources step.

Innovator Notices

The Innovator Notices step is a method by which innovators receive notification from the Innovator system and the organization of new developments. For example, new search results have been found (see the Create Search Agent step), collaboration agents have returned new results (see the Create Collaboration Agent step), it has been requested that the user perform an analysis on an innovation (See the Perform an Analysis step) or new comments have been added to one of the user's innovations (See the Forward Innovation and Request Review steps and FIG. 17).

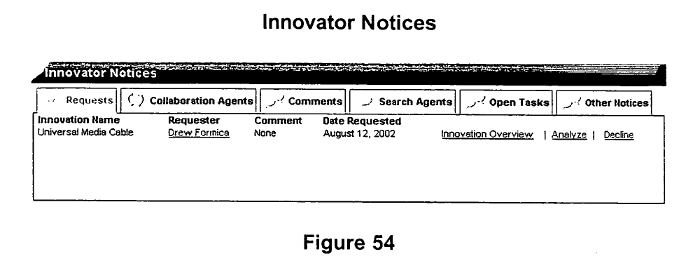

When such an event occurs, an Innovator Notices frame on the Homepage (see FIGS. 1 and 50) or an Innovator Notices page (see FIG. 54) over the Homepage is displayed upon entry to the system. Advantageously, the frame contains a tab or tab strip control with the tab headings such as Requests, Collaboration Agents, Comments, Search Agents, Open Tasks and Other Notices. The user clicks on a tab heading and information concerning the development is displayed. In preferred processes, the user is also presented with links to navigate them to the steps most logically following the development.

For example, a user clicks on Requests and such information as the Innovation Name, Requester, Comment and Date Requested is displayed for each request in a data grid format. In this example, the user is also presented for each individual request with links that allow them to navigate to the Overview, Perform an Analysis or Decline Request steps. To review the request, the user selects the innovation by highlighting and then clicks the Innovation Overview link. The user is navigated to the Overview step and Overview page where they review the innovation details, make comments (see the Add Comments and Resources step) or perform an analysis (see the Perform an Analysis step). If the user wishes to perform an analysis without reviewing the innovation, they click on the Analyze link and are navigated to the Perform an Analysis step. The user may also decline to take any action and click the Decline link. After the user has completed one of these steps, the innovation is cleared from the Innovator Notices frame.

If a user clicks on the Open Tasks tab such information as the Task Description, the associated Innovation Name, Requester and Deadline Date is displayed for each request in a data grid format.

The Collaboration Agents and Search Agents tabs only display on a user's Innovator Notices frame when results have been found by the agents. Clicking on the tab advantageously displays such information as the Agent Name and number of new Results. The Agent Name is displayed as a link that will navigate the user to the Collaboration and Search Agent Results pages when clicked. A Clear link is provided for each notice as well as a Clear All button that removes all notices displayed in the grid without having to clear each one individually.

Optimally, the Other Notices tab displays notices not included in the other sections with a Date and Text describing the notice. Text displays as a link that navigates the user to the appropriate page for action when clicked. Again, a Clear link is provided for each notice as well as a Clear All button that removes all notices displayed in the grid without having to clear each one individually.

Review Request Overview (View All Review Requests)

The Review Request Overview step allows users to view all the review requests they have received and the responses they have made to the requests. Users may also navigate to the Overview step for any of the innovations displayed in this step.

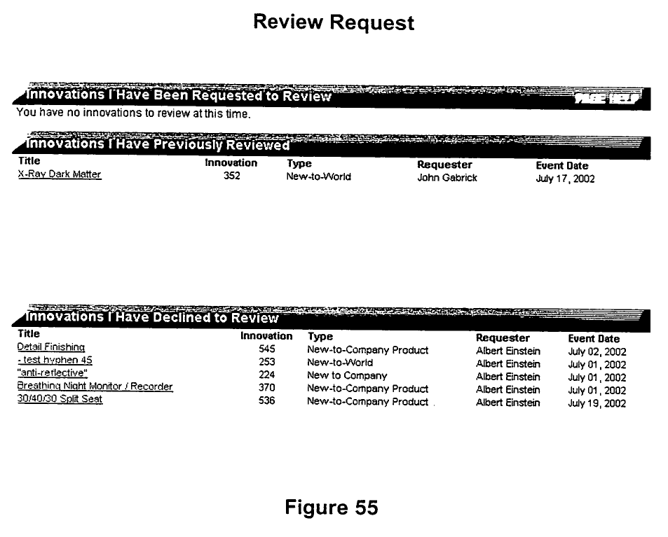

The user navigates to the Review Request Overview page (See FIG. 55) by. clicking the Review Requests menu item on the Homepage (See FIGS. 3 and 19a). Advantageously, 3 frames are presented on this page: the Innovations I Have Been Requested to Review frame, the Innovations I Have Previously Reviewed frame and the Innovations I Have Declined to Review frame. Within each of these frames is a data grid containing the Title of the Innovation(s), which is also a link to that innovation's overview (see the Overview step), and information such as the Innovation Number, Type, Requester Name and Event Date.

Innovators may click on the link provided in the data grid of any of the frames on the Review Request Overview page and navigate to the Overview step for that innovation. From the Overview step they may also navigate to the Perform an Analysis or Add Comments and Resources steps. Any innovations reviewed will be moved to the Innovations I Have Previously Reviewed frame.

Also, when a user is asked to perform an analysis of another user's innovation, a message is shown on the Homepage in the Innovator Notices frame (See Innovator Notices step and FIGS. 1 and 50). In the Innovator Notices step or in the Innovations I Have Been Requested to Review frame, a user may navigate to the Overview or Perform an Analysis steps or decline action. After the user chooses the Overview or Perform analysis steps' link from the Innovator Notices frame in the Innovator Notices step, the innovation is moved from the frame in the Review Request Overview step titled Innovations I Have Been Requested to Review to the Innovations I Have Previously Reviewed frame. If the user declines to take any action from this step or the Innovator Notices step, the user clicks the decline link on the innovations line in the data grid and the innovation is moved to the Innovations I Have Declined to Review frame.

Breakthrough Challenges (View)

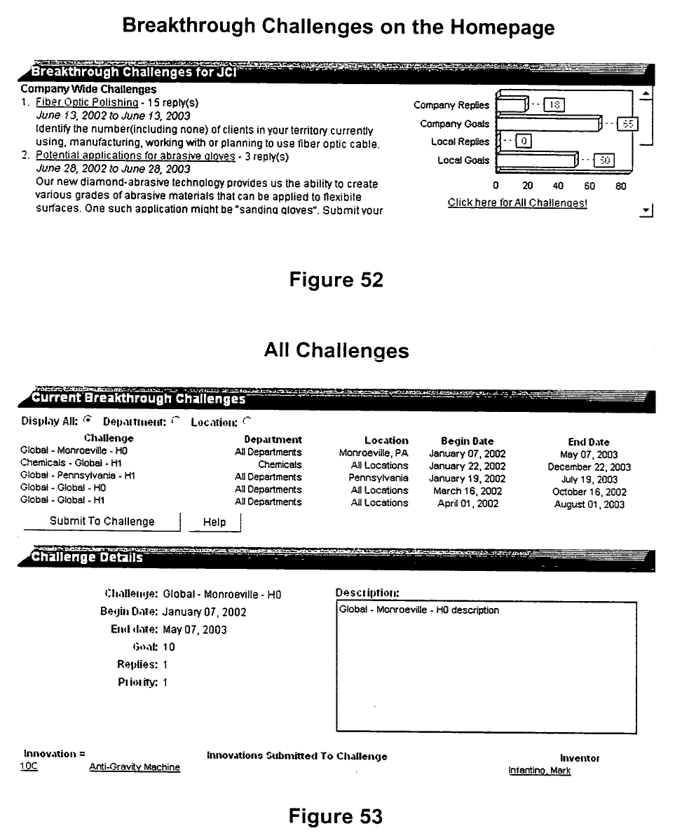

The Breakthrough Challenges step allows users to view and submit new innovations toward the most important challenges that their organization is currently addressing. Advantageously, a Breakthrough Challenges for [Division Name] frame on the Homepage (See FIGS. 1, 50 and 52) displays both a filtered list of breakthrough challenges for the user's department, location or division and a graphical representation of the performance data currently being collected to demonstrate progress toward the breakthrough challenge goals. Users automatically receive challenges in two categories: global challenges that have been sent to the entire organization, and department specific challenges that are sent only to their department, location or division.

To review all of the challenges that the organization is currently addressing, users may click the Click here for All Challenges link in the Breakthrough Challenges for [Division Name] frame or, alternatively, users may expand the Collaboration menu item on the Homepage (See FIGS. 3 and 19a) and click on All Challenges.

All Challenges (View)

The All Challenges step allows users to view all the breakthrough challenges that are currently being addressed by the organization.

Users navigate to the All Challenges step and page from the Breakthrough Challenges step by clicking on the All Challenges button or from the Homepage menu by expanding the Collaboration menu item (See FIGS. 3 and 19a) and clicking on All Challenges menu item (see FIG. 10).

The All Challenges page (see FIGS. 10 and 53) opens with a data grid displaying a list of the all the challenges currently in the system and select information for each such as Challenge Name, Department, Location, Begin Date, End Date and the number of Replies. Advantageously, users may filter the list by selecting a radio button for Display All, Department or Location and then selecting from drop-down lists of Departments and Locations.

Selecting a specific challenge in the list, by clicking on it or using the arrow keys, displays in a Challenge Details frame (see FIG. 53) information for that challenge such as Challenge Name, a Description, Begin Date, End Date, Goal, Number of Replies, Priority Number and Owners (the submitting user), Participants and Links. Also displayed in the frame is an Innovations Submitted to Challenge data grid that lists the innovations previously submitted towards a solution to the challenge and information for each such as Innovation Number, Innovation Name and Submitter. A Submit to Challenge button and a Add My Innovation to Challenge button on the page advantageously navigates users to the Add Innovation to Challenge step. Optimally, A Challenges button is also provided to allow innovators to submit a request for a new breakthrough challenge to be added to the system.

Challenge Submissions (View All)

The Challenge Submissions step allows users to view details of the current breakthrough challenge displayed on the Homepage and to view a listing of all the innovations that have been submitted to that challenge so far.

Users navigate to the Challenge Submissions step and page from the Breakthrough Challenges step by clicking on the highlighted name of the featured challenge (See FIGS. 1 and 10). The Challenge Submissions page opens containing a Challenge Detail frame displaying such information as the Challenge Name, Description, Begin Date, End Date, Last Modified By, Goal, Replies, Owners, Participants and Links. Advantageously, the Last Modified By and Owners names are links that when clicked take users to the My Profile page with the selected user's information displayed.

In addition, preferred processes have an Innovations Submitted to Challenge frame displaying a list of all the innovations that have been submitted to that challenge so far and relevant information about each such as Name, Number and Submitter. Each innovation name is displayed as a link that when clicked takes the user to the Overview step with the selected innovations data automatically displayed. Also, the Number of Innovations Submitted is displayed.

Optimally, should the user wish to submit an innovation to the challenge, two buttons are provided. The Add My Innovation To Challenge button opens a My Innovations frame with an interactive data grid displaying the user's innovations in a list and such information as the Date Submitted, Innovation Number, Innovation Title, whether it is Shared and the Status. To submit the innovation the user clicks an Add To Challenge link advantageously provided for each innovation. To submit a new innovation to the breakthrough challenge, the user clicks the Submit To This Challenge button and a modified version of the Submit New Innovation page opens with the selected breakthrough challenge's information displayed within the page. Users fill in the required information and submit the innovation as in the Submit New Innovation step.

Add Innovation To a Challenge

The Add Innovation to a Challenge step allows users to submit innovations that contribute to the solution of a challenge that the organization is currently addressing. Optimally, users may submit a new innovation (never before submitted to the system) or they may submit an innovation already in the-Innovator system.

To make a submission of a new idea, users may click on the title of the challenge in the Breakthrough Challenges for [Division Name] frame on the Homepage (see FIGS. 1, 50 and 52) and they are navigated to the Challenge Submissions page (see the Challenge Submissions step and FIG. 10). Alternately, users click on the All Challenges menu item on the (See FIGS. 3 and 19a) Homepage menu or the All Challenges button within the Breakthrough Challenges frame on the Homepage (see FIGS. 10 and 50). The All Challenges page opens (see the All Challenges step). Advantageously, the chosen challenge is highlighted within the data grid.

If a user already has an innovation that they wish submitted for consideration as a solution to this challenge, they click the Add My Innovation to Challenge advantageously provided and a My Innovations frame opens that contains a list of all the Innovator's innovations. The Innovator chooses the innovation they wish to submit by clicking on it or using the arrow keys and clicks the Add to Challenge link provided. Alternately, users submit innovations for consideration by expanding the My Innovations menu item on the Homepage (See FIGS. 3 and 19a), expanding the menu item for the innovation number they choose to submit and selecting Add to Challenge from the menu items directly below the innovation. An alternate method begins from the My Innovations step on the My Innovations-page (see FIG. 33). Located beneath the data grid that lists the users Innovations, is a drop-down list box labeled Select Innovation and Choose Option. The user selects a particular innovation in the data grid, by clicking on it or using the arrow keys, and then selects Add to Challenge from the drop-down list box. All these methods will advantageously navigate users to the Add to Challenge page with the selected innovation's data displayed. A Current Challenges frame displaying a list of the current challenges in an interactive data grid. The data grid displays the Challenge Name (as a link to the Challenge Detail page), the Begin Date, End Date and an Add to Challenge link for each challenge. Users click the Add to Challenge link and the selected innovation is submitted to the Challenge.

To submit a new innovation to the breakthrough challenge, the user clicks the Submit To This Challenge button and a modified version of the Submit New Innovation page opens with the selected breakthrough challenge's information displayed within the page. Users fill in the required information and submit the innovation as in the Submit New Innovation step.

All Shared Innovations

The All Shared Innovations step allows users to search, filter and view all of the shared innovations currently in the Innovator system (subject to the user's protection level and security clearance).

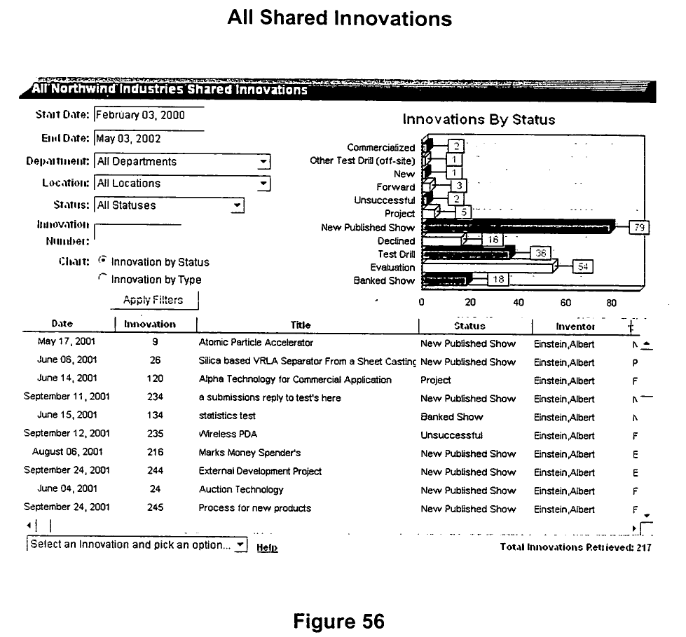

The user navigates to the All Shared Innovations page (see FIGS. 9 and 56) through the Homepage menu (See FIGS. 3 and 19a) by clicking on the All shared Innovations menu item. Located on the page is an interactive data grid that displays the list of all shared innovations, for which the particular Innovation user has security clearance, and specific information for each innovation such as Date Submitted, Innovation Number, Innovation Title, Status and Inventor. Optimally, the innovations are automatically sorted by clicking on any of the columns. Clicking on the column again sorts the column in reverse order. Optionally, the width of individual columns may be changed by dragging the column edge to the desired width using the mouse, and column titles may be rearranged in any order by clicking and holding the mouse on a column and then moving it to the desired location.

Users may reduce the number of innovations in the list or search for a specific innovation by entering data in text boxes, selecting from drop-down list boxes, check boxes, radio buttons and other methods then clicking an Apply Filters button. Examples of filter and search criteria entered are Start Date, End Date, Department, Location, Status, Innovations Number. For example, if a user only wants to see innovations in the Pittsburgh location, they select Pittsburgh from the Location drop-down list box and then click the Apply Filter button. In addition, the page displays the number of innovations retrieved to populate the grid. Also contained on the page is a graphical representation of the number of innovations currently shared and in the system for each Status or, alternatively, for each Type. Users choose which graph they view by clicking a radio button to select between Status and Type for display.

Beneath the Shared Innovations data grid, is a drop-down list box labeled Select an Innovation and Pick an Option. Users may navigate to optional steps as illustrated in FIG. 9. Options are similar to the My Innovations page and include items such as Overview, Perform Analysis, Activity Log, Forward, Comments, Add to Challenge and All Details. When a user selects a particular innovation in the data grid, by clicking on it or using the arrow keys, and then selects an option from the drop-down list box, they are advantageously navigated to the appropriate steps with the selected innovation's data transferred automatically.

Profile Overview (View a User's Profile)

When users are entered into the Innovator system, biographical information is entered and a biographical information page created. Data entered for a user's profile defines the innovator's interests and expertise in order to make the innovator available to other users as an expert for collaboration (see the Find an Expert and Create Collaboration Agent steps), review requests (see the Request Review step), searches (see the Quick Search and Create Search Agent steps) and routing (see the Forward Innovation step). The Profile Overview step allows users to view the biographical information currently in the system for themselves, as well as other innovators they are directed to by the previously mentioned steps.

Users navigate to the User Profile page through various means such as double-clicking on an inventor displayed in the data grid on the Search Results page (see Quick Search step).

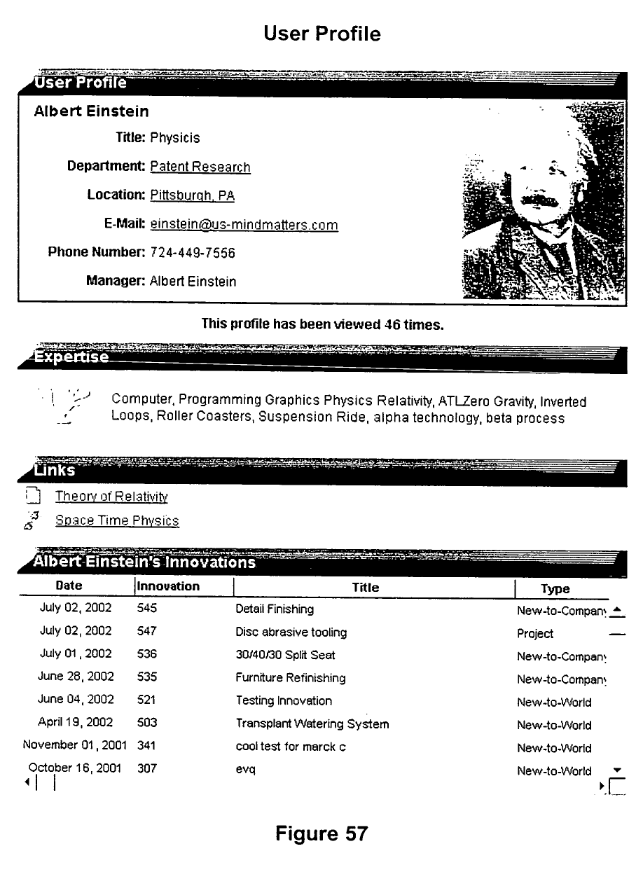

To view the biographical information on themselves, users may expand the My Profile menu item on the Homepage (see FIGS. 3 and 19a) and select View from the menu items below the folder. The User Profile page opens displaying the user's data (see FIGS. 12 and 57). Advantageously, a User Profile frame displays vital data such as the User Name, Title, Department, Location, E-Mail Address, Phone Number and Manager Name. An Expertise frame displays the keywords that the user wishes to be noted as areas of expertise. A Links frame provides the viewer with links to web sites inside or outside the organization and links to electronic documents available for viewing. Icons conveniently identify which links are web sites and which documents. In addition, a [User's Name] Innovations frame displays a data grid with the user's innovations listed (only those marked as shared) and information for each innovation such as Date Submitted, Innovation Number, Title and Type. Optimally, users are also informed on the User Profile page how many times the profile has been viewed.

Edit My Profile

The Edit My Profile step allows users to further refine the data displayed to other users on the User Profile page (see FIG. 57) as well as enter additional information to complete their profile. Uses for this data are described in the Profile Overview step.

Users navigate to the Edit My Profile page by expanding the My Profile menu item on the Homepage (see FIGS. 3 and 19a) and selecting the Edit menu item located below the expanded folder.

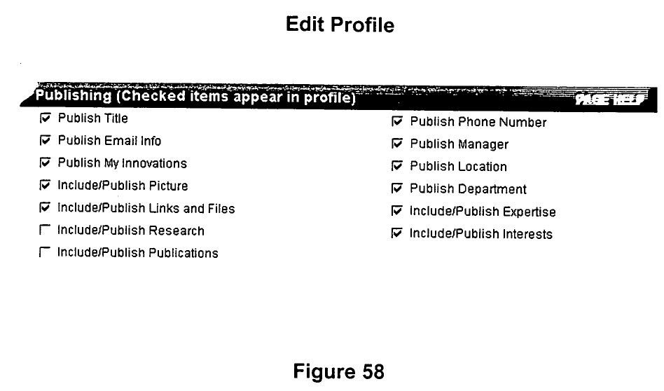

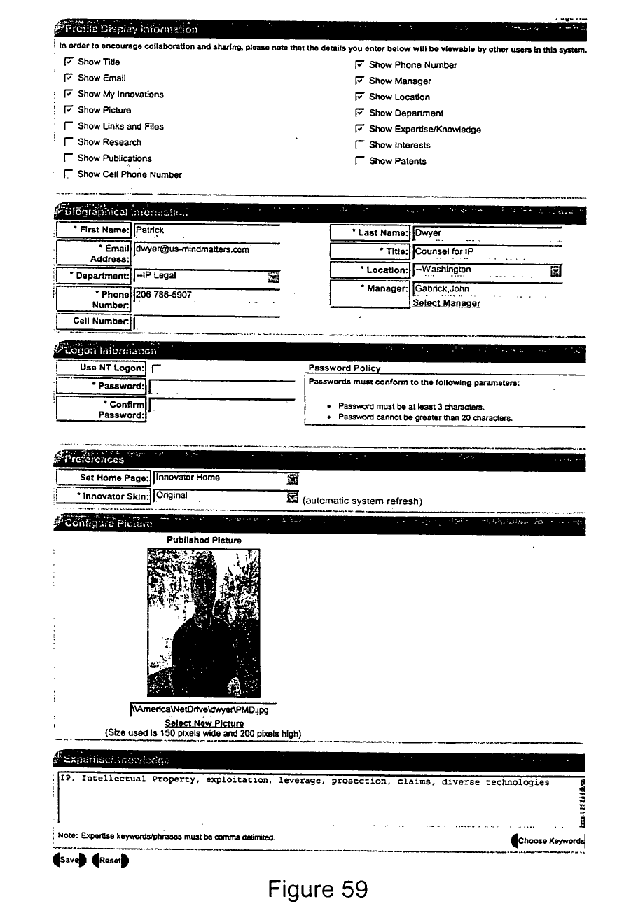

Once the user has navigated to the Edit My Profile page (see FIG. 58), they select fields from a Publishing frame for editing. Optimally users are informed that only checked items will appear in their profile on the User Profile page (see FIG. 57). Advantageously, a list of check boxes is provided for information such as the innovator's Title, E-Mail Address, Phone Number, Manager, Location, Department, Expertise, Interests, Picture, Links and Files, Research and Publications. In preferred processes, the user clicks the corresponding check boxes, and the appropriate data-entry text box appears in a new frame below (see FIG. 59). Once all the desired data has been entered, the user clicks on the Save button at the top or bottom of the page and their biographical information is updated. Optimally, users only need to click the Save button once for all changes.

Advantageously, a Public Links frame is provided to allow users to add links to their computer files, computer directories, or web sites that are beneficial to the profile. Within the frame users click on the Add button and a new input area is displayed. Optimally, a drop-down list is provided to select URL for a Web site, File for a specific file or File Location for an entire directory of files. When the user selects URL, text boxes are displayed to allow them to add a description of the web site, and enter the address for the web site. If the user selects File or File Location, optimally, an Add or Browse button is clicked and a Choose File page is displayed (see FIG. 35) with a familiar selection method such as a Windows™ Select box, directory list box or file list box, allowing the user to browse and select the electronic document to be attached or the file directory they wish users directed to as part of their profile. As above, the user clicks the Save button at the top or bottom of the page to update their information.

Preferentially, users select a photo to be displayed in their profile information (see FIG. 59). Upon creation of a user login, no photos are attached to the user's biographical information and a question mark and the text No Picture appears until users assign a photo location. On the Edit My Profile page, the user is allowed to click on a Select New Picture check box and a Choose File page is displayed with a familiar selection method such as a Windows™ Select box, directory list box or file list box, allowing the user to browse and select the electronic photo file to be attached to their profile information. As above, the user clicks the Save button at the top or bottom of the page to update their information.

Advantageously, user information is displayed in the lower left corner of the Homepage such as the user's name, title, department, and location. Also displayed are the Innovator User Groups of which a user is a member. This information is updated when information is changed through the Edit My Profile step or by an Administrator.

Personal Statistics (View)

The Personal Statistics step is a self evaluation tool allowing users to view any and all numbers concerning their involvement with the Innovator system, such as the number of Innovations Submissions, My Profile Hits, My Innovation Hits, Analysis Performed, Comments Added, Analysis Performed Not Forwarded (on an innovation that was not forwarded), Comments Submitted, Innovation Status Changes and Test Drills.

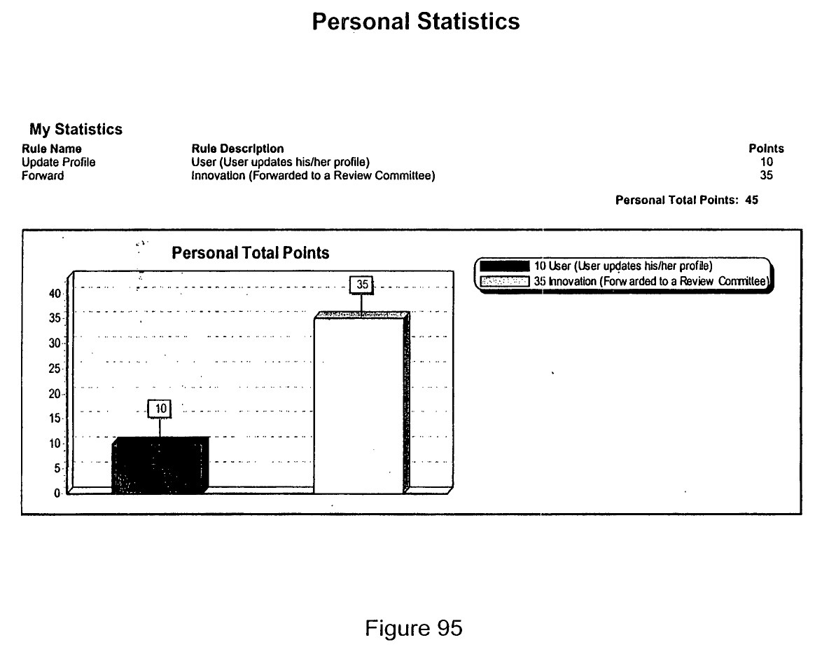

Users navigate to the Personal Statistics step and page through the Homepage menu (See FIGS. 3 and 19a) or the My Profile step. On the Homepage menu the user clicks the Personal Statistics menu item and the Personal Statistics page (see FIG. 95) opens displaying the My Statistics data grid with the relevant information listed, such as the name of the event for which points are being awarded, the description of the event and the points for each event. The total points accumulated by the user is also displayed. A Print button is advantageously provided to allow the user to print the list. If the user has no relevant data within the system, a message is displayed so stating.

Collaboration Agents Overview (View All)

Collaboration agents are automatic, user-directed, searches of the entire Innovator system database, and are based on keywords the user enters. The primary difference between collaboration agents and search agents is that search agents are attached to specific innovations and return results based on a particular innovation. Collaboration agents are more general, and are not associated with any particular innovation. For example, a user may create a collaboration agent to look for new camping locations, bicycles, semiconductor experts or chemical formulae. In preferred processes, collaboration agent searches are run by the Innovator system at the same time for all users, optimally once per day, at a time chosen by the system administrator. Users are notified that new information has been located by a collaboration agent through various methods throughout the system (see the Collaboration Agent Results step). This allows users to keep current on new submissions and new users within the Innovator system database without performing daily searching.

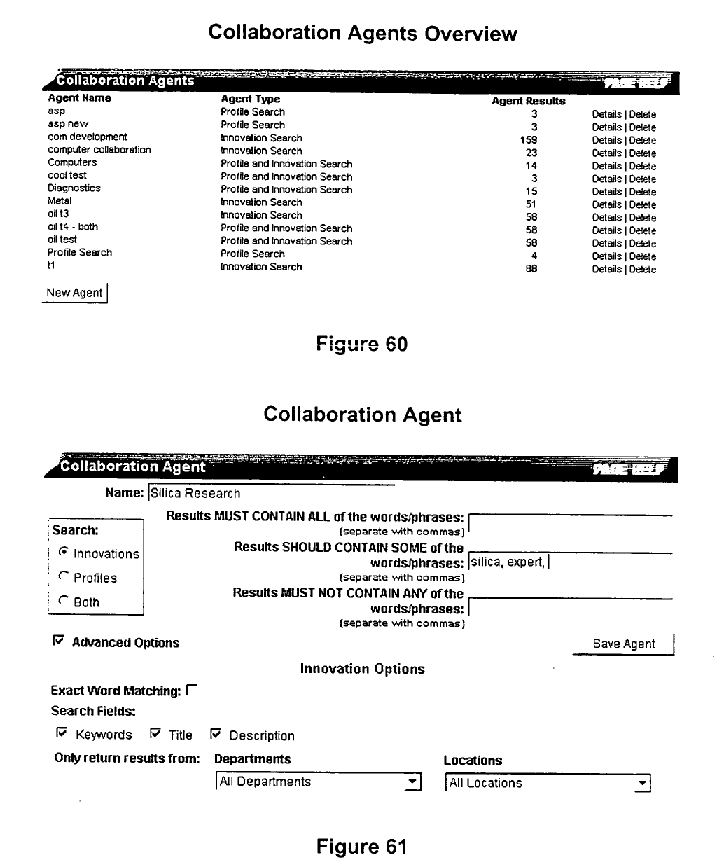

An innovator may view all of the collaboration agents they have created through the Collaboration Agents Overview step. Advantageously, users navigate to the Collaboration Agents page by expanding the Collaboration menu item on the Homepage (see FIGS. 3 and 19a) and clicking on Collaboration Agents (see FIG. 18). The Collaboration Agents page (see FIG. 60) opens with a data grid displaying a list of the all the collaboration agents currently in the system for the user and select information for each, such as Agent Name, Agent Type and the Number of Agent Results Returned. Optimally, the user is offered a button or link to navigate to the Edit Collaboration and Delete Collaboration Agent steps for each collaboration agent in the list.

Create Collaboration Agent

The Create Collaboration Agent step allows users to create an automated search process that will be performed periodically, optimally once per day or as directed by the Innovator system administrator. (See the Collaboration Agents Overview step for more information regarding Collaboration Agents.)

Users navigate to the Create Collaboration Agent step from the Collaboration Agents Overview step and the Collaboration Agents page (see FIGS. 18 and 60) by clicking on the New Agent button advantageously provided. On the New Agent page illustrated in FIG. 61, a frame contains text boxes, drop-down list boxes, check boxes or other means for entering the desired search criteria.

Optimally, a text box is provided for the collaboration agent's Name and several text boxes are provided for the search criteria. Users are instructed by labels attached to the series of text boxes that text is entered in comma delineated lists and of the function of each text box for the search. For example, one text box is labeled that the search results must contain all of the words of phrases entered. Another text box is labeled that the search results should contain some of the words or phrases entered and a third text box labeled that the results must not contain any of the words or phrases entered. Users create the collaboration agent by removing and entering text for the search criteria. Optimally, users enter either words or phrases, both of which are separated by commas. Desirably, phrases do not need to include quotes and they can be intermixed with single words, for example: golf, PGA, Arnold Palmer. To additionally simplify word entry, searches are not case sensitive.

In preferred processes, collaboration agents are configured to search exclusively in the Innovator Profiles, Innovations, or both. Advantageously, A Search frame is provided with radio buttons to choose between Profiles, Innovations or Both.

A Search Type frame advantageously provided on the page provides users with two radio buttons to choose whether they wish to perform an Exact Search or a Fuzzy Search. With Exact Search selected, the results will contain only the exact text entered in the Collaboration Agent frame. With the Fuzzy Search option selected variations such as plurals and verb declinations would be included. For example, if a user had Fuzzy Search selected and entered the word “play”, the results would contain “play”, “plays”, “player”, and “playing”.

Initially, the Create Collaboration Agent step returns results for all Keywords, Titles, Descriptions and other fields in the Innovator system database. Advantageously, users may click the check box labeled Advanced Options on the Search page and an Innovation Options frame opens that allows users to further refine their search. As described above collaboration agents are configured to search exclusively in the Innovator Profiles, Innovations, or both and a Search frame is provided with radio buttons to choose between Profiles, Innovations or Both. In preferred processes, the appropriate data entry methods are displayed in the Advanced Options frames for whichever range of search the user has selected.

In the Advanced Innovation Options frame (see FIG. 61), users are given the option of checking or unchecking check boxes to include or exclude Search Fields such as Keywords, Title and Description. The Search Fields check boxes default to checked. Another search refinement available through this frame are drop-down list boxes for Departments and Locations. For example, if a user only wanted results from one location, such as Pittsburgh, they would select Pittsburgh from the Locations drop-down list box. If no selection is made the list boxes default to All Departments and All Locations.

Optionally, in the Advanced Profile Options frame (see FIG. 61), users are given the option of checking or unchecking check boxes to include or exclude Search Fields such as Expertise, research and Development, Publications, Interests and Patents. The Search Fields check boxes default to checked. As above, another search refinement available through this frame are drop-down list boxes for Departments and Locations.

When the user has configured the collaboration agent to the desired search criteria, they click on the Save Agent button. The Collaboration Agent is created and, optimally, search results are returned immediately. A Search Results frame opens containing an Innovation Results data grid listing all returned innovations with information, such as Innovation Number, Title, Inventors, Type, Status and Date returned. Advantageously, users may double-click on any of the results to navigate to the Overview step and view the details of the innovation. A similar Profile Results data grid displays biographical data for other Innovator system users returned by the search such as Name, E-mail, Phone Number, Department, Location and Date returned. Advantageously, users may double-click on any of the results to navigate to the Profile Overview step and view the profile of the biographical data of the selected user. Also advantageously displayed on the page are the number of innovation and profile results returned. A Print Results button allows users to print out the results of the current search. As described above, the Collaboration Agent will repeat the search process at the scheduled time configured by the system administrator for the organization's system.

Edit Collaboration Agent

The Edit Collaboration Agent step allows users to change the configurations of their collaboration agents at any time. Users navigate to the Edit Collaboration Agent step from the Collaboration Agents Overview step by clicking on the Edit or Details button or link advantageously provided on each line for each listed collaboration agent within the data grid on the Collaboration Agents page (see FIGS. 18 and 60). The Collaboration Agent page (see FIG. 61) opens containing text boxes, drop-down list boxes, check boxes and other means for entering or changing the desired search criteria. The Collaboration Agent page is the same as described in the Create Collaboration Agent step. In preferred processes, the page opens with all of the current search criteria for the chosen collaboration agent displayed. Users are then able to delete, alter and add search criteria as desired. When the user has configured the collaboration agent to the new search criteria, they click on the Save Agent button and the collaboration agent is updated.

Delete Collaboration Agent

The Delete Collaboration Agent step allows users to remove their collaboration agents from the system at any time. Users navigate to the Delete Collaboration Agent step from the Collaboration Agents Overview step and the Collaboration Agents page (see FIGS. 18 and 60) by clicking on the Delete button or link advantageously provided on each line for each listed collaboration agent within the data grid. In preferred processes, a user is asked to confirm the deletion by means of another frame or page with Yes, No or Cancel buttons. Upon confirmation the collaboration agent is deleted.

Collaboration Agent Results (View)

Through the Collaboration Agent Results step, users view information returned on innovations found by the collaboration agents. Users are notified that new information has been located by a collaboration agent through various methods throughout the system. For example, users are notified through the Innovator Notices step (see FIGS. 1 and 50).

A user navigates to the Collaboration Agent Results page in several ways. One method is from the Homepage (see FIGS. 3 and 19a). The user expands the Collaboration menu item, and selects Collaboration Agents from the menu items directly below the selected folder. The Collaboration Agents page (see FIGS. 18 and 60) opens and the user highlights the desired collaboration agent in the data grid and clicks an advantageously provided Results or Details button or link.

Once the user has navigated to the Collaboration Agents Results page, an Innovation Results data grid displays the list of innovations returned by the collaboration agent and a Profile Results data grid displays the list of Innovator Users returned. The data grids include information for each innovation such as Number, Title, Inventors and Type and information for each user such as Name, Department and Location. Advantageously, users may double-click on any of the results to navigate to the Overview step and view the details of the innovation or the Overview Profile step and view the biography of the Innovator user.

Tasks Overview (View All Tasks for a Specific Innovation)

The Innovator system includes assigning tasks associated with a specific innovation to inventors, review committees, groups, and others in the system. Tasks are specific action requests created either automatically by the Innovator system based on a predetermined workflow or manually by a user. The Tasks Overview step allows an innovator to view all the tasks assigned to themselves and others for a specific innovation and view pertinent information, such as their status, completion and deadlines.

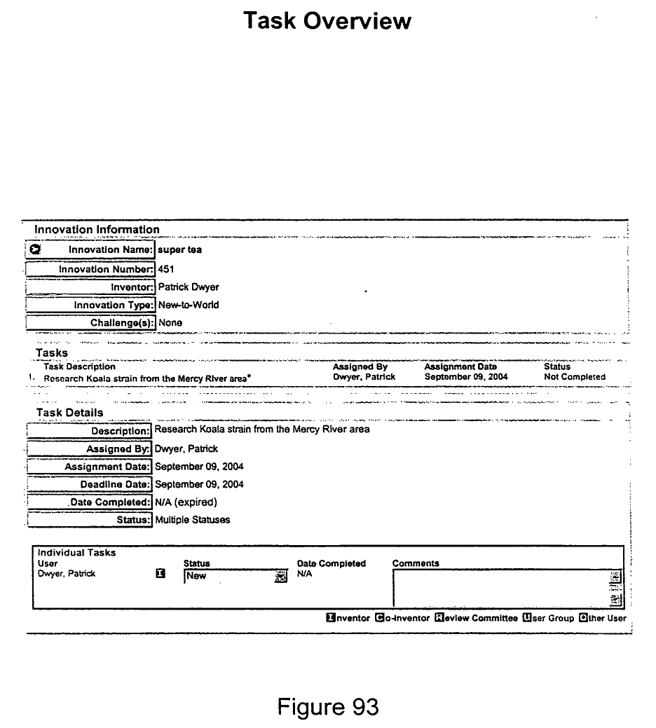

Users navigate to the Tasks Overview step and the Tasks page (see FIG. 93) in several ways. Navigation to various Task displays is illustrated in FIG. 13. One method is from the Homepage (see FIGS. 3 and 19a). The user expands the My Innovations menu item, expands the innovation for which they wish to view tasks and selects Tasks from the menu items directly below. An alternate method begins from the My Innovations step on the My Innovations page (see FIGS. 7 and 33). Located beneath the data grid that lists the user's Innovations, is a drop-down list box labeled Select Innovation and Choose Option. The user selects a particular innovation in the data grid, and then selects Tasks from the drop-down list box. Alternately, from the Homepage, the My Innovations page or the All Shared Innovations page, a user may double-click the innovation to view the innovation's Overview page. On the top right of the Overview page, users select the Innovation Pages tab, then select the Tasks item.

Options available from the Tasks Overview step are illustrated in FIG. 14. The Tasks page illustrated in FIG. 93 opens displaying, in an Innovation Information frame, the selected innovation's information, such as the Innovation Name (as a link to the Overview step), Innovation Number, Inventor and Innovation Type. Also, attached to this frame is an Innovation Pages tab list that allows users to select any of the Overview step's options for the selected innovation. Optimally, a Tasks data grid lists all of the tasks that are associated with the innovation and detailed information for each task, such as a Description, who it was Assigned By, the Assignment Date, Status and Completion Date. An asterisk is attached to tasks assigned to the user themselves. In preferred processes, selecting a task displays the task's information in a Task Details frame. Information includes the Description, who it was Assigned By, the Assignment Date, the Deadline Date, the Completion Date and Status.

Also appearing on the page, is an Individual Tasks frame that advantageously contains a data grid displaying information for the task selected in the data grid of the Tasks frame. In the Individual Tasks frame are listed the individual tasks assigned to each member of the task. Should the task assignment involve multiple users, each user will be able to view information about the individual tasks for all assignees, such as the User name, a user description such as Inventor, Co-inventor or Review Committee member, a drop-down list box to change the Status, Date Completed and a text box to add Comments. Optimally, users are allowed to change the status of a task from this grid by selecting another option from the drop-down list. For example, users would select Complete from the drop-down list when they have finished with the task.

Optimally, if a user changes the status of a task or adds comments, they must click a Save button placed on the page to update the task data (see the Change Task Status and Add Comments to Task steps).

In preferred processes, buttons and links from this page allow users to navigate to the Add Another Task, Edit Task, and Delete Task steps. A Print button also allows users to print the innovation's tasks list.

My Tasks (View All Tasks Currently Assigned to the User)

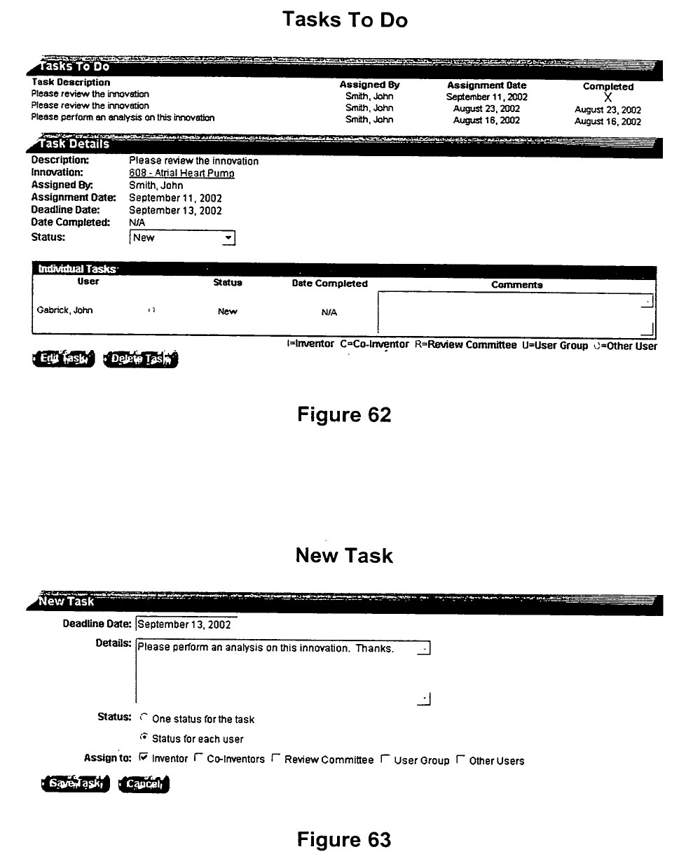

The My Tasks step allows users to view, all the tasks that have been assigned to them and the task details. From this step, users navigate to the Add Task, Edit Task and Delete Task steps. Newly assigned tasks are displayed on the assignee's Homepage in the Innovator Notices frame (see FIGS. 50 and 54) with a Description, the Innovation Name (a link to the Tasks To Do page (see FIG. 62), and the Deadline Date and who it was Assigned By displayed (see the Innovator Notices step).

Optimally, users navigate to the My Tasks step and the Tasks To Do page (see FIG. 62) through several routes. Navigation to various Task displays is illustrated in FIG. 13. One such method is from the Homepage (see FIGS. 3 and 19a). The user expands the My Tasks menu item and selects the My Tasks menu item directly below. The Tasks To Do page opens. Another method is through the Innovator Notices step. The user clicks on a link provided as described above.

Options available to users from the My Tasks step are illustrated in FIG. 15. On the Tasks To Do page (see FIG. 62), a Tasks To Do frame advantageously contains a data grid with the list of tasks that have been assigned to the user for completion and important information such as Task Description, Assigned By, Assignment Date, Status and Completion Date. Optimally, three radio buttons offer the user the option of displaying All tasks, only tasks which have been Completed or Refused, or only Uncompleted tasks. The number of uncompleted tasks is also displayed.

In preferred processes, below the Tasks To Do Frame is the Task Details frame. As the user selects a task in the Tasks To Do frame, the details for the task appear below in the Task Details frame, such as Description, Innovation Name and Number, Assigned By, Assignment Date, Deadline Date, Date Completed and Status. The Innovation Name and Number display is also a link that when selected navigates the user to the Overview step. Also in this frame is an Innovation Overview frame containing the Innovation Name (displayed as a button to navigate the user to the innovation Overview step), the Innovation Number and the Inventor Name. Also, attached to this frame is an Innovation Pages tab list that allows users to select any of the Overview step's options for the selected innovation.

Also appearing on the page, is an Individual Tasks frame that lists the individual tasks assigned to each member of the task. Should the task assignment involve multiple users, each user will be able to view information about the individual tasks for all assignees, such information as the User name, a user description such as Inventor, Co-inventor or Review Committee member, a drop-down list box to change the Status, Date Completed and a text box to add Comments. Optimally, users are allowed to change the status of a task from this grid by selecting another option from the drop-down list. For example, users would select Complete from the drop-down list when they have finished with the task.

Optimally, if a user changes the status of a task or adds comments, they must click a Save button placed on the page to update the task data (see the Change Task Status and Add Comments to Task steps).

Advantageously, on the Tasks To Do page are Add Task, Edit Task and Delete Task buttons to navigate users to the Edit Task and Delete Task steps. Also included is a View Tasks button to navigate users to the Overview Tasks step where they can view all the tasks assigned all users for the selected innovation.

Assigned Tasks (View All Tasks Assigned by This User to Other Users)

The Assigned Tasks step allows users to view all the tasks that they have assigned to other users and the task details. From this step, users navigate to the Add Task, Edit Task and Delete Task steps. Newly assigned tasks show up on the assignee's Homepage with a brief description, the innovation referenced, and the due date (see the Innovator Notices step).

Navigation to various Task displays is illustrated in FIG. 13. Optimally, users navigate to the Assigned Tasks step and the Assigned Tasks page from the Homepage (see FIGS. 3 and 19a). The user expands the My Tasks menu item and selects the Assigned Tasks menu item directly below and the Assigned Tasks page opens.

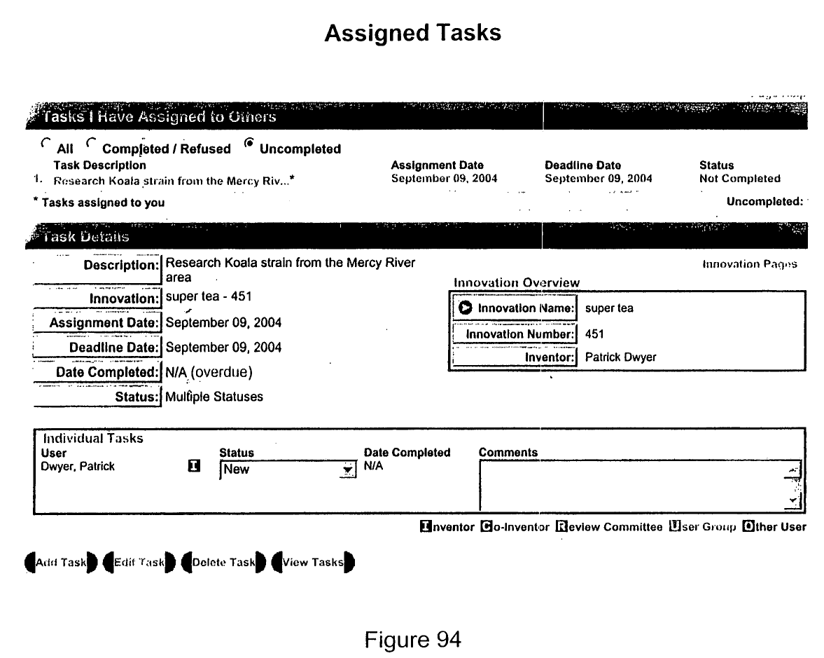

Options available to users from the Assigned Tasks step are illustrated in FIG. 14. On the Assigned Tasks page (see FIG. 94), a Tasks I Have Assigned to Others frame advantageously contains a data grid with the list of tasks that have been assigned by the user to others and important information, such as Task Description, Assigned By, Assignment Date and Completion Date. An asterisk is attached to tasks the user has assigned to themselves. The number of uncompleted tasks is also displayed.

In preferred processes, as the user selects a task in the Tasks I Have Assigned to Others frame, the details for the task, such as Description, Innovation Name and Number, Assigned By, Assignment Date, Deadline Date and Date Completed, appear below in the Task Details frame. The Innovation Name and Number display is also a link that when selected navigates the user to the Overview step. Also in this frame is an Innovation Overview frame containing the Innovation Name displayed as a button to navigate the user to the innovation Overview step, the Innovation Number and the Inventor Name. Also, attached to this frame is an Innovation Pages tab list that allows users to select any of the Overview step's options for the selected innovation.

Also appearing on the page, is an Individual Tasks frame that advantageously contains a data grid displaying information for the task selected in the data grid of the Tasks I Have Assigned to Others frame. In the Individual Tasks frame are listed the individual tasks assigned to each member of the task. Should the task assignment involve multiple users, each user will be able to view information about the individual tasks for each user, such as the User name, a user description such as Inventor, Co-inventor or Review Committee member, a drop-down list box to change the Status, Date Completed and a text box to add Comments. Optimally, users are allowed to change the status of a task from this grid by selecting another option from the drop-down list. For example, users would select Complete from the drop-down list when they have finished with the task.

Optimally, if a user changes the status of a task or adds comments, they must click a Save button placed on the page to update the task data (see the Change Task Status and Add Comments to Task steps).

In preferred processes, buttons are provided to navigate users to the Add Task, Edit Task, Delete Task and Tasks Overview (View All Tasks for a Specific Innovation) steps.

Add Task

This step allows a user to create a new task for an innovation and assign it to other inventors, review committees, groups or others in the system.

Users navigate to the Add Task step from the Tasks Overview, My Tasks or Assigned Tasks steps (see FIGS. 13, 14 and 15). Advantageously located Add Task buttons navigate users to the New Task page (see FIG. 63). Another method to navigate to the New Tasks page, used only to add tasks to innovations that have already had tasks previously assigned, is to navigate through the Assigned Tasks page and, in the section labeled Task Details, click on the Add Task to This Innovation link.

The New Task page opens (see FIG. 63). In preferred processes, if the page has been accessed from a step that specifies an innovation for the task, an Innovation Information frame on the page displays the selected innovation's information, such as the Innovation Name (as a link to the Overview step), Innovation Number, Inventor and Innovation Type. Also, attached to this frame is an Innovation Pages tab that allows users to select any of the Overview step's options for the selected innovation.

Optimally, the New Task page contains a date picker control for the Deadline Date and a Details text box. A set of check boxes with an Assign To label allows users to select the type of assignees the task is directed to from the following: Inventor, Co-Inventors, a Review Committee, a User Group and Other Users. Advantageously, as the user checks the Review Committee or User Group check boxes, appropriately labeled drop-down list boxes are displayed for selection from the groups within the system. As the user checks the Other Users check box, the selection method used for the Forwarding step (utilizing the User Lookup step) is displayed. If the user selects multiple assignees, two radio buttons, labeled Status and marked as One Status for the Task and Status for Each User (or a similar labeling) allow the user to indicate whether all assignees must individually complete the task before it is marked complete, or if any assignee can complete the task and result in it being marked complete. The user then clicks the Save Task button to create the task and automatically send notifications of the new task assignment to the assignees. Cancel and Print buttons are also advantageously provided.

Add Another Task

The Add Another Task step allows users to add additional tasks to innovations for which they have already been assigned at least one task. In other words, innovations that already appear in that user's Tasks To Do frame on their Tasks To Do page (See the My Tasks step and FIG. 15).

The user navigates to the Add Another Task step from the My Tasks step. To add a new task to an innovation, the user selects the innovation in the data grid of the Tasks To Do frame on the Tasks To Do page, by clicking with the mouse or using the arrow keys, so that the task's information is displayed in the Task Details frame. The user then clicks on the Add Task To This Innovation link to navigate to the New Task page (see FIG. 63). The data entry for the new task is the same process as for the Add Task step including clicking the Save Task button to create the task and automatically send notifications of the new task assignment to the assignees.

Edit Task

This step allows users to change the data entered for a task. Users navigate to the Edit Task step through the Tasks Overview, My Tasks or Assigned Tasks steps (see FIGS. 13, 14 and 15). Advantageously located Edit Task buttons navigate users to the Edit Task page. Optimally, the user selects the task in the data grid listing tasks on one of the pages listed above and the selected task's information is then displayed in the Task Details frame. The user then clicks the Edit Task button advantageously provided. The Edit Task page opens, displaying the current data for the selected task. The Edit Task page is a similar configuration to the New Task page (see FIG. 63) and contains the same input controls. In preferred processes, all controls on the page behave in the same manner as the New Task page. Users then alter the data they wish to change and click the Save Task key to update the task data. A Cancel button allows users to leave the page without altering the state of the task data.

Change Task Status

In the course of task processing, this step allows users who have been assigned tasks to change the status of the task, including marking it Completed.

The user navigates to the Change Task Status step from the Tasks Overview, My Tasks or Assigned Tasks steps (see FIGS. 13, 14 and 15). The user selects the innovation in the data grid by clicking with the mouse or using the arrow keys, so that the task's information is displayed in the Task Details frame (see FIGS. 62, 93 and 94). The user then selects the appropriate status, such as Completed, from the drop-down list box labeled Status in the Individual Tasks frame. The user then clicks the Save button to update the task's data.

After Completed is selected from the Status list box, the task is automatically recorded as Completed, along with the date that it was completed, and the task is removed from the user's list of tasks in the Tasks To Do frame on the Tasks To Do page and the Innovator Notices frame on the Homepage (See FIGS. 1, 50 and 54). However, users, managers and administrators are able to view the same task's data through the connection to the innovation associated with the task (see the Tasks Overview step).

Add Comments To Task

This step allows users who have been assigned tasks to add comments to the assignment.

The user navigates to the Add Comments to Task step from the Tasks Overview, My Tasks or Assigned Tasks steps (see FIGS. 13, 14 and 15). The user selects the innovation in the data grid by clicking with the mouse or using the arrow keys, so that the task's information is displayed in the Task Details frame (see FIGS. 62, 93 and 94). The user then enters comments in the text box labeled Comments in the Individual Tasks frame and clicks the Save button to update the task's data. The comments will now be displayed with the tasks data.

Delete Task

In preferred processes, users are allowed to delete a task from the Tasks Overview, My Tasks or Assigned Tasks steps, provided the task has not been assigned a status change. To delete a task, the user selects the innovation in the data grid on one of the pages, so that the task's information is displayed in the Task Details frame. The user then clicks the Delete Task button advantageously provided (see FIGS. 62, 93 and 94). In preferred processes, a user is asked to confirm the deletion by means of another frame or page with Yes, No or Cancel buttons. Upon confirmation the task is deleted, no longer displaying in the assignee's Task To Do page or Innovator Notices page.

The Manager's Process

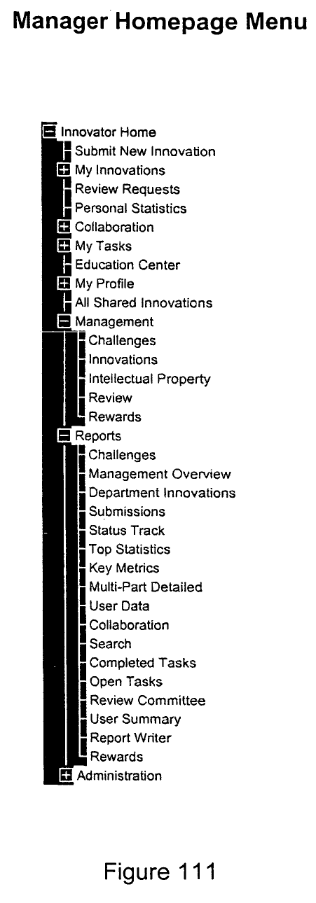

FIG. 111 illustrates the manager's Homepage menu with menu items advantageously available to manager's expanded.

In addition to the steps only performed by managers described below, managers have available to them all steps in the Innovator Process. Since through the Management's Innovations step below, managers have innovations available to them that are not their personal submissions, but that have been shared (see the Share Innovation step in the Innovator Process), managers can perform Innovator Process steps such as Add Task, Forward and so forth, on all innovations within their security clearance.

Management's Innovations (View All Innovations)

The Management's Innovations step (see FIG. 21) advantageously allows managers to view key data and general status for all of the innovations that are set as shared and are currently in the Innovator system, subject to the manager's protection level and security clearance. In preferred processes, the Management's Innovations step also provides navigation opportunities to further steps, such as the Forward A Single Innovation, Set Status and Perform an Analysis steps, for each innovation from one page. The Management's Innovations step is similar to the My Innovations step in the Innovator's process. However, it provides additional graphical representation, filtering of the display and navigation to management steps.

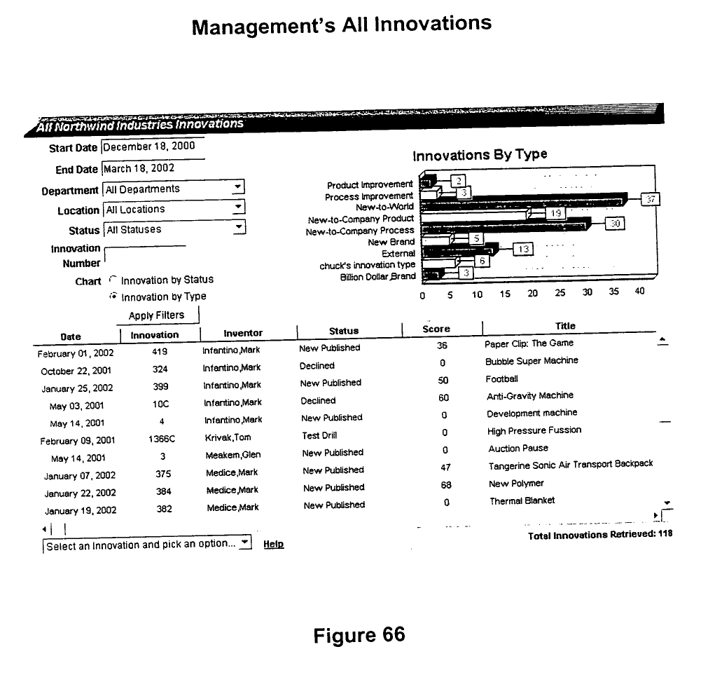

The user may navigate to the All Innovations page (see FIG. 66) by a number of means such as clicking on the Innovations menu item on the Home page (see FIGS. 19a and 20). On the All Innovations page, Managers may access all of the innovations submitted by the individual innovators within the Manager's security clearance. Innovations are optimally displayed in an interactive data grid. Data pertaining to the innovations is advantageously displayed in columns and includes such information as the Date the innovation was submitted, Innovation Number, Innovation Name, Department, Location, assigned Status of the innovation, Type, the Inventor, Analysis Score, Security Level, whether it is Confidential and whether it has been added to a Challenge. Optimally, there is also a column labeled Shared indicating whether the innovator has marked the innovation as available to be displayed to others in the organization. In addition, the page displays the number of innovations retrieved to populate the data grid.

In preferred processes, the innovations are automatically sorted by clicking on any of the column titles. Clicking on the column again sorts the column in reverse order. Optimally, the width of individual columns may be changed by dragging the column edge to the desired width using the mouse, and column titles may be rearranged in any order by clicking and holding the mouse on a column and then moving it to the desired location.

The All Innovations page (see FIG. 66) advantageously provides a way to manage large numbers of innovations by allowing the user to enter filter criteria to selectively view only the desired data. For example, to reduce the number of innovations displayed in the data grid, the manager restricts the innovations by selecting a Department, Location, Inventor (or Developer) and Status from any or all of the drop-down list boxes provided or entering Start Date, End Date and Innovation Number in any or all of the text boxes provided. For example, if a manager only wanted to see innovations in the Pittsburgh location, they would select Pittsburgh from the drop-down list box labeled Location and then click on the Apply Filters button. The data grid would then display a list of only innovations submitted from, or later assigned to, the Pittsburgh location. Optimally, defaults for the filter criteria are set to return the greatest number of innovations viewable by the manager (all those for which the manager has security clearance). For example, All Departments, All Locations and All Statuses are the default settings for the above mentioned drop-down list boxes.

In preferred processes, the All Innovations page (see FIG. 66) also provides a graphical representation of the Innovations listed titled Innovator Management Chart. The manager selects, through some method (such as the use of two radio buttons provided for the chart or tabs attached to the chart), a graphical display of the number of innovations in each category by innovation type or by status. Also available are tabs or radio buttons to facilitate the saving of the chart as a GIF, MS Excel or other type of file.

Beneath the My Innovations data grid, is a drop-down list box labeled Select an Innovation and Pick an Option. This list contains options that navigate to steps only available to managers, such as Set Status, Edit Security Information, Forward to Other Department, Change Department, Set Spotlight, Set Showcase, Set Challenges, Forward Multiple Innovations, Make Innovation Private, Set Type, and View and Set Tasks, as well as Innovator process options such as Overview, Perform Analysis, View Analysis Results, Activity Log and Forward. When a user selects a particular innovation in the data grid, by clicking on it or using the keyboard, and then selects an option from the drop-down list box, they are advantageously navigated to the appropriate steps with the selected innovation's data, in applicable cases, transferred automatically.

Set Spotlight

The In The Spotlight frame on the Homepage (see FIG. 50) allows users to view information about an innovation or multiple innovations that the organization decides deserve recognition or that are of particular interest to everyone using the Innovator system (see the Spotlight step in the Innovator process). The Set Spotlight step allows managers to change the innovation currently displayed in the Spotlight on the Home page. In preferred processes, innovations to be displayed in the In The Spotlight frame are entered into a queue, and are rotated to display in sequence based on when the innovation is entered and how long each innovation is set to display.

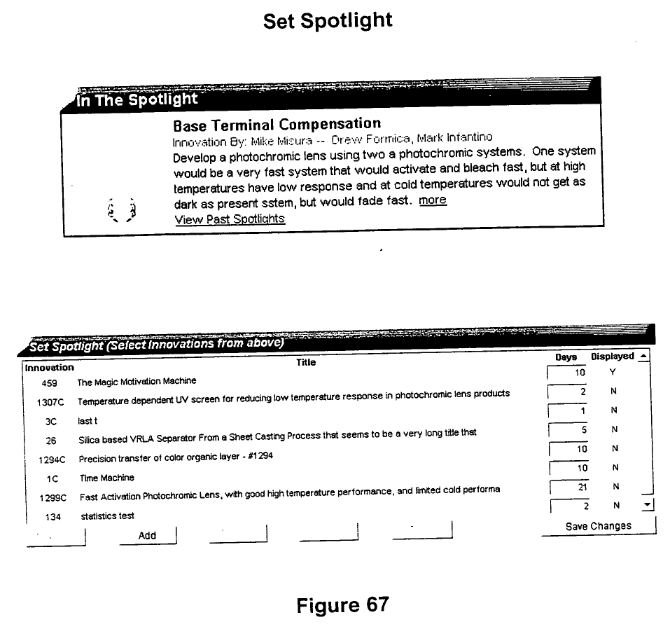

Managers navigate to the Set Spotlight page (See FIG. 67) from the Management's Innovations step and the All Innovations page (see FIGS. 21 and 66). Located beneath the data grid that lists the manager's viewable Innovations, is a drop-down list box labeled Select Innovation and Choose Option. The user selects Set Spotlight from the drop-down list box. The Set Spotlight frame is displayed below the drop-down list box (See FIG. 67).

Optimally, the Set Spotlight frame contains an interactive data grid listing the innovations queued for display in the Spotlight on the Homepage and displaying information about the innovations, such as the innovation Number, Title and whether it has been Displayed yet. The grid also contains a text box for the user to enter the Number of Days the innovation should be displayed in the Spotlight.

To add new innovations to the spotlight list, the user selects an innovation from the Innovator Management's All Innovations data grid, and then clicks the Add button advantageously provided in the Set Spotlight frame. The user then enters the number of days the innovation should be displayed and places it in the queue as desired using the methods described below.

To delete innovations from the Set Spotlight frame's data grid, managers select an innovation from the list and then click the Remove button, advantageously provided.

Optimally, managers may change the order the innovations are queued to display by changing the order of the innovations within the Set Spotlight frame's data grid. The manager selects an innovation from the Set Spotlight frame's data grid and then clicks either the Up or Down button to move the innovation to an earlier or later position.

When the Spotlight list is set to the desired content and order, the manager clicks the Save Changes button to save the work.

In preferred processes, the manager may view details for each innovation by selecting an innovation from the Set Spotlight frame's data grid and then clicking the Overview button. The user is then navigated to the Overview page with the selected innovation's information automatically displayed (see the Overview step in the Innovator Process).

Advantageously, managers locate the currently spotlighted innovation by clicking on the Locate button. The user is then navigated to the innovation in the Set Spotlight frame's data grid and the innovation is highlighted.

Set Showcase

In order to for each department or location to advertise more about itself, the Showcase step and Showcase Innovations page (See FIG. 51) allow users who are innovators, managers and administrators to view information regarding the innovation activity of different divisions within the organization, such as departments and locations (see the Showcase step in the Innovator process). Predefined divisions within the organization showcase their most promising, most interesting, or more important innovations. The Set Showcase step allows managers to add innovations and associated comments to either a department or location, determine where in the data grid on the Showcase Innovations page innovations are displayed and remove previously displayed innovations.

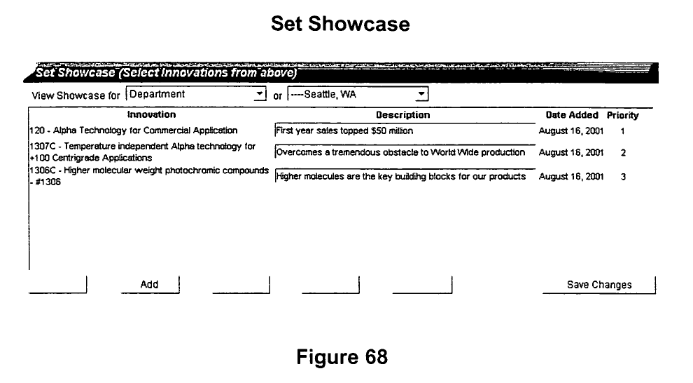

Managers navigate to the Set Showcase frame (See FIG. 68) from the Management's Innovations step and the All Innovations page (see FIGS. 21 and 66). Located beneath the data grid that lists the manager's viewable Innovations, is a drop-down list box labeled Select Innovation and Choose Option. The user selects Set Showcase from the drop-down list box. The Set Showcase frame is displayed below the drop-down list box (See FIG. 68).

The Set Showcase frame contains drop-down list boxes for selection of the Department or Location the manager wishes to view. Once the manager has selected a Department or Location, the innovations are displayed in an interactive data grid. The data grid lists the innovations to be displayed for that Department or Location and displays information about the innovations, such as the innovation Number and Title, the Date Added and Priority. The grid also contains a text box for the user to enter a Description to be displayed.

To add new innovations to the Showcase list, the user selects an innovation from the Innovator Management's All Innovations data grid, and then clicks the Add button advantageously provided in the Set Showcase frame. The user then enters or changes the description and places it in the list using the methods described below.

To delete innovations from the Set Showcase frame's data grid, managers select an innovation from the list and then click the Remove button advantageously provided.

Optimally, managers may change the order the innovations are listed for viewing by changing the order of the innovations within the Set Showcase frame's data grid. The manager selects an innovation from the Set Showcase frame's data grid and then clicks either the Up or Down button to move the innovation to a higher or lower position.

When the Showcase list is set to the desired content and order, the manager clicks the Save Changes button to save the work.

In preferred processes, the manager may view details for each innovation by selecting an innovation from the Set Showcase frame's data grid and then clicking the Overview button. The user is then navigated to the Overview page with the selected innovation's data automatically displayed (see the Overview step in the Innovator Process).

Overview Breakthrough Challenges

In the interest of spurring focused innovation, the Breakthrough Challenge steps in the Innovator process allow users to view and submit new innovations toward the challenges that their organization is currently addressing. (see the Breakthrough Challenges (View) and Add Innovation to a Challenge steps in the Innovator process). The Overview Breakthrough Challenges step allows managers to view key data and general status for all of the challenges that are currently in the Innovator system. The overview also provides additional graphical representation and filtering of the display and navigation to other breakthrough challenge management steps. See FIG. 22.

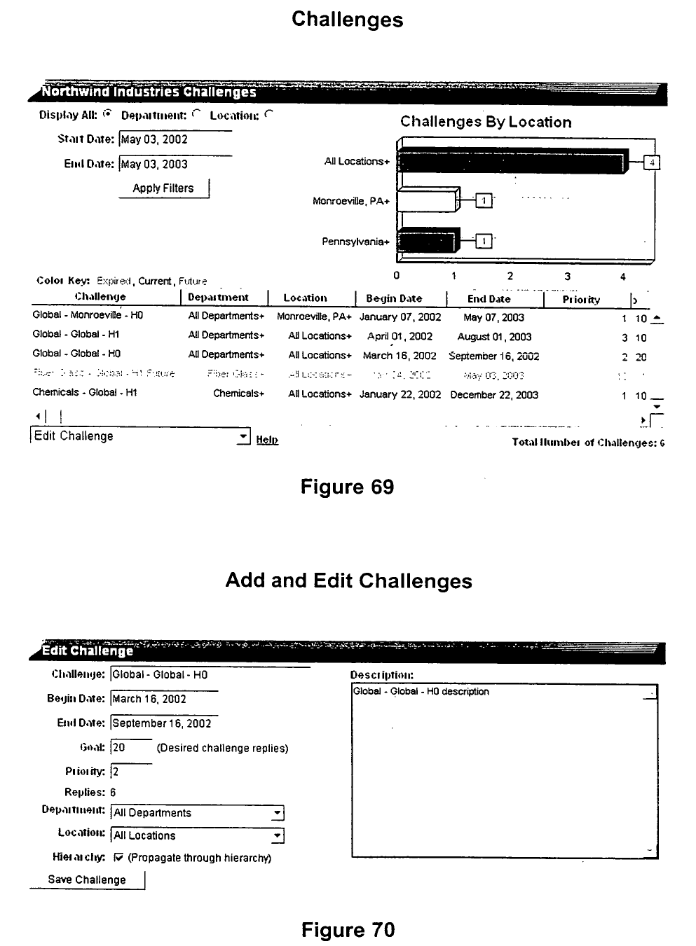

Managers navigate to the Challenges page (See FIGS. 22 and 69) from the Management's Innovations step and the All Innovations page (see FIGS. 21 and 66). Advantageously located beneath the data grid that lists the manager's viewable Innovations, is a drop-down list box labeled Select Innovation and Choose Option. The user selects Challenge Management from the drop-down list box. The Challenges page (See FIG. 69) opens with a data grid displaying a list of the challenges currently in the system and select information for each, such as Challenge Name, Department, Location, Begin Date, End Date and Priority. In addition, the page displays the number of challenges retrieved to populate the data grid. A color key is advantageously provided within the data grid list. Optimally, challenges are color-coded based on date. Red is used for challenges that are expired, black for current challenges, and green for future challenges.

Optimally, the Challenges page (See FIG. 69) also provides a graphical representation of the challenges listed. The manager selects, through a method such as the use of radio buttons or tabs provided for the chart, a graphical display of the number of challenges in each category by department or by location.

The Challenges page (See FIG. 69) advantageously provides a way to manage large numbers of challenges by entering filter criteria to selectively view only the desired data. For example, to reduce the number of challenges displayed in the data grid, the manager restricts the challenges by entering a Start Date or End Date in any or both of the text boxes provided and then clicking on the Apply Filters button. The data grid and chart would then display a list of only challenges submitted to display between the selected dates. Optimally, defaults for the filter criteria are set to return the greatest number of challenges viewable by the manager user.

Advantageously, in the Department and Location columns, if a department or location includes a plus sign next to the name, it indicates that the challenge will be displayed within sub-departments or sub-locations as well. For example, consider an Engineering department structure that includes three sub-departments, Software, Hardware and Testing. A challenge is created for the Engineering department and the submitter indicates sub-departments are to be included. It will be displayed as Engineering+ in the Department column. In addition, if a user examines challenges for the Hardware department, the challenge created for Engineering would also be shown as Engineering+.

In preferred processes, the Overview Breakthrough Challenges step also provides navigation opportunities to further steps. Located beneath the data grid is a drop-down list box that the manager can use to navigate to steps such as the Add Breakthrough Challenge, Edit Breakthrough Challenge, Delete Breakthrough Challenge and View Responses to a Breakthrough Challenge, for each challenge. The manager highlights the desired innovation and selects one of the above steps from the drop-down list.

Add Breakthrough Challenge

The Add Breakthrough Challenge step allows managers to add new breakthrough challenges to the system. (For a description of breakthrough challenges see the Overview Breakthrough Challenges step.)

The user navigates to the Add Breakthrough Challenges step from the Overview Breakthrough Challenges step and the Challenges page (see FIGS. 22 and 66). Beneath the Challenges data grid, is a drop-down list box. The user selects Add Challenge from the drop-down list advantageously provided and an Add Challenge frame appears below the Challenges page (See FIG. 70).

Advantageously, users enter data into the Add Challenges frame through textboxes, drop-down list boxes, checkboxes and other methods. Optimally, data includes a Name for the challenge, a Description, a Beginning Date and an Ending date (determining when the challenge will be displayed), a Goal for the number of desired challenge responses and a Priority level (determined according to an organizational standard). Optimally, the priority is used to sort multiple challenges for the same department or location. For example, a challenge entered with a priority of 1 would be displayed before a challenge with priority of 2. In preferred processes, the user selects a department or location from drop-down lists to indicate where a challenge should be shown. For example, for a challenge that should be viewed by every department and every location, the user selects All Departments and All Locations. If a user wants a challenge to show up under a particular department, that individual department is selected, for example Manufacturing. If Manufacturing were selected as the Department, and All Locations left selected for the Location (since it is the default) the challenge would be displayed in the Manufacturing department regardless of location. Advantageously, users are allowed to decide whether to include sub-departments or sub-locations by clicking the Hierarchy checkbox. Optimally, if a user does not check this box, then the challenge will only be viewable by users whose department or location matches exactly with what has been selected.

After all data has been entered to the managers satisfaction, the user clicks the Save Challenge button advantageously provided in the Add Challenge frame to save the work.

Edit Breakthrough Challenge

The Edit Breakthrough Challenge step allows managers to change data previously entered and displayed for breakthrough challenges within the system. (For a description of breakthrough challenges see the Overview Breakthrough Challenges step.)

The user navigates to the Edit Breakthrough Challenges step from the Overview Breakthrough Challenges step and the Challenges page (see FIGS. 22 and 66). The user selects a challenge from the data grid using the mouse or arrow keys, then selects Edit Challenge from the drop-down list box advantageously provided below the data grid. An Edit Challenge frame appears below the Challenges page (See FIG. 70).

The Edit Challenge page contains all of the input methods described in the Add Breakthrough Challenge step. In addition, the page displays the number of Replies to the challenge received to date. Users change any of the data they wish and click the Save Challenge button to save the work when they have finished.

Delete Breakthrough Challenge

The Delete Breakthrough Challenge step allows managers to remove challenges previously entered and displayed within the system, subject to the manager's security clearance. (For a description of breakthrough challenges see the Overview Breakthrough Challenges step.)

The user navigates to the Delete Breakthrough Challenges step from the Overview Challenges step and the Challenges page (see FIGS. 22 and 66). The user selects a challenge from the data grid using the mouse or arrow keys, then selects Delete Challenge from the drop-down list box advantageously provided below the data grid.

Optimally, the user is prompted for confirmation that the challenge is to be deleted. After confirmation, the challenge is removed from the system.

View Responses to a Breakthrough Challenge

The View Responses to a Breakthrough Challenge step allows managers to view the responses that have been made to a particular challenge by innovators within the system. (For a description of breakthrough challenges see the Overview Breakthrough Challenges step.)

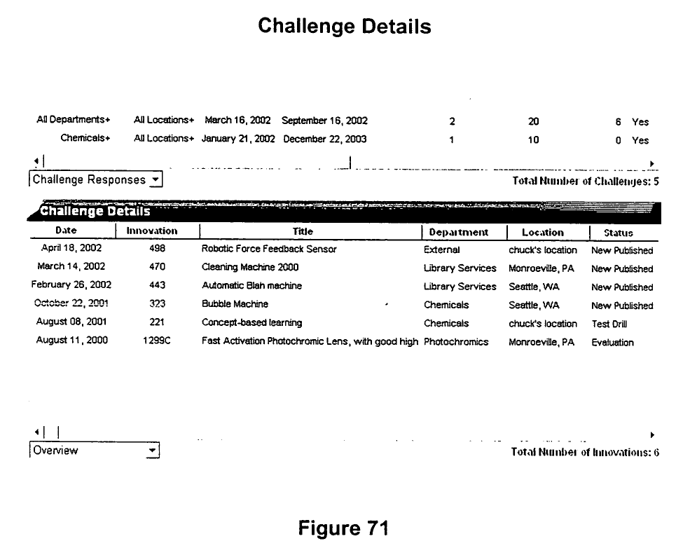

The user navigates to the View Responses to a Breakthrough Challenges step from the Challenges page (see FIGS. 22 and 66). The user selects a challenge from the data grid using the mouse or arrow keys, then selects Responses from the drop-down list box advantageously provided below the data grid. A Challenge Details frame appears below the Challenges page (see FIG. 71).

The Challenge Details frame contains a data grid listing each innovation that has been submitted in response to the selected challenge (see the Add Innovation to a Challenge step in the Innovator process). The data grid displays information for each innovation such as the Date submitted, the Innovation Number, the Innovation Title, Department, Location and Status. In addition, the page displays the number of innovations retrieved to populate the data grid. A drop-down list box advantageously located below the data grid provides navigation to additional steps, such as the Overview step (see the Overview step in the Innovator process). When a user selects a particular innovation in the data grid, by clicking on it or using the keyboard, and then selects an option from the drop-down list box, they are advantageously navigated to the appropriate steps with the selected innovation's data, in applicable cases, transferred automatically.

Set Status

In preferred processes, when an innovator submits an innovation to the system (see the Submit New Innovation step in the Innovator process), the innovation is assigned the default status of New. The Set Status step allows managers to guide innovations through a series of statuses defined by the organization.

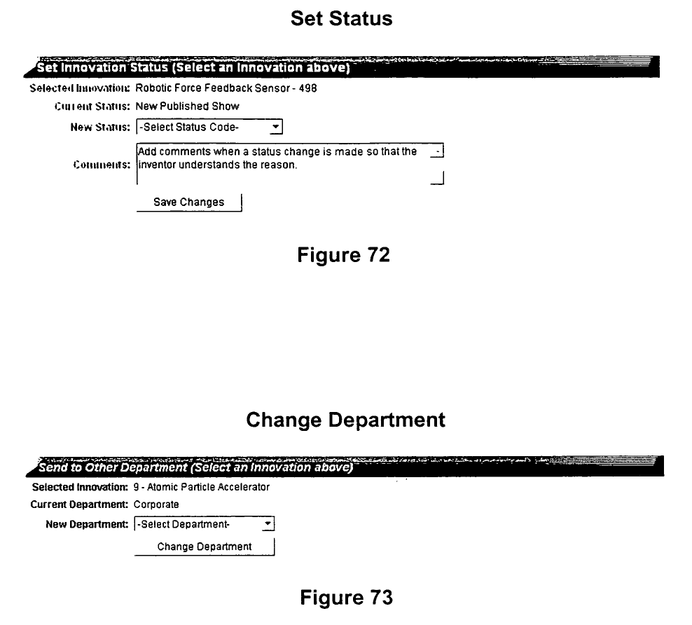

Managers navigate to the Set Status step and page (See FIG. 72) from the Management's Innovations step and the All Innovations page (see FIGS. 21 and 66). The user selects an innovation from the data grid using the mouse or arrow keys, then selects Set Status from the drop-down list box advantageously provided below the data grid. The Set Status page is displayed below the drop-down list box (See FIG. 72).

In preferred processes, the Set Status page will display the Selected Innovation Title and Current Status. A drop-down list box titled New Status will provide the list from which the manager may select the new status. Optimally, the user is also provided with a text box to add comments associated with the status change, such as next steps or the reason for the status change.

Users enter the appropriate data and click the Save button to save the work when they have finished.

Set Type

From time to time, it may be necessary to change the Innovation Type of an innovation. The Set Type step allows a manager to change the Type assigned to an innovation when it was first submitted or the Type it was later assigned. Since each Innovation Type has a particular question set associated with it, any previous analyses will be deleted when the type is changed (see the Perform an Analysis step in the Innovator process). In addition, if automated workflow has been associated with this innovation, changing the type might change the workflow associated with that innovation.

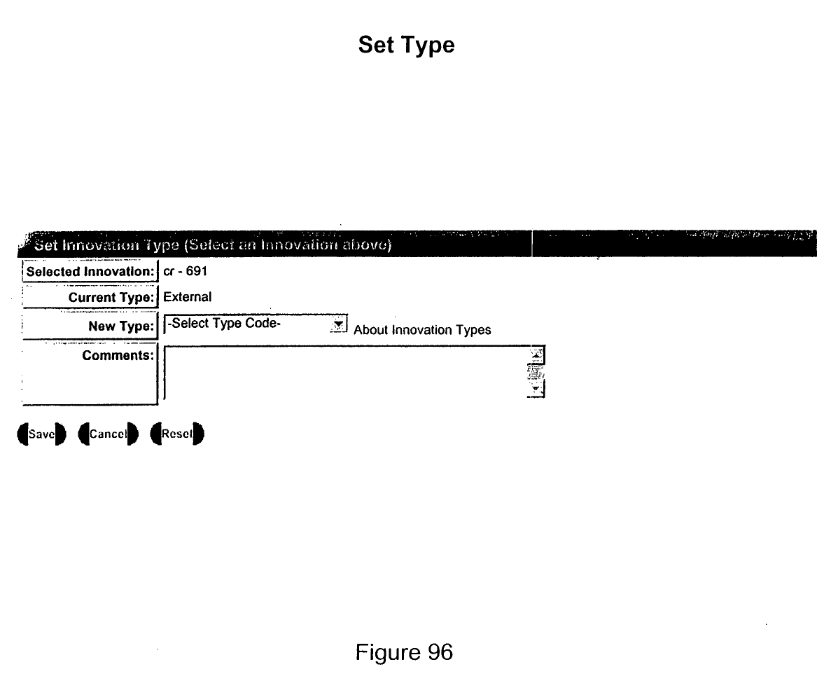

Managers navigate to the Set Type step and page from the Management's Innovations step and the All Innovations page (see FIGS. 21 and 66). The user selects an innovation from the data grid using the mouse or arrow keys, then selects Set Type from the drop-down list box advantageously provided below the data grid and the Set Innovation Type page opens (see FIG. 96).

The Set Innovation Type page displays the name and number of the Selected Innovation and the Current Type. In preferred processes, a drop-down list box is provided for selection of a new type from those currently defined in the system (Administrators define the available types). In addition, a Comment text box is provided for the manager's use in explaining this type change. Save, Cancel and Reset buttons are advantageously provided to save the change, cancel the operation or reset the type to the original.

IP Status Track

The IP Status Track step allows managers to view a history of the changes to the IP Status of an innovation. Managers navigate to the IP Status Track step and page from the Management's Innovations step and the All Innovations page (see FIGS. 21 and 66). The user selects an innovation from the data grid using the mouse or arrow keys, then selects IP Status Track from the drop-down list box advantageously provided below the data grid. Advantageously, a list box displays a list of the IP Status changes the innovation has undergone and relevant information such as the Date the status was applied, the Name of the status, the name of the User who changed the status and any Comments.

Make Innovation Private

Shared innovations are innovations viewable by all users with the appropriate security privileges. When an innovator submits a Shared innovation (see the Share Innovation step in the Innovator process), it is sent to the appropriate review committees or individuals as determined by the organization's distribution policy. Once an innovator has shared an innovation, they cannot make it private again, nor can they delete it from the system. From time to time, however, this is desirable and the Make Innovation Private step allows managers to perform this task.

Managers perform the Make Innovation Private step from the Management's Innovations step and the All Innovations page (see FIGS. 21 and 66). The user selects an innovation from the data grid using the mouse or arrow keys, then selects Make Innovation Private from the drop-down list box advantageously provided below the data grid. The innovation is changed from shared to private within the system. Thus, it will no longer appear in the Management's My Innovations data grid, and the submitting innovator will be able to delete the innovation from their home page.

Change Department

Innovations have two department designations, the department of the user who submitted the innovation and the department that the innovation is submitted to for review. When innovations are initially submitted, they are assigned to a review department based on the innovator's own department, unless the user specifically changes it (see the Submit New Innovation step in the Innovator process). The assumption is that a user will submit innovations primarily of concern to their own department's priorities. In the case where the innovation is not germane to the originally entered department, the Change Department step allows managers to change the department where the idea will be reviewed.

Managers navigate to the Change Department step and the Send to Other Department page (See FIG. 73) from the Management's Innovations step and the All Innovations page (see FIGS. 21 and 66). The user selects an innovation from the data grid using the mouse or arrow keys, then selects Set Status from the drop-down list box advantageously provided below the data grid. The Send to Other Department page is displayed below the drop-down list box (See FIG. 73).

Optimally, the Send to Other Department page displays the Number and Name of the innovation and the Current Department it is assigned to for review. The manager selects the new review department from an advantageously provided drop-down list box labeled New Department and clicks the Change Department button to save the change. The innovation will then be sent to the Review Committee appropriate to the new department from the Forward to a Review Committee step.

Edit Security Information

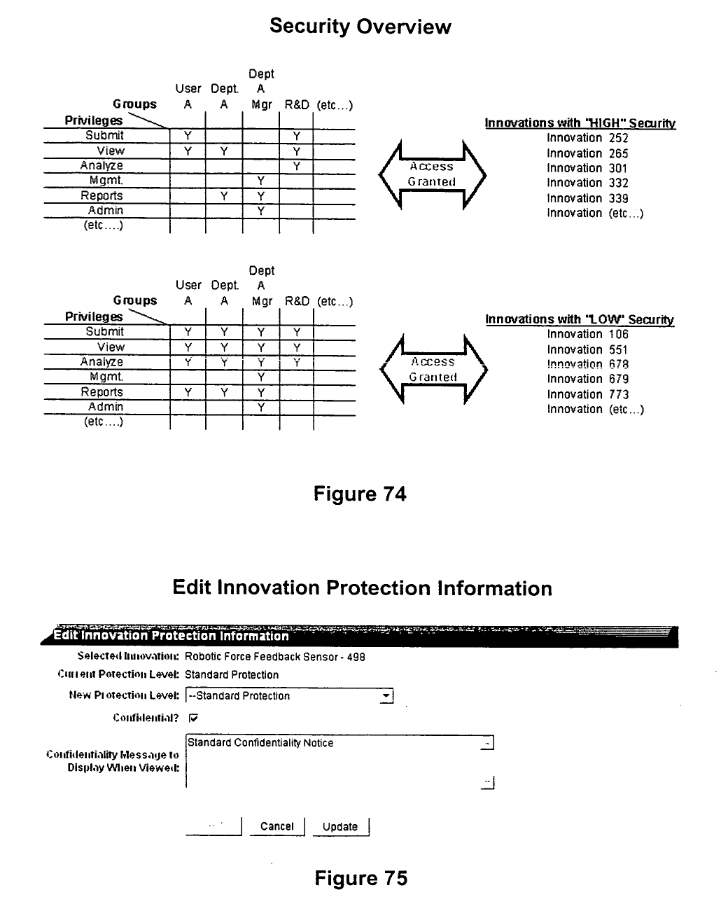

The security mechanism within the Innovator system is very extensive and flexible. It distinguishes between security for individual users and groups of users as well as individual innovations and groups of innovations. In preferred processes, several user groups and several innovation security levels are configured to achieve the level of protection required for the organization (See FIG. 74).

User groups are created by an administrator to assign privileges to all of the members. For example, an administrator may create a user group called R&D, assign all of the people from the Pittsburgh location into that group, and then allow them only to Submit, View, and Analyze innovations. In contrast to user groups that assign rights to users, innovation security assigns groups of innovations to different security classes. Classes do not assign privileges; they are merely groups of innovations. These hierarchical classes are then related with specific user groups and their privileges. For example, a specific user group could view innovations that are classified as High, and view, but not edit, innovations that are classified as Confidential. Optimally, administrators, not managers, create and maintain user groups and assign them privileges. Managers assign innovations a security class.

When innovations are submitted, they are automatically given a default security level or class. The Edit Security Information step allows managers to change the security class of an innovation, assign the innovation Confidential status and edit the text displayed for a confidential innovation. This function is used when there is a desire to remove an innovation from general viewing. For example, in some organizations, when the manager changes the security class from standard to high, normal users will be prevented from viewing or modifying the innovation.

Managers navigate to the Edit Security Information step and the Edit Innovation Protection Information page (See FIG. 75) from the Management's Innovations step and the All Innovations page (see FIGS. 21 and 66). The user selects an innovation from the data grid using the mouse or arrow keys, then selects Edit Security Information from the drop-down list box advantageously provided below the data grid. The Edit Innovation Protection Information page (See FIG. 75) is displayed below the drop-down list box.

Optimally, the Edit Innovation Protection Information page (See FIG. 75) displays the Name and Number of the innovation and the Current Protection Level of the innovation selected. Managers may select a security class, within the structure developed by the organization, from the drop-down list box labeled New Security Level. By selecting a security level from the drop-down list, they assign a new set of privileges to the innovation as explained above. Managers may check or uncheck a checkbox advantageously provided and labeled Confidential to change the innovations status to one indicating that it contains proprietary information. When displayed to users, the confidential indicator will change from N to Y and the innovation will display a confidentiality message every time a user performs any action on it, such as view or edit. A textbox is provided for the manager labeled Confidentiality Message to Display When Viewed. The manager enters the text message that will be displayed each time an innovation that is designated as Confidential is viewed. The message is displayed at the top of each page where the innovation is displayed. Optimally, the default for the message will be a standard message created for use throughout the organization.

The manager then clicks the Save button advantageously provided to save the changes or clicks the Cancel button to close the page without changing the security information.

Forward Multiple Innovations

From time to time, it may be necessary or desirable to send an innovation to a peer, supervisor, team member or any number of other user types for their help. The Forward Multiple Innovations step allows the manager to forward multiple innovations to the same users in a block instead of having to select users for each innovation (see the Forward a Single Innovation step).

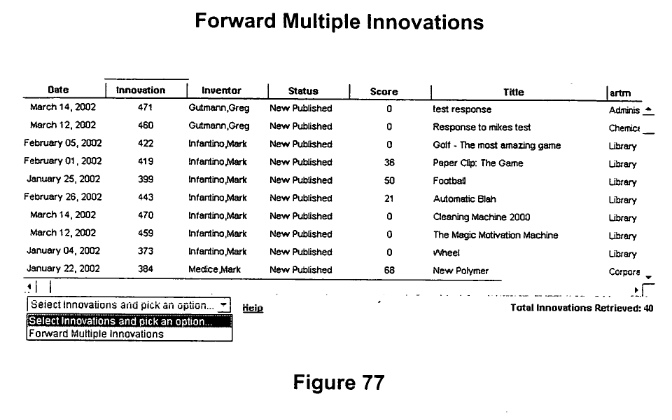

In preferred processes, managers navigate to the Forward Multiple Innovations step from the Management's Innovations step and the All Innovations page (see FIGS. 21 and 66). To forward multiple innovations, the manager selects the desired innovations from the My Innovations data grid (see FIG. 77). To select innovations listed in a block, the manager clicks the first innovation, then holds the Shift key down on the keyboard and clicks the last innovation. The entire block is selected. To select multiple innovations from the data grid, that are not in a block, the manager clicks on each innovation while continually holding the Ctrl key on the keyboard down. Each time a manager clicks on a new innovation, it is selected. To deselect an innovation, the manager clicks on it again.

Once multiple innovations are selected, the drop-down list box, advantageously provided below the data grid, includes the item Forward Multiple Innovations. The manager then selects Forward Multiple Innovations from the drop-down list box and is navigated to the Forward Innovation step in the Innovator process and the Forward Innovation page (See FIG. 40). The step from this point is the same as the Forward Innovation step in the Innovator process. The multiple innovations selected may also be forwarded to a review committee or forwarded for an analysis just as a user would forward a single innovation (see the Forward to a Review Committee and Perform an Analysis steps.)

Forward to a Review Committee

In preferred processes, innovations are moved through levels of analysis and review during their entire development. The review committee is the primary body that performs this function. The Forward to a Review Committee step allows managers to move an innovation to the next level of review by selecting and forwarding the innovation to the appropriate review committee according to the organization's escalation policy.

Optimally, managers perform the Forward to a Review Committee step from the Forward a Single Innovation or the Forward Multiple Innovations steps and the Forward Innovation page (See FIGS. 21 and 40). Once the innovation (or innovations) have been selected and the manager has navigated to the Forward Innovation page, the manager selects a review committee from the drop-down list, labeled Forward to Review Committee, advantageously provided in the Forward To Review Committee frame included on the page. The manager then clicks the Forward to Review Committee button provided in the frame and messages are sent to everyone on the predetermined list of users constituting the selected committee.

View Reports

In preferred processes, managers get more detailed information on innovations and users by generating a variety of reports. Examples of reports that are available to managers are illustrated in FIG. 25 and described below. Selection of a specific report listed under the Reports menu item in the Manager's Homepage menu (see FIGS. 19a and 20) will navigate the manager to that report's criteria selection page.

Several buttons are advantageously provided at the bottom of most of the report criteria selection pages. A Reset button returns all selection criteria to their default settings. After selecting desired criteria, the manager clicks on the Run Report button to generate the report. In preferred processes, after the report is displayed on the screen, the manager has the option of saving the report in either Rich Text Format (RTF), suitable for most word processing applications, or Comma Separated Values (CSV), suitable for most spreadsheet applications, by clicking the appropriately labeled buttons. There is also an option to print the report as it is displayed by clicking the Print button.

In preferred processes, a manager has the option of displaying data in a report as a bar chart, line chart, or area chart. Optimally, managers save chart preferences by clicking a Save Chart Configuration button.

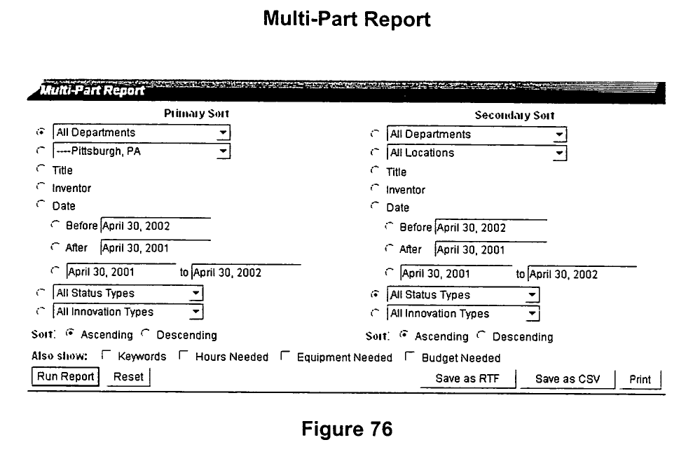

FIG. 76 provides an example of a report page where filter criteria are selected. The example displays the method for selecting criteria for the Multi-Part Detailed report. The Multi-Part Report page allows managers to select one sort or filter criteria from each of two columns, a primary sort or filter column and a secondary sort or filter column. In preferred processes, managers are allowed to select a sort or filter criteria and, if the criteria requires configuration, a drop-down list box, frame or page appears allowing the user to configure the criteria appropriately. For example, if a manager wants to generate a report listing only newly submitted innovations, they click on the button next to Statuses, then select New from the drop-down list box. After choosing a primary sort or filter criteria, the next optional step is to click on one of the buttons under the Secondary sort column and configure it appropriately to further sort or filter the innovations included in the report. Primary and Secondary Sort criteria are data such as Department, Location, Innovation Title (Alphabetically), Inventor, Date, Status and Type. Optimally, managers are allowed to select for the Date criteria (whether innovations with submission dates Before a certain date, After a certain date or Between two dates will be returned) and are allowed to enter the desired dates through text boxes. When a manager selects Department, Location, Status or Type, they may choose a specific from drop-down lists. In preferred processes, the default for drop-down lists is All.

Following is a listing of advantageously provided report types in one embodiment of the system (see FIG. 25):

1) Multi-Part Detailed Report (See FIG. 76): a listing of all innovations, viewable by the manager, sorted or filtered according to selected criteria and displaying selected information such as Keywords, Hours Needed, Equipment Needed and Budget Needed.

2) Management Overview Report: a summary report that displays information such as Innovations By Year, Innovations By Type, Shared vs. Private Innovations, Innovations By Status, Innovations By Location, and Top Inventors. Managers select the report to display by checking an advantageously provided checkbox, selecting from a drop-down list or similar method.

3) Department Innovations Report: displays the current department hierarchy along with the number of innovations in each department. Managers click on a department advantageously displayed on the left-hand side of the page to see the corresponding chart.

4) Submissions Report: a summarization of innovations by department and status. Optimally, the report initially displays innovations for all departments and all statuses, but can be filtered to display more specific information.

5) Status Track Report: a summarization of the length of time that innovations have been in various statuses. Initially, the report shows innovations for all department and all statuses, but can be filtered to display more specific information.

6) Top Statistics Report: a listing of the top ten innovations by the number of times the innovations have been viewed by users other than the manager. Also displayed is a listing of the top ten innovators by successful commercialization.

7) Key Metrics Report: a detailed management report that displays the overall activity within the system. The report includes information such as statistics about submissions, users, current statuses, productivity indices, and execution times.

8) User Data Report: a report that displays, information for an individual user such as the Five Most Recent Innovations, Innovations Updated, Comments Made, Analyzed Innovations, Innovations for which an Analysis was declined, Forwarded Innovations, Viewed Innovations, and Confidential Information Viewed. In preferred processes, the manager generates the report by selecting a user, by clicking on an advantageously provided Select User button, and entering beginning and ending dates.

9) Collaboration Report: a summary report that provides an overview of how much collaboration is occurring within the Innovator system. In preferred processes, results include information such as the number of users who have filled out their profiles, the number of search agents and collaboration agents created, how many find experts searches were performed, and the results of various searches or search agents. For a description of the steps referred to by the report, see the Edit My Profile, Create Search Agent, Create Collaboration Agent, Find an Expert and Quick Search steps in the Innovator process.

10) Completed Tasks Report: a summary report that provides information on completed tasks. Tasks are selectable by criteria such as user, assignor, assignee, review committee or innovation.

11) Open Tasks Report: a summary report that provides information on open tasks. Tasks are selectable by criteria such as user, assignor, assignee, review committee or innovation.

12) Task Status Report: a listing of tasks by user.

The Administrator's Process

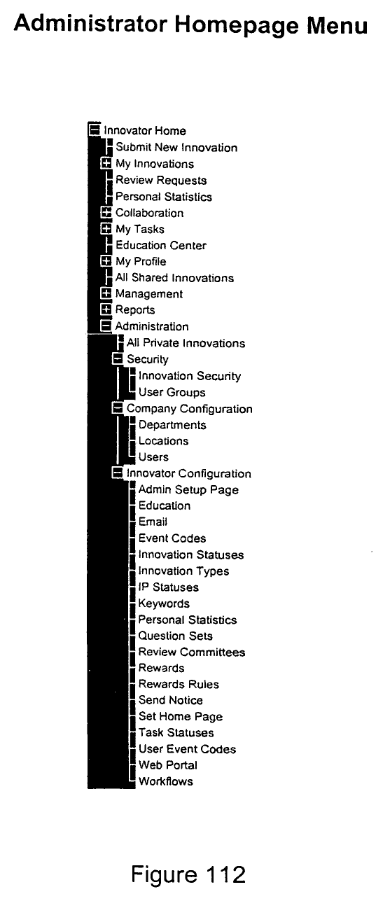

FIG. 112 illustrates the administrator's Homepage menu with menu items advantageously available to administrators expanded.

In addition to the steps only performed by administrators and described below, administrators have available to them all steps in the Innovator Process. Since, administrators have innovations available to them that are not their personal submissions, including all private innovations (See the Access All Private Innovations step below), administrators can perform Innovator Process steps such as Add Task, Forward and so forth, on all innovations within their security clearance.

Set User Groups

The security mechanism within the Innovator system is very extensive and flexible. It distinguishes between security for individual users and groups of users as well as individual innovations and groups of innovations. In preferred processes, several User Groups and several Innovation Protection Groups (or security levels) are configured to achieve the level of protection required for the organization (See FIG. 74).

The Set User Groups step allows administrators to create new and edit existing User Groups. The groups are then used to assign privileges to all of the members. For example, an administrator may create a User Group called Read Only, assign all of the people from the Pittsburgh location into that group, and then, through the Set User Group Access step, allow them only to Submit, View, and Analyze innovations.

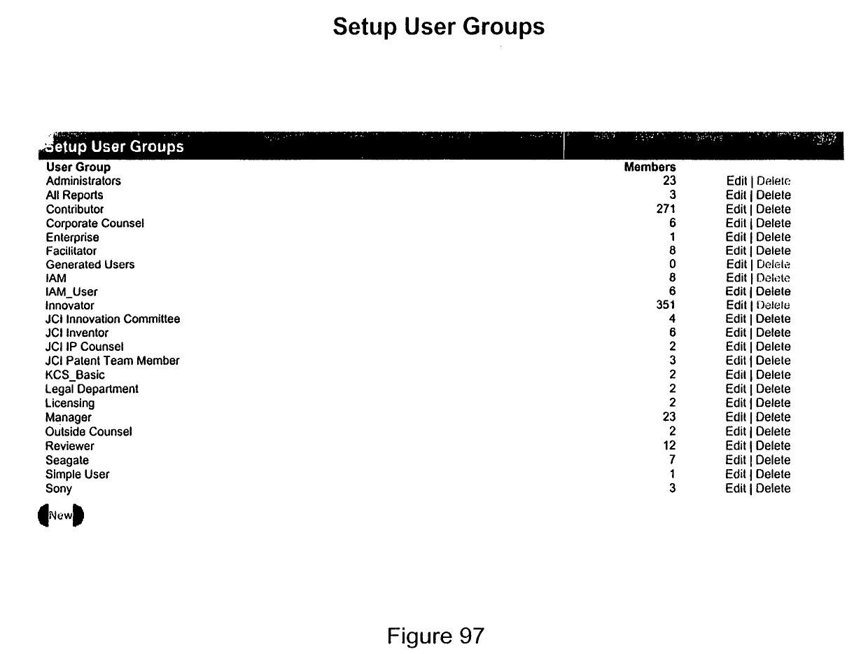

In preferred processes, administrators navigate to the Set User Groups step through the Administration menu item on the Homepage menu (see FIGS. 19b and 26). Administrators select the menu item User Groups under the menu item Security in the Administration menu item on the Homepage menu (see FIG. 27). The User Group page (see FIG. 97) opens displaying all of the current User Groups available in the Innovator system.

To create a new User Group, the administrator clicks on the New button advantageously provided and the New User Group frame appears instructing the user to enter the name of the new User Group to be created and providing a text box for entry. The administrator types in a name and clicks the OK button advantageously provided. The user is then returned to the User Group page and the new group has been added to the main list of groups.

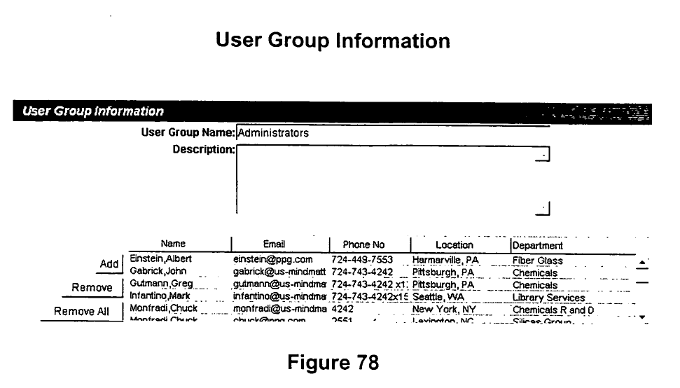

After creating the new User Group, administrators assign users into the group. The administrator selects the new user group just created from the data grid on the User Group page by either double-clicking it, or highlighting it and clicking the Edit button advantageously provided. The User Group Information page is then displayed (see FIG. 78). In preferred processes, the page contains a User Group Name text box, in case the administrator wishes to change the assigned name, and a Description text box for the administrator to enter the description of the User Group. The page also contains a User Group Members data grid displaying all the current members of the User Group in a list and their pertinent data such as Name, Email, Phone Number, Location and Department. The page advantageously contains Add, Remove and Remove All buttons for adding and removing members from the User Group. Administrators add members to the new group by clicking on the Add button. The administrator is then navigated to the User Name Lookup page and the User Name Lookup step, which is the same as the step by that name in the Innovator Process. Optimally, administrators add group members one by one until the group is complete. The administrator uses the Remove button to delete members from the group one by one and the Remove All button to clear the entire group membership. Note that, in preferred processes, administrators are able to see a list of all the groups that a user is a member of, and add, edit and delete the user from groups, through the User Maintenance step as well (see below).

When all members have been assigned to the User Group, the administrator clicks the Save button to save the work.

Set User Group Access

In addition to assigning users to one or more User Groups, administrators set the privileges for the User Groups. In preferred processes, a configuration creates security settings that add and remove data and pages from the user's view or access. The Set User Group Access step allows administrators to configure security through five main types of access: Innovation Settings, Profile Settings, Innovation Management, Administration Functions, and Review Committees.

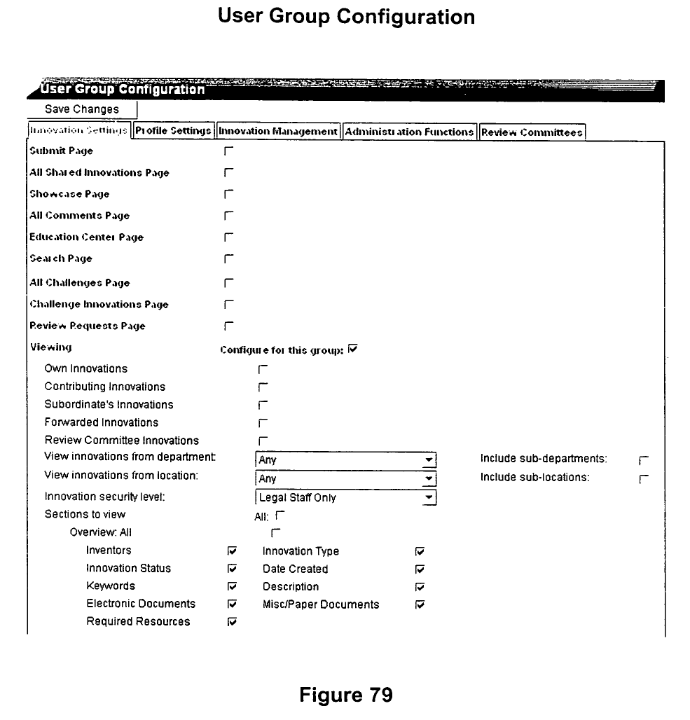

Administrators navigate to the Set User Group Access step from the Set User Groups step and the User Group page (see FIG. 27). Optimally, the administrator double clicks the User Group to be configured from the data grid on the User Group page or highlights it and clicks an Edit button or link advantageously provided. The User Group Configuration page then opens (see FIG. 79).

Optimally, the User Group Configuration page displays tabs for each of the five types of access listed above. Clicking the tab displays the page where the access type is configured. On each page are provided check boxes, drop-down list boxes or other types of input controls to configure. Each page is unique; not all items are available under each access type. In preferred processes, pages are protected from accidental data input. One such method is to require the administrator to click a Configure for This Group check box to begin configuring the items on each page.

Selecting the Innovation Settings tab displays the Innovation Settings page (see FIG. 79) where the administrator will assign the privileges that a group can have with respect to viewing, editing, analyzing, and forwarding an innovation. The administrator configures the check boxes and drop-down list boxes to assign appropriate access to the selected User Group.

In preferred processes, on the Innovation Settings page, administrators are presented with check boxes for the pages that are to be shown as menu items in the users' menus, such as the Submit Page check box that allows the user to make submissions, the Shared Innovations Page check box that allows the user to view the All Shared Innovations Page and so forth.

Optimally, also on the Innovation Settings page, a check box is provided for various steps that the administrator wants or does not want the user to have access to, such as the Search Page check box that allows the user to perform innovation searches. If this is not checked, then the selection for searching innovations is not shown as an option. Additionally, a check box is provided for the All Challenges page that allows the user to view all of the challenges currently configured in the system. Users would also be able to submit to any viewable challenge. Additionally, a check box is provided for the Challenge Innovations Page. This check box determines whether, on the user's Homepage, the Challenges section is displayed. This section lists applicable challenges, usually company wide challenges and user specific (either department or location based) challenges. Activating this page allows users to click on a challenge and view the innovations that have been submitted to it. Optimally, if this page is not checked, then the All Challenges Page check box is unchecked, as it provides similar functionality. Additionally, a check box is provided for the Review Requests Page. This page displays the innovations that a user has been requested to review. These review requests are from other users, not review committees.

In preferred processes, sections are provided on the Innovation Settings page for Viewing, Editing, Analyzing, and Forwarding. The administrator configures these sections to explicitly determine whether the User Group can perform these actions on various types of innovations. Similarly named items such as, View Innovations from Locations and Edit Innovations from Locations perform identical functions in their respective sections. Within the sections, a check box is provided for the user's Own Innovations. The administrator checks this box for the Inventor or Author to be able to view, edit, analyze or forward their own innovations. A check box is provided for Contributing Innovations. The administrator checks this box for contributors to be able to view, edit, analyze or forward their own innovations. (Contributors are people who are added to an initial submission by the original submitter. By default, the person who submits the innovation is the author and other inventors are called contributors.) A check box is provided for Subordinate's Innovations. The administrator checks this box for managers to be able to view, edit, analyze or forward the innovations of users who report to them directly. A check box is provided for Forwarded Innovations. The administrator checks this box for the group to be able to view, edit, analyze or forward innovations that are forwarded to them. A check box is provided for Review Committee Innovations. The administrator checks this box for the users to view, edit, analyze or forward innovations for a review committee for which they are a member. In preferred processes, View Innovations from Department and View Innovations from Location drop-down list boxes are provided. Using these lists administrators select from which departments or locations a user in the group can view, edit, analyze or forward innovations administrators may select Any, and allow the group to view, edit, analyze or forward all innovations. Administrators may also select a specific department or location, and limit the group to innovations only in that department or location. Advantageously, an Include Sub-Department check box is provided to allow administrators to decide whether innovations from sub-departments will be included or only the specified department. Administrators may also select None, thereby preventing the group from viewing, editing, analyzing or forwarding any innovations. Optimally, selecting None cancels any other selections, meaning that the group will not be able to view, edit, analyze or forward any innovations, regardless of the other drop-down list box selections. Similarly, if Any is selected, the group will be allowed to view, edit, analyze or forward regardless of the other drop-down list box selections.

On the Innovation Settings page, a drop-down list box is advantageously provided for selection of the innovation security level. This is the where the Innovation Protection Groups are assigned to the User Group. The administrator selects from the predefined Innovation Protection Groups to pick the security levels from the drop-down list box that this group will be able to view, edit, analyze or forward. See the Setup Innovation Protections Groups step for more information.

Also, on the Innovations Settings page are sections titled Sections to View and Sections to Edit. An All check box is provided for each of these sections. The default setting for the sections is that the All check box is checked, allowing all data for an innovation to be viewable or editable. If an administrator unchecks this box, then another list of check boxes is shown, allowing the administrator to select specific data for viewing or editing. These are displayed with accompanying check boxes and include such data as Inventors, Innovation Type, Innovation Status, Date Created, Keywords, Description, Electronic Documents, Miscellaneous and Paper Documents and Required Resources.

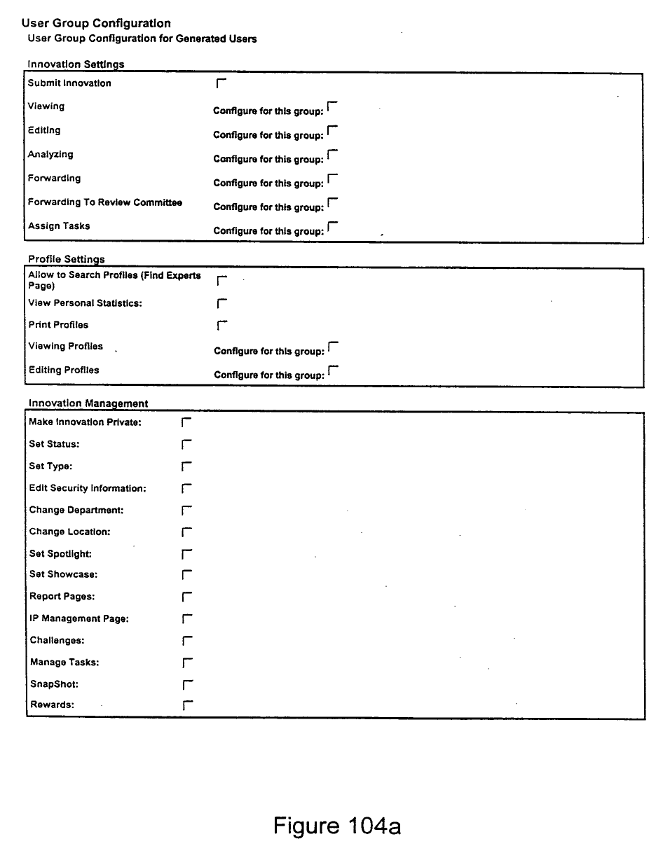

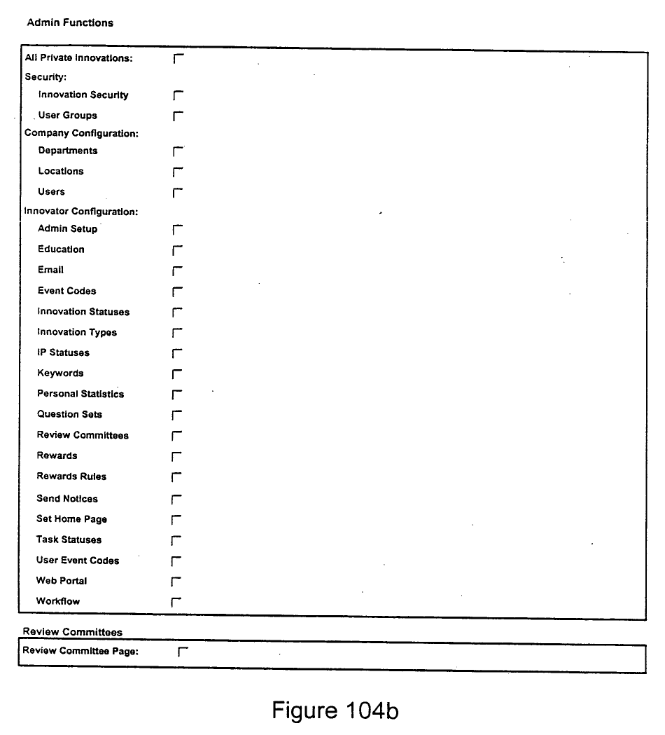

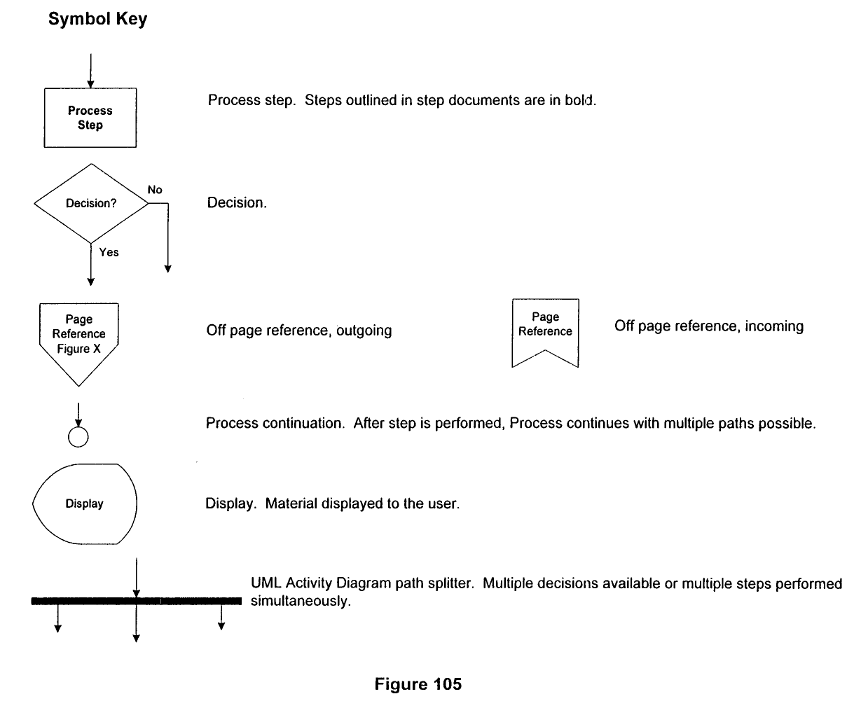

From the User Group Configuration page, the administrator selects the Profile Settings tab to display the Profile Settings page (illustrated in FIG. 104a) and assign the access that the User Group will have to viewing and editing profiles. As on the other four User Group Configuration pages, the administrator clicks on the check box labeled Configure for This Group to begin the input for the page.

In preferred processes, the Profile Settings page (see FIG. 104a) contains several sections, and within each section, there are several check boxes and drop-down list boxes to configure. One such section is the Allow to Search section. This allows the User Group to search through the profiles. If this is not checked, then the search choice for profiles is not shown and the Find Experts menu item is not shown. Another such section is the View Personal Statistics section that allows users to view the personal statistics page. The Viewing and Editing sections allow the User Group to view or edit profiles. Optimally, the configurable items within this section are similar to those described for the Innovation Settings page above.

From the User Group Configuration page, the administrator selects the Innovation Management tab to display the Innovation Management page (illustrated in FIG. 104a) and assign the access that the User Group will have to innovation management functions. As on the other four User Group Configuration pages, the administrator clicks on the check box labeled Configure for This Group to begin the input for the page, and there are several check boxes and drop-down list boxes to configure. For example, specific functions that can be allowed include: Make Innovation Private, Set Status, Edit Protection Information, Change Department, Set Showcase, Set Spotlight, Edit Challenges, Reports, and IP Management. Optimally, the page follows the format of the other configuration pages. Administrators activate functions by clicking on the check box next to the name of the function or another such selection method. Certain functions require that additional criteria be configured, such as department or location restrictions. Optimally, this criteria is displayed on the page for configuration as the function is activated.

From the User Group Configuration page, the administrator selects the Administration Functions tab to display the Administration Functions page (illustrated in FIG. 104b) and assign the access that the User Group will have to system administration functions. As on the other four User Group Configuration pages, the administrator clicks on the check box labeled Configure for This Group to begin the input for the page, and there are several check boxes and drop-down list boxes to configure. For example, specific functions that can be allowed include All Private Innovations, Review Committees, Question Sets, E-Mail Configuration, Setup Users, Setup Groups, Innovation Protections, Innovation Types, Configure Education, Personal Statistics, Set Departments, and Set Locations. Optimally, the page follows the format of the other configuration pages. Administrators activate functions by clicking on the check box next to the name of the function or another such selection method. Certain functions require that additional criteria be configured, such as department or location restrictions. Optimally, this criteria is displayed on the page for configuration as the function is activated.

From the User Group Configuration page, the administrator selects the Review Committees tab to display the Review Committees page (illustrated in FIG. 104b) and assign the access that the User Group will have to the review committee process. It allows the Review Committee page to be displayed, as well as certain functions to be specified.

After the administrator has configured the access settings for all or any of the five access types for the selected User Group, they click the Save Changes button advantageously provided at the top of the page to save the work (see FIG. 79).

Set Innovation Protection Groups

The security mechanism within the Innovator system is very extensive and flexible. It distinguishes between security for individual users and groups of users as well as individual innovations and groups of innovations. In preferred processes, several User Groups and several Innovation Protection Groups (or security levels) are configured to achieve the level of protection required for the organization (See FIG. 74).

In contrast to User Groups, that assign rights to users, innovation protection assigns groups of innovations to different security classes. Innovation Protection Group assignments (security classes), do not assign privileges; they are merely groups of innovations. These hierarchical security classes are then related with specific User Groups and their privileges. For example, a specific User Group could view innovations that are classified as High, and view, but not edit, innovations that are Confidential. Optimally, administrators, create and maintain User Groups, assign User Groups privileges and define the Innovation Protection Groups. Managers assign the individual innovations to a security class or Innovation Protection Group.

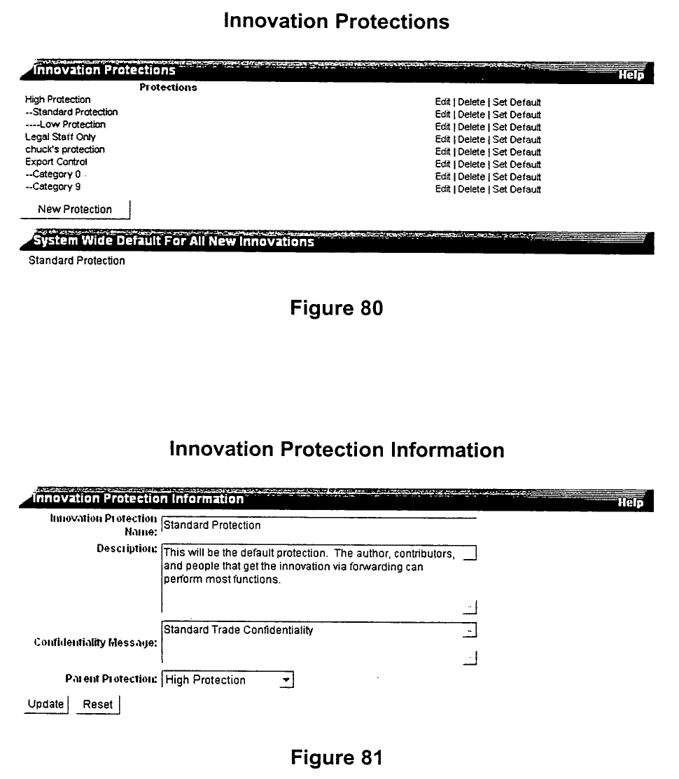

In preferred processes, administrators navigate to the Set Innovation Protection Groups step through the Administration menu item on the Homepage menu as illustrated in FIGS. 19b and 26. Administrators select the menu item Innovation Protection under the menu item Security in the Administration menu item on the Homepage menu. The Innovation Protections page (see FIGS. 27 and 80) opens.

Optimally, the Innovation Protections page (see FIG. 80) contains a list box displaying a list of all of the Protections currently defined in the Innovator system. In addition, each protection is presented with the option to Edit, Delete and Set Default (set as the default for all submitted innovations) as part of the list. Innovation Protections can be related in a hierarchy as Parent to Child. The page displays child Innovation Protections in an outline format beneath their parent Innovation Protection, similar to a Menu control. A System Wide Default For All New Innovations frame appears below the Protections list to advantageously clarify the current default protection setting.

To create a new Innovation Protection Group, the administrator clicks the advantageously provided New Protection button below the Protections list box on the Innovation Protections page. The Innovation Protection Information page (see FIG. 81) opens. The page contains text boxes for input of data such as the Name of the new protection group, a Description and the Confidentiality Message. The Confidentiality Message is the text that will be displayed at the top of any innovation that is assigned this Protection Group, as well as any innovations that have been changed to show the Confidentiality Message (see the Edit Security Information step in the Manager process). In preferred processes, a Parent Protection drop-down list box allows the administrator to select a Protection Group previously defined as the parent for this Protection Group or to indicate that None is to be assigned. Optimally, the administrator clicks an Update button advantageously provided to save the new Protection Group and return to the Innovation Protections page (see FIG. 80).

To edit an Innovation Protection Group, the administrator clicks the advantageously provided Edit link next to the Protection Group that they want to change within the Protections list box on the Innovation Protections page. The Innovation Protection Information page (see FIG. 81) opens with the current data for the Protection Group displayed. The administrator edits the Protection Group's data, such as the Name, Description, Confidentiality Message, and Parent Protection. A Reset button is advantageously provided to return data to the original definition if desired. Optimally, the administrator clicks an Update button advantageously provided to save the new Protection Group and return to the Innovation Protections page (see FIG. 80).

To delete an Innovation Protection Group, the administrator clicks the advantageously provided Delete link next to the Protection Group that they want to delete within the Protections list box on the Innovation Protections page (see FIG. 80). A Delete Confirmation page is displayed to give the administrator the opportunity to confirm the deletion or to cancel. Once the deletion is confirmed the administrator is returned to the Innovation Protections page and the deleted Protection Group is removed from the Protections list box.

To set an Innovation Protection Group as the system wide default for all submitted innovations, the administrator clicks the advantageously provided Set Default link next to the Protection Group within the Protections list box on the Innovation Protections page (see FIG. 80). A Set Default Confirmation page is displayed to give the administrator the opportunity to confirm or to cancel the default reset. Once the Set Default is confirmed the administrator is returned to the Innovation Protections page and the new default is displayed in the System Wide Default for All New Innovations frame.

User Maintenance

The User Maintenance step allows administrators to add new users, edit existing users information and delete users within the Innovator system.

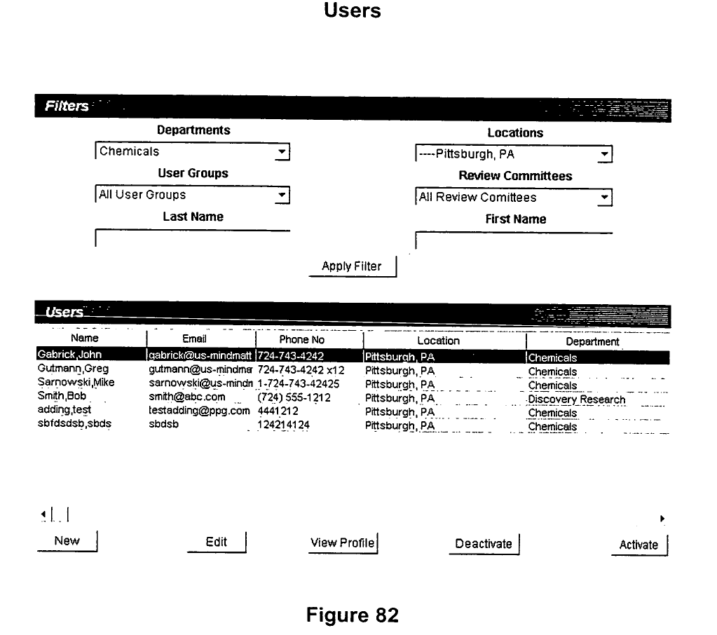

In preferred processes, administrators navigate to the User Maintenance step (see FIG. 28) through the Administration menu item on the Homepage menu as illustrated in FIGS. 19b and 26. Administrators select the Users menu item under the Company Configuration menu item in the Administration menu item on the Homepage menu and the Users page (see FIG. 82) opens.

Optimally, the Users page (see FIG. 82) contains a Users data grid displaying a list of all the users currently in the Innovator system, and such information as the users' Name, E-Mail, Phone Number, Location, Department and whether the user is Active. Advantageously, a Filters frame contains text boxes and drop-down list boxes to enable administrators to limit the number of users displayed in the data grid by entering filter criteria, such as Department, Location User Group, Review Committee, Last Name and First Name. Optimally, administrators enter any combination of letters in the Last Name or First Name fields to find specific users. For example, an administrator types in G to the Last Name text box to display all of the users with a last name that starts with G. The administrator clicks on the an button labeled Apply Filter to display the list based on the specified filters. In addition, the page displays the number of users retrieved to populate the data grid.

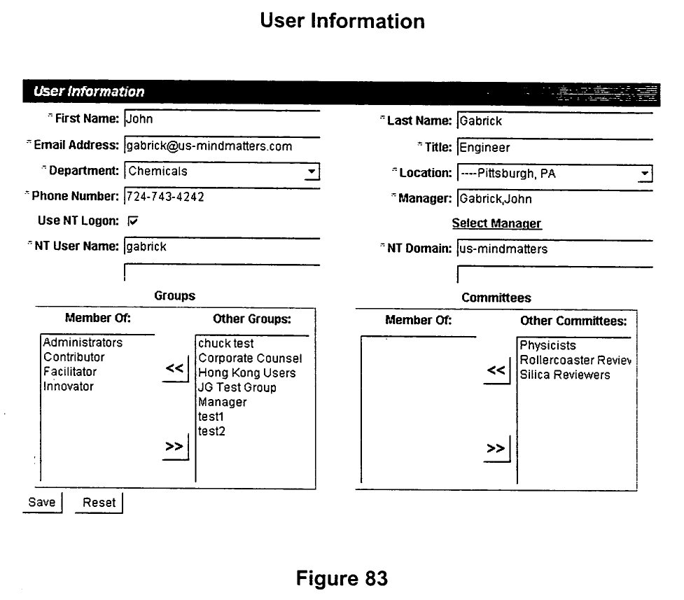

The administrator adds a new user by clicking on the New button advantageously located below the Users data grid on the Users page (see FIG. 82). The User Information page opens (see FIG. 83). The User Information page contains text boxes, drop-down list boxes, framed sets of list boxes and other controls to specify all the data to be input, such as First Name, Last Name, E-Mail, Title, Department, Location, Phone Number, Manager, whether to use NT Logon and NT Domain. The page contains a text box for a Password and a Password Confirmation. It also advantageously contains a Groups frame and a Committees frame that list in one list box the groups or committees of which the user is a member, and a companion list box of the available groups or committees of which the user is not currently a member. Accompanying arrows allow an administrator to conveniently add or remove users from User Groups and Review Committees by transferring group or committee names from one list box to the other. Preferably, required information is marked with an asterisk. The administrator fills in the required information. Optimally, the administrator has the option of clicking on a Use NT Logon check box, if their system uses NT authentication to allow users into the Innovator system. After the administrator has entered the desired data, they click the Save button to save the work and are returned to the Users page.

To edit the data for an existing user, the administrator selects a user from the Users data grid on the Users page (see FIG. 82), clicks the Edit button advantageously provided. This opens the User Information page (see FIG. 83) described above with the selected user's data displayed. The administrator can then edit any of the data. Preferably, a Reset button is provided to return the data to its original state if the administrator desires. After the administrator has edited the data, they click the Save button to save the work and they are returned to the Users page.

To delete an existing user from the active members of the Innovator system, the administrator clicks the Deactivate button advantageously provided on the Users page (see FIG. 82). In preferred processes, a dialog box prompts the user to confirm the deactivation or cancel it. The administrator confirms the deactivation to remove that user from the active user list. Throughout the Innovator system, the user will no longer be shown in selection lists to be chosen as an inventor or contributor. In preferred processes, this is the only way to remove users from the system. The administrator clicks on the Activate button advantageously located beneath the Users data grid on the Users page to re-activate a user.

Set Departments

The Set Departments step allows administrators to create, configure, edit and delete the departments defined for use throughout the Innovator system. Departments are set up in a hierarchy. As such, each department can have parents and children. It is important to maintain this hierarchy because many of the security functions can be based on a user's department. For example, a user may have the ability to view innovations in their department as well as all child departments.

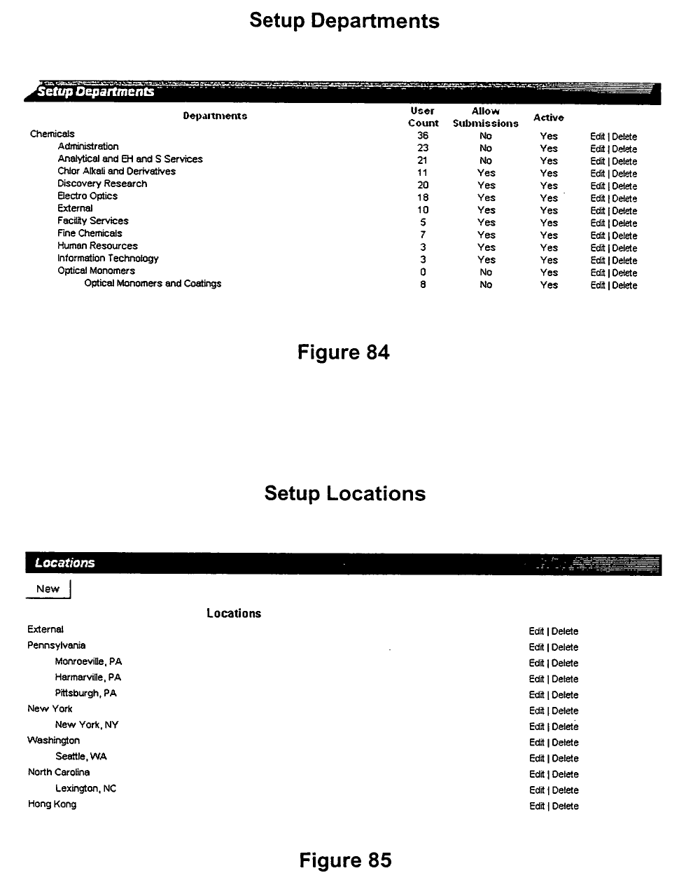

In preferred processes, administrators navigate to the Set Departments step through the Administration menu item on the Homepage menu as illustrated in FIGS. 19b and 26. Administrators select the menu item Departments under the menu item Company Configuration in the Administration menu item on the Homepage menu (see FIG. 28) and the Departments page (see FIG. 84) opens.

Optimally, the Departments page (see FIG. 84) contains a Departments data grid displaying a list of all the departments currently in the Innovator system, displayed in outline form according to the hierarchy, and such information as the departments' Name, User Count, whether to Allow Submissions and whether Active. In addition, the page displays the number of departments retrieved to populate the data grid.

The administrator creates a new department by clicking on the New button advantageously located below the Departments data grid on the Departments page (see FIG. 84). The New Department frame opens. The New Department frame contains text boxes, drop-down list boxes and other controls to specify department information, such as the Department Name and Parent. In preferred processes, a Parent Department drop-down list box allows the administrator to select a department previously created as the parent for this department or to indicate that None is to be assigned. For example, if a department exists named Accounting, the administrator may wish to create a sub-department called Accounts Receivable. In this case, Accounting would be the parent of Accounts Receivable. After the administrator has entered the desired data, they click the OK button to save the work. The administrator is returned to the Departments page and the new department has been added to the list of departments in the data grid.

To complete the department creation, the administrator navigates to the Department Information page, by selecting the new department just created from the data grid on the Setup Departments page (see FIG. 84) and either double-clicking it, or highlighting it and clicking the Edit button advantageously provided. The Department Information page is then displayed. Preferably, the page contains a department Name text box (in case the administrator wishes to change the assigned name), a Parent drop-down list box and a Description text box for the administrator to enter the description of the department. To mark a department as included in the list of available departments when users submit innovations, the administrator checks a check box labeled Allow Submissions. If the check box is left unchecked, an administrator has decided not to allow users to submit to the department (perhaps because there will be no manager to review ideas). The administrator checks a check box labeled Active to maintain this department as an active selection within the Innovator system. When a department has users in it, it cannot be deleted. So, to remove it from use, the administrator must deactivate it by unchecking the Active box. After the administrator has entered the desired data, they click the Save button to save the work and the administrator is returned to the Setup Departments page.

To edit the data for an existing department, the administrator selects a department from the Departments data grid on the Setup Departments page (see FIG. 84) and clicks the Edit button advantageously provided. This opens the Department Information page described above, with the selected department's data displayed. The administrator can then edit any of the data included in the page's description above, such as the department Name, Description, Parent, whether to Allow Submissions and the Active status. Preferably, a Reset button is provided to return the data to its original state if the administrator desires. After the administrator has edited the data, they click the Save button to save the work and they are returned to the Setup Departments page.

To delete a department, the administrator selects the department from the Departments data grid on the Setup Departments page (see FIG. 84) by highlighting it, and clicks the Delete button advantageously provided. If there are no users in the department, then it will be deleted. In preferred processes, if there are users in the department the administrator is not allowed to delete it from this page, but must deactivate the department, by clicking the Edit button and then unchecking the box labeled Active on the Department Information page (see above).

Set Locations

The Set Locations step allows administrators to create, configure, edit and delete the locations defined for use throughout the Innovator system. Locations are set up in a hierarchy. As such, each location can have parents and children. It is important to maintain this hierarchy because many of the security functions can be based on a user's location. For example, a user may have the ability to view innovations in their location as well as all child locations.

In preferred processes, administrators navigate to the Set Locations step through the Administration menu item on the Homepage menu as illustrated in FIGS. 19b and 26. Administrators select the menu item Locations under the menu item Company Configuration in the Administration menu item on the Homepage menu (see FIG. 28) and the Setup Locations page opens.

Optimally, the Setup Locations page (see FIG. 85) contains a Locations data grid displaying a list of all the locations currently in the Innovator system, displayed in outline form according to the hierarchy, and such information as the locations' Name. In addition, the page displays the number of locations retrieved to populate the data grid.

The administrator creates a new location by clicking on the New button advantageously located above the Locations data grid on the Setup Locations page (see FIG. 85). The New Location frame opens. The New Location frame contains text boxes, drop-down list boxes and other controls to specify location information, such as the location Name. In preferred processes, a Parent Location drop-down list box allows the administrator to select a location previously created as the parent for this location or to indicate that None is to be assigned. For example, if a location exists named California, the administrator may wish to create a sub-location called Los Angeles. In this case, California would be the parent of Los Angeles. After the administrator has entered the desired data, they click the OK button to save the work. The administrator is returned to the Setup Locations page and the new location has been added to the list of locations in the data grid.

To complete the location creation, the administrator navigates to the Location Information page, by selecting the new location just created from the data grid on the Setup Locations page (see FIG. 85) and either double-clicking it, or highlighting it and clicking the Edit button advantageously provided. The Location Information page is then displayed. Preferably, the page contains a location Name text box (in case the administrator wishes to change the assigned name), a Parent drop-down list box and a Description text box for the administrator to enter the description of the location. The administrator checks a check box labeled Active to maintain this location as an active selection within the Innovator system. When a location has users in it, it cannot be deleted. So, to remove it from use, the administrator must deactivate it by unchecking the Active box. After the administrator has entered the desired data, they click the Save button to save the work and the administrator is returned to the Setup Locations page.

Optimally, to edit the data for an existing location, the administrator selects a location from the Locations data grid on the Setup Locations page (see FIG. 85) and clicks the Edit button advantageously provided. This opens the Location Information page described above, with the selected location's data displayed. The administrator can then edit any of the data included in the page's description above, such as the location Name, Description, Parent and the Active status. Preferably, a Reset button is provided to return the data to its original state if the administrator desires. After the administrator has edited the data, they click the Save button to save the work and they are returned to the Setup Locations page.

To delete a location, the administrator selects the location from the Locations data grid on the Setup Locations page (see FIG. 85) by highlighting it and clicks the Delete button advantageously provided. If there are no users in the location, then it will be deleted. In preferred processes, if there are users in the location, the administrator is not allowed to delete it from this page, but must deactivate the location, by clicking the Edit button located underneath the data grid and then unchecking the box labeled Active on the Location Information page (see above).

Set Education Center

The Education Center step in the Innovator Process provides a method of disseminating information on patenting, searching and any other topics the organization deems important. The Set Education Center step allows administrators to add, edit and delete the information that will be contained on the Education Center page in the Innovator Process.

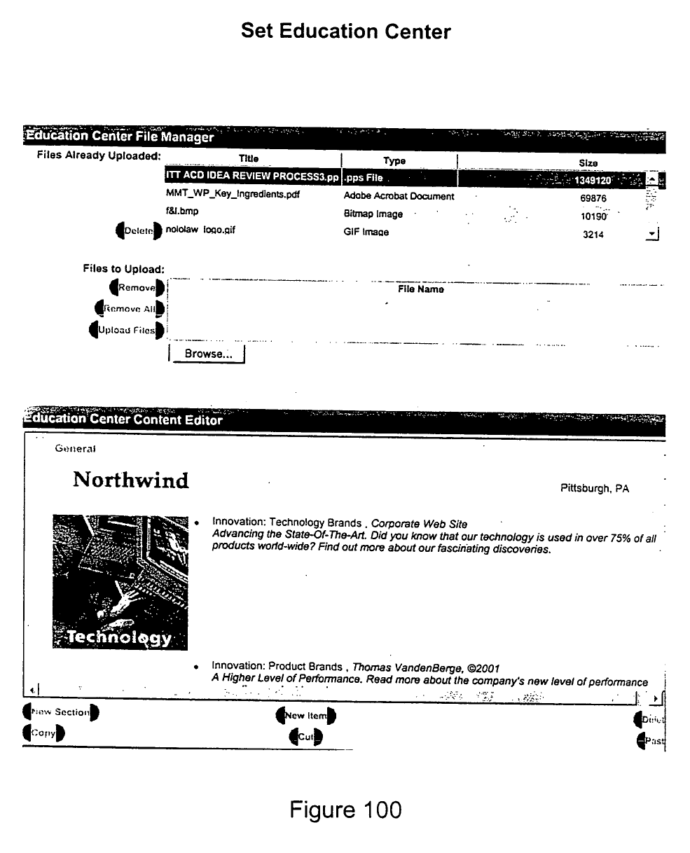

In preferred processes, administrators navigate to the Set Education Center step through the Administration menu item on the Homepage menu as illustrated in FIGS. 19b and 26. Administrators select the Education menu item under the Innovator Configuration menu item under the Administration menu item on the Homepage menu (see FIG. 29) and the Set Education page illustrated in FIG. 100 opens.

The Set Education page (see FIG. 100) contains an Education Center File Manager frame. This frame represents the storage area for all the files from which the Education Center page may be created. Within this frame is a Files Already Uploaded data grid displaying information for each file already selected for possible display in the Education Center. Files may be of any type including (but not limited to) word processed documents, slide shows, images and web pages. The grid displays information such as the item Title, Type and Size. Selecting a file within the grid and clicking an advantageously provided Delete button allows administrators to remove uploaded files from the list.

Also contained in the Education Center File Manager frame is a Files to Upload list box (see FIG. 100). The user selects new files to be uploaded by clicking an advantageously provided Browse button and, through the use of a file selection control, the selections are returned to be displayed by File Name in the list. Remove and Remove All buttons are advantageously provided to enable deletion of one, all or multiple files from the list. Files displayed in the Files to Upload frame are recorded and added to the display within the Files Already Uploaded data grid when the administrator clicks the Upload Files button.

The Set Education page optionally contains an Education Center Content Editor frame (see FIG. 100). Administrators create the Education Center page using the tools provided in this frame and uploaded files listed in the Education Center File Manager frame. The Education Center page is displayed at the top of this frame as it will be displayed in the Innovator Process (see the Education Center step in the Innovator Process). In preferred processes, the Education Center page begins with an a prefabricated General section. To create a new section of the page, administrators click an advantageously provided New Section button. An Insert Section frame displays containing a text box for the entry of the Section Name or the Title that will display on the Education Center page for this section. Users enter the name and create the section by clicking an advantageously provided Save button or users click a Cancel button to cancel the adding of a section operation. Administrators add a new item to the new section or any existing section by clicking within the section at the insertion point and clicking an advantageously provided New Item button. An Insert Item frame displays containing text boxes for the following input: Image Source, Image Height, Image Width, Link Text, Link Address or Location, Reference and a Description. The description text entered will be displayed on the Education Center page along with the images and links of the item. Users create the item display by clicking an advantageously provided Save button or click a Cancel button to cancel the adding of an item operation.

Administrators can edit any existing sections or items by clicking on the section and item in the Education Center page display. Clicking on a section bar will display an Edit Section frame containing a text box with the current section Name. Users may edit the name and click the save button to save the change or the cancel button to end the editing process. Optimally, the Education Center page contains a General section. This section is configured to display the organization's name and logo. To edit the General sections display, administrators click on the General section title bar and an Edit General Section frame appears containing text boxes for entry or editing of the Company Location, Company Logo Source, Company Logo Height, and Company Logo Width. Administrators click the save button to save the change or the cancel button to end the editing process. Clicking on an item in any section will display the Edit Item frame containing text boxes for the entry of the Image Source, Image Height, Image Width, Link Text, Link Address or Location, Reference and Description to be displayed. Optimally, if a specified item is not already included in the Files Already Uploaded frame the user is given the opportunity to add it. A Save and Cancel button are provided to complete the step. In preferred processes, Copy, Cut and Paste buttons are provided to allow further editing of the page.

Configure E-Mail Notification

During all processes, there are numerous times that the users will want notification that a step or change has taken place. (See the Innovation Notices step in the Innovator process.) Examples include when an innovator or manager forwards an innovation for review or comment, when an innovator's innovation is selected for the Spotlight step, when an innovation's status changes and when a comment has been submitted for an innovation. In preferred processes, when such changes occur, a message is displayed on the appropriate user's Homepage. In addition, optimally, an automatically generated e-mail can be sent to the appropriate user's e-mail account. This speeds processing time for users who do not visit their Homepage often.

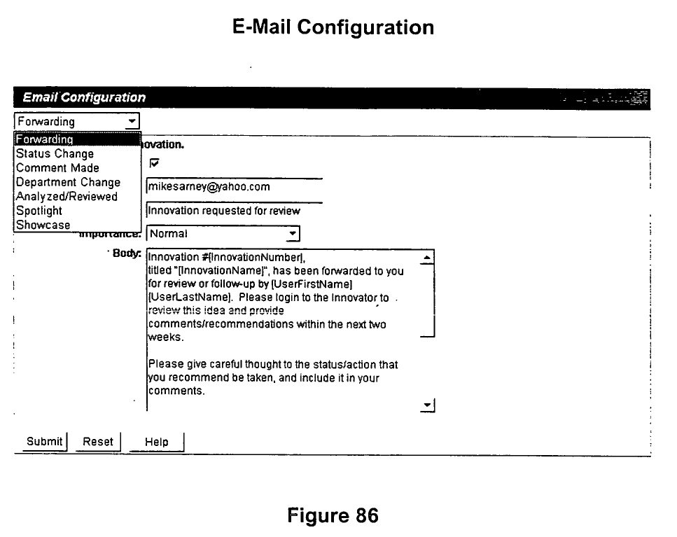

In preferred processes, administrators navigate to the Configure E-Mail Notification step through the Administration menu item on the Homepage menu as illustrated in FIGS. 19b and 26. Administrators select the menu item E-Mail under the menu item Innovator Configuration in the Administration menu item on the Homepage menu (see FIG. 29). The E-Mail Configuration page (see FIG. 86) opens.

Optimally, at the top of the E-Mail Configuration page (see FIG. 86) is a drop-down list box containing a list of all the types of e-mail that can be configured. In preferred processes, the e-mail types include when an innovation is forwarded, when the status of an innovation changes, when a comment has been made on an innovation, when the review department or location has been changed, when an analysis has been performed on an innovation, when an innovation has been selected for the Spotlight, when an innovation has been selected for a Showcase, when a new innovation has been submitted, when a peer review request has been declined.

In addition, the E-Mail Configuration page (see FIG. 86) contains text boxes, check boxes, drop-down list boxes and other input controls for additional necessary data. For Example, the administrator types in the From text box, the name that the e-mail message displays as the originator of the e-mail. In preferred processes this address must be a valid e-mail address, such as admin@company.com. Similarly, in the CCB text box, the administrator types any additional addresses that the e-mail message should be copied to (besides those assigned to the e-mail type). In the Subject text box, the administrator types the e-mail subject appropriate to the type, such as Innovation Review/Analysis Request. In the Importance drop-down list box, the administrator selects High, Normal, or Low. The importance will be displayed on the recipients e-mail software program. The administrator clicks the Send to Additional Inventors check box to include all of the inventors associated with the innovation as e-mail recipients. In the Body text box, the administrator types the text for the body of the e-mail message. The administrator enters text that describes the procedure and the request, such as “You have been requested to review/analyze the innovation below. Click on the link to go directly to the innovation. Do not reply to this message as it is sent automatically and no one will respond. Thank you.” In preferred processes, the administrator can also add field variables, designated by [ ] into the body of the e-mail. Optimally, to include these, an administrator is allowed to drag and drop the variables in the textbox with the mouse.

Optimally, an administrator can design an e-mail notification without enabling it at the same time by not checking an advantageously provided Enable check box. To begin use of the e-mail notification configuration, the administrator checks the Enable check box. In either case clicking a convenient Save button saves the work.

Optimally, to edit the data for an existing e-mail configuration, the administrator selects a type from the drop down list box at the top of the E-Mail Configuration page (see FIG. 86). The current data for this e-mail type is displayed. The administrator can then edit any of the data included in the page's description above, such as whether it is enabled, the From address, the Body of the message and so forth. Preferably, a Reset button is provided to return the data to its original state if the administrator desires. After the administrator has edited the data, they click the Save button to save the work.

Preferably, e-mail types cannot be deleted. The types are defined by the system. However, they may be disabled by the administrator for a particular system, as described above.

Set Event Codes

In preferred processes, administrators define a set of significant events called event codes within the Innovator processes that merit tracking or counting. Event codes are used, for example, in the Highlights and Personal Statistics steps in the Innovator Process and in the Reports generated in the Manager Process. The Set Event Codes step allows administrators to create, describe and later edit these event codes.

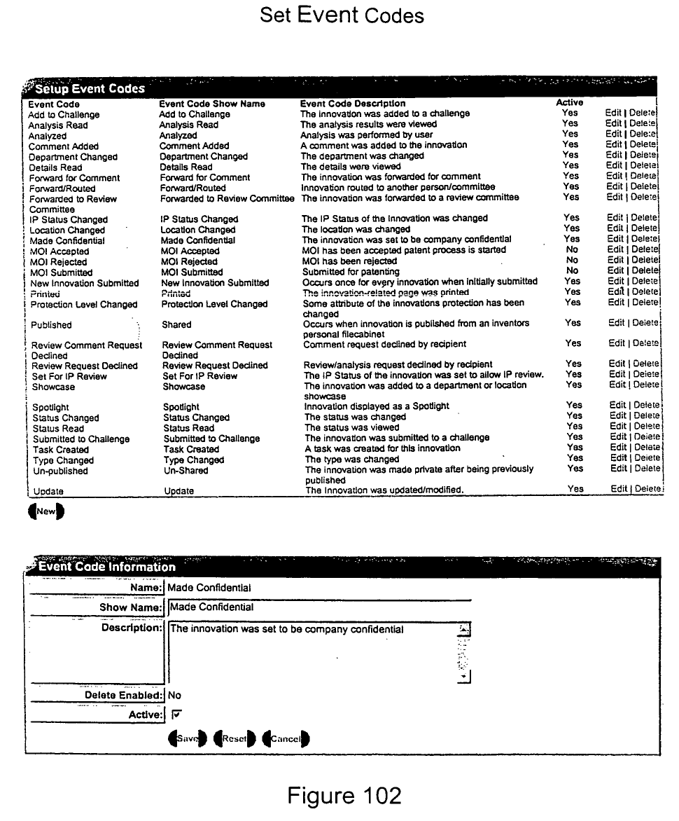

Administrators navigate to the Set Event Codes step through the Administration menu item on the Homepage menu as illustrated in FIGS. 19b and 26. Administrators select the Event Codes menu item under the Innovator Configuration menu item under the Administration menu item on the Homepage menu (see FIG. 29) and the Event Codes page illustrated in FIG. 102 opens.

Optimally, the Event Codes page contains a Setup Event Codes data grid displaying a list of all the event codes currently in the Innovator system, and such information as the event code's Name, the Name Shown, a Description and whether it is still active.

The administrator creates a new event code by clicking on the New button advantageously located on the Event Codes page and the Add Event Code frame opens. The Add Event Code frame contains a text box in which to enter the new event code's Name, Show Name and Description. The administrator then clicks an OK button to return to the Event Codes page and the new event code now appears in the data grid list.

Optimally, to edit the data for an existing event code, the administrator selects an event code from the Setup Event Codes data grid on the Event Codes page and clicks the Edit button or link advantageously provided. This opens the Event Code Information page illustrated in FIG. 102 with the selected event code's data displayed. The page displays the Event Code Name and whether it is Delete Enabled. Once an event code has been used in another process, it cannot be deleted. The page also contains input controls for editing the current event code definition such as a text box for the Show Name, a text box for the Description and a check box to determine whether the event code is Active or Inactive. Save, Cancel and Reset buttons are advantageously provided to save the change, cancel the operation or reset the status to the original.

To delete an event code, the administrator selects the event code from the Setup Event Codes data grid on the Event Codes page and clicks the Delete button advantageously provided. In preferred processes, a user is asked to confirm the deletion by means of another frame or page with OK and Cancel buttons. After confirmation, the event code is deleted if deletion is allowed. Otherwise, the user is notified that the event code has been used and cannot be deleted.

Set User Event Codes

User event codes are similar to event codes except that they apply to significant events performed on users or their profiles instead of innovations. In preferred processes, administrators define the set of user event codes in exactly the same manner as event codes. The User Set Event Codes step allows administrators to create, describe and later edit user event codes.

Administrators navigate to the Set User Event Codes step through the Administration menu item on the Homepage menu as illustrated in FIGS. 19b and 26. Administrators select the User Event Codes menu item under the Innovator Configuration menu item under the Administration menu item on the Homepage menu (see FIG. 29) and the User Event Codes page opens.

Optimally, the User Event Codes page contains a Setup User Event Codes data grid and, from this point on in the step, all functions and displays parallel the Set Event Code step above.

Set Innovation Statuses

In preferred processes, innovations progress through a set of predefined statuses. The status of an innovation communicates to the users where the innovation is in its development and its intellectual property registration process. The Set Innovation Statuses step in the Administrator Process allows administrators to define the series of steps managers are using to move innovations forward through their processing.

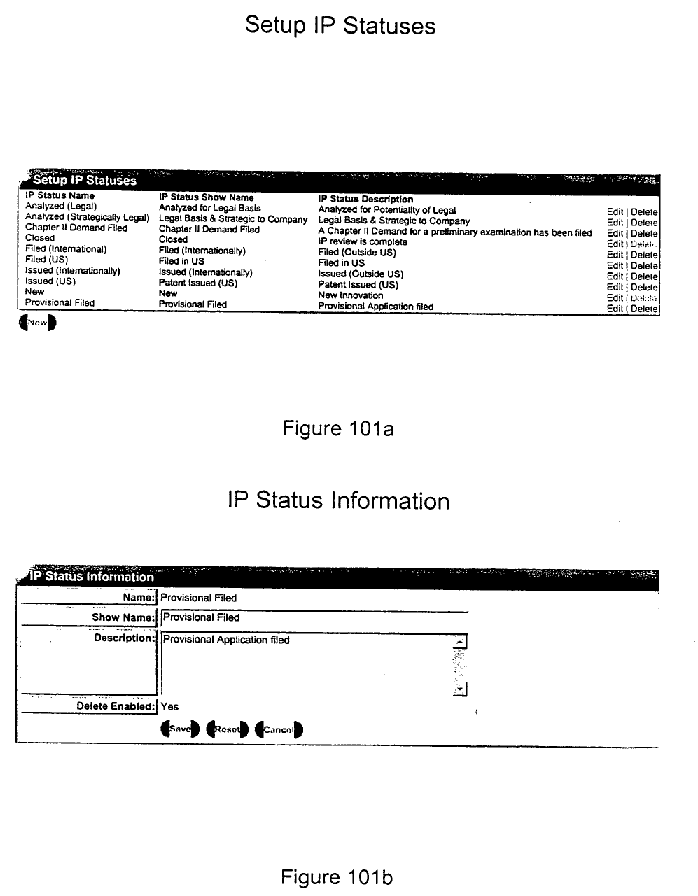

Administrators navigate to the Set Innovation Statuses step through the Administration menu item on the Homepage menu as illustrated in FIGS. 19b and 26. Administrators select the Innovation Statuses menu item under the Innovator Configuration menu item under the Administration menu item on the Homepage menu (see FIG. 29) and the Innovation Statuses page illustrated in FIG. 101a opens.

Optimally, the Innovation Statuses page contains a Setup Innovation Statuses data grid displaying a list of all the innovation statuses currently in the Innovator system, and such information as the innovation status's Name, the Name Shown, a Description, whether it is still active and the number of innovations in the system with this status designation. In addition, the page displays the number of statuses retrieved to populate the data grid.

The administrator creates a new innovation status by clicking on the New button advantageously located on the Innovation Statuses page. The Add Status frame opens. The Add Status frame contains text boxes in which to enter the new status's Name, Show Name and Description. The administrator then clicks an OK button to return to the Innovation Statuses page and the new status now appears in the data grid list.

Optimally, to edit the data for an existing innovation status, the administrator selects a status from the Setup Innovation Statuses data grid on the Innovation Statuses page and clicks the Edit button or link advantageously provided. This opens the Status Information page illustrated in FIG. 101b, with the selected innovation status's data displayed. In preferred processes, the page contains a Status Name text box, a Show Name text box, a Description text box and a check box to Activate or Deactivate the status. Once a status has been assigned to an innovation it cannot be deleted. On this page, whether a status may be deleted or not is also displayed. The administrator can then edit any of the data they wish to change. Save, Cancel and Reset buttons are advantageously provided to save the changes, cancel the operation or reset the status to the original.

To delete a status, the administrator selects a status from the Setup Innovation Statuses data grid on the Innovation Statuses page and clicks the Delete button advantageously provided. In preferred processes, a user is asked to confirm the deletion by means of another frame or page with OK and Cancel buttons. After confirmation, the status is deleted if deletion is allowed. Otherwise, the user is notified that the status has been assigned to an innovation or innovations and cannot be deleted.

Set Task Statuses

The Set Task Statuses step is similar to the Set Innovation Statuses step except that the statuses defined apply to tasks rather than innovations. In preferred processes, tasks progress through a set of predefined statuses. The status of a task communicates to the users where the task is in its processing and completion. The Set Task Statuses step allows administrators to define the series of statuses managers and innovators are using to track task progress.

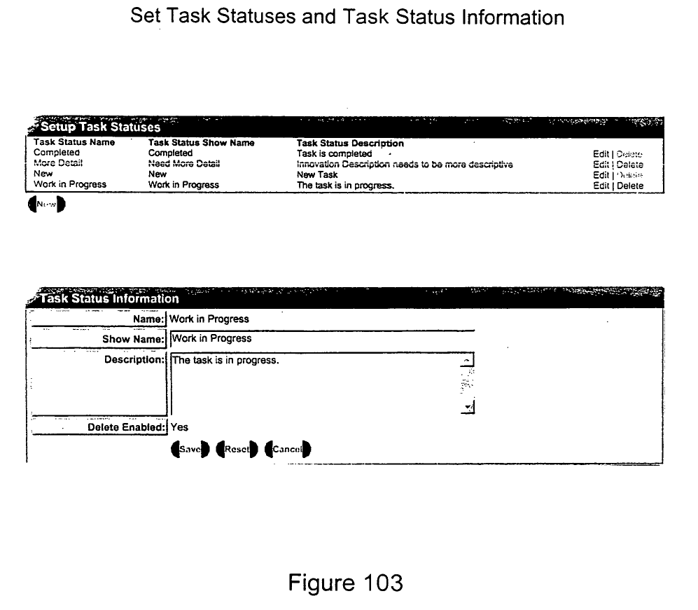

Administrators navigate to the Set Task Statuses step through the Administration menu item on the Homepage menu as illustrated in FIGS. 19b and 26. Administrators select the Task Statuses menu item under the Innovator Configuration menu item under the Administration menu item on the Homepage menu (see FIG. 29) and the Task Statuses page illustrated in FIG. 103 opens.

Optimally, the Task Statuses page contains a Setup Task Statuses data grid displaying a list of all the task statuses currently in the Innovator system, and, from this point on in the step, all functions and displays parallel the Set Innovation Statuses step above. The Task Status Information page is illustrated in FIG. 103.

Configure Innovation Types

Innovation types are used to associate an innovation with a particular set of analysis questions. In this way, innovations with certain characteristics can be grouped together for reporting as well as analysis comparisons. The Configure Innovation Types step allows administrators to create, configure, edit and delete the innovation types defined for use throughout the Innovator system.

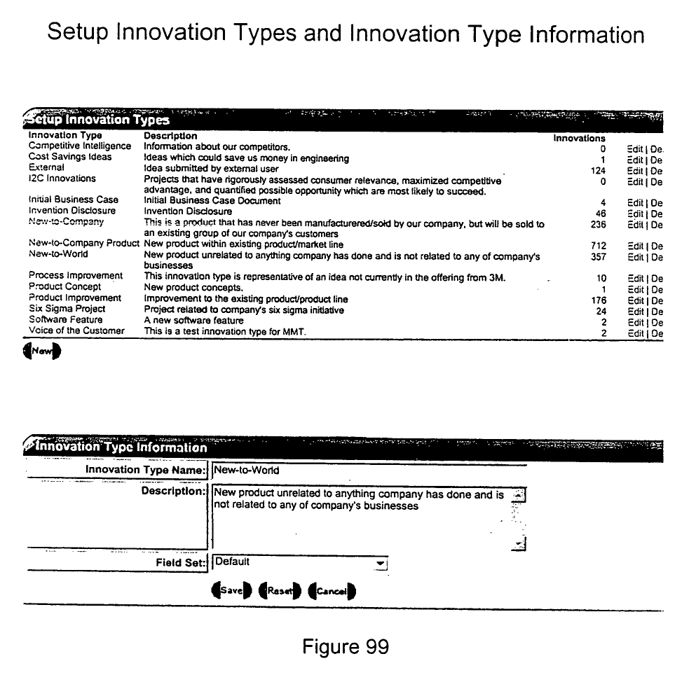

In preferred processes, administrators navigate to the Configure Innovation Types step through the Administration menu item on the Homepage menu as illustrated in FIGS. 19b and 26. Administrators select the Innovation Types menu item under the Innovator Configuration menu item under the Administration menu item on the Homepage menu (see FIG. 29) and the Innovation Types page illustrated in FIG. 99 opens.

Optimally, the Innovation Types page (see FIG. 99) contains an Innovation Types data grid displaying a list of all the innovation types currently in the Innovator system, and such information as the innovation type's Name, Description, associated Question Set and the number of innovations in the system with this type designation. In addition, the page displays the number of innovation types retrieved to populate the data grid.

The administrator creates a new innovation type by clicking on the New button advantageously located on the Innovation Types page. The New Innovation Type frame opens. The New Innovation Type frame contains a text box in which to enter the new innovation type's Name. The administrator then clicks an OK button to return to the Innovation Types page and the new innovation type now appears in the data grid list. To complete the new innovation type creation, the administrator navigates to the Innovation Type Information page illustrated in FIG. 99, by selecting the new innovation type just created from the data grid on the Innovation Types page and either double-clicking it, or highlighting it and clicking the Edit button advantageously provided in the data grid. The Innovation Type Information page (see FIG. 99) is then displayed. Preferably, the page contains an innovation type Name text box (in case the administrator wishes to change the assigned name), and various text boxes, list boxes, drop-down list boxes and other controls for data entry. In preferred processes, these include a Description text box and a Question Set drop-down list box to select the associated question set. After the administrator has entered the desired data, they click the Save button to save the work.

Optimally, to edit the data for an existing innovation type, the administrator selects a innovation type from the Innovation Types data grid on the Innovation Types page and clicks the Edit button advantageously provided. This opens the Innovation Type Information page described above, with the selected innovation type's data displayed. The administrator can then edit any of the data included in the page's description above, such as the innovation type's Name and associated question set. Preferably, a Reset button is provided to return the data to its original state if the administrator desires. After the administrator has edited the data, they click the Save or Update button to save the work and they are returned to the Innovation Types page.

To delete a innovation type, the administrator selects a innovation type from the Innovation Types data grid on the Innovation Types page and clicks the Delete button advantageously provided. In preferred processes, a user is asked to confirm the deletion by means of another frame or page with OK and Cancel buttons. After confirmation, the innovation type is deleted.

Set Personal Statistics

In preferred processes, users are allowed to view their statistics relative to all of the other users in the Innovator system. The Set Personal Statistics step allows the administrator to change the number of points associated with each statistic, as well as add new statistics.

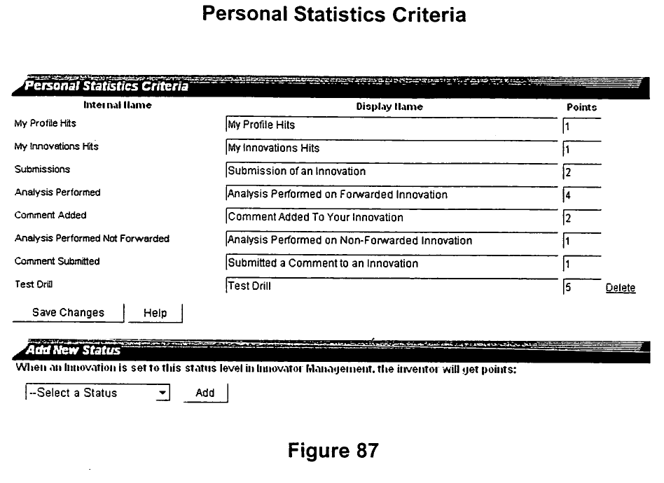

In preferred processes, administrators navigate to the Set Personal Statistics step through the Administration menu item on the Homepage menu as illustrated in FIGS. 19b and 26. Administrators select the Personal Statistics menu item under the Innovator Configuration menu item under the Administration menu item on the Homepage menu (see FIG. 29) and the Personal Statistics Criteria page (see FIG. 87) opens.

The Personal Statistics Criteria page (see FIG. 87) optimally displays the list of statistics compiled within the Innovator system for each user. The standard Internal Name for each statistic is displayed. For each statistic in the list, is an accompanying text box for the administrator to enter the Display Name (the name users will see displayed by the program) and the number of points relegated to that statistic for managerial and administrative review purposes. The points system allows certain personal statistics criteria to be weighted more heavily than others in a general evaluation of the user's performance. Criteria may include, but are not limited to, My Profile Hits, My Innovation Hits, Submissions, Analysis Performed, Comment Added, Analysis Performed Not Forwarded (on a non-forwarded innovation), Comment Submitted and Test Drill. The administrator makes whatever changes they desire to the default names for the Display Names and the default values for the associated points for each criteria and clicks an advantageously provided Save Changes button to save the work.

In addition, the Personal Statistics Criteria page (see FIG. 87) contains an Add New Status frame. It contains a drop-down list box displaying the status levels an innovation moves through within the organization (see the Set Status step in the Manager process). A label informs the administrator that when an innovation is set to this status level in the Manager process, the inventor will get points. The administrator selects whatever levels are to be used for scoring points and clicks the Add button advantageously provided.

Configure Question Sets

The Perform an Analysis step in the Innovator process is based upon the use of question sets. Question sets are powerful tools within the Innovator system that have several components. Each question set contains one or more analysis factors. Analysis factors are descriptive categories for questions, such as Marketing, or Technical, and each analysis factor has a percentage weight. Within each analysis factor, there are one or more questions. The Configure Question Sets step allows the administrator to create, edit, and delete question sets, along with the associated analysis factors and questions. As described in the Innovator process, the Perform an Analysis step results in a number between 1-100, based on the answers given to all the questions associated with the analysis factors within the question set. Each analysis factor is given a percentage of the total score to weight it according to its importance to the organization. The Configure Question Sets step allows the administrator to create the analysis factors, determine the percentage of each analysis factor and compose the questions associated with it.

Here is an example with numerical values:

### EXAMPLE

Essentially, the analysis process comes up with a number between 1-100 based on your answers. Assume there are two Factors. Marketing and Technical, each with two questions as described below:
Marketing=30% of total score
Q1. How large is the market? (1-10)=you answer 5
Q2. Is it a good market? (1-10)=you answer 10
Technical=70% of total score
Q1. Is this a good technology? (1-10)=you answer 8
Q2. Is it easy to make? (1-10)=you answer 2

This shows that Marketing factors are weighted 30% of the total score, whereas, Technical factors are 70% of the score. So, if both marketing questions were answered 10 each, the total marketing score would be 20. In this case, the answer is (5+10)=15 out of a possible 20, or 15/20=0.75, but then you need to multiply by 30%, so 0.75*0.30=0.225. Therefore, the total weighted Marketing score is 22.5%. The Technical score is ((8+2)/20)*0.70=0.35, or 35%, so the overall score is 22.5%+35%=57.5%

The Question Set named New-to-World contains an analysis factor named Marketing and another Analysis factor named Technical each with two associated questions. The analysis factor Marketing has been assigned 30% of the total score, and Technical has been assigned 70% of the total score. The first question the user answers for Marketing is, “How large is the market?” The administrator has indicated that the question is to be answered on a scale of 1-10. The user answers 5. The second question is, “Is it a good market?”. This also is to be answered on a scale of 1-10. The user answers 10. The user moves to the Technical analysis factor questions. The first question is, “Is this a good technology?” On a scale of 1-10, the user answers 8. The second question is, “Is it easy to make?” On a scale of 1-10, the user answers 2. The Marketing analysis factor is weighted 30% of the total score, whereas, the Technical analysis factor is 70% of the total score. If both marketing questions were answered 10 each, the total Marketing score would be 20. In this case, however, the answer is (5+10)=15 out of a possible 20, or 15/20 which equals 75%. However, the Marketing analysis factor only counts for 30% of the total score. 75% of 30% is 22.5%. Therefore, the total weighted Marketing score is 22.5%. Similarly, the Technical analysis factor's score is ((8+2)/20)*0.70=0.35, or 35%, so the overall score for the question set is 22.5%+35%=57.5%.

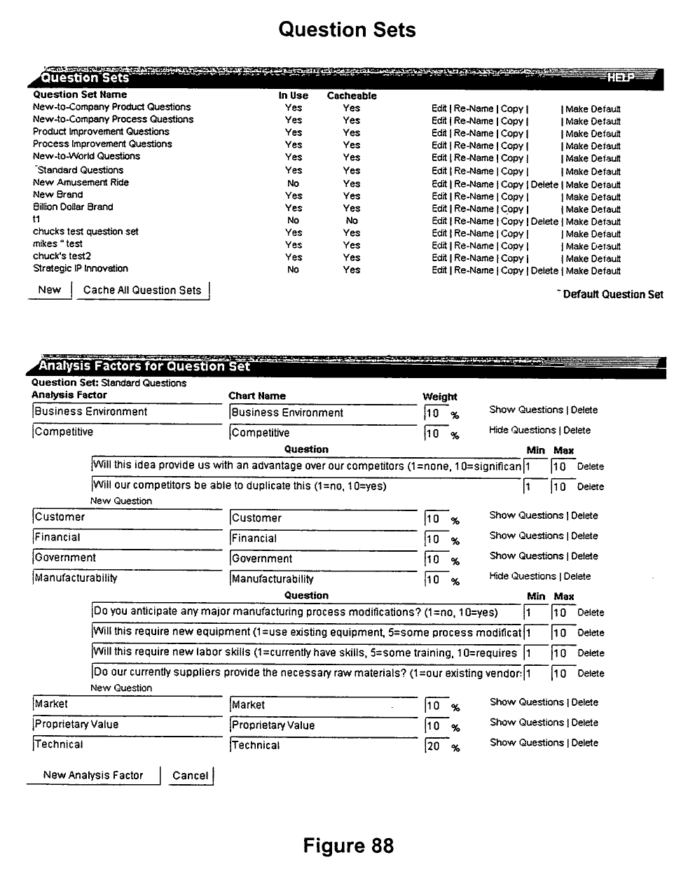

In preferred processes, administrators navigate to the Configure Question Sets step through the Administration menu item on the Homepage menu as illustrated in FIGS. 19b and 26. Administrators select the menu item Question Sets under the menu item Innovator Configuration in the Administration menu item on the Homepage menu (see FIG. 29) and the Question Sets page (see FIG. 88) opens.

Optimally, the Question Sets page (see FIG. 88) contains a Question Sets data grid displaying a list of all the question sets currently in the Innovator system, and containing such information as the question set's Name, whether it is In Use and whether it is Cacheable. Preferably, each question set listed has a link or button to allow the administrator to Edit, Rename, Copy, Delete, and Make the Default. Advantageously, the default question set is used for innovation types that have not been assigned a specific question set. The page also displays the number of question sets retrieved to populate the data grid.

The administrator creates a new question set by clicking on the New button advantageously located next to the Question Sets data grid on the Question Sets page (see FIG. 88). The New Question Set frame opens. The New Question Set frame contains a text box in which to enter the new question set's Name. The administrator then clicks an OK button to return to the Question Sets page and the new question set now appears in the data grid list.

To complete the question set creation, the administrator navigates to the Analysis Factors for Question Set page (see FIG. 88), by selecting the new question set just created from the data grid on the Question Sets page and either double-clicking it, or highlighting it and clicking the Edit button advantageously provided in the data grid. The Analysis Factors for Question Set page (see FIG. 88) is then displayed.

On the Analysis Factors for Question Set page (see FIG. 88) the administrator systematically adds analysis factors and their associated questions. Advantageously, the administrator clicks the button labeled New Analysis Factor and a set of text boxes and links are displayed. These include a blank text box allowing the administrator to type in the Name of the new analysis factor, the Chart Name that will appear on any charts displaying this factor (chart names are typically abbreviated so that they are easier to read), and the Weight of this factor. The weight must be a number between 1 and 100, and it will represent the percentage that this analysis factor is weighted versus other analysis factors. Optimally, the administrator is notified if the total weight for all factors entered is more than 100%. A Delete link allows for the deletion of an analysis factor during the design process.

In preferred processes, the administrator adds questions by clicking the New Question link advantageously provided for each analysis factor, and a set of text boxes and links are displayed for the question. The administrator types in the question and the minimum and the maximum values allowed for the answer. A delete link allows for the deletion of a question during the design process. The administrator continues adding questions and analysis factors in this manner until the question set is completed. Optimally, the administrator can remove the questions from the display by selecting a Hide Questions link advantageously provided for each analysis factor. After the administrator has finished entering questions, they click on the Save button to save the work and are returned to the Question Sets page (see FIG. 88).

Optimally, administrators are allowed to work on question sets periodically before they are put into use in the Innovator system. To make the question set available to the users, the administrator marks the question set as Cacheable and clicks the Cache All Question Sets button advantageously provided on the Question Sets page (see FIG. 88). Since there can be only one active question set per innovation type, this function is necessary so that a partial question set is not inadvertently used. The old question set will continue to be active until this button is pressed.

Optimally, to edit the analysis factors and questions for an existing question set, the administrator selects the question set from the Question Sets data grid on the Question Sets page and clicks the Edit link advantageously provided. This opens Analysis Factors for Question Set page (see FIG. 88) described above, with the selected question set's analysis factors displayed. The administrator can then edit any of the data included in the page's description above, such as the analysis factors' Name, Chart Name and Weight. Each analysis factor also displays links to Show Questions, Delete (the factor), and add a New Question. If the administrator wishes to edit the questions associated with the analysis factor, they click the advantageously provided Show Questions link and the question text, minimum value and maximum value is displayed for each question. Administrators can also add new analysis factors or questions as described above. After the questions have been edited, the administrator clicks the Hide Questions link advantageously provided. Preferably, a Reset button is provided to return the data to its original state if the administrator desires. After the administrator has edited the data, they click the Save or Update button to save the work and they are returned to the Question Sets page.

To delete a question set, the administrator selects a question set from the Question Sets data grid on the Question Sets page and clicks the Delete button advantageously provided. In preferred processes, a user is asked to confirm the deletion by means of another frame or page with OK and Cancel buttons. After confirmation, the question set is deleted.

Configure Review Committees

The Configure Review Committees step allows administrators to create, configure, edit and delete the review committees defined for use throughout the Innovator system.

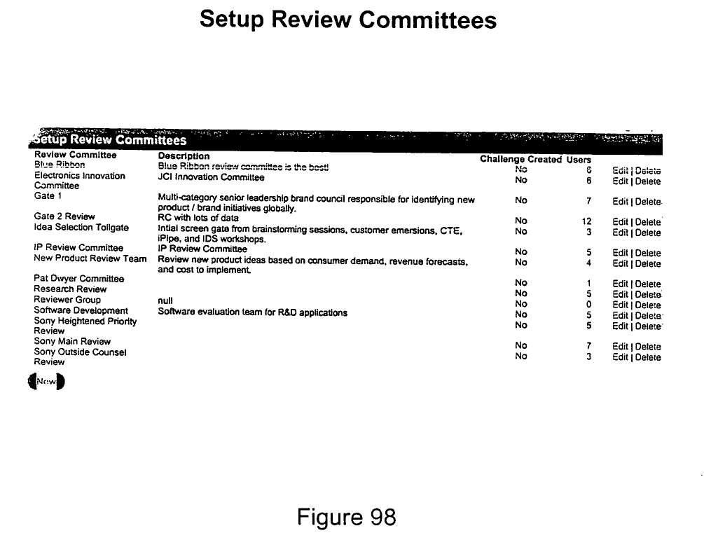

In preferred processes, administrators navigate to the Configure Review Committees step through the Administration menu item on the Homepage menu as illustrated in FIGS. 19b and 26. Administrators select the Review Committees menu item under the Innovator Configuration menu item in the Administration menu item on the Homepage menu (see FIG. 29) and the Review Committees page as illustrated in FIG. 98 opens.

Optimally, the Review Committees page (see FIG. 98) contains a Review Committees data grid displaying a list of all the review committees currently in the Innovator system, and such information as the review committees' Name, a Description and the number of Users on the committee. In addition, the page displays the number of review committees retrieved to populate the data grid.

The administrator creates a new review committee by clicking on the New button advantageously located on the Review Committees page. The New Review Committee frame opens. The New Review Committee frame contains a text box in which to enter the new review committee's Name. The administrator then clicks an OK button to return to the Review Committees page and the new review committee now appears in the data grid list.

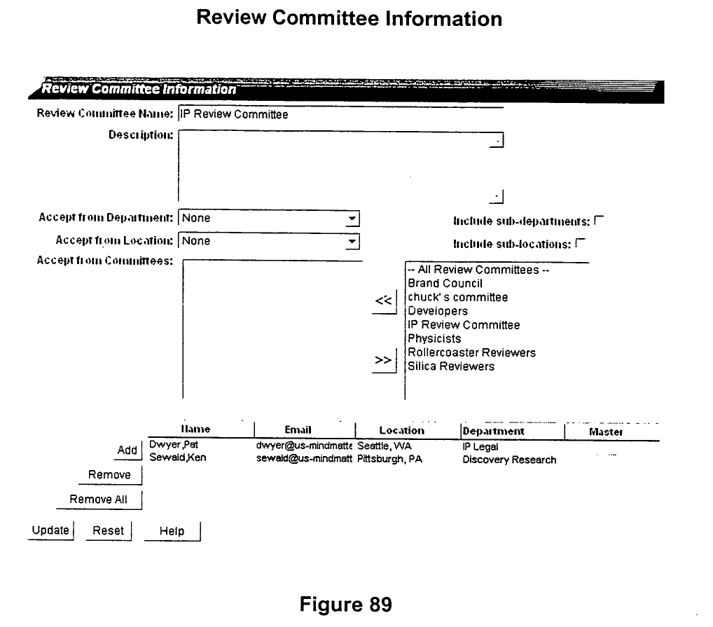

To complete the review committee creation, the administrator navigates to the Review Committee Information page (see FIG. 89), by selecting the new review committee just created from the data grid on the Review Committees page and either double-clicking it, or highlighting it and clicking the Edit button advantageously provided in the data grid. The Review Committee Information page (see FIG. 89) is then displayed. Preferably, the page contains a review committee Name text box (in case the administrator wishes to change the assigned name), and various text boxes, list boxes, drop-down list boxes and other controls for data entry. In preferred processes, these include a Description text box, and various controls for determining what departments, locations and other review committees are allowed to forward innovations to this review committee. For example, a drop-down list box labeled Accept from Department or Accept from Location allows administrators to select from the departments and locations in the Innovator system, and accompanying check boxes labeled Include Sub-departments or Include Sub-locations allow administrators to select those inclusions in the routing. Optimally, a list box labeled Accept From Committee and a list box labeled All Review Committees are paired with arrows to move list items from one box to the other, allowing administrators to indicate which review committees can route innovations to this review committee.

In addition, on the Review Committee Information page (see FIG. 89), is displayed a Review Committee Members data grid displaying a list of all current members of the review committee and relevant data for them, such as Name, E-Mail, Location and Department. To add members to the review committee, the administrator clicks the advantageously provided Add button and a list of registered users is displayed in a grid. Display information includes Name, Email Address, Phone Number, Location, Department and other pertinent data. The submitting innovator selects the inventors from the list by highlighting them, using standard techniques such as single clicking and using the Shift and/or Control keys for multiple selections. Remove and Remove All buttons are provided to enable removal of one, all or multiple user's from the list. Alternately, the administrator navigates to the User Name Lookup step (see the User Name Lookup step in the Innovator process) by clicking the User Name Lookup button provided. This step enables users to reduce a list of all the users of the Innovator system to a more manageable number while making selections. The selected names are then returned to the Review Committee Members data grid on the Review Committee Information page at the completion of the User Name Lookup step. The administrator determines which review committee members will be able to determine the final status and forwarding of an innovation by clicking the check box labeled Chair next to each person who should have this ability. After the administrator has entered the desired data, they click the Save button to save the work.

Optimally, to edit the data for an existing review committee, the administrator selects a review committee from the Review Committees data grid on the Review Committees page and clicks the Edit button advantageously provided. This opens the Review Committee Information page (see FIG. 89) described above, with the selected review committee's data displayed. The administrator can then edit any of the data included in the page's description above, such as the review committee Name, routing information and members. Preferably, a Reset button is provided to return the data to its original state if the administrator desires. After the administrator has edited the data, they click the Save or Update button to save the work and they are returned to the Review Committees page.

To delete a review committee, the administrator selects a review committee from the Review Committees data grid on the Review Committees page and clicks the Delete button advantageously provided. In preferred processes, a user is asked to confirm the deletion by means of another frame or page with OK and Cancel buttons. After confirmation, the review committee is deleted.

Access All Private Innovations

In preferred processes, private innovations are accessible only by the submitting inventor, collaborators and authors within their own accounts. Unless the innovator chooses to share the innovation (see the Share Innovation step in the Innovator process), not even the innovator's facilitator or manager are allowed to view the innovation or send it to review committees or other users. In cases where an inventor leaves the company or otherwise becomes incapable of managing their own innovations, it is necessary for an administrator to have access to an Innovator's private innovations. The View All Private Innovations step and the All Private Innovations page allow an administrator to perform actions on private innovations.

In preferred processes, administrators navigate to the Access All Private Innovations step through the Administration menu item on the Homepage menu as illustrated in FIGS. 19b and 26. Administrators select the All Private Innovations menu item under the Administration menu item on the Homepage menu (see FIG. 29) and the All Private Innovations page opens.

The All Private Innovations page contains a data grid listing the innovations in the system that are still private. The page is configured with the same structure and functionality as the Management's All Innovations step and page in the Manager Process (see FIG. 66), including the graphical display of innovation statistics by status or type, and the drop-down list box beneath the Innovation data grid labeled Select an Innovation and Pick an Option. This list contains options such as Overview, Perform Analysis, View Analysis Results, Activity Log, Search Agents, Search Results, Forward, Share Innovation, Delete Private Innovation, View Comments, Comments, Add to Challenge, All Details, Tasks, Timeline and Review Status. When an administrator selects a particular innovation in the data grid, by clicking on it or using the arrow keys, and then selects an option from the drop-down list box, they are navigated to the appropriate steps with the selected innovation's data advantageously transferred automatically. Optimally, the page contains a graphical.

Set System Variables

In preferred processes, there are a number of system variables that make changes to the Innovator system that are only available by editing the file GLOBAL.ASA in the wwwroot directory. The Set System Variables step allows administrators to make changes to the following variables by accessing this global file and replacing the existing text with the new values.

The login_header variable allows the administrator to add text, links, or other information to the initial login page. Optimally, the normal login page contains only a username and password entry text boxes.

The profile_warning variable allows the administrator to add text or information to the user profile page. Some organizations require that a notice be given to employees notifying them that others may share their information. Advantageously, this variable allows for that notification.

The report_footer variable is the text displayed as the footer on all of the report pages.

The page_footer variable is the text displayed as the footer on all pages in the Innovator.

The forgot_password variable displays a Forgot Password label and link when set to true.

The new_page_expires variable sets the number of minutes before web pages must be refreshed. Optimally, administrators may set this variable to zero for the pages of the program to never expire.

The allowCreateUser variable is set to true if the administrator wants to allow users to create their own account. When the Innovator cannot authenticate a user based on their domain password or e-mail account (they are not in the Innovator system), then this allows them to set up their own account. Since users can theoretically enter false information through this step, the administrator sets whether it is allowed. If it is allowed, text is displayed on the Login page such as “Click here to create new login”.

The hideInventorsOnSubmit variable allows administrators to eliminate a step in the submission of an innovation. If the administrator sets this value to true, it hides the Inventors or Contributors section on the submit page, but allows the user to unhide the section by clicking a checkbox labeled Additional Inventors.

The showIAMNotLink variable anticipates a user accidentally logged in to the wrong account. If the administrator sets this variable to true, users may communicate to the system that they are not the user logged on to the current account (see FIG. 64). This allows the system to return them to the Login page for a correct login identity.

The SecurityModel variable determines how security will work in the Innovator system. In preferred processes, there are three modes the administrator can choose from:

1) EIMS: In this mode, the Innovator system (and only the Innovator system) will authenticate users into the system. If a user has the Use NT Login check box checked on their User Profile, the password will still be their network/NT password and not the password recorded in the User Profile. Optimally for this case, the security for the virtual directory is set to ANONYMOUS.

2) NTLM: In this mode, users will be authenticated based on their domain username and password. If users have to log on to the organization's network before they can access any programs or internet, then this allows security to be handled seamlessly. Optimally, the Use NT Login check box on each User Profile should be checked for this to work properly. If it is not checked, then the Innovator login page will be displayed instead. In any case, the user MUST be logged into the domain first. Advantageously, if they are not, then they will be unable to access the Innovator system. Security for the virtual directory should be set to one of the NT validation schemes and ANONYMOUS should be disabled.

3) MIXED: This mode will first try to authenticate based on the domain username and password (NTLM mode), and if unsuccessful will try the Innovator system database (EIMS). Unlike the NTLM mode, in this mode, the user does not have to be logged into the network first.

The Reportlogo variable is the file name and path of the graphical logo displayed on all of the report pages.

The SysAdminEmail variable is the e-mail account that receives e-mails that cannot be delivered by the Innovator system. It also serves as the e-mail account that will receive messages when the user clicks on the I Am Not link described above.

The DefaultDomain variable is the domain in which the user's password will be authenticated. Optimally, the server from which the Innovator system is running should have easy access to this domain via the organization's network. For example, configuring the Innovator system server such that it requires communicating with various Domain Controllers to authenticate users will slow system login time.

The CompanyName variable is the name that is shown on reports and various pages throughout the Innovator system.

Review Committee Member and Chair Process

Review Committee Innovations

In preferred processes, innovations are moved through levels of analysis and review during their entire development. The review committee is the primary body that performs this function. The Review Committee Innovations step allows review committee members to display all of the innovations that have been forwarded to them for review. The Review Committee Innovations step is similar to the My Innovations step in the Innovator's process. However, it provides additional graphical representation, filtering of the display and navigation to additional review committee steps.

Review committee members navigate to the Review Committee Innovations step by expanding the Management menu item on the Home page menu, as illustrated in FIGS. 19a and 30. The user selects the Review menu item and the Review Committee Innovations page (see FIG. 31) opens.

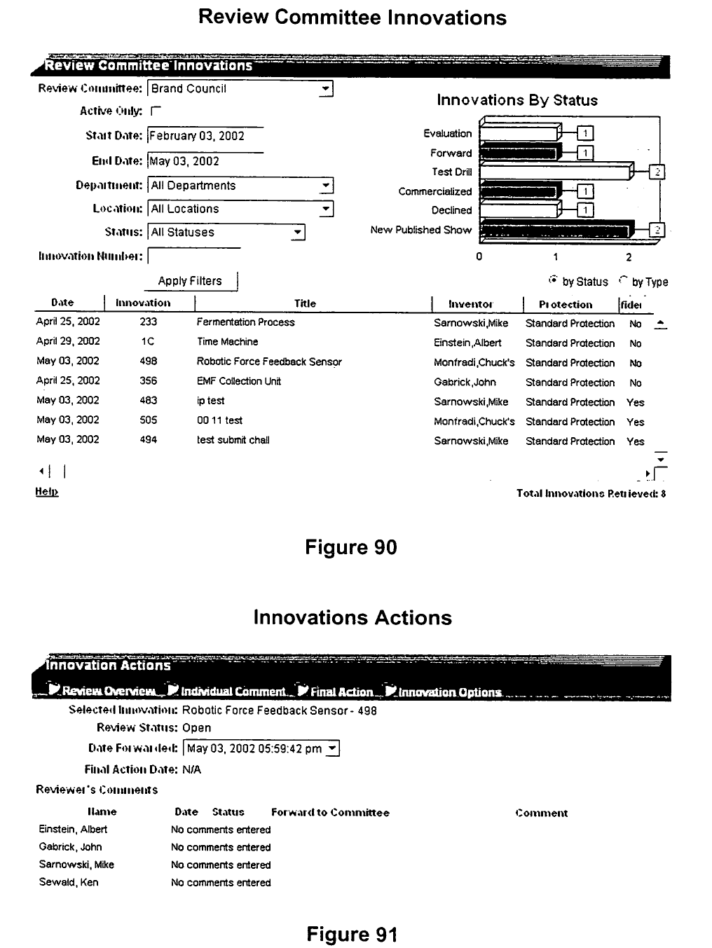

On the Review Committee Innovations page (see FIG. 90) all of the innovations submitted to a particular review committee are optimally displayed in an interactive data grid. (See the My Innovations step in the Innovator's process for a description of the data grid.) Selecting a review committee from the drop-down list box labeled Review Committee at the top of the page will display the innovations submitted to that review committee. If a user belongs to multiple review committees, this is the preferred method used to display the different lists of innovations submitted to each committee. Data pertaining to the innovations is advantageously displayed in columns and includes information such as the Date the innovation was submitted, an Innovation Number, the Innovation Title, the Inventor and the Protection level. In addition, the page displays the number of innovations retrieved to populate the data grid.

The Review Committee Innovations page (see FIG. 90) advantageously provides a way to manage large numbers of innovations by entering filter criteria to selectively view only the desired data. For example, to reduce the number of innovations displayed in the data grid, the review committee member filters the innovations by selecting a Department, Location and Status from any or all of the drop-down list boxes provided or entering Start Date, End Date and Innovation Number in any or all of the text boxes provided. If a review committee member wishes to see only innovations that have not had a final action, they check the Active Only check box advantageously provided. Optimally, defaults for the filter criteria are set to return the greatest number of innovations viewable by the user. For example, All Departments, All Locations and All Statuses are the default settings for the above mentioned drop-down list boxes.

In preferred processes, when review committee members select an innovation from the data grid, highlighting it by clicking on it or using the keyboard, the Innovation Actions page (see FIG. 91) opens beneath the data grid. Tabs or buttons are advantageously provided on the Innovation Actions page (see FIG. 91) to navigate review committee members to other steps such as a Review Overview, Individual Comment, Final Action and Innovation Options. In preferred processes, the Innovation Actions page (see FIG. 91) opens with the Review Overview step selected (see step description below). Clicking on Individual Comment button will navigate review committee members to the Add Comments step. If a review committee member is the chair of the committee, clicking on the Final Action button navigates them to the Final Action step. Clicking the Innovation Options button displays a list of steps similar to those available from the Innovator process's Overview page. The user may select from steps such as the Perform An Analysis, Overview or View Analysis Results steps and be navigated to the appropriate pages.

Review Overview

The Review Overview step allows review committee members to display information for the selected review request and the responses of other review committee members.

Users navigate to the Review Overview step from the Review Committee Innovations step as illustrated in FIGS. 30 and 31. When the Review Overview tab is selected on the Innovation Actions page (see FIG. 91) information is displayed such as the Innovation Title, the Review Status, the Date Forwarded and the Final Action Date. In addition, a Reviewer's Comments data grid is displayed containing comments for each review committee member assigned to this innovation. The Reviewer's Comments data grid contains information such as the review committee member's Name, the Date of the input, the suggested Status for the innovation, the name of any review committee the member suggested the innovation be forwarded to and any textual Comment. In preferred processes, all committee members are listed. Those which have not responded yet are displayed with the message “No comments entered.”

Individual Comment

The Individual Comment step allows review committee members to enter comments, the status that should be assigned to the innovation, and the name of the next review committee they recommend. Optimally, users do not have to enter either a status or a next review committee. These only represent the review committee member's opinion with respect to the innovation.

Users navigate to the Individual Comment step from the Review Committee Innovations step as illustrated in FIGS. 30 and 31. When the Individual Comments tab is selected on the Innovation Actions page (see FIG. 91) information is displayed such as the Innovation Title and Number. In addition, text boxes are provided for the review committee member to enter a Subject heading and Comment. Review committee members submit their comments by clicking an advantageously provided Save button or they may begin the comment process again by clicking an advantageously provided Reset button to clear their entries before saving.

In addition, during this step the page contains a Comments frame with a data grid displaying all other comments for the review. The grid contains such information for each comment as the Subject, commenting review committee member's Name and the Date of the input. Should the user want to view the comment in detail, an All Comments button is advantageously provided to navigate the user to the View All Comments for a Particular Innovation step in the Innovator Process.

Final Action

The Final Action step may be performed by a review committee member who is also the chair for the review committee. In preferred processes, the Final Action step will be available only to the review committee chair. This step allows the review committee chair to enter what the final disposition of the innovation should be based on all of the review committee members' feedback. This input is the same as for an Individual Comment, but it becomes the recorded result of the review. For example, if a next review committee were selected, then the innovation would appear as an action item in the new review committee's notices. In addition, in this example, the innovation would become inactive for the chair's review committee and thus disappear from the data grid on the Review Committee Innovations page (see FIG. 90).

Users navigate to the Final Action step from the Review Committee Innovations step as illustrated in FIG. 31. When the Final Action tab is selected on the Innovation Actions page (see FIG. 91) information is displayed such as the Innovation Title and Number. In addition, drop-down list boxes are provided for the review committee chair to select a Final Status and and Next Committee. In addition, a Comment text box is advantageously provided for the final comment by the review committee chair. Review committee chairs then submit the final actions by clicking an advantageously provided Save button or they may begin the final action process again by clicking an advantageously provided Reset button to clear their entries before saving.

### INDUSTRIAL APPLICABILITY

The disclosed system for automating and managing an intellectual property environment in an organization over a network of computers is unique. The system has user interface displays on each of the computers, and includes computer readable code devices in computer readable media for displaying, and methods for displaying, a number of management tools in the form of frames or screens or pages that provide for users submitting and sharing innovations, innovation analysis, finding experts for collaboration and evaluation of innovations, highlighting, spotlighting and showcasing innovations and innovation development, creating and responding to innovation challenges, and timelining, tasking and workflow peculiar to innovation management in an organization, the combination of which amounts to a breakthrough in intellectual property management and automation. IP organizations and companies worldwide, using the technology disclosed, can expect to reduce employee turn-over, technology leakage and mismanagement, and litigation, while increasing levels of profitable exploitation of new technology, technology advancement, and contribution to betterment of the world.

In compliance with the statute, the invention has been described in language more or less specific as to structural features. It is to be understood, however, that the invention is not limited to the specific features shown, since the means and construction shown comprise preferred forms of putting the invention into effect. The invention is, therefore, claimed in any of its forms or modifications within the legitimate and valid scope of the appended claims, appropriately interpreted in accordance with the doctrine of equivalents.

1. A method of stimulating intellectual property development in an organization by rewarding innovation, or rewarding inventors for sharing their ideas, by giving organization wide recognition to inventors for generating ideas and submitting them to the organization, and/or by giving organization wide recognition from time to time for best ideas submitted, the method comprising at least one of the following steps implemented over a network of computers:
a. displaying on a plurality of the computers a spotlight frame that gives recognition to a selectable number of selectable innovation ideas submitted;
b. displaying on a plurality of the computers a highlights frame that gives at least one ‘innovations submitted’ statistic for a top department in the organization, or top location or for the most prolific innovators;
c. displaying on at least one computer an option box giving an inventor the option of keeping a submitted idea private until such time as the inventor chooses to share the idea, where sharing the idea makes the idea viewable over the network, while keeping it private restricts who may view the idea;
d. displaying on a plurality of the computers a showcase frame or page for each department and location, each showcase frame or page displaying at least one set of data from the group of data consisting of a selectable number of innovations that are judged by the organization to be outstanding for each department and location, a number representing the number of employees participating in invention submissions for a previous time period of selectable length, a number representing the number of innovations shared with the organization compared with the number of innovations submitted to the organization but kept private;
e. displaying on at least one computer a personal statistics page that is customized for each inventor who make an idea submission to the organization, the page displaying one or more of, a number representing the number of hits on the inventor's profile, a number representing the number of submissions by the inventor, results of an analysis performed on an idea submitted by the inventor;
f. displaying on at least one computer a listing of organizational development resources and/or collaboration available for each submitted idea, and/or a form for requesting organizational development resources and/or collaboration.

2. A method of stimulating collaboration in intellectual property development in an organization, the method comprising at least one of the following steps implemented over a network of computers:
a. displaying on a plurality of the computers a profile of each user on the network outlining one or more of, the user's areas of expertise, degrees held, papers published, and the like, each profile optionally accessible through a link wherever the user's name appears in the network;
b. displaying on a plurality of the computers a ‘find an expert’ page, the page providing means to anyone in the organization to search through the profiles for an individual with needed resources or expertise;
c. displaying on a plurality of the computers a page displaying at least substantially all of the innovations shared in the organization, the page searchable for ideas of interest to a user;
d. displaying on a plurality of the computers a page or frame by which a user may submit comments on, and associated with, a shared innovation, or whereby the user may enter an organization wide discussion about the shared innovation;
e. displaying on a plurality of the computers a page or frame whereby, once a user has located a second user that may be of collaborative help, the user may forward a submitted idea to the second user, the second user, also referred to as an expert, optionally receiving a notice on their computer with a link to the submitted idea;
f. displaying on a plurality of the computers a page or frame for creating a collaboration agent, whereby a user may automatically and at selected intervals search the network for collaboration possibilities;
g. displaying on a plurality of the computers
(1) a page or frame where a user may specify desired resources of in the form of person-hours, equipment and/or budget for each idea submitted by the user and (2) a page or frame where any second user viewing the submitted idea may contribute resources to the idea;

3. A method of stimulating and directing intellectual property development in an organization by directing a plurality of users to focus on a selected number of selected innovation challenges, the method comprising at least one of the following steps implemented over a network of computers:
a. displaying on a plurality of the computers a challenges frame on a homepage of the network, the frame containing a selectable number of innovation areas considered by the organization to be most important, whereby a user may submit an innovation to the challenge, and a selected manager is optionally notified of the submission;
b. after an innovation is submitted to the challenge, creating a search agent to periodically search the network and associated databases for similar innovations, whereby similar innovations are reported to the submitting user, and optionally to the selected manager;
c. after an innovation is submitted to the challenge, creating a search agent to periodically search various Internet innovation databases, such as the USPTO database, and to use Internet search engines, such as Google, whereby similar innovations are reported to the submitting user, and optionally to the selected manager.

4. A method of managing intellectual property development in an organization by displaying for a manager one or more of a selected number of management tools, the method comprising at least one of the following steps implemented over a network of computers:
a. displaying on a plurality of the computers a Perform An Analysis screen or page, whereby a selectable question set comprising a plurality of questions each having at least one weighting factor, is applied to a submitted innovation and scored according to answers generated in response to the question set, and further whereby the generated score is representative of what factor(s) are most important to the organization;
b. displaying on a plurality of the computers an innovation comments screen or page, whereby a user can submit comments to another user about a selected innovation that has been submitted to the organization;
c. displaying on a plurality of the computers an activity log that shows a user and/or a manager how much user activity an innovation has generated, whereby the user or manager receives a measure of how much interest the innovation has in the organization;
d. displaying on a manager computer any innovation submitted and shared on the network, substantially immediately after the innovation is first submitted and shared, whereby the manager may optionally comment back to the user submitting the innovation, or send back an analysis, or start an organization wide discussion, or forward the innovation to another user demonstrating interest in the area of the innovation, or assign tasks to the innovator and/or others in the organization;
e. displaying on a plurality of the computers at least one screen or page selected from timeline screen or page, workflow screen or page and tasks screen or page whereby a manager or a innovator may see progress and direction of development for a selectable submitted innovation.

5. A method of managing intellectual property development in an organization by displaying for a manager one or more of a selected number of tracking tools, the method comprising at least one of the following steps implemented over a network of computers, each tracking tool associated with a database on the network::
a. time/date stamping every submitted innovation or idea as it enters the database, wherein the stamp is permanently associated with the innovation;
b. attaching selected electronic documents to the innovation, wherein a document creation date is permanently associated with the document and with the innovation to which it is attached;
c. updating an electronic document with a new time/date stamp, whereby previous versions are retained in the database with their time/date stamps;
d. attaching paper documents and/or material objects such as spreadsheets, drawings or sketches, source code, material samples, white paper, lab notebooks, prototypes or other objects, to an innovation, by automatically creating a unique bar code for the document or object, the bar code containing document or object descriptive information and document or object physical location information, the bar code printable and attachable to the document or object, and permanently associated with the innovation to which they are attached;
e. step d above, except it is performed by a user other than the inventor;
f. taking a digital snapshot of the submitted innovation and its current state, including all of its attachments, description, analysis results, comments, and the like, and time/date stamping the snapshot and storing it in the database.

6. A method of quantitatively evaluating employees according to their creativity, innovation and/or contribution to the intellectual property of the organization by evaluating innovation contribution and quality for each employee, the method comprising at least one of the following steps implemented over a network of computers:
a. generating and displaying on a manager's computer a plurality of reports summarizing for each employee the employee's innovation contribution and the quality and impact to date of each innovation submitted by the employee;
b. generating and displaying on a manager's computer a report of review committee comments and recommendations as to a particular employee;
c. generating and displaying on a manager's computer an employee's personal statistics page.

7. In a computer system implemented over a network of computers for managing intellectual property in an organization, the improvement comprising a innovation submission display on a plurality of the computers that provides a user an option of either submitting the innovation so that it is available for immediate sharing with all other users on the network, or submitting the innovation so that it is only available to the user and to selected organization management, wherein the innovation submission is in any case time/date stamped immediately upon submission.

8. The system of claim 7 wherein, the user first opts for submitting the innovation so that it is only available to the user and to selected organization management, and then opts for submitting the innovation so that it is available for immediate sharing with all other users on the network.

9. A computer system comprising a network of computers and a plurality of users, the system providing stimulation of intellectual property development in an organization, the system further comprising at least one of the following:
a. a user interface display on each of a plurality of the computers, the display displaying a spotlight frame that gives recognition to a selectable number of selectable innovation ideas submitted;
b. a user interface display on each of a plurality of the computers, the display displaying on a plurality of the computers a highlights frame that gives at least one ‘innovations submitted’ statistic for a top department in the organization, or top location or for the most prolific innovators;
c. a user interface display on each of a plurality of the computers, the display displaying on at least one computer an option box giving an inventor the option of keeping a submitted idea private until such time as the inventor chooses to share the idea, where sharing the idea makes the idea viewable over the network, while keeping it private restricts who may view the idea;
d. a user interface display on each of a plurality of the computers, the display displaying on a plurality of the computers a showcase frame or page for each department and location, each showcase frame or page displaying at least one set of data from the group of data consisting of a selectable number of innovations that are judged by the organization to be outstanding for each department and location, a number representing the number of employees participating in invention submissions for a previous time period of selectable length, a number representing the number of innovations shared with the organization compared with the number of innovations submitted to the organization but kept private;
e. a user interface display on each of a plurality of the computers, the display displaying on at least one computer a personal statistics page that is customized for each inventor who make an idea submission to the organization, the page displaying one or more of, a number representing the number of hits on the inventor's profile, a number representing the number of submissions by the inventor, results of an analysis performed on an idea submitted by the inventor;
f. a user interface display on each of a plurality of the computers, the display displaying on at least one computer a listing of organizational development resources and/or collaboration available for each submitted idea, and/or a form for requesting organizational development resources and/or collaboration.

10. A computer system comprising a network of computers and a plurality of users, the system providing stimulation for collaboration in intellectual property development in an organization, the system further comprising at least one of the following:
a. a user interface display on each of a plurality of the computers, the display displaying on a plurality of the computers a profile of each user on the network outlining one or more of, the user's areas of expertise, degrees held, papers published, and the like, each profile optionally accessible through a link wherever the user's name appears in the network;
b. a user interface display on each of a plurality of the computers, the display displaying on a plurality of the computers a ‘find an expert’ page, the page providing means to anyone in the organization to search through the profiles for an individual with needed resources or expertise;
c. a user interface display on each of a plurality of the computers, the display displaying on a plurality of the computers a page displaying at least substantially all of the innovations shared in the organization, the page searchable for ideas of interest to a user;
d. a user interface display on each of a plurality of the computers, the display displaying on a plurality of the computers a page or frame by which a user may submit comments on, and associated with, a shared innovation, or whereby the user may enter an organization wide discussion about the shared innovation;
e. a user interface display on each of a plurality of the computers, the display displaying on a plurality of the computers a page or frame whereby, once a user has located a second user that may be of collaborative help, the user may forward a submitted idea to the second user, the second user, also referred to as an expert, optionally receiving a notice on their computer with a link to the submitted idea;
f. a user interface display on each of a plurality of the computers, the display displaying on a plurality of the computers a page or frame for creating a collaboration agent, whereby a user may automatically and at selected intervals search the network for collaboration possibilities;
g. a user interface display on each of a plurality of the computers, the display displaying on a plurality of the computers
(1) a page or frame where a user may specify desired resources of in the form of person-hours, equipment and/or budget for each idea submitted by the user and (2) a page or frame where any second user viewing the submitted idea may contribute resources to the idea;

11. A computer system comprising a network of computers and a plurality of users, the system providing direction of intellectual property development in an organization, the system further comprising a user interface display on each of a plurality of the computers, the display displaying on a plurality of the computers a challenges frame on a homepage of the network, the frame containing a selectable number of innovation areas considered by the organization to be most important, whereby a user may submit an innovation to the challenge, and a selected manager is optionally notified of the submission;

12. A computer system comprising a network of computers and a plurality of users, the system providing management of intellectual property development in an organization, the system further comprising at least one of the following:
a. a user interface display on each of a plurality of the computers, the display displaying on a plurality of the computers a Perform An Analysis screen or page, whereby a selectable question set comprising a plurality of questions each having at least one weighting factor, is applied to a submitted innovation and scored according to answers generated in response to the question set, and further whereby the generated score is representative of what factor(s) are most important to the organization;
b. a user interface display on each of a plurality of the computers, the display displaying on a plurality of the computers an innovation comments screen or page, whereby a user can submit comments to another user about a selected innovation that has been submitted to the organization;
c. a user interface display on each of a plurality of the computers, the display displaying on a plurality of the computers an activity log that shows a user and/or a manager how much user activity an innovation has generated, whereby the user or manager receives a measure of how much interest the innovation has in the organization;
d. a user interface display on each of a plurality of the computers, the display displaying on a manager computer any innovation submitted and shared on the network, substantially immediately after the innovation is first submitted and shared, whereby the manager may optionally comment back to the user submitting the innovation, or send back an analysis, or start an organization wide discussion, or forward the innovation to another user demonstrating interest in the area of the innovation, or assign tasks to the innovator and/or others in the organization;
e. a user interface display on each of a plurality of the computers, the display displaying on a plurality of the computers at least one screen or page selected from timeline screen or page, workflow screen or page and tasks screen or page, whereby a manager or a innovator may see progress and direction of development for a selectable submitted innovation.

13. A computer readable medium containing program instructions for providing stimulation of intellectual property development in an organization, the computer readable medium comprising at least one of the following:
a. computer readable code devices for displaying on a plurality of the computers a spotlight frame that gives recognition to a selectable number of selectable innovation ideas submitted;
b. computer readable code devices for displaying on a plurality of the computers a highlights frame that gives at least one ‘innovations submitted’ statistic for a top department in the organization, or top location or for the most prolific innovators;
c. computer readable code devices for displaying on at least one computer an option box giving an inventor the option of keeping a submitted idea private until such time as the inventor chooses to share the idea, where sharing the idea makes the idea viewable over the network, while keeping it private restricts who may view the idea;
d. computer readable code devices for displaying on a plurality of the computers a showcase frame or page for each department and location, each showcase frame or page displaying at least one set of data from the group of data consisting of a selectable number of innovations that are judged by the organization to be outstanding for each department and location, a number representing the number of employees participating in invention submissions for a previous time period of selectable length, a number representing the number of innovations shared with the organization compared with the number of innovations submitted to the organization but kept private;
e. computer readable code devices for displaying on at least one computer a personal statistics page that is customized for each inventor who make an idea submission to the organization, the page displaying one or more of, a number representing the number of hits on the inventor's profile, a number representing the number of submissions by the inventor, results of an analysis performed on an idea submitted by the inventor;
f. computer readable code devices for displaying on at least one computer a listing of organizational development resources and/or collaboration available for each submitted idea, and/or a form for requesting organizational development resources and/or collaboration.

14. A computer readable medium containing program instructions for providing stimulation for collaboration in intellectual property development in an organization, the computer readable medium comprising at least one of the following:
a. computer readable code devices for displaying on a plurality of the computers a profile of each user on the network outlining one or more of, the user's areas of expertise, degrees held, papers published, and the like, each profile optionally accessible through a link wherever the user's name appears in the network;
b. computer readable code devices for displaying on a plurality of the computers a ‘find an expert’ page, the page providing means to anyone in the organization to search through the profiles for an individual with needed resources or expertise;
c. computer readable code devices for displaying on a plurality of the computers a page displaying at least substantially all of the innovations shared in the organization, the page searchable for ideas of interest to a user;
d. computer readable code devices for displaying on a plurality of the computers a page or frame by which a user may submit comments on, and associated with, a shared innovation, or whereby the user may enter an organization wide discussion about the shared innovation;
e. computer readable code devices for displaying on a plurality of the computers a page or frame whereby, once a user has located a second user that may be of collaborative help, the user may forward a submitted idea to the second user, the second user, also referred to as an expert, optionally receiving a notice on their computer with a link to the submitted idea;
f. computer readable code devices for displaying on a plurality of the computers a page or frame for creating a collaboration agent, whereby a user may automatically and at selected intervals search the network for collaboration possibilities;
g. computer readable code devices for displaying on a plurality of the computers
(1) a page or frame where a user may specify desired resources of in the form of person-hours, equipment and/or budget for each idea submitted by the user and (2) a page or frame where any second user viewing the submitted idea may contribute resources to the idea;

15. A computer readable medium containing program instructions for providing direction of intellectual property development in an organization, the computer readable medium comprising computer readable code devices for displaying on a plurality of the computers a challenges frame on a homepage of the network, the frame containing a selectable number of innovation areas considered by the organization to be most imnortant whereby a user may submit an innovation to the challenge.

16. A computer readable medium containing program instructions for providing management of intellectual property development in an organization, the computer readable medium comprising at least one of the following:
a. computer readable code devices for displaying on a plurality of the computers a Perform An Analysis screen or page, whereby a selectable question set comprising a plurality of questions each having at least one weighting factor, is applied to a submitted innovation and scored according to answers generated in response to the question set, and further whereby the generated score is representative of what factor(s) are most important to the organization;
b. computer readable code devices for displaying on a plurality of the computers an innovation comments screen or page, whereby a user can submit comments to another user about a selected innovation that has been submitted to the organization;
c. computer readable code devices for displaying on a plurality of the computers an activity log that shows a user and/or a manager how much user activity an innovation has generated, whereby the user or manager receives a measure of how much interest the innovation has in the organization;
d. computer readable code devices for displaying on a manager computer any innovation submitted and shared on the network, substantially immediately after the innovation is first submitted and shared, whereby the manager may optionally comment back to the user submitting the innovation, or send back an analysis, or start an organization wide discussion, or forward the innovation to another user demonstrating interest in the area of the innovation, or assign tasks to the innovator and/or others in the organization;
e. computer readable code devices for displaying on a plurality of the computers at least one screen or page selected from timeline screen or page, workflow screen or page and tasks screen or page, whereby a manager or a innovator may see progress and direction of development for a selectable submitted innovation.
